(19) United States
(12) Patent Application Publication
(10) Pub. No.: US 2026/0342586 A1
(43) Pub. Date: Oct. 29, 2026

(54) ARTIFICIAL INTELLIGENCE GOVERNANCE AND REALIGNMENT SYSTEMS

(71) Applicant: REGULAYER, LLC, Wilmington, DE (US)

(72) Inventor: Louisa Johnson Bullock, Encinitas, CA (US)

(21) Appl. No.: 19/660,193

(22) Filed: Apr. 27, 2026

Related U.S. Application Data
(60) Provisional application No. 63/795,501, filed on Apr. 27, 2025.
(60) Provisional application No. 63/797,050, filed on Apr. 29, 2025.
(60) Provisional application No. 63/815,849, filed on Jun. 1, 2025.
(60) Provisional application No. 63/822,651, filed on Jun. 12, 2025.

(51) Int. Cl. H04L 9/32; H04L 9/00; H04L 9/08

(52) U.S. Cl. CPC H04L 9/3236; H04L 9/0891; H04L 9/50

(57) ABSTRACT

Systems and methods for artificial intelligence governance and realignment systems. A system includes a processor that receives a single browser-executable file containing artificial-intelligence-generated content. The processor determines a content hash match by recomputing a content hash associated with the artificial-intelligence-generated content. The processor validates an attestation signature using a public key embedded in artificial-intelligence-generated content. The processor renders the artificial-intelligence-generated content at the user interface in response to validating the attestation signature and determining the content hash match.

### CROSS-REFERENCE TO RELATED APPLICATIONS

This application claims priority to: U.S. Provisional Application No. 63/822,651 filed on Jun. 12, 2025; U.S. Provisional Application No. 63/815,849 filed on Jun. 1, 2025; U.S. Provisional Application No. 63/797,050 filed on Apr. 29, 2025; U.S. Provisional application No. 63/795,501 filed on Apr. 27, 2025, the disclosures of which are incorporated herein by reference in their entirety.

### BACKGROUND

### Technical Field

This disclosure relates to artificial intelligence computing systems, and more specifically to systems and methods for governing safety compliance of artificial intelligence computing systems and AI-generated data.

### Description of Related Art

Existing systems are architecturally incapable of true privacy and effective governance. AI-generated content delivered via conventional web platforms inevitably leaves multiple persistent traces—across browsers, devices, servers, and third-party infrastructure—that allow sensitive information to be reconstructed or exfiltrated. As a result, the industry relies on privacy-by-policy (trust and promises) that are overlooked, bypassed, ignored, or not detected. Further, governance mechanisms likewise operate almost entirely post-hoc, using probabilistic detectors after content has already been generated and distributed. These systems are reactive, easily bypassed, and incapable of enforcing policy at render time. Further, because these determinations are external and retrospective, they neither travel reliably with the content across platforms nor remain inseparable from it as the content is modified or redistributed.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting.

FIG. 1 depicts a block diagram of the SignalDrop™ Single-File Artifact, organized into four tiers: the eight architectural modules, the six DryRun reference sub-components, the three-role delivery mode, and the external dual-sink registry anchors.

FIG. 2 depicts the SDKontrol™ Governance Kernel Eight-Layer Pipeline, showing the complete render-time decision flow for the embedded runtime governance kernel.

FIG. 3 depicts the cryptographic byproduct attestation module, illustrating the complete flow from attestation inputs through signature generation to three-way non-repudiation binding and dual-sink anchor commitment.

FIG. 4 depicts a session-scope diagram for Session Ephemerality with Zero Persistent Trace, showing the browser session boundary, the complete set of volatile in-memory artifacts that exist only during the session, the exhaustive list of prohibited persistent sinks, and the explicit purge flow triggered at session termination.

FIG. 5 depicts the HumanMark™ Six-State Disclosure Machine, comprising a state-transition diagram for the three quantitative scoring states and three absorbing override states, together with the locked composite formula displayed at the bottom of the figure.

FIG. 6 depicts the Tamper-Evident Audit Trail with Dual-Sink Root Anchor, showing the complete append-only hash-chain log structure, the root anchor computation, the local-queue DDIL fallback, and the simultaneous commitment to two independent registry sinks.

FIG. 7 depicts a tabular matrix of the three-role delivery mode, showing the per-role configuration across seven operational dimensions for end-user delivery, counsel review, and reseller packaging.

FIG. 8 depicts the universal substrate showing the SignalDrop™ universal substrate, the fourteen presently enumerated branded-instance species in three rows below it, and the branded-instance doctrine statement at the bottom.

FIG. 9 depicts a transaction-flow diagram of Governed Distributed Transaction Processing, illustrating the complete flow from originator through the SignalDrop™ artifact to the recipient, through transaction execution and settlement, with the governance receipt produced as an inseparable computational byproduct, and the no-clearing-house/no-third-party-data-retention property.

FIG. 10 depicts the PUF-ZKP Hardware-Bound Zero-Knowledge Governance Attestation architecture, illustrating the complete flow from the Physically Unclonable Function primitive through ZK proof generation to the ZK attestation artifact, recipient-side verification, and the Energy-Pattern-as-Proof extension.

FIG. 11 depicts the architecture of the HumanMark™ continuous human-authorship attestation subsystem.

FIG. 12 depicts the six-state state machine implemented by the state resolver of FIG. 11, comprising three reversible quantitative scoring states—GREEN, AMBER, RED—and three absorbing override states—TAMPERED, UNVERIFIABLE, EXPIRED—together with the calibrated-score axis HMS_cal graduated from 0 to 100 along the central vertical axis of the figure, and the override-transition arrows extending laterally from each scoring state to the corresponding override state.

FIG. 13 depicts the locked mathematical formulas used by the composite scorer and Platt calibrator of FIG. 11, illustrated in three labeled panels: a composite raw score formula, a Platt Sigmoid calibration formula, and a dynamic weight renormalization formula with enumerated availability-mask examples.

FIG. 14 depicts a tabular enumeration of the canonical field schema of the HumanMark™ Token (HMT) generated by the HMT token generator of FIG. 11, structured as a four-column table comprising a CBOR map key, a CBOR-encoded type, a semantic description, and a field reference number for each field.

FIG. 15 depicts the three-tier trust anchor license model that organizes the SignalDrop™ ecosystem into three operationally distinct tiers—Tier 1 creator tools, Tier 2 verification, and Tier 3 certification authorities—each interacting with a shared append-only registry implemented as a Merkle-anchored append-only log.

FIG. 16 depicts an end-to-end transaction-flow diagram of the HumanMark™ content lifecycle across three swim-lane actors—creator, platform, and recipient—illustrating the nine sequential operational steps from content composition through recipient-side rendering of the HumanMark™ Index.

FIG. 17 is a cross-sectional schematic of the flexible substrate stack.

FIG. 18 is a block diagram of the governance architecture of the substrate.

FIG. 19 is a finite-state diagram of the physical-refusal tamper-response state machine.

FIG. 20 is a schematic of the unified magneto-optical layer of FIG. 17, showing that three otherwise distinct functions—energy harvesting, non-volatile memory storage, and optical actuation—may be performed simultaneously within a single material volume of bismuth-substituted rare-earth iron garnet.

FIG. 21 is a block diagram of the distributed cognition mesh comprising a plurality of substrate instances—illustrated in FIG. 21 as nodes—connected by inter-substrate signaling paths that may operate over passive backscatter (FCC Part 15 compliant) and over photon-magnon optical actuation as further described below.

FIG. 22 is a cross-reference diagram showing the integration of SignalDrop™ single-file delivery format and the sibling HumanMark™ continuous human-authorship score system.

FIG. 23 is a combined architectural diagram illustrating three interrelated properties of the substrate.

FIG. 24 is a system-architecture diagram depicting the eight-layer pre-inference runtime governance enforcement kernel and the cleanroom architectural isolation boundary between the kernel and the governed artificial-intelligence system.

FIG. 25 is a data-flow diagram of the three-vector Bias Override Index™ (BOI) computation, showing three orthogonal measurement-vector inputs feeding a composite scorer with locked composite weights, a Platt calibrator with locked calibration parameters, and a four-state enforcement machine output with absorbing SAFE_HALT override.

FIG. 26 is a state-transition diagram of the four-state enforcement machine illustrating the GREEN, AMBER, RED, and SAFE_HALT states together with the +2-point hysteresis bands applied at every quantitative state-transition threshold.

FIG. 27 is a sequence diagram of the cleanroom-architectural-isolation message-passing protocol between the governance kernel and the governed artificial-intelligence system, illustrating the unidirectional channel and the enumerated zero-shared-resource guarantees that distinguish the cleanroom architecture from sandboxing, containerization, or virtualization as those terms are conventionally used.

FIG. 28 is a structural diagram of the CognitiveIdentityMap™ (CIM) runtime constraint, showing a named operator at the top of the figure, ten enumerated CIM fields in the middle of the figure, and a CIM-intercept layer at the lower portion of the figure positioned downstream of an LLM output and upstream of any physical action.

FIG. 29 is a flowchart of the cross-layer fusion logic implementing an immutable precedence engine that combines heterogeneous governance signals from a drift-detection layer (DriftGuard™ Layer 1, emitting one of {GREEN, AMBER, RED, SAFE_HALT}), a consent-and-proxy layer (SynapseProxy Layer 2, emitting one of {PROCEED, BLOCK, REVIEW}), and a CognitiveIdentityMap™ evaluation layer (emitting one of {allow, prohibited, escalate}) into a single deterministic enforcement verdict.

FIG. 30 is a time-series diagram of the predictive kinematic drift-detection subsystem, illustrating an observed BOI(t) trajectory plotted as filled circles along a time axis, a second-order Taylor extrapolation BOI_predicted (t+ΔT)=BOI(t)+v(t)·ΔT+½·a(t)·ΔT² depicted as a dashed projection arrow extending forward in time, a horizontal threshold line at the GREEN-state entry threshold of 85, a horizontal ceiling line at the integer-100 BOI scale ceiling, and a SAFE_HALT-fired-at-t marker depicted at the time at which the proactive override is triggered.

FIG. 31 is an architecture diagram of the Meta-Governance Integrity Monitor with dual-jurisdiction sinks, illustrating a primary governance kernel maintaining a primary SHA3-512 hash-chained ledger, a meta-governance monitor maintaining a cryptographically independent secondary ledger keyed under a distinct keypair from the primary ledger, a Meta-Drift Index (MDI) computation block, a United-States-jurisdiction sink dashed-boundary, and a European-Union-jurisdiction sink dashed-boundary.

FIG. 32 (in addition to depicting the generic computing system described elsewhere in this specification) is a structural diagram of the Automated Regulatory Evidence Package Generator, showing a canonical audit ledger source maintaining a SHA3-512 hash-chained record of all governance events, a framework-mapping engine transforming the canonical ledger into framework-specific evidence packages, and a plurality of regulatory-framework target outputs comprising 21 C.F.R. Part 11 (FDA electronic records), EU GMP Annex 11 (Computerised Systems), EU AI Act Articles 9, 14, 15, 50, and 52, FDA-EMA Joint Principles 2026 Principle 9, NIST AI RMF (Govern, Map, Measure, Manage functions), and a cross-framework hash-chain-traceability output.

FIG. 33 is a phase-portrait diagram of the SomaLayer™ Lyapunov-stability proof for the personality-drift co-dependency engine, showing on the left side of the figure a coupled system with coupling parameter κ greater than a critical value κ_critical, exhibiting trajectories that converge to a closed equilibrium orbit (globally asymptotically stable), and showing on the right side of the figure an uncoupled system with κ equal to zero, exhibiting trajectories diverging exponentially from the origin (exponential divergence and finite-time blowup).

FIG. 34 is a closed-loop block diagram of the MODLAYER™/FELTSTACK: LAUGH™ structured-humor parasympathetic-override system, illustrating a wearable sensor array measuring heart-rate variability (HRV), galvanic skin response (GSR), blood pressure, and a cortisol-proxy metric, an autonomic classifier distinguishing sympathetic-dominant from parasympathetic-dominant operator state, a governance-intercept block implementing the BOI/CIM/SomaLayer™ gating, a humor taxonomy enumerating six humor classes, an artificial-intelligence humor generator selecting humor under the six-class taxonomy with temporal-decay habituation prevention, a wearable actuator delivering humor through haptic, audio, or display modalities, a biometric-feedback block measuring post-intervention biometric delta, and a response-profile-update block adjusting future humor selection based on the measured response.

FIG. 35 is a treatment-protocol flowchart for the method-of-use claim directed to mast-cell-driven fibrotic disease with runtime governance, illustrating a patient-enrolled stage with patient phenotype CD25-positive cutaneous mastocytosis, a screening stage encompassing tryptase, interleukin-13, and biopsy assessment, a four-layer combination regimen comprising a mast-cell-stabilization layer L1, a fibrinolytic-enzyme-therapy layer L2, a mitochondrial-restoration layer L3, and a transforming-growth-factor-beta suppression layer L4, a runtime-governance-kernel boundary encompassing BOI-plus-predictive-drift gating, CognitiveIdentityMap™-based required_escalations enforcement, and 21 C.F.R. Part 11—compliant audit-ledger evidence generation, a concurrent-anticoagulation contraindication decision diamond, a fibrinolytic-suspension and clinician-escalation branch entered on YES, and a continue-regimen branch entered on NO.

FIG. 36 is a unified-architecture overview diagram showing thirteen claim territories integrated within a single governance stack with a shared cryptographic substrate at the center of the figure, illustrating each territory as a labeled node radially connected to the shared substrate; additional architectural primitives and territories beyond the thirteen enumerated in FIG. 36 are disclosed elsewhere in the specification and are integrated with the thirteen-territory core as a known scope-expansion.

FIG. 37 depicts how the current subject matter can be configured to be implemented in a system.

### DETAILED DESCRIPTION OF CERTAIN EMBODIMENTS

In the following detailed description, reference is made to the accompanying drawings, which form a part of the present disclosure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure. For example, a system or apparatus may be implemented or a method may be practiced using any number of the aspects set forth herein. In addition, such a system or apparatus may be implemented or such a method may be practiced using other structure, functionality, or structure and functionality in addition to or other than one or more of the aspects set forth herein.

Similarly, methods disclosed herein may be performed by one or more computer processors configured to execute instructions retrieved from a computer-readable storage medium. A computer-readable storage medium stores information, such as data or instructions, for some interval of time, such that the information can be read by a computer during that interval of time. Examples of computer-readable storage media are memory, such as random-access memory (RAM), and storage, such as hard drives, optical discs, and flash memory.

Unless otherwise defined, each technical or scientific term used herein has the same meaning as commonly understood by one of ordinary skill in the art to which this disclosure belongs. In accordance with the claims that follow and the disclosure provided herein, the following terms are defined with the following meanings, unless explicitly stated otherwise.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a device or method consisting essentially of the elements as defined herein would not exclude other materials or steps that do not materially affect the basic and novel characteristic(s). “Consisting of” shall mean that the devices, systems, and methods include the recited elements and exclude anything more than a trivial or inconsequential element or step. Embodiments defined by each of these transitional terms are within the scope of this disclosure.

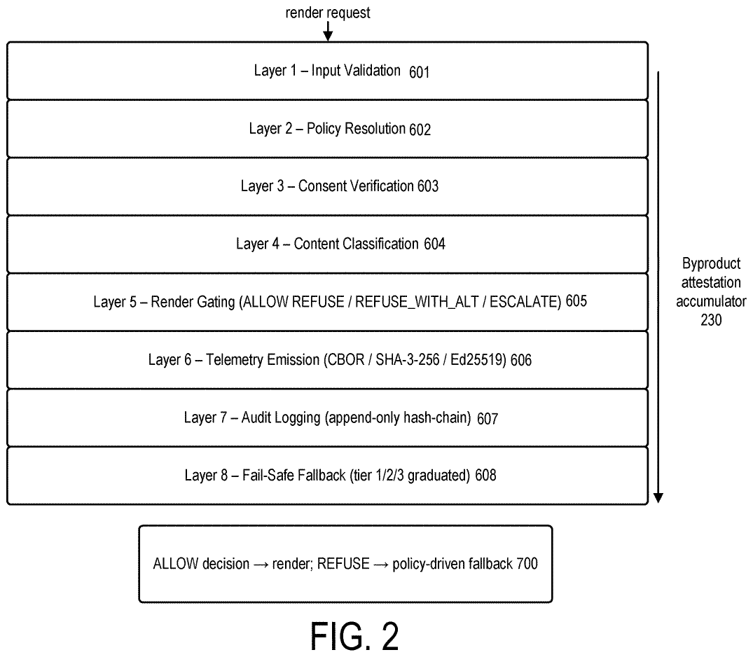

As used herein, the term “rendering protocol” refers to the rendering pipeline, rendering path, or render-time governance pipeline by which an artificial-intelligence-generated content artifact is processed at render time within the embedded governance kernel, including without limitation the eight-layer pipeline of FIG. 2 (input validation, policy resolution, consent verification, content classification, render gating, telemetry emission, audit logging, and fail-safe fallback) and any functional equivalent thereof. The terms “rendering protocol,” “rendering pipeline,” “rendering path,” and “render-time governance pipeline” are used interchangeably herein.

The problems described in the background are addressed by providing a novel single-file, browser-executable architecture that converges five elements never before achieved together: embedded local governance, cryptographic attestation as a computational byproduct, strictly ephemeral sessions with zero residual trace, embedded commerce without external navigation, and continuous human-authorship attestation bound to the content itself.

A fundamentally different architecture based on render-time enforcement is presented. This is a privacy-by-architecture rather than privacy-by-policy applied by prior systems. In a privacy-by-architecture system, sensitive information cannot be disclosed because it was never captured, stored, or transmitted in a form that persists beyond the interaction. In a privacy-by-architecture system, sensitive information is structurally unavailable to consumers and enterprises deploying generative artificial-intelligence content.

Instead of remote servers, governance policy is evaluated locally in a privacy-by-architecture. For example, the governance policy may be evaluated inside the same browser-executable file that delivers the content, before reaching the user interface. A co-resident governance kernel may produce cryptographic attestation as an automatic byproduct of rendering rather than as a separate logging step. Additionally, the co-resident governance kernel may issue deterministic enforcement actions (such as allow, refuse, or escalate). Unlike prior enterprise governance systems, this approach requires no centralized policy servers, inference endpoints, audit databases, or license checks, reducing privacy exposure and operational fragility.

Authentication and governance enforcement occurs at render time inside the delivery artifact, producing allow/refuse decisions before content reaches the user interface. The authentication and governance enforcement may resolve the conflict between persistent attestation authentication and non-persistent sessions by anchoring cryptographic proof to an external root of the artifact while keeping all session state transitory. Sources cannot be stripped because content, governance, commerce, and authorship are embodied in the same bytes.

Unlike other systems—such as C2PA, watermarking schemes, post-hoc detectors, confidential computing, enterprise governance platforms, TEEs, blockchains, or offline payment systems—none achieve the five-element convergence in a single file or enforce governance as an inseparable computational residue of rendering itself. The record exists because the event occurred, not because a separate system later logged it. This “attestation-as-byproduct” approach transforms AI content delivery into a materially different artifact governed by architectural constraints rather than policy promises, defining a new class of zero-residency, self-governing AI delivery systems.

Cryptographic proof needs something permanent that others can verify later, while a truly ephemeral session leaves no lasting trace. The cryptographic proof solves that problem by separating what must last from what must disappear. The cryptographic proof is anchored to an external, persistent root, while the content, governance logic, transaction records, and audit data exist only during the session and are destroyed afterward. When the session ends, a cryptographic hash chain links the ephemeral session to the permanent anchor. As a result, the proof endures, even though the session itself leaves nothing behind.

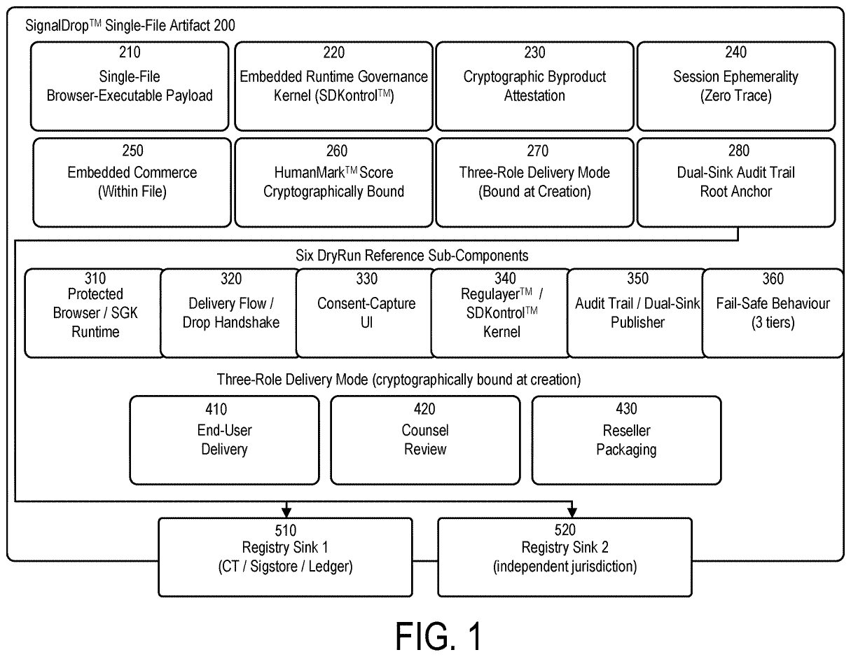

FIG. 1 depicts a block diagram of the SignalDrop™ Single-File Artifact 200, organized into four tiers: the eight architectural modules (210-280), the six DryRun reference sub-components (310-360), the three-role delivery mode (410-430), and the external dual-sink registry anchors (510, 520). The architectural structure may be defined by the co-presence of all eight modules within a single browser-executable file.

The browser executable payload 210 is a self-contained, standalone file that executes within a standard web browser user agent without requiring server-side rendering, external plugin installation, or network dependency beyond the initial retrieval of the file itself. The browser executable payload may include: a HyperText Markup Language (HTML) file embedding inline ECMAScript and Cascading Style Sheets; a WebAssembly (WASM) binary packaged with its runtime glue code; a Portable Document Format (PDF) container executing embedded JavaScript per ISO 32000-2; a Scalable Vector Graphics (SVG) document containing scripting; a signed-exchange bundle per the World Wide Web Consortium WebPackage specification; an Electronic Publication (EPUB) container with embedded scripting; and a functional equivalent thereof packaged in any file format permitting browser-native execution of the complete payload without external runtime installation.

The browser executable payload contains a complete, policy-driven governance enforcement kernel 220—herein referred to by the trademark SDKontrol™—that evaluates every render-time decision against a machine-readable policy specification and classifies each decision as ALLOW, REFUSE, REFUSE_WITH_ALTERNATIVE, or ESCALATE. The kernel may be co-resident in the same scripting context as the content; resolved at parse time from a trusted registry; compiled to WebAssembly for isolated execution; deployed as a service worker intercepting resource requests; deployed as a browser extension; executed within a trusted execution environment composed into the browser via Janus-class TEE-WebAssembly-plus-native-composition; and a functional equivalent thereof.

As the embedded kernel processes each render decision through its eight-layer pipeline, the kernel simultaneously accumulates the attestation input set and produces a cryptographic signature binding those inputs to the specific rendering event using a cryptographic byproduct attestation 230. The attestation cannot be produced without running the governance pipeline; the governance pipeline cannot complete without producing the attestation; and therefore the attestation is architecturally inseparable from the act of rendering. The cryptographic attestation is not a separate post-hoc verification step, external service call, or manually triggered process. The attestation input set may comprise: the content hash computed under SHA-3-256 (or a functional equivalent thereof) over canonicalized artifact content at render time; the semantic version identifier of the embedded kernel; the computed HumanMark™ Score and its resolved state; the SHA-3-256 hash of the governing policy specification; a cryptographically random 128-bit session nonce bound to an sdk_instance_id; and a timestamp in RFC 3339 millisecond UTC format. The attestation envelope may be implemented as any of the following species: a JSON Web Signature (JWS) object per RFC 7515 using EdDSA (Ed25519 per RFC 8032); a Cryptographic Message Syntax (CMS) envelopedData structure per RFC 5652; a detached Ed25519 signature over a canonical CBOR-serialized payload per RFC 8949 § 4.2.1; a SHA-3 Merkle-leaf commitment; a zk-SNARK proof carrying the input set as public inputs; and a functional equivalent thereof.

The pipeline may execute without leaving any persistent artifact on the recipient device storage subsystem after session termination using an ephemerality module 240. Features of ephemerality include: pure in-memory execution where JavaScript variables, Document Object Model state, and WebAssembly linear memory are never written to IndexedDB, localStorage, sessionStorage, Cache API, or the File System Access API; explicit purge logic overwriting all sensitive TypedArrays containing content data, HumanMark™ Score values, attestation signatures, and audit entries with cryptographically random data sourced from the Web Crypto API crypto.getRandom Values( ) function prior to dereference and garbage collection; execution within an incognito or private-browsing browser context suppressing history recording, cache retention, and cookie persistence; execution within a sandboxed iframe element with storage API restrictions imposed through a restrictive Content Security Policy; and execution within an ephemeral browser context instantiated via the Chromium DevTools Protocol Target.createTarget( ) or equivalent programmatic instantiation. Session termination triggers the destruction of derived keys such that any attestation output bound to the session is verifiable against the dual-sink anchor but cannot be regenerated from the session.

The payload contains a complete commercial-transaction module 250 executing wholly within the file boundary, comprising five sequential stages: consent capture, item selection, checkout, payment processing, and receipt generation. Payment processing species include: tokenized iframe integration with Stripe Checkout Elements, Adyen Drop-in, PayPal Smart Payment Buttons, Apple Pay, or Google Pay; W3C Payment Request API invocation within the payload scripting context; DriftCard™ ephemeral payment-credential integration producing single-use virtual card numbers valid for one transaction; governed distributed transaction processing, in which governance receipts are produced as a computational byproduct of transaction execution; direct embedded-wallet signing for cryptocurrency settlement against a distributed ledger; and a functional equivalent thereof. All payment pathways preserve session ephemerality through cryptographic binding of the transaction record to the session's audit chain rather than to any persistent user-identifier surface.

A HumanMark™ Score 260 is computed, resolved, cryptographically bound to the attestation, and displayed on first content render without user interaction or external network query. The score is a composite calibrated probability on the integer scale from zero to one hundred (0-100) computed as a weighted linear combination of four orthogonal analyzer outputs with the following locked weights: w_SE=0.28 for Semantic Entropy; w_SF=0.32 for Stylometric Fingerprint; w_GA=0.25 for Generative Artifact (entering the composite inverted as one minus GA); and w_PV=0.15 for Provenance Verification. The weights sum exactly to unity. The raw composite is transformed into a calibrated probability through Platt scaling with locked composite parameters α=0.45 and β=0.18; the Semantic Entropy sub-score is separately Platt-calibrated with sub-score-specific parameters α=0.35 and β=0.12 prior to composite entry. Content-type modulation is applied through modality-specific gamma factors: γ_text=1.0, γ_image=0.8, γ_audio=0.9, γ_video=0.85. Section-level aggregation uses a weighted harmonic mean encoding a weakest-link property. The resolved state is one of six: GREEN at HMS≥85; AMBER at 40≤HMS≤84; RED at HMS≤39; and three absorbing override states UNVERIFIABLE, TAMPERED, and EXPIRED. A ±2-point hysteresis band is applied at every quantitative threshold to prevent oscillation. The full HumanMark™ Score architecture is incorporated by reference from the sibling utility patent application of the same inventor titled “HumanMark™ Content Provenance System” being filed contemporaneously.

The payload is created in a delivery mode module 270. For example, the payload may be created in one of three mutually exclusive delivery modes, selected at generation time by the originator and cryptographically bound to the artifact through inclusion of the mode identifier in the content hash computation and attestation signature input set. Modification of the mode identifier invalidates the content hash and therefore the attestation signature. One of the three modes may include delivering the full content experience renders with embedded commerce enabled subject to consent verification, and displaying a compact HumanMark™ Score badge. This mode may be focused on the delivery to the end user in which the recipient is the intended consumer of the content.

Another mode includes delivering the full content rendered with enhanced governance visibility, and delivering an expanded HumanMark™ Score computation panel. The HumanMark Score computation panel may display all four weighted dimensions with sub-scores and a complete policy specification viewer is presented with human-readable annotations. A full audit-trail explorer is presented, and payment processing is disabled with a redacted commerce preview. This mode may be delivered for counsel-review, in which the recipient is a legal or compliance professional evaluating the content prior to authorizing broader distribution.

Another mode includes delivering a chain-of-custody transfer interface, recipient-list management, mode-reassignment controls, and commission-structure display for reseller-packaging, in which the recipient is an authorized intermediary redistributing the payload under governed sub-policies, with a sub-policy editor. Mode transition between the three modes may not be permitted within a single artifact session and requires creation of a new artifact.

Every state change within the render-time governance pipeline is recorded in an append-only hash-chain log, with each entry signed under Ed25519 by the embedded kernel's signing key. The root anchor of the hash chain is simultaneously committed to at least two independent registry sinks such that compromise of any single sink does not invalidate the audit trail. Registry sink species include: Certificate Transparency logs per IETF RFC 6962 or RFC 9162; sigstore Rekor transparency logs; permissioned distributed ledgers with Byzantine-fault-tolerant consensus (Hyperledger Fabric, R3 Corda, Quorum); public blockchain ledgers (Ethereum, Bitcoin, Polygon, Solana); centralized audit services operated by independent trust anchors, accounting firms, or compliance service providers; academic or research institutional archives; threshold-cryptographic multi-signature notarization services; trusted timestamp authorities per RFC 3161; and a functional equivalent thereof. Sink independence requires distinct administrative control, distinct technical infrastructure, and distinct legal jurisdiction. Local-queue fallback with exponential backoff preserves audit integrity under denied, degraded, intermittent, or low-bandwidth (DDIL) environments.

### SignalDrop DryRun Reference Modules

SignalDrop™ Delivery Flow/Drop Handshake. Create→deliver→render pipeline. Creation-side SDK packages content+kernel+HumanMark™ score+policy bundle into a single file under canonical CBOR serialization, Ed25519 signature over SHA-3-256 digest, and dual-sink anchor publication. Transport over HTTPS, email attachment, peer-to-peer WebRTC/IPFS/Bluetooth OBEX/LoRa/sneakernet, QR code, NFC tap, or physical media. Render pipeline bootstraps governance kernel loader, verifies signature, checks anchor, evaluates policy, renders content only on GREEN state.

Consent-Capture UI. Disclosure+explicit consent+tamper-evident state. Displays HumanMark™ Score immediately; displays AI-source disclosure; displays policy summary; displays consent request. Records consent with timestamp, session nonce, and recipient attestation. Signs consent record under Ed25519. Anchors to dual-sink root. Enumerable consent mechanisms: WebAuthn biometric (RFC 8809/W3C WebAuthn Level 3), FIDO2 CTAP2, TPM 2.0 attestation, passkey, smartcard, click-through with device attestation, voice-captured consent with audio attestation, gesture-captured consent with motion attestation, and a functional equivalent thereof.

Regulayer™/SDKontrol™ Governance Kernel. Policy-driven decision engine. Eight-layer architecture: input validation, policy resolution, consent verification, content classification, render gating, telemetry emission, audit logging, fail-safe fallback. Classifies each decision ALLOW/REFUSE/REFUSE_WITH_ALTERNATIVE/ESCALATE. Co-resident with the protected runtime or invoked from a trusted registry, WebAssembly module, service worker, browser extension, or TEE-composed Janus-class module.

Audit Trail/Dual-Sink Anchor Publisher. Append-only tamper-evident hash-chain log of every state change: file open, governance-kernel decisions, consent events, content render, commerce events, refusal events, session close, storage purge. Canonical CBOR serialization, SHA-3-256 hash chain, Ed25519 per-entry signature. Dual-sink commitment to two or more independent registries.

Fail-Safe Behaviour. Deterministic non-bypassable fallback on failure of any other sub-component. Three graduated tiers: Tier 1 component-level (most-restrictive policy gating applied to the failed component, session integrity preserved for non-failed components); Tier 2 pipeline-level (governance transferred to a minimal pre-validated fallback kernel with hardcoded ALLOW/REFUSE rules); Tier 3 session-level (session terminated, all memory purged, refusal rendered with diagnostic indicator).

### Three-Role Delivery Mode-Summary Matrix

| | End-User | Counsel | Reseller |
|---|---|---|---|
| Element | Delivery | Review | Packaging |
| Recipient | Intended | Legal/ | Authorized |
| | consumer | compliance | intermediary |
| | | professional | |
| Content | Full experience, | Full content | Condensed |
| rendering | all interactive | with annotation | preview |
| | elements | capability | |
| HMS | Compact badge, | Expanded | Distributor |
| display | upper-right | panel with | format |
| | corner | 4 sub-scores | |
| Commerce | Enabled | Disabled | Enabled per |
| | subject to | (preview only) | reseller sub- |
| | consent | | policy |
| Policy | Summary | Full spec | Sub-policy |
| viewer | tooltip | viewer with | editor |
| | | human | |
| | | annotations | |
| Audit trail | Standard | Full explorer | Maximum |
| | granularity | with signature | granularity with |
| | | verification | chain-of-custody |
| Transition | Not permitted; | Not permitted; | Not permitted; |
| to another | new artifact | new artifact | new artifact |
| mode | required | required | required |

The SignalDrop™ architecture is a universal substrate. Embodiments for regulated verticals are provided by configuring: (i) the content-type permitted within the artifact; (ii) the policy rule population applicable to the regulatory framework of the vertical; (iii) the HumanMark™ Score semantic interpretation appropriate to the vertical; (iv) the user interface color scheme, typography, and iconography of the branded instance; and (v) the enumerable consent mechanisms, audit sink species, and transport mechanisms supported. The branded-instance registry enumerates the species presently claimed: MedDrop™, EduDrop™, MortgageDrop™, TrainingDrop™/Certificate Drop™, DropShop™, Quote Engine™, Connection Drop™, OrgDrop™, Note Drop™, BrandLayer™, Aerospace Passenger-Experience Deployment, Governed Internet Deployment, Resonance Identification System, and the EQVOS SignalDrop-vertical aspect, together with any functionally equivalent branded instance for a regulated vertical not specifically enumerated.

The architectural model depicted in FIG. 1 may be defined by the convergence of five architectural features into a single browser-executable artifact: (a) embedded runtime governance that executes at the recipient's browser rather than at a server; (b) cryptographic attestation produced as a byproduct of that execution rather than as a separate act; (c) session ephemerality such that no trace persists on the recipient device after the session ends; (d) embedded commerce executing wholly within the file boundary without external navigation; and (e) continuous human-authorship attestation bound to every rendered content element. The convergence may resolve a specific architectural incompatibility between elements (b) and (c): persistent attestation versus non-persistent session. The resolution is cryptographic binding of ephemeral session state to a persistent dual-sink root anchor external to the session. The attestation is anchored externally; the session is ephemeral internally; the binding between them is the hash chain committed at session termination.

The browser-native execution property of the artifact 200 depicted in FIG. 1 is material for three reasons. First, the browser-native execution property eliminates the installation barrier: the recipient need not install specialized software. Second, the browser-native execution property exploits the mature sandboxing, cryptographic, and rendering capabilities of contemporary browsers (Web Crypto API, Subtle Crypto, WebAuthn, Web Workers, WebAssembly, WebGPU, Service Workers, Content Security Policy, Subresource Integrity, Payment Request API, Web Speech API) as the execution substrate, thereby reducing the implementation burden and the trust-surface of the artifact itself. Third, the browser-native execution property permits the same artifact to execute across heterogeneous devices-desktop and laptop computers, mobile phones, tablets, set-top boxes, automotive infotainment systems, aerospace passenger in-seat displays, and any device hosting a compliant browser-without per-device porting.

In some embodiments, size bounds of the browser-executable payload 210 of FIG. 1 may range between four (4) kilobytes for minimal ShrinkDrop™-discipline artifacts and twenty (20) megabytes for full multimodal content-heavy artifacts. The ShrinkDrop™ sub-thirty-kilobyte discipline is a tight-budget embodiment suitable for denied, degraded, intermittent, or low-bandwidth (DDIL) environments. ShrinkDrop™-discipline artifacts targeting≤30 kilobytes may be suitable for SMS-link distribution, QR-code encoding, email-attachment distribution at scale, and DDIL-environment delivery. Standard artifacts target≤2 megabytes and support typical text plus inline image content. Multimodal-heavy artifacts target≤20 megabytes and support full audio and video embedding. Performance bounds at rendering may include: kernel initialization≤50 milliseconds on mid-tier consumer hardware; first-content render≤200 milliseconds; full artifact signature and hash verification≤100 milliseconds; and session-termination purge≤500 milliseconds.

The artifact 200 of FIG. 1 may follow a six-phase lifecycle: (1) Creation, in which the originator's SDK packages content, embedded kernel, HumanMark™ Score, policy bundle, metadata, and modal configuration into the single file; (2) Signing, in which the originator computes the content hash under SHA-3-256 over canonical bytes, signs with Ed25519, and publishes the root anchor to at least two independent registry sinks; (3) Delivery, in which the signed artifact is transmitted to the recipient over any transport preserving file integrity; (4) Integrity verification, in which the recipient's runtime recomputes the hash, verifies the signature, and validates the root anchor; (5) Rendering, in which the governance kernel gates every render-time decision and the content is rendered only on ALLOW decisions; and (6) Expiry, in which the session terminates, memory is purged, the final audit-trail entry is committed to the anchor, and no persistent trace remains on the recipient device. The entire lifecycle may operate without any server-side processing after initial retrieval.

Artifact integrity for the artifact 200 of FIG. 1 may be protected by a two-layer cryptographic structure. The outer layer may be the content-hash signature: the originator computes the SHA-3-256 digest of the canonical-bytes representation of the artifact and signs the digest with Ed25519 (RFC 8032) using a signing key stored in a hardware-rooted key-store (platform Secure Enclave, Trusted Platform Module, Hardware Security Module, threshold-secret-shared distributed key generation, or FIDO2 resident-key storage). The inner layer may be the audit-chain hash chain: each audit entry contains a SHA-3-256 hash of the preceding entry, forming an immutable chain from the genesis entry (containing session initialization parameters and a constant seed hash) through the session-termination entry. Every audit entry is individually signed under Ed25519 by the embedded kernel's per-session derived signing key. The combination may permit verification that the artifact has not been modified since originator signing, and that the internal audit chain has not been tampered with during execution.

The artifact payload of FIG. 1 may be organized into six sections: (i) a header section containing the artifact UUID, creation timestamp, mode identifier, policy version, kernel version, and originator public key; (ii) a content section containing the AI-generated or AI-assisted content in one or more modalities; (iii) a kernel section containing the embedded governance kernel executable code; (iv) a policy section containing the machine-readable policy specification in canonical CBOR; (v) an HMS metadata section containing the pre-computed HumanMark™ Score components and bindings; and (vi) a signature section containing the Ed25519 signature over the SHA-3-256 digest of the canonical-bytes serialization of sections (i) through (v). Sections (i) through (v) are covered by the signature; section (vi) is the signature itself.

FIG. 2 depicts the SDKontrol™ Governance Kernel Eight-Layer Pipeline, showing the complete render-time decision flow for the embedded runtime governance kernel 220.

An incoming render request enters at the top of the pipeline. Input validation layer 601 may validate, sanitize, and schema-validate all data entering the governance decision flow, including artifact metadata, content assets, the policy specification, consent data, and any runtime-configurable external inputs. Invalid inputs cause input validation layer 601 to emit a REFUSE decision with a diagnostic code and trigger a fail-safe.

Policy resolution layer 602 may map the validated metadata, content classification, and recipient context to the applicable rule set through a cascading hierarchy of global, content-type-specific, mode-specific, vertical-specific, and artifact-specific rules. The policy and conflict resolution may follow a strict precedence order in which TAMPERED supersedes EXPIRED, which supersedes UNVERIFIABLE, which supersedes REFUSE, and so on through ALLOW.

Consent verification layer 603 confirms that all required recipient consents have been obtained, schema-validated, signature-verified, nonce-checked against replay, and matched to the governing policy version in a consent verification. Missing or expired consent causes Layer 3 to emit a REFUSE with a content classification layer 604 solicitation directive.

Content classification layer 604 assigns modality (text, image, audio, video, interactive), content-type modulation factor γ, sensitivity level, and regulatory applicability to each content element, thereby determining which policy rule subset render gating layer 605 will evaluate.

Render gating layer 605 is the central decision stage for applying the resolved rules to each content element and classifies the outcome as ALLOW, REFUSE, REFUSE_WITH_ALTERNATIVE, or ESCALATE. An ALLOW command issues when all applicable rules evaluate to true with no WARNING-severity or higher findings. A REFUSE command issues when at least one CRITICAL rule fails without override consent. A REFUSE_WITH_ALTERNATIVE command issues when a WARNING-level failure has a compliant alternative specified in the policy. An ESCALATE command routes the decision to a human-in-the-loop responder.

Telemetry emission layer 606 classifies each governance event under canonical CBOR, hashes it under SHA-3-256, chains it to the preceding audit entry, signs it under Ed25519, and either transmits it to the configured audit sink or enqueues it locally under DDIL fallback.

Audit logging layer 607 maintains the append-only, cryptographically linked, Ed25519-signed hash chain of all governance events within the session, committing the root anchor to at least two independent registry sinks at session termination.

Fail-Safe Layer 608 provides deterministic non-bypassable graduated response: Tier 1 applies most-restrictive policy gating to the failed component while preserving session integrity for functioning components; Tier 2 transfers governance to a minimal pre-validated fallback kernel; Tier 3 terminates the session, purges all memory, and displays a refusal indicator. In no tier is governance bypassed: failure closes the system. Running alongside Layers 1 through 8 is the byproduct attestation accumulator 230, which simultaneously collects the attestation input set as the pipeline executes. The attestation cannot be produced without running the pipeline, and the pipeline cannot complete without producing the attestation. At the bottom, decision box 700 shows the final output: an ALLOW decision permits content to render; a REFUSE or other non-ALLOW outcome invokes the policy-driven fallback specified in Fail-Safe Layer 608.

The eight-layer pipeline of FIG. 2 may be implemented as eight modules corresponding to the eight architectural layers, with thirteen (13) unit tests enforcing correct behavior across all four decision outcomes (ALLOW, REFUSE, REFUSE_WITH_ALTERNATIVE, ESCALATE) and all three fail-safe tiers. The eight modules with their respective approximate line counts may comprise: input_validation.py implementing validate_artifact_metadata( ) validate_content_assets( ) validate_policy_spec( ) validate_consent_data( ) and validate_external_inputs( ) with REFUSE+TAMPERED emission on failure; policy_resolution.py implementing resolve_policy (artifact_metadata, content_classification, recipient_context) returning a rule_set through the cascade of global, content-type, mode, vertical, and artifact-specific rules; consent_verification.py implementing verify_consent (consent_record, policy_version, nonce_cache) returning a Boolean with schema validation, signature verification, check, freshness and nonce uniqueness; content_classification.py implementing classify_content (element) returning the tuple (modality, gamma_factor, sensitivity, regulatory_applicability, hms_state); render_gating.py implementing gate_render (element, applicable_rules) returning ALLOW, REFUSE, REFUSE_WITH_ALTERNATIVE, or ESCALATE per the meta-rule logic of layer 605; telemetry_emission.py implementing emit_event (event_type, payload) with canonicalization to CBOR, hashing under SHA-3-256, signing under Ed25519, and append-or-queue under sink unavailability; audit_logging.py implementing append_audit_entry( ) compute_chain_hash( ) sign_entry( ) and commit_root_anchor( ) that maintains the hash chain and the dual-sink commit at termination; and failsafe_fallback.py implementing tier_1_component_fault( ) tier_2_pipeline_fault( ) and tier_3_session_fault( ) with deterministic graduated fallback in which failure closes the system rather than opening it.

The thirteen unit tests for the pipeline of FIG. 2 may comprise: test_allow_decision verifying content satisfying all policy rules receives an ALLOW decision with correct audit entry; test_refuse_decision verifying content violating a prohibitory rule receives a REFUSE decision with blocked render and correct audit entry; test_refuse_with_alternative verifying content requiring alternative receives REFUSE_WITH_ALTERNATIVE and the specified compliant alternative is presented; test_escalate_decision verifying content triggering ESCALATE routes to human-in-the-loop and holds rendering pending that decision; test_cert not found verifying missing certificate causes TAMPERED state and Tier-3 fail-safe; test_revoked_cert verifying revoked issuer certificate causes UNVERIFIABLE state; test_lease_expired verifying expired policy lease causes EXPIRED state and refusal to render; test fork_attack verifying detection of hash-chain fork attempts via chain hash validation; test_consent_missing verifying missing consent record emits Layer 3 REFUSE with Layer 4 consent solicitation directive; test_cdi_threshold_breach verifying Cognitive Drift Index threshold breach causes SAFE_HALT event per the governance-event taxonomy; test_json_receipt_output verifying the JSON Governance Receipt is correctly formed and cryptographically valid; test_replay_attack verifying replay of a consent token at the same (nonce, sdk_instance_id) is detected and refused; and test_signature_tampering verifying signature modification on any entry is detected via Ed25519 verification failure and emits TAMPERED.

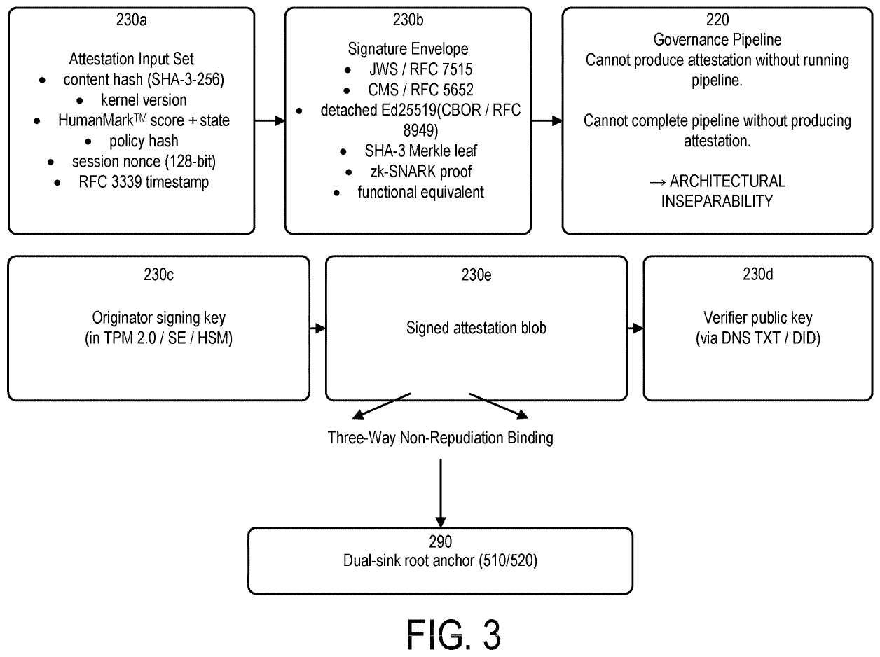

FIG. 3 depicts the cryptographic byproduct attestation module 230, illustrating the complete flow from attestation inputs through signature generation to three-way non-repudiation binding and dual-sink anchor commitment.

The attestation input set 230a is assembled in parallel with governance pipeline execution and comprises the following mandatory fields: the content hash computed under SHA-3-256 over canonicalized artifact content bytes at render time (where canonicalization is modality-specific: Unicode NFC normalization for text, lossless re-encoding or raw-pixel hashing for images, PCM-to-FLAC normalization for audio, and elementary-stream demultiplexing for video); the semantic version identifier of the embedded governance kernel; the HumanMark™ Score including the composite score, the resolved state, all four sub-score values, and the +2-hysteresis flag; the SHA-3-256 hash of the operative policy specification in canonical CBOR serialization; a cryptographically random 128-bit session nonce generated via the Web Crypto API's crypto.getRandom Values( ) function, bound to the sdk_instance_id for anti-replay; and an RFC 3339 millisecond UTC timestamp.

The assembled input set feeds into the signature envelope 230b, which may be implemented as any of the following species: a JSON Web Signature (JWS) object per RFC 7515 using EdDSA (Ed25519 per RFC 8032) or ES256; a Cryptographic Message Syntax (CMS) envelopedData structure per RFC 5652; a detached Ed25519 signature over canonical CBOR per RFC 8949 § 4.2.1; a SHA-3 Merkle-leaf commitment with inclusion proof; a zk-SNARK proof carrying the input set as public inputs; or a post-quantum alternative including CRYSTALS-Dilithium (ML-DSA per FIPS 204), Falcon, or SPHINCS+, optionally hybrid-composed with a classical signature.

The originator signing key 230c is stored in a hardware-rooted key store (platform Secure Enclave, Trusted Platform Module, Hardware Security Module, threshold-secret-shared distributed key generation, or FIDO2 resident-key storage) and is never transmitted; only the signature itself travels with the artifact.

The verifier public key 230d is retrieved by the recipient from embedded artifact metadata, from a DNS TXT record under the originator's domain, or from a Decentralized Identifier (DID) document, enabling recipient-side verification without external API queries. Verification comprises recomputation of the content hash, signature validation, session-nonce anti-replay check, timestamp-plus-TTL validation (default 300-second window, 30-second clock-skew tolerance), and policy-version match. The signed attestation blob constitutes a three-way non-repudiation binding: the originator cannot deny having created the artifact (because only the originator controls the hardware-rooted signing key); the content cannot be repudiated (because the SHA-3-256 content hash covers the exact rendered bytes); and the policy state cannot be repudiated (because the policy hash covers the exact rules applied).

The governance pipeline 220 is shown to the right with the notation that the pipeline cannot produce the attestation without running, and the pipeline cannot complete without producing the attestation—expressing architectural inseparability.

The final output flows downward to the dual-sink root anchor 290, corresponding to registry sinks 510 and 520 of FIG. 1, where the root hash is simultaneously committed to at least two independent registry sinks with distinct administrative control, distinct technical infrastructure, and distinct legal jurisdiction, providing persistent external verifiability even after the ephemeral session has been purged.

The byproduct attestation architecture of FIG. 3 may have three material properties: (i) the attestation cannot be produced without running the kernel, such that post-hoc fabrication is impossible; (ii) the kernel cannot complete without producing the attestation, such that governance cannot be performed without creating its own evidence; and (iii) the attestation is bound to the session in which it was produced, such that cross-session replay is prevented by the per-session nonce. The attestation is not an abstract idea—it is a physical residue of computation already performed, which cannot be achieved by a generic-computer instrumentation that produces attestation as a separate act.

Recipient-side verification of the attestation of FIG. 3 may occur entirely within the recipient's browser without external API queries, registry lookups, or network round-trips, such that the recipient verifies by recomputing the content hash and checking the signature. The verification process may comprise: (V1) recomputation of the content hash from the rendered content and comparison with the attestation content hash; (V2) verification of the attestation signature using the originator's public key embedded in the artifact metadata or retrieved from a DNS TXT record or a Decentralized Identifier (DID) document; (V3) validation of the session nonce against the current session for cross-session replay prevention; (V4) timestamp-plus-TTL validation with a configurable window (default 300 seconds) and a clock-skew tolerance (default 30 seconds); (V5) policy-version match between the attestation policy hash and the active policy; and (V6) optional dual-sink root-anchor lookup for non-revocation proof where the recipient has network connectivity to the sinks, or deferred verification against a local cache in DDIL environments.

For embodiments requiring the strongest session-ephemerality guarantee, the attestation architecture of FIG. 3 may implement a self-destructing attestation chain. The attestation signing key may be derived per-session from the session nonce via HKDF-SHA-3-256. At session termination the per-session key is cryptographically destroyed through explicit zero-overwrite of its TypedArray representation. The per-session signature remains valid against the externally anchored root—recipients can verify—but no party, including the originator, can reproduce the signature or forge a new signature claiming to be from the session. Decryption-triggered attestation generation may include: successful decryption of content segment N automatically triggers attestation generation for segment N+1, thereby binding sequential decryption to sequential attestation. Session termination destroys all derived keys, rendering the attestation unverifiable from the session's internal state but persistently verifiable against the dual-sink anchor 290.

Post-quantum alternatives for the signature envelope 230b of FIG. 3 may include CRYSTALS-Dilithium (ML-DSA per FIPS 204), Falcon, and SPHINCS+, optionally with hybrid signing combining classical and post-quantum signatures in the same envelope to support migration-period deployments without forfeiting backward compatibility with classical verifiers.

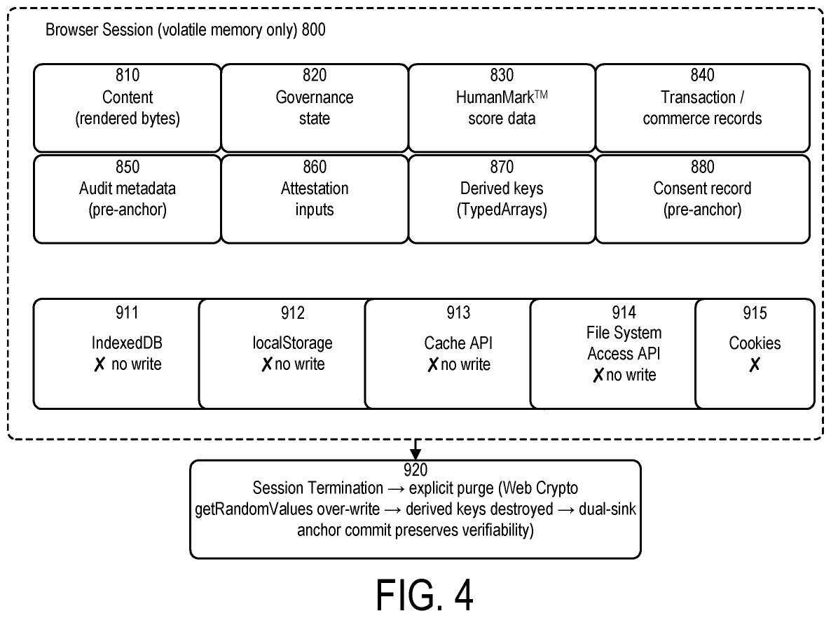

FIG. 4 depicts a session-scope diagram for Session Ephemerality with Zero Persistent Trace, showing the browser session boundary 800, the complete set of volatile in-memory artifacts that exist only during the session (810-880), the exhaustive list of prohibited persistent sinks (911-915), and the explicit purge flow 920 triggered at session termination.

The dashed outer boundary 800 denotes the browser session context in which all SignalDrop™ content, governance state, and transaction data reside exclusively in volatile memory (random-access memory) for the duration of the session and are irrecoverable after session termination.

Within the volatile memory region, eight artifact classes are identified: rendered content bytes 810, held in JavaScript variables and WebAssembly linear memory and never serialized to any persistent store; governance state 820, comprising the kernel's eight-layer pipeline execution context, rule evaluation results, and policy resolution cache; HumanMark™ score data 830, including the composite score, the four sub-score values, the resolved state, the +2-hysteresis flag, and all Platt-calibration intermediate values; transaction and commerce records 840, including cart state, payment intent references, and pre-receipt transaction data; audit metadata 850, comprising the append-only hash-chain log entries accumulated during the session prior to the session-termination anchor commit; attestation inputs 860, comprising the attestation input set elements accumulated as the governance pipeline executes; derived cryptographic keys 870, held in TypedArrays and never persisted—these include the session-derived Ed25519 signing key generated via HKDF-SHA-3-256 from the session nonce, which is destroyed at termination to produce the self-destructing attestation chain property; and the consent record 880, captured and signed during the Consent-Capture UI interaction and held only for the session duration, committed to the audit chain before purge.

Below the volatile memory region, the five prohibited persistent sinks are enumerated: IndexedDB 911, localStorage 912, Cache API 913, File System Access API 914, and cookies 915, each marked with a prohibition indicator. The in-memory-only execution model operates through five technical mechanisms: JavaScript variables and object graphs are stored exclusively in the V8, JavaScriptCore, or SpiderMonkey heap with no serialization to any of the prohibited sinks; WebAssembly linear memory is allocated as a typed-array buffer that is never persisted; Web Worker state is isolated in worker-context memory and cleared when workers terminate; audio and video media streams are processed via MediaStream, Web Audio API, and WebCodecs without MediaSource buffer persistence; and temporary state is held in transient TypedArrays subject to explicit overwrite.

The session termination trigger 920 shows the explicit purge logic: all TypedArrays containing content data, HumanMark™ score values, attestation signatures, and audit entries are overwritten with cryptographically random data sourced from the Web Crypto API's crypto.getRandom Values( ) function; derived keys are destroyed via explicit zero-overwrite of their TypedArray representations; the session root anchor is committed to the dual-sink registry at this moment, preserving external verifiability; and after the commit, no residue of the session remains on the recipient device. The session may execute within an incognito or private-browsing context for enhanced ephemerality, or within a sandboxed iframe with restrictive Content Security Policy directives, or within an ephemeral browser context instantiated via the Chromium DevTools Protocol for near-zero residue deployments.

The session ephemerality architecture of FIG. 4 may be implemented across a graduated set of ephemerality modes, each providing increasing residue-elimination guarantees with corresponding increases in deployment overhead. An in-memory-only mode requires only a standard browser and is suitable for consumer use cases, providing very low residue risk. An explicit-purge mode requires the Web Crypto API crypto.getRandom Values( ) function and is suitable for professional and enterprise use cases, providing very low residue risk. An incognito-context mode requires the user or automation framework to open an incognito browsing window and is suitable for HIPAA, FERPA, and attorney-client privilege use cases, providing minimal residue risk. A sandboxed-iframe mode requires Content Security Policy plus sandbox attributes and is suitable for embedding within host applications, providing minimal residue risk. An ephemeral-browser-context mode requires the Chromium DevTools Protocol or equivalent automation and is suitable for defense, classified, and GDPR-maximalist deployments, providing near-zero residue risk.

The incognito or private-browsing context activation depicted in FIG. 4 may be effected through: browser-native incognito-window opening; ephemeral browser-context instantiation via Chromium DevTools Protocol Target.createTarget( ) with user-data-directory pointed at a temporary filesystem that is deleted on session end; programmatic instantiation within automation frameworks (Puppeteer, Playwright, Selenium) with incognito mode enabled; and equivalent mechanisms in Firefox Gecko (private browsing mode) and Safari WebKit. The sandboxed-iframe configuration may include the sandbox attribute allowing scripts and same-origin access while disabling form submission, popups, pointer lock, and presentation API; a Content Security Policy enforcing default-src ‘self’, script-src with allow-list, connect-src restricted to dual-sink-anchor endpoints only, and img-src permitting data URIs for embedded content; optional frame-src, object-src, and base-uri directives preventing iframe-based escape; and Referrer-Policy: no-referrer to suppress outbound URL disclosure.

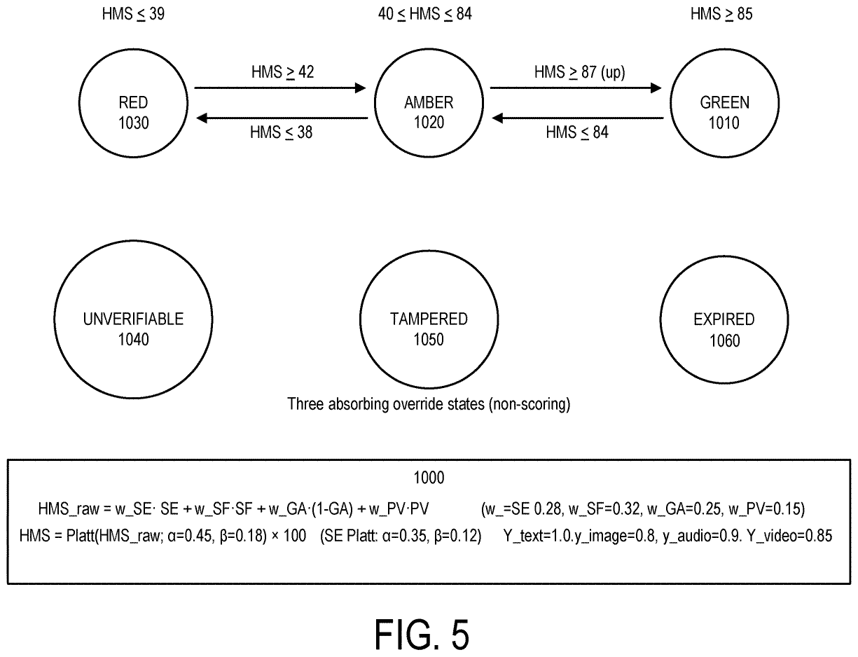

FIG. 5 depicts the HumanMark™ Six-State Disclosure Machine, comprising a state-transition diagram for the three quantitative scoring states and three absorbing override states, together with the locked composite formula displayed at the bottom of the figure.

The three quantitative states are arranged in a horizontal row at the top: GREEN 1010, AMBER 1020, and RED 1030. GREEN is entered when the calibrated HumanMark™ Score (HMS) is at or above 85; the +2-point hysteresis band requires HMS to fall to 83 or below before the state transitions to AMBER. AMBER occupies the band from 40 to 84, inclusive; the hysteresis band requires HMS to reach 87 or above to re-enter GREEN, and HMS to fall to 38 or below to transition to RED. RED is entered when HMS is at or below 39; the hysteresis band requires HMS to reach 42 or above to re-enter AMBER. The threshold labels shown at the top of the diagram (HMS≤39, 40≤HMS≤84, HMS≥85) are the nominal entry thresholds; the transition arrows between states are labeled with the hysteresis-guarded transition values (HMS≥42 to exit RED; HMS≤37 to enter RED; HMS≥87 to enter GREEN; HMS≤83 to exit GREEN).

The three absorbing override states occupy the lower row: UNVERIFIABLE 1040, TAMPERED 1050, and EXPIRED 1060. These states are designated absorbing because, once entered, the state machine does not exit them based on the quantitative HMS value alone-only successful re-verification of the artifact can exit TAMPERED or EXPIRED, and only restoration of sufficient analyzer signal can exit UNVERIFIABLE. UNVERIFIABLE is entered when insufficient analyzer signal is present, specifically when fewer than two of the four analyzer channels return valid outputs under the require-full-coverage policy. TAMPERED is entered on signature verification failure or content-hash mismatch, indicating that the artifact has been modified after originator signing. EXPIRED is entered when the artifact timestamp plus the configured TTL has been exceeded. Rule precedence across all six states is: TAMPERED supersedes all; EXPIRED supersedes UNVERIFIABLE and the quantitative states; UNVERIFIABLE supersedes the quantitative states; the quantitative transitions apply only when no absorbing-state condition is present; within the quantitative states, hysteresis-guarded transitions govern; absent any transition trigger, the current state is preserved.

The formula panel 1000 at the bottom of the figure displays the locked composite formula and calibration parameters. The raw composite score is computed as HMS_raw=w_SE·SE+w_SF·SF+w_GA·(1−GA)+w_PV·PV, with locked weights w_SE=0.28, w_SF=0.32, w_GA=0.25, and w_PV=0.15, summing exactly to unity. The Generative Artifact term enters the composite inverted as (1−GA) because the GA analyzer natively measures likelihood of artificial generation rather than likelihood of human authorship. The raw composite is transformed into a calibrated probability via Platt scaling: HMS_calibrated=1/(1+exp(−(α·HMS_raw+β))) with locked composite parameters α=0.45 and β=0.18; the Semantic Entropy sub-score is separately Platt-calibrated with sub-score-specific parameters α=0.35 and β=0.12 prior to composite entry. The calibrated value is multiplied by 100 and integer-rounded to produce the published HMS on the integer scale from 0 to 100. Content-type modulation is applied through modality-specific gamma factors: γ_text=1.0, γ_image=0.8, γ_audio=0.9, and γ_video=0.85. For structurally composite content, per-section HMS values aggregate to the artifact-level HMS via a weighted harmonic mean encoding a weakest-link sensitivity property, ensuring that a mixed-modality artifact cannot achieve a high artifact-level score by embedding a single high-scoring modality alongside low-scoring modalities.

The section-level aggregation depicted in FIG. 5 may be expressed in closed-form as HMS_artifact=1/Σ_i (γ_i/max (s_i, ε)), with modality-specific gammas γ_text=1.0, γ_image=0.8, γ_audio=0.9, and γ_video=0.85, and with ε=10\hat{ }(−6) inserted as a numerical guard against division by zero. The harmonic-mean encoding may ensure that a mixed-modality artifact cannot achieve a high artifact-level score by embedding a single high-score modality alongside low-score modalities; the weakest modality may pull the artifact-level score toward the compromised extreme, encoding a weakest-link sensitivity property suitable for cross-modality provenance attribution.

The rule precedence governing the six-state machine of FIG. 5 may be encoded as eight ordinal rules: (R1) TAMPERED 1050 supersedes all other states upon detection of a defined tamper condition; (R2) EXPIRED 1060 supersedes UNVERIFIABLE 1040 and the quantitative scoring states upon TTL expiration; (R3) UNVERIFIABLE 1040 supersedes the three quantitative scoring states upon detection of insufficient analyzer signal; (R4-R7) hysteresis-guarded quantitative transitions govern transitions among GREEN 1010, AMBER 1020, and RED 1030 in the absence of any absorbing-state condition; and (R8) absent any transition trigger, the current state is preserved.

The HumanMark™ Score depicted in FIG. 5 may be cryptographically bound to the byproduct attestation 230 of FIG. 1 and FIG. 3 through inclusion in the attestation input set. The binding may ensure that: any modification of the HMS value after attestation generation invalidates the signature, providing tamper detection; the HMS cannot be fabricated or replayed from a different artifact, providing cross-artifact replay prevention; and the HMS computation and state resolution are part of the non-repudiable record established at the moment of rendering, structurally binding the score determination to the cryptographic attestation.

When any analyzer channel of FIG. 5 is unavailable—for example, a pure-image artifact does not support Semantic Entropy text analysis—the system may determine a binary availability mask m=(m_SE, m_SF, m_GA, m_PV), compute the active weight sum S_active=Σ_c m_c·w_c, and renormalize to preserve unit normalization: w′_c=(m_c·w_c)/S_active. If S_active=0 the system may transition to the UNVERIFIABLE state 1040. The worst-case renormalization error may be bounded by the sum of unavailable-channel weights and may be reported in the attestation metadata for downstream verifier assessment, providing a closed-form guarantee on score-stability properties under partial-channel unavailability.

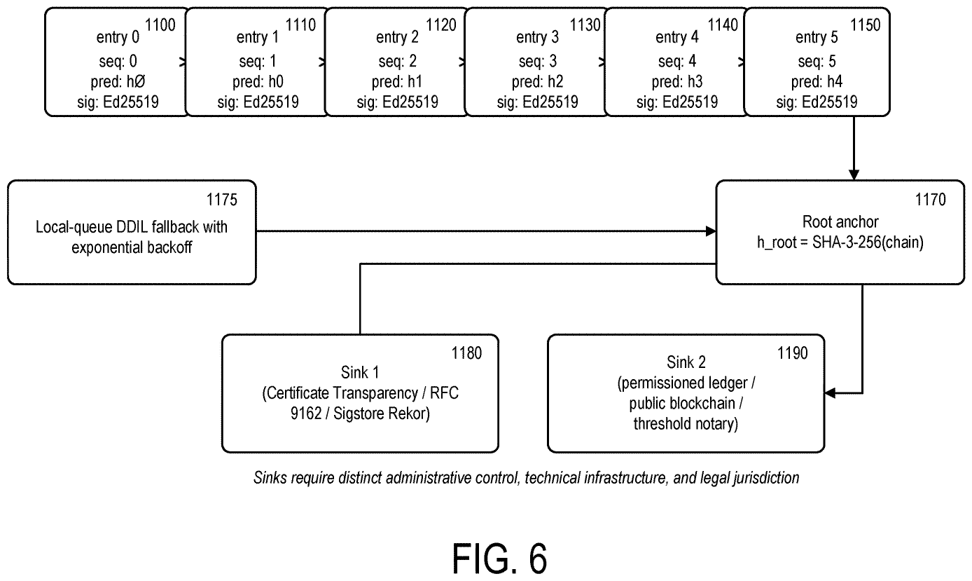

FIG. 6 depicts the Tamper-Evident Audit Trail with Dual-Sink Root Anchor, showing the complete append-only hash-chain log structure (entries 1100 through 1150), the root anchor computation 1170, the local-queue DDIL fallback 1175, and the simultaneous commitment to two independent registry sinks (1180 and 1190). The audit trail is structured as an append-only hash chain in which retroactive modification, deletion, or reordering of any entry is immediately detectable because each entry is cryptographically linked to its predecessor.

Entry 0 1100 is the genesis entry, containing the session initialization parameters (artifact UUID, creation timestamp, mode identifier, policy version, and kernel version) and a constant seed hash derived from a fixed protocol identifier string; its predecessor hash field (pred) references h0, the constant seed.

Entry 1 1110 contains seq=1, the SHA-3-256 hash of entry 0 as its predecessor hash (pred: h0), and an Ed25519 signature (sig: Ed25519) over the canonicalized entry payload. Each subsequent entry (1120, 1130, 1140, 1150) follows the same structure: an event type from the telemetry taxonomy, a monotonically increasing sequence number, the SHA-3-256 hash of the immediately preceding entry as the chain link, a timestamp in RFC 3339 millisecond UTC format, an event-specific payload canonicalized under canonical CBOR per RFC 8949 § 4.2.1, and an Ed25519 signature of the canonicalized entry content by the kernel's per-session derived signing key.

The Ed25519 scheme provides 128-bit security equivalent to RSA-3072 with significantly smaller key and signature sizes (32-byte public keys, 64-byte signatures), enabling high-frequency entry emission within the session's memory budget. Governance events recorded in the audit trail include: file-open and session-initialization; input validation results from input validation layer 601, policy resolution outcomes from policy resolution layer 602; consent capture events from consent verification layer 603; content classification assignments from content classification layer render-gating 604; decisions (ALLOW, REFUSE, REFUSE_WITH_ALTERNATIVE, ESCALATE) from render gating layer 606; telemetry emission receipts from Layer 6; HMS computation and state transitions including each hysteresis-guarded boundary crossing; commerce events (consent, item selection, checkout, payment, receipt); refusal and alternative-presentation events; and session-close and memory-purge markers.

At session termination, the final entry is hashed under SHA-3-256 to produce the root anchor 1170, expressed as h_root=SHA-3-256 (chain). The local-queue DDIL fallback 1175 is shown feeding into the root anchor 1170: when configured sinks are unavailable due to network outage, service degradation, or DDIL-environment constraints, audit entries continue to be generated and appended to the in-memory hash chain; uncommitted entries are retained in an encrypted volatile buffer using AES-256-GCM encryption with a session-derived key from HKDF-SHA-3-256 over the session nonce plus sdk_instance_id; retry attempts follow exponential backoff with initial delay of 1 second, doubling per attempt, up to a maximum of 60 seconds between attempts; the encrypted buffer is purged upon successful commit or at session termination.

The root anchor 1170 is simultaneously committed to Sink 1 1180 and Sink 2 1190. The caption beneath notes that sinks require distinct administrative control, distinct technical infrastructure, and distinct legal jurisdiction. Sink 1 1180 may be implemented as a Certificate Transparency log per IETF RFC 6962 or RFC 9162, a sigstore Rekor transparency log, or a functional equivalent thereof. Sink 2 1190 may be implemented as a permissioned distributed ledger (Hyperledger Fabric, R3 Corda, Quorum), a public blockchain ledger (Ethereum, Bitcoin, Polygon, Solana), a threshold-cryptographic multi-signature notarization service, a trusted timestamp authority per RFC 3161, or a functional equivalent thereof. Compromise of any single sink does not invalidate the audit trail's integrity guarantee because the root hash is independently held by each sink; an adversary must simultaneously compromise both sinks under different administrative control and legal jurisdiction to suppress the audit evidence.

Sink pairings for the dual-sink architecture of FIG. 6 may include: Certificate Transparency plus sigstore Rekor for software-development provenance; Certificate Transparency plus permissioned blockchain for regulated industries requiring public plus auditor-verifiable anchoring; permissioned blockchain plus notarized hash chain for enterprise-internal deployments; and a distributed Merkle-tree log plus a trusted timestamp authority for minimum-viable dual-sink deployments. The selection of sinks may be made by the originator at artifact creation time according to the regulatory and operational requirements of the deployment vertical.

A concrete end-to-end embodiment of the dual-sink commit of FIG. 6 may proceed as follows for a Certificate Transparency plus sigstore Rekor pairing. At session termination, the kernel may compute the SHA-3-256 hash of the final audit-trail entry as the root hash. The root hash may be formatted as a certificate-transparency precertificate extension with serial number equal to the session UUID and subject common-name equal to the artifact UUID, then signed with the issuer Ed25519 key and submitted to two independent Certificate Transparency logs via the CT log submission API per RFC 6962; the logs may return signed certificate timestamps (SCTs) which are embedded in the final audit entry. Simultaneously, the root hash may be submitted to sigstore Rekor as a canonical CBOR payload via the Rekor REST API; Rekor may return a transparency-log entry UUID and an inclusion proof. Both the SCTs and the Rekor UUID may be included in the attestation output and may be verifiable independently by any party with internet access to either sink network. The session may close successfully; memory may be purged; but the anchor may persist in both sink networks indefinitely. Approximate total network cost at session termination may comprise approximately four sub-second round-trips (two CT logs, one Rekor submission, and one SCT confirmation).

Each audit-trail entry of FIG. 6 may be individually signed under the Ed25519 scheme (RFC 8032), which provides 128-bit security equivalent to RSA-3072 with significantly smaller key and signature sizes (32-byte public keys, 64-byte signatures), and fast signature generation and verification suitable for high-frequency entry emission. The session-derived signing key may be generated at session start via HKDF-SHA-3-256 from a root key held in the hardware-rooted key store, ensuring that per-session compromise does not extend to other sessions. Post-quantum alternatives including CRYSTALS-Dilithium ML-DSA per FIPS 204, Falcon, and SPHINCS+ may be supported with hybrid signing combining classical and post-quantum signatures for migration-period deployments.

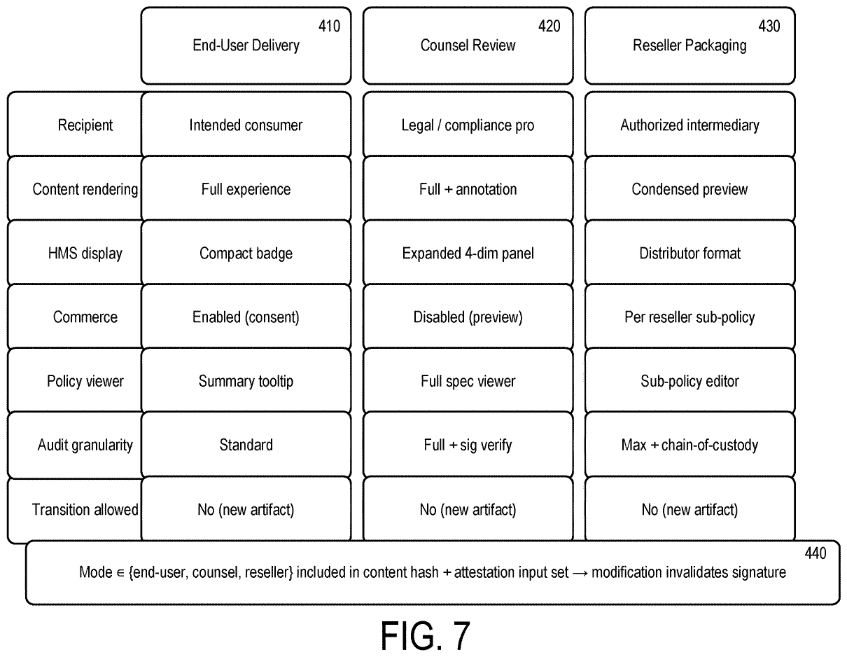

FIG. 7 depicts a tabular matrix of the three-role delivery mode, showing the per-role configuration across seven operational dimensions for end-user delivery 410, counsel review 420, and reseller packaging 430. Together with the cryptographic binding note 440 at the bottom. The mode may be selected by the originator at artifact creation time and is cryptographically bound to the artifact through inclusion of the mode identifier in the content-hash computation and attestation-signature input set. Modification of the mode identifier may invalidate the content hash and therefore the attestation signature, making the mode immutable for the artifact's lifetime. Mode transition between the three modes is not permitted within a single artifact session and requires creation of a new artifact by the originator.

The seven dimensions shown in the matrix rows are as follows. Recipient class: End-User Delivery targets the intended consumer of the content; Counsel Review targets the legal or compliance professional evaluating the content prior to authorizing broader distribution; Reseller Packaging targets the authorized intermediary redistributing the payload under governed sub-policies.

Content rendering: End-User Delivery activates the full content experience with all interactive elements; Counsel Review activates the full content with annotation capability and enhanced governance visibility; Reseller Packaging renders a condensed content preview rather than the full consumer experience.

HumanMark™ Score display: End-User Delivery shows a compact badge in the upper-right viewport corner, color-coded per resolved state (green for GREEN, amber for AMBER, red for RED, gray for UNVERIFIABLE and EXPIRED, red with broken-lock icon for TAMPERED), with the numeric composite score visible on hover; Counsel Review shows an expanded four-dimension computation panel displaying all four weighted sub-scores, the composite formula with applied weights, the Platt-calibration parameters, the modality-gamma factors, and the hysteresis-band state; Reseller Packaging shows a distributor-format summary.

Embedded commerce: End-User Delivery enables full commerce subject to explicit consent verification; Counsel Review disables commerce processing, showing only a redacted preview with a “Commerce Disabled in Review Mode” indicator and payment processing blocked; Reseller Packaging enables commerce per the reseller's sub-policy within the bounds set by the originating policy.

Policy viewer: End-User Delivery presents a summary tooltip; Counsel Review presents a full policy specification viewer with human-readable annotations, rule-precedence tree, and regulatory-framework mapping; Reseller Packaging presents a sub-policy editor enabling the reseller to assign derived governance rules within parent-policy bounds.

Audit granularity: End-User Delivery records events at standard granularity; Counsel Review records at full granularity with additional entries for every governance-decision evaluation, every rule-firing, and every hysteresis transition, and enables a full audit-trail explorer with signature verification and hash-chain validation; Reseller Packaging records at maximum granularity with additional chain-of-custody entries recording the reseller's identity, timestamp, and Ed25519 signature.

Mode transition allowed: all three modes show “No (new artifact required)”, reflecting the cryptographic binding that prevents within-session mode changes. The footer note 440 confirms: Mode E {end-user, counsel, reseller} is included in the content hash and attestation input set, so any modification invalidates the signature.

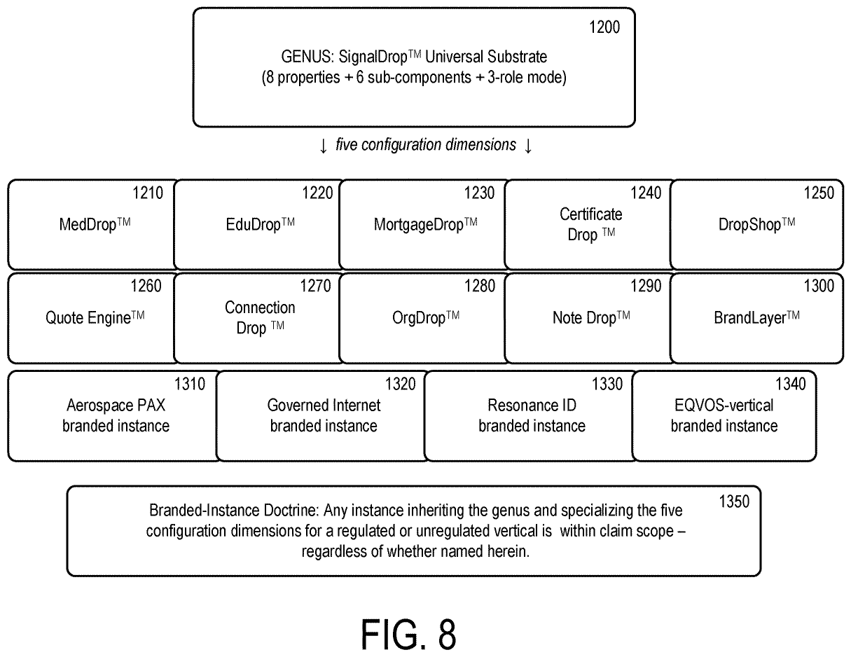

FIG. 8 depicts the universal substrate showing the SignalDrop™ universal substrate 1200, the fourteen presently enumerated branded-instance species in three rows below it, and the branded-instance doctrine statement 1350 at the bottom.

The universal substrate 1200 is labeled “SignalDrop™ Universal Substrate (8 properties+6 sub-components+3-role mode)”, and may be defined by the co-presence of the eight architectural properties of the single-file browser-executable artifact, the six DryRun reference sub-components, and the three-role delivery mode.

The label “configuration dimensions” with downward arrows indicates that each branded instance inherits the full eight-property features and specializes only along five enumerated configuration dimensions: (i) permitted content type; (ii) policy rule population applicable to the regulatory framework of the vertical; (iii) HumanMark™ Score semantic interpretation appropriate to the vertical; (iv) user-interface color scheme, typography, and iconography; and (v) enumerable consent mechanisms, audit-sink species, and transport mechanisms.

The first row of species shows MedDrop™ 1210, the HIPAA-compliant patient-communication branded instance whose consuming applications include remote patient monitoring, digital therapeutics, clinical decision support, tele-medicine, mental-health assessment, field-medic decision support in DDIL environments, and military medical assessment.

The first row also shows EduDrop™ 1220, the FERPA-compliant educational content instance covering learning management systems, online course delivery, student assessment, and academic-integrity adjudication.

The first row also shows MortgageDrop™ 1230, covering RESPA/TILA/TRID-compliant mortgage origination, closing-disclosure delivery, property-valuation narrative, and title-report summary.

The first row also shows Certificate Drop™ 1240, the W3C VCDM 2.0/Open Badge 3.0/eIDAS 2.0 corporate training and professional certification instance; and the first row also shows DropShop™ 1250, the e-commerce with embedded governance instance covering direct-to-consumer, subscription, B2B marketplace, and regulated-goods commerce.

The second row shows Quote Engine™ 1260, covering zero-friction supplier quoting, sealed-bid procurement, and governmental procurement under FAR and state procurement codes; Connection Drop™ 1270, the governed professional and social networking instance whose HumanMark™ Score is exposed as a numerical literal in profile and message contexts to expose synthetic-persona fraud; OrgDrop™ 1280, covering intra-organization Sarbanes-Oxley and SEC-compliant board communications, regulatory disclosures, and executive briefings; Note Drop™ 1290, covering ambient governed capture for meeting notes, interview transcripts, research journals, and clinical records; and BrandLayer™ 1300, the governed brand-management substrate covering brand-portal delivery, authorized-creator attestation, and counterfeit detection under the Lanham Act.

The third row shows the Aerospace Passenger-Experience branded instance 1310, covering governed in-flight content delivery for seat-back infotainment, airline application content, in-flight WiFi captive portals, and preflight-briefing content under applicable FAA and EASA advisory circulars; the Governed Internet branded instance 1320, a browser-wide governance substrate extending SignalDrop™ from per-artifact to per-session open-web browsing governance; the Resonance Identification branded instance 1330, covering digital phenotype matching, content-similarity attribution, styleprint verification, and cover-song attribution through integration with the HumanMark™ Stylometric Fingerprint analyzer; and the EQVOS-vertical branded instance 1340, the SignalDrop™-deployable slice of the EQVOS governance architecture scoped to delivery-format aspects only.

Any instance inheriting the eight architectural properties and specializing along the five configuration dimensions for a regulated or unregulated vertical is within claim scope regardless of whether the specific branded instance is named herein, and design-around attempts based on renaming a branded instance under a different trademark fail because the doctrine operates on architectural property rather than brand name.

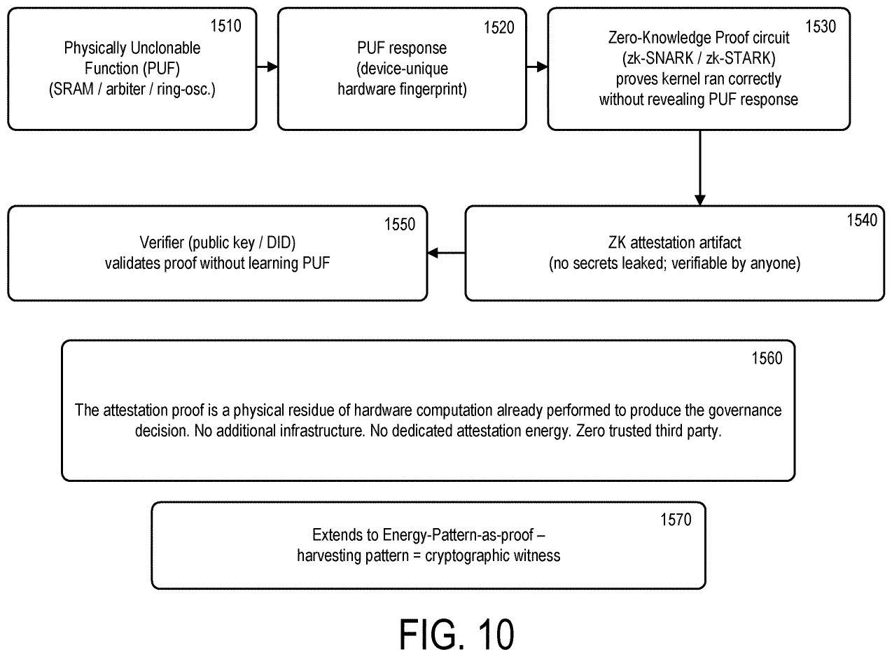

Any instance that inherits the eight properties and specializes along the enumerated dimensions is within the scope of the claims regardless of whether the specific branded instance is enumerated herein. Second, any attempt to design around the claims by renaming a branded instance fails because the doctrine operates on architectural property rather than on brand name. Third, any enablement deficiency in a specific enumerated branded instance does not propagate to the other enumerated instances; each is separately enabled through the enumerable configuration dimensions.

Where the SignalDrop™ artifact of FIG. 8 is delivered to or hosted on a self-energizing substrate—a membrane, textile, wearable, or device deriving its operating power from ambient energy gradients via harvesting of solar, vibration, thermal, RF, or biomechanical sources—the harvesting pattern itself may operate as the energy-pattern proof described in connection with FIG. 10. The integration may permit the artifact to execute without an external power source while still producing cryptographic attestation, supporting deployment in DDIL environments, disaster zones, military field operations, rural-area commerce without persistent power, and maritime or aviation in-transit scenarios. This self-energizing embodiment may be a species of the universal substrate inheriting the full eight-property features while specializing the power-source and harvesting-pattern dimensions.

Additional branded instances within the scope of the universal substrate of FIG. 8 may include: governed press-release delivery; governed policy-document distribution; governed research-publication delivery; governed litigation-discovery production; governed insurance-policy delivery; governed financial-advisory delivery; governed real-estate-disclosure delivery; governed automotive-recall-notice delivery; governed utility-bill delivery; and a functional equivalent thereof. Each may inherit the eight-property features and specialize along the five configuration dimensions of permitted content type, policy rule population, HumanMark™ Score semantic interpretation, user-interface presentation, and enumerable consent/audit-sink/transport mechanisms.

Within the MedDrop™ branded instance 1210 of FIG. 8, the consuming applications may further include digital therapeutics, clinical decision support, mental-health assessment, cognitive assessment, pre-visit triage, post-discharge monitoring, chronic-disease self-management, wellness assessment, clinical-trial subject self-report, disaster-response medical assessment, and military medical assessment. Provenance-proof binding within MedDrop™ 1210 may include clinician identifier, patient identifier (where lawful and consented), session identifier, device identifier, sensor identifier, clinical-trial identifier, study-arm identifier, intended-use classification, and regulatory-class token. Regulatory anchors within MedDrop™ 1210 may include the minimum necessary standard (45 CFR 164.502 (b)); treatment-specific consent (45 CFR 164.506); provider-specific authorization (45 CFR 164.508); PHI access logging (45 CFR 164.308 (a)(1)); Business Associate Agreement chain-of-custody (45 CFR 164.504 (e)); FDA Software-as-a-Medical-Device (SaMD) AI/ML submission requirements; FDA 21 CFR Part 11 electronic records compliance; and a functional equivalent thereof. The HumanMark™ Score within MedDrop™ 1210 may interpret GREEN as clinical content reviewable with standard clinical procedure, AMBER as content requiring provider review before clinical action, and RED as content not suitable for clinical use without regeneration.

Within the Certificate Drop™ branded instance 1240 of FIG. 8, artifacts may include W3C Verifiable Credentials Data Model 2.0 credentials; Open Badge 3.0 credentials; X.509-attested certificates; eIDAS 2.0 qualified certificates under Regulation (EU) 2024/1183; JSON-LD-formatted attestation documents; and human-readable PDF renderings. Provenance-proof binding within Certificate Drop™ 1240 may include issuer identifier, holder identifier, curriculum-or-course identifier, HumanMark™ Score for the session, governance-kernel-version identifier, regulatory-regime token, issuance timestamp, and verification-endpoint identifier. Regulatory anchors within Certificate Drop™ 1240 may include ABA Model Rules 1.1 and 5.3; FINRA Rule 3110 and Rule 1240; FDA 21 CFR Parts 211 (cGMP) and 820 (QSR); HIPAA workforce training requirement at 45 CFR § 164.530 (b); eIDAS 2.0 Regulation (EU) 2024/1183 qualified-certificate issuance requirements; W3C VCDM 2.0 and Open Badge 3.0 specifications; and a functional equivalent thereof.

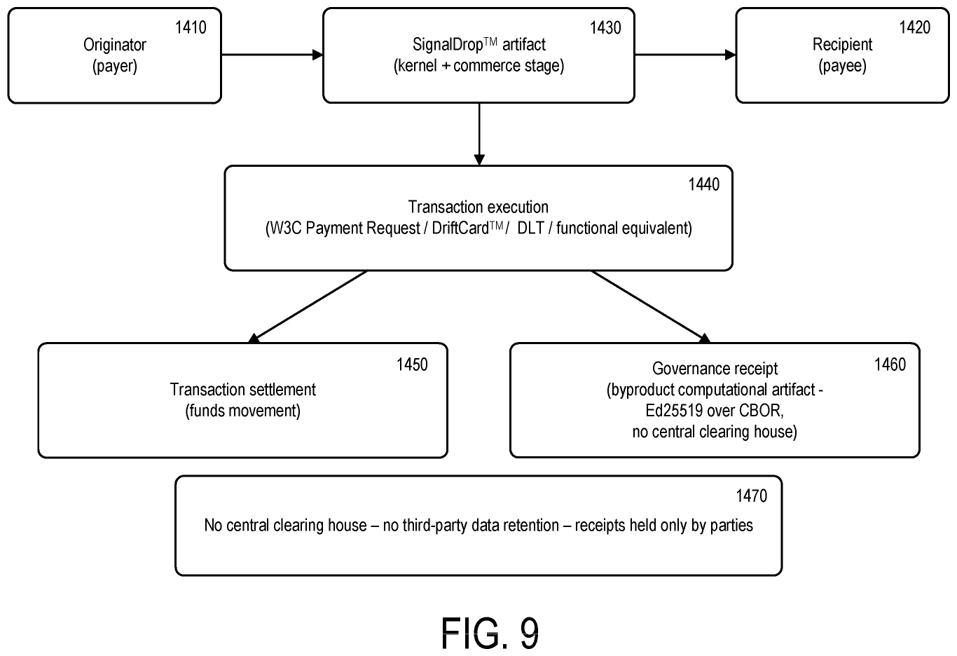

FIG. 9 depicts a transaction-flow diagram of Governed Distributed Transaction Processing, illustrating the complete flow from originator through the SignalDrop™ artifact to the recipient, through transaction execution and settlement, with the governance receipt produced as an inseparable computational byproduct, and the no-clearing-house/no-third-party-data-retention property.

The originator 1410 is the payer in the transaction and the creator of the SignalDrop™ artifact. The recipient 1420 is the payee, receiving the artifact through any of the transport mechanisms disclosed herein (HTTPS, email attachment, QR code, NFC tap, LoRa, sneakernet, or functional equivalent). The SignalDrop™ artifact commerce stage 1430 is the central element: it is the single browser-executable file that carries the content, the embedded runtime governance kernel, the HumanMark™ Score, the policy specification, and the complete commercial transaction capability, all co-resident within the file boundary. The commerce stage routes to the transaction execution block 1440, which may be implemented via the W3C Payment Request API invoked within the artifact's scripting context, DriftCard™ ephemeral payment credential (a single-use virtual card number generated at checkout, authorized for the exact transaction amount, and immediately invalidated upon completion), distributed-ledger transaction (DLT) settlement through a blockchain-native payment channel, or a functional equivalent thereof.

Transaction execution produces two simultaneous outputs. The first output is transaction settlement 1450, representing the movement of funds between originator and recipient through the selected payment pathway. The second output is the governance receipt 1460, which is produced as an inseparable computational byproduct of transaction execution itself—not as a subsequent log entry and not as a separate act. The governance receipt is serialized in canonical CBOR per RFC 8949 § 4.2.1, signed under Ed25519 per RFC 8032 over a SHA-3-256 digest, and comprises: a transaction-validity attestation; a hash-chained transaction record; a payer-side proof-of-payment artifact; a payee-side proof-of-receipt artifact; a settlement-reconciliation artifact; and a tax-or-audit evidence artifact reproducible on demand by either party. The receipt is hash-chained with the participant's own prior receipts and committed to the session's dual-sink root anchor.

The bottom property box 1470 states the three key architectural distinctions from both traditional payment networks and blockchain networks: no central clearing house (each transaction is locally processed at the participant nodes without routing through a central authority, distinguishing the architecture from Visa, Mastercard, SWIFT, and analogous centralized networks); no third-party data retention (the transaction record is held only by the participating parties, so no intermediary accumulates sensitive payment data); and receipts held only by parties (the governance receipt and settlement record are not held by any clearing house, bank, or payment network—they are owned by the originator and recipient only, with the hash committed to the dual-sink anchor for verification purposes only).

The architecture supports DDIL-environment deployments because no central clearing house is required and the cryptographic stack operates offline, with dual-sink anchor commit deferred to local queue with exponential backoff when sinks are unreachable. This makes the governed distributed transaction architecture natively suitable for military field transactions, disaster-zone commerce, rural commerce without persistent connectivity, and maritime or aviation in-transit purchase scenarios.

The architecture of FIG. 9 may be distinguished from both traditional payment networks and blockchain networks. Traditional payment networks (Visa, Mastercard, American Express, SWIFT) are centralized and efficient but route every transaction through a central clearing house and incur third-party data retention. Blockchain networks are decentralized but incur substantial energy and latency costs through global-consensus protocols. The governed distributed transaction architecture of FIG. 9 may be both decentralized and efficient: each transaction is locally processed at the participant nodes; a governance receipt 1460 is produced as a computational byproduct of execution itself rather than as a subsequent log entry; the receipt is hash-chained with the participant's own prior receipts; the record is held only by the participating parties; no central clearing house is required; no third-party data retention is incurred; settlement is finalized upon mutual signature exchange between the two participant nodes; and downstream dispute-resolution, audit-evidence, or regulatory-inspection processes bind to the joint signatures of the participants only with their consent.

The transaction execution block 1440 of FIG. 9 may produce, as computational byproduct, the following artifact classes in canonicalized CBOR serialization signed under Ed25519: (a) a transaction-validity attestation generated at execution; (b) a hash-chained transaction record held only by the participants; (c) a payer-side proof-of-payment artifact; (d) a payee-side proof-of-receipt artifact; (e) a settlement-reconciliation artifact; (f) a tax-or-audit evidence artifact reproducible on demand by either party; and (g) a dispute-resolution artifact bindable to a third-party arbiter only with the parties' joint consent. The extension of the Ed25519 (RFC 8032)/SHA-3-256/canonical CBOR (RFC 8949 § 4.2.1) cryptographic stack from content provenance to transaction provenance may be explicit: the same primitives that bind a score to content bind a settlement to a transaction, and the same dual-sink anchor architecture supports both.

The architecture of FIG. 9 may be applicable to any financial-transaction processing system including: a point-of-sale transaction-processing system; a peer-to-peer financial-transfer system; a card-network-replacement architecture; a bank-to-bank settlement system; a remittance-and-cross-border-transfer system; a micropayment system; a disaster-zone or denied-environment commerce system; a military field-transaction system operating in DDIL environments; a rural-area commerce system without persistent connectivity; a maritime or aviation in-transit purchase system; an offline retail commerce system; an offline business-to-business procurement settlement system; and a functional equivalent thereof.

The governed distributed transaction architecture of FIG. 9 may compose with the embedded commerce pipeline such that a SignalDrop™ artifact carrying commerce capability may execute a transaction wholly within the artifact's protected runtime, producing a settlement record that is cryptographically bound to the session's audit chain and simultaneously committed to the dual-sink anchor 290 of FIG. 3. Commerce-specific governance rules executed within the artifact commerce stage 1430 may include: maximum transaction-amount limits per transaction, per day, and per week; prohibited product-category restrictions for regulated items, age-restricted goods, and export-controlled products; geographic restrictions via shipping-destination validation, sanctions-list screening, and export-control compliance; recipient-eligibility restrictions via consent-gated commerce requiring explicit authorization per category; and payment-method restrictions via whitelist of permitted processors, blacklist of prohibited instruments, DriftCard™ requirement thresholds, geographic restrictions on payment-instrument usage, and cryptocurrency-settlement restrictions based on jurisdiction.

FIG. 10 depicts the PUF-ZKP Hardware-Bound Zero-Knowledge Governance Attestation architecture, illustrating the complete flow from the Physically Unclonable Function primitive through ZK proof generation to the ZK attestation artifact, recipient-side verification, and the Energy-Pattern-as-Proof extension.

A Physically Unclonable Function (PUF) 1510 is a hardware primitive that produces a device-unique response to a cryptographic challenge by exploiting sub-micron manufacturing variations that cannot be replicated even by the original manufacturer. Enumerable PUF species include SRAM-PUF (exploiting power-on state variation in static RAM cells), Arbiter-PUF (exploiting timing variations in delay-line races), Ring-Oscillator-PUF (exploiting frequency variations in ring oscillators), Optical-PUF (exploiting light-scattering patterns in inhomogeneous media), Bistable-Ring-PUF, Butterfly-PUF, and functional equivalents thereof. The PUF is challenged by the governance kernel at the moment of governance-event firing and produces the PUF response 1520, a device-unique hardware fingerprint. Critically, the PUF response is never transmitted, stored, or disclosed outside the device's secure boundary: it exists only transiently within the local secure computation.

The PUF response flows into the Zero-Knowledge Proof circuit 1530, which may be implemented as a Groth16 SNARK (pairing-based, trusted-setup), a PLONK universal SNARK with updatable structured reference string, a STARK (transparent, post-quantum-secure), Halo2 with recursive composition, Bulletproofs for logarithmic-size range proofs, or a functional equivalent thereof. The ZKP circuit uses the PUF response as the witness (the secret input to the proof) and the governance-event parameters (artifact identifier, event type, timestamp, HMS state, and session nonce) as the public inputs.

The circuit generates a ZK attestation artifact 1540 that proves two statements simultaneously: that a particular device identity was present at the governance event, and that the governance kernel executed correctly for that event-without revealing the PUF response, the device identity, or any other secret. The ZK attestation artifact is therefore verifiable by anyone with the verifier's public key, yet reveals nothing about the device's hardware fingerprint.

The verifier 1550, holding the originator's public key (retrieved from embedded artifact metadata, DNS TXT record, or Decentralized Identifier document), validates the ZK proof against the public inputs without learning the PUF response and without querying any external service. The attestation proof is a physical residue of hardware computation already performed to produce the governance decision. This attestation may be a physical artifact emerging from a physical hardware process (the PUF's exploitation of manufacturing variations) combined with a computation that cannot be performed without producing the attestation as its residue.

The Energy-Pattern-as-Proof extension 1570 extends the same architectural primitive to environments where ambient energy harvesting patterns serve as the cryptographic witness: on a self-energizing substrate deriving operating power from solar irradiance, mechanical vibration, thermal gradient, radio-frequency signal strength, biomechanical motion, or a functional equivalent thereof, the time-series of energy input to the substrate constitutes a unique environmental fingerprint at a given location and time; this fingerprint is sampled at sub-second resolution, aggregated into a windowed hash under SHA-3-256, and included as a field in the attestation input set, providing proof of when and where the governance event occurred without GPS, without a timestamp server, without blockchain consensus, and without burning dedicated energy. The PUF-ZKP primitive also composes with a Trusted Execution Environment (TEE) in a Janus-class configuration for defense-in-depth deployments, where the TEE (Intel SGX, AMD SEV, ARM TrustZone, Apple Secure Enclave, or functional equivalent) serves as the confidentiality-and-integrity layer and the PUF-ZKP serves as the identity-attestation layer.

The Janus-class TEE-PUF composition of FIG. 10 may be bidirectional: the TEE may verify the PUF-ZKP attestation before admitting the kernel to the trusted context, and the PUF-ZKP witness may be derived from state protected by the TEE. The Trusted Execution Environment may be implemented as Intel SGX, AMD SEV, ARM TrustZone, Apple Secure Enclave, or an equivalent hardware-backed trusted-execution environment.

The PUF-ZKP primitive of FIG. 10 may compose cleanly with: (i) the governed distributed transaction architecture of FIG. 9, in which the PUF-ZKP proves device identity at transaction execution; (ii) the Energy-Pattern-as-Proof extension 1570, in which the PUF-ZKP and the energy pattern are dual witnesses to the same governance event, one hardware-bound and one environmentally-bound; (iii) the Certificate Drop™ branded instance 1240 of FIG. 8, in which the PUF-ZKP binds the certificate to the issuing device; and (iv) the dual-sink anchor architecture of FIG. 6, in which the hash of the energy pattern and/or the ZK attestation artifact 1540 may be committed alongside the session root.

Enumerable harvesting pattern sources for the Energy-Pattern-as-Proof extension 1570 of FIG. 10 may include: solar irradiance pattern captured by a photovoltaic harvester integrated with the substrate; mechanical vibration pattern captured by a piezoelectric harvester; thermal gradient pattern captured by a thermoelectric harvester; RF signal strength pattern captured by an RF harvester (including ambient Wi-Fi, cellular, and broadcast); biomechanical motion pattern captured by an inertial-measurement-unit harvester (accelerometer, gyroscope); electromagnetic gradient pattern; capacitive-coupling pattern; and a functional equivalent thereof.

Proof-of-work blockchain consensus requires the burning of dedicated energy to prove something happened; the governance pipeline of FIG. 10 may prove something happened because it happened—the energy pattern is a residue of ambient environmental conditions already present at the moment of governance, and the attestation emerges from computation already performed. The architecture may not build a ledger; it may build a law of physics. The record exists because the event existed. The architectural result may be that the attestation is not an abstract idea subjected to generic-computer instrumentation—it is a physical artifact emerging from a physical process, which cannot be achieved by any combination of prior-art elements that produce attestation as a separate dedicated act.

### End-to-End Exemplary Implementation of SignalDrop

The SignalDrop™ Delivery Flow may accept the single-file payload through any transport preserving artifact integrity from originator to recipient. Enumerated transport mechanisms may include: (i) HyperText Transfer Protocol over Transport Layer Security 1.3 (HTTPS) from a web server, Content Delivery Network, or object storage bucket; (ii) email attachment transmitted as MIME multipart with base64 encoding and optional S/MIME or PGP signature covering the attachment; (iii) peer-to-peer file transfer via WebRTC data channels, InterPlanetary File System (IPFS) content-addressed retrieval, or Bluetooth OBEX file transfer; (iv) QR code scan encoding the artifact or an ephemeral retrieval URL, suitable for in-person handoff; (v) Near-Field Communication (NFC) tap encoding the artifact or retrieval URL; (vi) physical media mount (USB flash drive, SD card, optical media); (vii) Long Range (LoRa) and Long Range Wide Area Network (LoRaWAN) transmission for low-bandwidth long-distance delivery in denied environments; (viii) sneakernet (physical courier of encrypted media) for air-gapped classified environments; (ix) Bluetooth Low Energy (BLE) transfer for proximate delivery; (x) Airdrop and equivalent proximity-based mobile file sharing; and (xi) a functional equivalent thereof. The Delivery Flow may be transport-agnostic: artifact integrity may be protected by the originator's cryptographic signature regardless of transport channel.

Upon receipt, the Delivery Flow may execute a four-step integrity verification before any content rendering or governance kernel activation: (V1) hash recomputation of the artifact under SHA-3-256 over canonicalized bytes, excluding the signature field; (V2) Ed25519 signature verification using the originator's public key embedded in the artifact metadata, retrieved from a DNS TXT record under the originator's domain, or resolved via a Decentralized Identifier (DID) document; (V3) mode identifier validation confirming the mode identifier is one of the three cryptographically bound valid values (end-user-delivery, counsel-review, reseller-packaging); and (V4) timestamp-plus-TTL validation rejecting artifacts with creation timestamps more than 300 seconds in the past (configurable per policy) or with timestamps in the future beyond a clock-skew tolerance of 30 seconds. Any verification failure may emit a Tier-3 fail-safe session termination with a TAMPERED or EXPIRED audit entry.

After successful integrity verification, the Delivery Flow may inspect the mode identifier bound to the artifact and select an appropriate rendering path. End-user-delivery may activate the full content rendering pipeline with standard policy strictness, embedded commerce enabled, compact HMS badge display, and standard audit granularity. Counsel-review may activate enhanced policy detail visibility, full audit-trail explorer, redacted commerce preview with payment disabled, HMS computation breakdown with all four sub-scores, and maximum audit granularity. Reseller-packaging may activate redistribution tooling including the sub-policy editor, chain-of-custody transfer interface, recipient-list management, and commission-structure display. Mode transition may be cryptographically prohibited because the mode identifier is part of the content-hash input; changing the mode invalidates the signature.

The Delivery Flow may hand off control to the SDKontrol™ governance kernel through a five-step activation sequence: (H1) kernel location, resolving the governance kernel from inline JavaScript, WebAssembly binary, or trusted registry reference; (H2) kernel integrity verification, confirming the kernel semantic version and integrity hash match the expected values embedded in artifact metadata; (H3) kernel initialization, invoking the kernel's init( ) function with the artifact metadata, policy specification, mode identifier, HumanMark™ Score, and consent-capture handlers; (H4) governance activation, instantiating the eight-layer pipeline with session-derived signing key and the dual-sink anchor configuration; and (H5) rendering authorization, after which the kernel is the sole arbiter of every render-time operation until session termination.

The Delivery Flow may implement anti-replay protection through a triple-bound mechanism. (A) Session nonce validation: each rendering session may generate a cryptographically unpredictable 128-bit nonce via the Web Crypto API crypto.getRandom Values( ) function included in the attestation signature input set; the same artifact cannot be re-rendered with the same nonce; attempting replay triggers TAMPERED. (B) sdk_instance_id binding: the nonce may be bound to the SDK-instance identifier so that even across distinct instances the (nonce, sdk_instance_id) pair is unique. (C) Bounded LRU cache: verifiers may maintain a bounded least-recently-used cache of recently seen (nonce, sdk_instance_id) pairs and reject duplicates within the TTL window. Timestamp windowing may reject artifacts with creation timestamps outside the configured window. The combination may provide strong protection against session-replay attacks.

The Delivery Flow may operate as a finite state machine with the following states and transitions: IDLE (initial, awaiting retrieval)→TRANSPORTING (bytes being received)→RECEIVED (fully received, awaiting integrity verification)→VERIFYING (hash and signature in progress)→VERIFIED (integrity verified, mode selection pending)→MODE SELECTED (rendering path selected, awaiting kernel handoff)→KERNEL ACTIVE (kernel controls all further operation)→SESSION_CLOSING (user or policy termination)→PURGING (explicit memory purge in progress)→ANCHOR_COMMIT (final audit entry committed to dual-sink root)→CLOSED (session terminated; no residue). Fault states TAMPERED, EXPIRED, and UNVERIFIABLE may be entered from any state, all of which transition directly to PURGING.

The embedded commercial-transaction module 250 of FIG. 1 may further include a DriftCard™ pay-per-governance-event billing architecture, separately-inventive from the DriftCard™ ephemeral-credential payment instrument, in which the billing unit is a governance event itself rather than a seat, subscription period, or content-item count. Enumerated governance event types may include: a drift-detection firing (a Cognitive Drift Index value crossing an operator-configurable threshold); a SAFE_HALT event (an enforcement action halting artificial-intelligence output pending human review); a flagged intervention (a policy-engine determination triggering human-in-the-loop escalation); a score-state-transition event (an HMS state boundary crossing out of GREEN); a signature-verification-failure event; a TTL-expiration event; a dynamic-weight-renormalization event; an operator-configuration-hash-mismatch event; a biometric-liveness-attestation-failure event; and any other enumerated governance operation specified in the operator-configuration bundle.

Each governance event under the DriftCard™ pay-per-governance-event architecture may emit a governance-event record comprising: an event identifier; a timestamp; a monotonic event sequence number; a cryptographic binding to the SDK-instance identity; a reference to the content artifact and HMT if applicable; an event-type enumeration; and an attestation signature over the foregoing. Governance-event records may be append-only, may participate in the dual-sink anchor root, and may be priced according to an event-type price list in the licensee's DriftCard™ billing contract. Micropayment settlement per event may be performed either against a prepaid licensee balance (analogous to API-credit or Stripe account models) or against an enterprise invoice cycle. In some embodiments, DriftCard™ events may be cryptographically bound at the time of firing and may be independently auditable, creating a self-attesting billing record that cannot be reconstructed or disputed post-hoc.

The Consent-Capture UI of the SignalDrop™ system may support a five-stage transaction flow executing wholly within the protected runtime: (S1) Consent Capture, in which the recipient provides explicit granular authorization for commercial engagement, with consent categories including product browsing, price display, payment processing, data sharing with payment processor, and receipt delivery; (S2) Item Selection, in which the recipient browses the embedded product catalog, selects variants, and configures quantities; (S3) Checkout, in which an itemized summary, tax computation, shipping and handling calculation, and terms presentation are surfaced and the recipient reviews and confirms; (S4) Payment Processing, executed wholly within the protected runtime via an enumerated payment-method species; and (S5) Receipt Generation, producing a cryptographically signed receipt bound to the session's audit chain and presenting the receipt to the recipient with an option to export a stand-alone signed receipt artifact.

The DriftCard™ ephemeral-credential payment integration of the embedded commerce module 250 may provide a natively session-bounded payment method designed for session-ephemeral commerce. The DriftCard™ system may generate a single-use virtual card number at checkout with a short-duration validity window matching the session lifetime; the card may be authorized for the exact transaction amount plus a small configurable buffer; the card may decline any subsequent authorization attempt; and upon transaction completion the card may be immediately invalidated and cannot be reused. The card generation, authorization, and invalidation cycle may be governed by the embedded kernel and may be recorded in the session's audit chain. Distributed-ledger settlement pathways may provide alternatives in which the SignalDrop™ artifact includes a blockchain-native payment channel configuration with channel identifier, participant addresses, and smart-contract reference; the recipient's wallet (MetaMask, WalletConnect-compatible, or hardware wallet) may sign a payment-authorization transaction; the transaction may be submitted to the distributed ledger for confirmation; upon confirmation the smart contract may release payment and generate a settlement record cryptographically bound to the session's audit chain.

The branded-instance registry of the universal substrate may further include the EQVOS branded instance, which may be the SignalDrop™-deployable slice of an upstream EQVOS governance architecture, scoped to exclude upstream biometric and emotional-state sensing claimed in separate provisional applications and to include only the delivery-format aspects within SignalDrop™. The branded-instance registry may further include a Connection Drop™ instance for governed professional and social networking in which HumanMark™-scored profile verification exposes synthetic-persona fraud as a numerical literal; a Note Drop™ instance for ambient governed capture for personal and professional note-taking applications including meeting notes, interview transcripts, research journals, and clinical records; a BrandLayer™ instance providing a governed brand-management substrate for brand-portal delivery, authorized-creator attestation, and counterfeit detection under the Lanham Act; and a Resonance Identification System instance for digital phenotype matching including content-similarity attribution, styleprint verification, and cover-song attribution.

A reduction-to-practice operation of the SDKontrol™ governance kernel reference implementation may be effected at consumer hardware scale. In one operative example, the reference implementation may operate against an inventor's own operator state in an instrumented test harness while the inventor interacts with an artificial-intelligence system. The kernel may detect operator fatigue via the governance-event taxonomy, fire a SAFE_HALT event, and interrupt the inventor's interaction pending the inventor's own attested consent to proceed. In this operative example, all five elements of the claimed convergence may be present and operating: the embedded kernel (executing in-browser via the reference harness); byproduct attestation (a JSON Governance Receipt generated as a residue of the SAFE_HALT decision); session ephemerality (no persistent record remaining on the test machine after the session ends); commerce-adjacent capability (the DriftCard™ billing harness invoked for the SAFE_HALT event as a governance-event billing trigger); and human-authorship attestation (the kernel's HMS subsystem evaluating the inventor's interaction stream and producing the composite score that supports the fatigue detection).

The four-analyzer composite of the HumanMark™ Score may further be implemented as follows. The Semantic Entropy (SE) analyzer may encode text with a primary dense embedding model (e.g., text-embedding-3-large producing a 3,072-dimensional vector) and, under fallback conditions, with a secondary model such as all-mpnet-base-v2 producing a 768-dimensional vector with affine or multilayer-perceptron alignment. The Stylometric Fingerprint (SF) analyzer may extract a 187-dimensional stylometric feature vector organized into six functional categories: 132 character-level n-gram distribution features, 20 function-word frequency features, 15 sentence-level structural features, 2 vocabulary richness features, 2 entropy features, and 16 syntactic-depth and part-of-speech transition features. The feature vector may be fed to an XGBoost gradient-boosting ensemble- or alternatively LightGBM, CatBoost, random forest, logistic regression with polynomial expansion, or neural-network binary classifier-producing a log-odds score mapped to probability. The Generative Artifact (GA) analyzer may operate per modality, applying a fine-tuned transformer discriminator such as a ROBERTa-large architecture with a classification head for text, discrete-cosine-transform coefficient anomalies and diffusion noise residuals for still images, an anti-spoofing ensemble such as RawNet2 for audio, and optical-flow inconsistencies, photo-response-non-uniformity sensor-noise absence, remote photoplethysmography, and temporal frame-interpolation artifacts for video. The Provenance Verification (PV) analyzer in a web-browser embodiment may be implemented via the Clipboard API for paste-event detection, the Keyboard Events API for keystroke capture with typing-cadence biometric signals, the Web Speech API for voice-dictation attribution, the Pointer Events API for drag-and-drop tracking, Web Workers for background computation, WebGPU for local inference, and WebAuthn/FIDO2 for hardware-rooted biometric liveness.

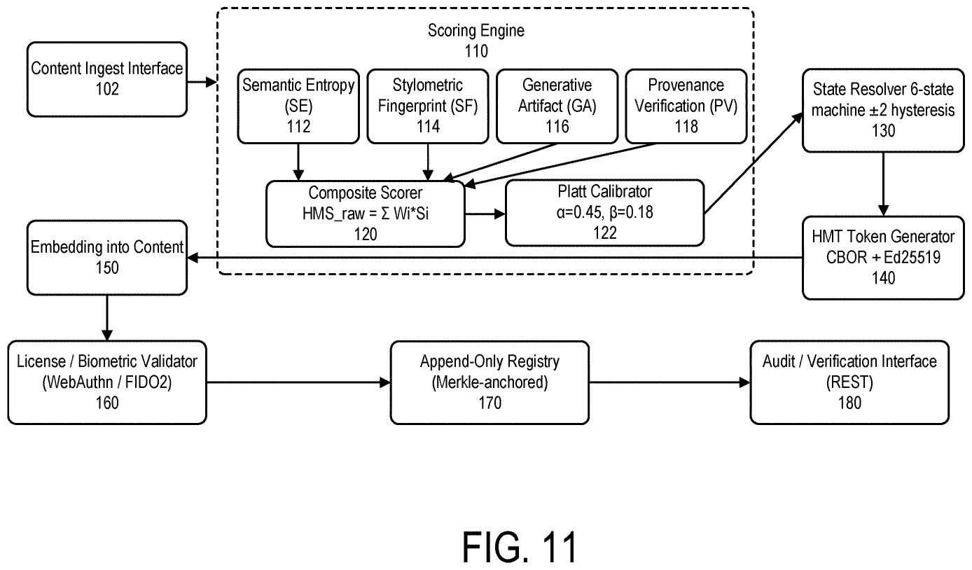

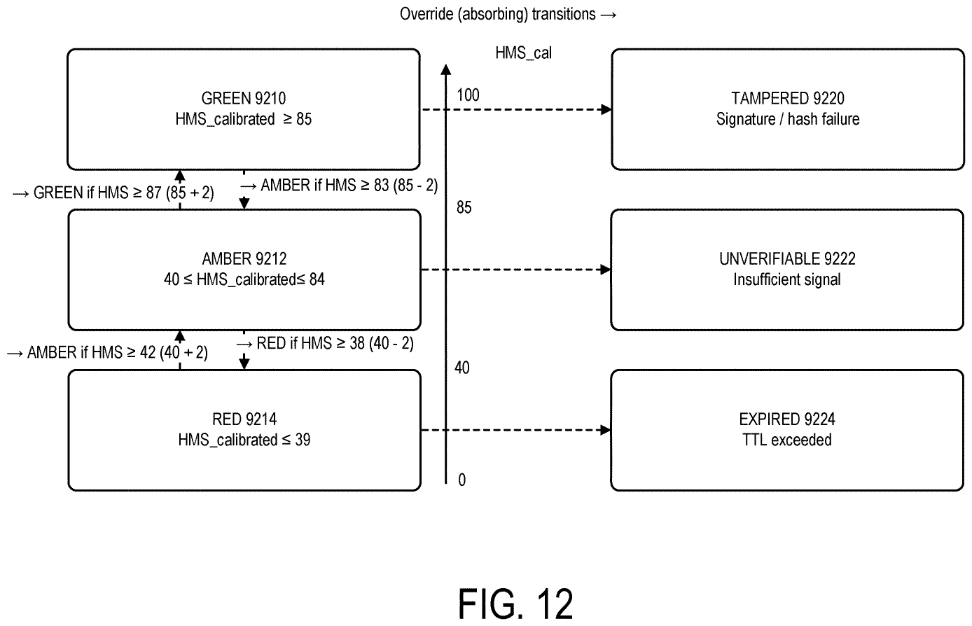

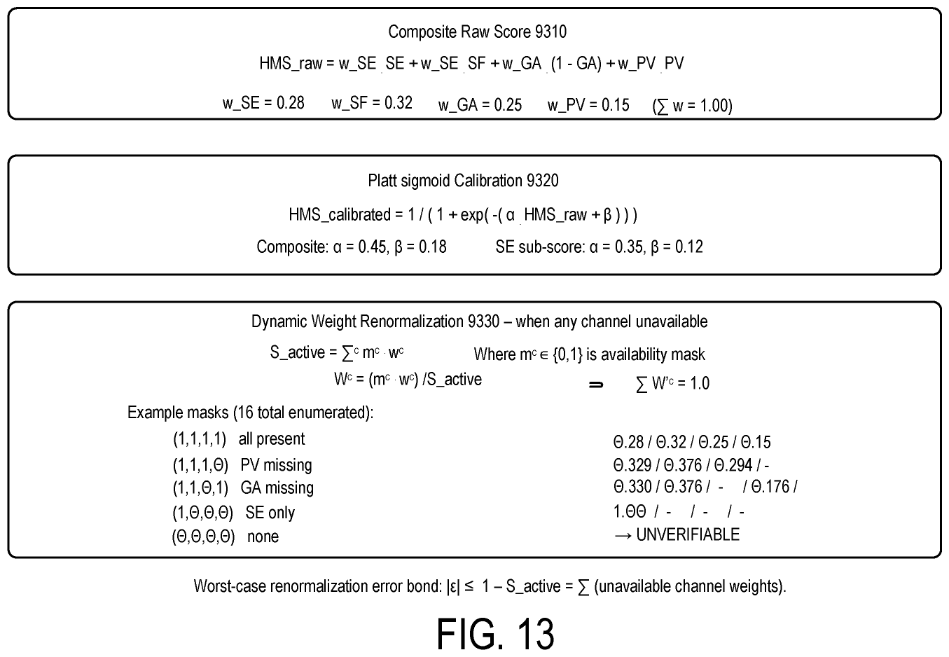

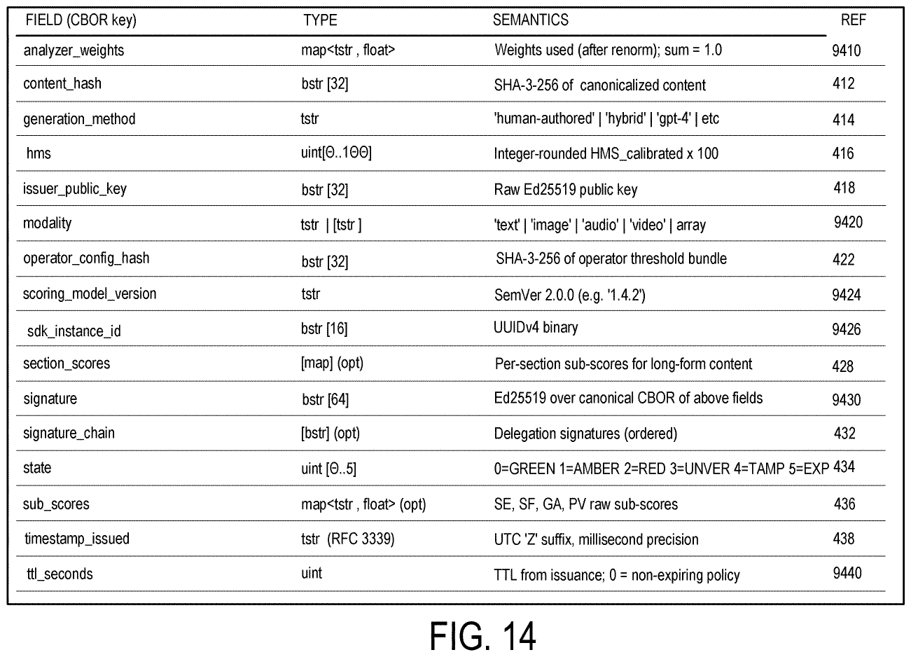

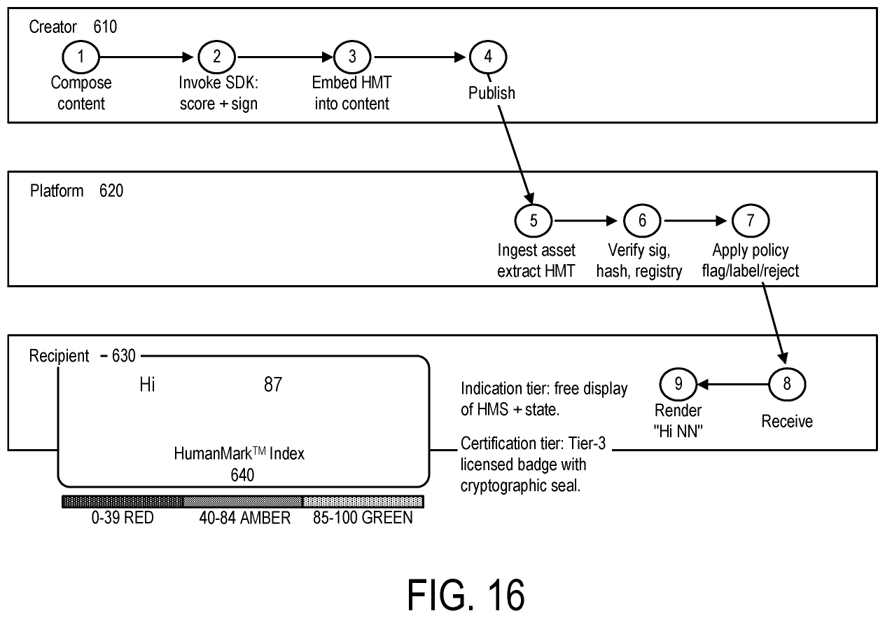

FIG. 11 depicts the architecture of the HumanMark™ continuous human-authorship attestation subsystem. FIG. 11 illustrates the complete pipeline from content ingestion through multi-channel score computation, calibration, state resolution, token generation, content embedding, identity validation, append-only registry commitment, and audit verification. The architecture maps directly to the HumanMark™ score cryptographically bound module 260 of FIG. 1 and provides the substrate for the six-state resolution machine of FIG. 12, the locked mathematical formulas of FIG. 13, the canonical token schema of FIG. 14, and the recipient-side rendering of FIG. 16.

The content ingest interface 102 receives content for scoring. Content modalities may include text, image, audio, video, multi-modal arrays, and a functional equivalent thereof, encoded according to the modality field 9420 of the HumanMark Token (HMT) schema described in connection with FIG. 14. The content ingest interface 102 may accept content via direct stream input, file upload, browser drag-and-drop event, JavaScript promise resolution, an SDK function call, an HTTP/2 streaming endpoint, an in-memory buffer, and a functional equivalent thereof. The content ingest interface 102 operates within the same browser-executable scripting context as the embedded runtime governance kernel 220 of FIG. 1 such that content does not exit the local execution boundary during scoring.

Content received at the content ingest interface 102 flows into the scoring engine 110. The scoring engine 110 comprises a plurality of independent analyzer channels operating in parallel, including a semantic entropy (SE) analyzer 112, a stylometric fingerprint (SF) analyzer 114, a generative artifact (GA) analyzer 116, a provenance verification (PV) analyzer 118, a composite scorer 120, and a Platt calibrator 122. The scoring engine 110 may be co-resident with the embedded runtime governance kernel 220 of FIG. 1, executed in an isolated WebAssembly module, deployed as a service worker, executed within a trusted execution environment, composed via the Janus-class TEE-Web Assembly-plus-native-composition described in connection with the kernel 220, and a functional equivalent thereof.

The semantic entropy analyzer 112 may compute a Shannon-entropy-derived measure of token-distribution unpredictability over a sliding window, comparing observed token entropy against a corpus reference distribution to estimate the degree to which the content evidences human-authored stochastic variation rather than the lower-entropy distributions typical of large-language-model output. Inputs to the semantic entropy analyzer 112 may include byte-pair-encoded token streams, n-gram frequency profiles, modality-specific feature vectors, and a functional equivalent thereof. The semantic entropy sub-score is the SE input to the composite formula 9310 of FIG. 13.

The stylometric Fingerprint analyzer 114 may compute author-stable lexical and structural features including function-word frequency vectors, average sentence length and variance, punctuation-profile signatures, character-level n-gram distributions, paragraph-rhythm Fourier spectra, vocabulary richness measures, and a functional equivalent thereof, comparing the content's fingerprint against an author baseline previously bound to the SDK instance identifier 9426 of FIG. 14. The stylometric fingerprint sub-score is the SF input to the composite formula 9310 of FIG. 13.

The generative artifact analyzer 116 may detect synthesis-characteristic artifacts including repetitive phrase scaffolds, low-perplexity transitional structures, characteristic punctuation regularity, image-domain JPEG-quantization residues, image-domain frequency-domain compression patterns, audio-domain phase-coherence anomalies, video-domain inter-frame coherence anomalies, and a functional equivalent thereof. The Generative Artifact analyzer 116 produces a probability that the content originated from a generative model; the inversion (1−GA) is used in the composite formula 9310 of FIG. 13 such that lower artifact probability contributes positively to the overall score.

The provenance verification analyzer 118 may verify the presence and validity of upstream cryptographic attestations bound to the content, including Coalition for Content Provenance and Authenticity (C2PA) manifests, watermarks, prior HMT signatures, embedded Ed25519 chained signatures, and a functional equivalent thereof. The Provenance Verification analyzer 118 confirms cryptographic chain-of-custody from source to current artifact and contributes a verification score to the composite computation as the PV input to the formula 9310 of FIG. 13.

The four analyzer channels produce sub-score outputs that flow into the composite scorer 120. The composite scorer 120 evaluates the closed-form weighted-sum formula HMS_raw=w_SE·SE+w_SF·SF+w_GA·(1-GA)+w_PV·PV using the locked weight set illustrated in FIG. 13 and described in greater detail in connection with that figure. The composite raw score HMS_raw flows into the Platt calibrator 122, which applies a Platt sigmoid transform HMS_calibrated=1/(1+exp(−(α·HMS_raw+β))) using the locked calibration parameters α=0.45, β=0.18 to map the raw score onto a calibrated probability scale on the unit interval (0,1). When one or more analyzer channels are unavailable, the composite scorer 120 applies the dynamic weight renormalization 330 of FIG. 13 prior to weighted summation.

The calibrated score flows into the state resolver 130. The state resolver 130 implements the six-state machine described in connection with FIG. 12, comprising three reversible quantitative scoring states (GREEN 9210, AMBER 9212, RED 9214) and three absorbing override states (TAMPERED 9220, UNVERIFIABLE 9222, EXPIRED 9224). The state resolver 130 applies ±2 hysteresis to threshold transitions to suppress chatter at threshold boundaries, prevent destabilization of recipient-side display logic in the presence of border-case scores, and avoid confusing flicker between states when the calibrated score oscillates near a threshold over successive scoring events on revised content.

The resolved state and accompanying score data flow into the HMT token generator 140, which assembles the HumanMark™ Token (HMT). The HMT token generator 140 may serialize the token under canonical Concise Binary Object Representation (CBOR) per RFC 8949 § 4.2.1 and apply an Ed25519 (RFC 8032) signature over the canonical serialization. The HMT field schema is enumerated in connection with FIG. 14. The HMT token serves as the cryptographic byproduct attestation 230 of FIG. 1 with respect to the human-authorship determination, such that the act of scoring the content cannot be performed without producing the HMT as its computational residue.

The HMT token flows into the embedding into content module 150, which embeds the token into the artifact according to modality-specific embedding strategies including: an HTML data attribute, an Exchangeable Image File Format (EXIF) metadata field, an International Press Telecommunications Council (IPTC) photo metadata field, an ID3 audio tag, an MPEG-4 Part 14 (MP4) box, a Portable Document Format (PDF) object stream, an embedded CBOR resource, a signed-exchange attestation field per the World Wide Web Consortium WebPackage specification, and a functional equivalent thereof. The embedding strategy may be selected such that downstream content modification invalidates the embedded signature, providing tamper evidence as a structural property of the content rather than a separately invocable verification step.

The license/biometric validator 160 receives the embedding output and applies optional WebAuthn/FIDO2 verification of the originator. The validator 160 may invoke a hardware-bound platform authenticator (Touch ID, Windows Hello, Android BiometricPrompt, security key, and a functional equivalent thereof) to bind the HMT to a verified originator identity prior to publication, may issue a cryptographic challenge to the platform authenticator, and may receive an Ed25519 or ECDSA signature over the HMT content_hash field 9412 (FIG. 14) that is appended to the signature_chain field 9432 of the HMT.

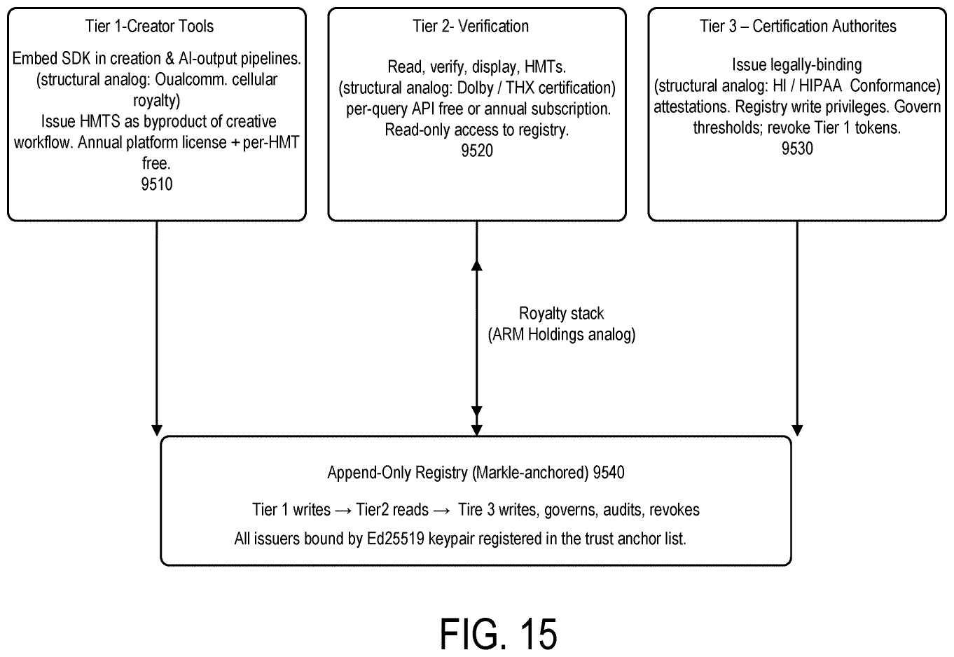

The HMT and content are then committed to the Append-Only Registry 170, which is implemented as a Merkle-anchored append-only log structure and may be co-instantiated with the dual-sink registry anchors 510 and 520 of FIG. 1. Entries are added but never modified or deleted; retroactive modification is detectable because each entry is cryptographically linked to the Merkle root and the root is anchored to at least two independent registry sinks with distinct administrative control, distinct technical infrastructure, and distinct legal jurisdiction. The append-only registry 170 corresponds to the shared substrate of FIG. 15 across the three-tier trust anchor license model.

The audit/verification interface 180 exposes a Representational State Transfer (REST) endpoint or functional equivalent (gRPC, GraphQL, JSON-RPC, and a functional equivalent thereof) for third-party verification of HMT validity. The audit/verification interface 180 may accept an HMT and corresponding content artifact as input, recompute the content hash, validate the Ed25519 signature against the issuer_public_key field 9418 of the HMT, validate the Merkle inclusion proof against the append-only registry 170, validate the wall-clock time against the timestamp_issued field 9438 and the ttl_seconds field 9440, and return an aggregate verification verdict comprising one of the six state values of FIG. 12.

FIG. 12 depicts the six-state state machine implemented by the state resolver 130 of FIG. 11, comprising three reversible quantitative scoring states-GREEN 9210, AMBER 9212, RED 9214—and three absorbing override states—TAMPERED 9220, UNVERIFIABLE 9222, EXPIRED 9224—together with the calibrated-score axis HMS_cal graduated from 0 to 100 along the central vertical axis of the figure, and the override-transition arrows extending laterally from each scoring state to the corresponding override state.

The GREEN state 9210 may indicate high-confidence human authorship and may be entered when the calibrated score HMS_calibrated is greater than or equal to 85. The GREEN state 9210 may correspond, in a recipient-side rendering, to a green badge color, an integer score display in the HumanMark™ Index 640 of FIG. 16 (e.g., the “Hi 87” example shown in FIG. 16), and an optional Tier-3-licensed certification seal indicating verified high-confidence human authorship under the trust anchor model of FIG. 15.

The AMBER state 9212 may indicate moderate or ambiguous authorship determination and may be entered when the calibrated score HMS_calibrated falls within the inclusive range of 40 to 84. The AMBER state 9212 may correspond to an amber badge color and a numeric index display indicating moderate confidence requiring contextual judgment by the recipient.

The RED state 9214 may indicate low-confidence human authorship (i.e., high probability of generative-model authorship) and may be entered when the calibrated score HMS_calibrated is less than or equal to 39. The RED state 9214 may correspond to a red badge color and a numeric index display indicating low confidence in human authorship.

Transitions among the three quantitative scoring states 9210, 9212, and 9214 are governed by +2 hysteresis to suppress threshold-boundary oscillation. A transition from AMBER 9212 upward into GREEN 9210 may require HMS_calibrated to be greater than or equal to 87 (i.e., the GREEN entry threshold of 85 plus the +2 hysteresis margin). A transition from GREEN 9210 downward into AMBER 9212 may require HMS_calibrated to be less than or equal to 83 (i.e., the GREEN exit threshold of 85 minus the −2 hysteresis margin). Similarly, a transition from RED 9214 upward into AMBER 9212 may require HMS_calibrated to be greater than or equal to 42 (40+2), and a transition from AMBER 9212 downward into RED 9214 may require HMS calibrated to be less than or equal to 38 (40−2). The hysteresis structure may prevent rapid alternation between states for content scoring near a threshold and may provide rendering stability over content-edit revisions and over multi-frame video sequences exhibiting frame-to-frame score variation.

The three absorbing override states are entered by lateral transitions from any of the quantitative scoring states 9210, 9212, 9214 upon detection of a defined override condition; once entered, an absorbing override state may not be exited within the artifact lifetime. The TAMPERED state 9220 may be entered upon detection of a signature failure, a content-hash mismatch, an Ed25519 verification failure, a Merkle-inclusion-proof verification failure, or a functional equivalent thereof. The UNVERIFIABLE state 9222 may be entered upon detection of insufficient signal—for example, where the dynamic weight renormalization availability mask is (0,0,0,0) per the enumeration of FIG. 13—indicating that no analyzer channel produced a usable sub-score. The EXPIRED state 9224 may be entered when the wall-clock time elapsed since the value of the timestamp_issued field 9438 of FIG. 14 exceeds the ttl_seconds field 9440, indicating that the issuance policy time-to-live has been exceeded.

Each absorbing override state may render with a dedicated visual indicator at the recipient that distinguishes it from the three reversible scoring states. In some implementations, override states may suppress the integer score display entirely and present only the override-state name, indicating to the recipient that no quantitative authorship determination is available for the content. In alternate implementations, override states may render with a contextual explanatory tooltip identifying the specific failure mode (e.g., “signature mismatch” for TAMPERED 9220, “TTL exceeded” for EXPIRED 9224, “insufficient signal” for UNVERIFIABLE 9222).

The state value resolved by the state machine is encoded into the state field 9434 of the HMT (FIG. 14) using the integer encoding 0=GREEN, 1=AMBER, 2=RED, 3=UNVERIFIABLE, 4=TAMPERED, 5=EXPIRED, providing a compact, deterministic representation of the resolved state for inclusion in the canonical CBOR serialization signed under Ed25519. The state field 9434 is included in the signature input set such that any tampering with the resolved state value invalidates the Ed25519 signature, structurally binding the state determination to the cryptographic attestation.

FIG. 13 depicts the locked mathematical formulas used by the composite scorer 120 and Platt calibrator 122 of FIG. 11, illustrated in three labeled panels: a composite raw score formula 9310, a Platt Sigmoid calibration formula 9320, and a dynamic weight renormalization formula 9330 with enumerated availability-mask examples. The formulas are version-locked under the scoring_model_version field 9424 of FIG. 14 such that any two implementations conformant to the same Sem Ver scoring_model_version will produce identical outputs given identical inputs.

The composite raw score formula 9310 specifies HMS_raw=w_SE·SE+w_SF·SF+w_GA·(1−GA)+w_PV·PV, where SE is the semantic entropy sub-score produced by analyzer 112 of FIG. 11, SF is the stylometric fingerprint sub-score produced by analyzer 114, GA is the generative artifact probability produced by analyzer 116 (inverted by subtraction from 1 such that lower artifact probability contributes positively to the overall score), and PV is the Provenance Verification sub-score produced by analyzer 118. The locked weight values are w_SE=0.28, w_SF=0.32, w_GA=0.25, and w_PV=0.15, summing to unity (Σw=1.00). The locked weights provide deterministic, version-stable scoring across all SDK instances such that any two implementations conformant to the same scoring_model_version 9424 of the HMT (FIG. 14) will produce identical raw scores given identical sub-score inputs. In some implementations, the locked weight values may be modified upon promotion of the scoring_model_version 9424 to a successor Sem Ver-encoded version identifier, with the prior weight set retained for backward verification of HMTs issued under earlier versions.

The Platt Sigmoid Calibration formula 9320 specifies HMS_calibrated=1/(1+exp(−(α·HMS_raw+β))). The composite-level calibration parameters are α=0.45 and β=0.18, mapping the raw weighted-sum score onto a calibrated probability on the unit interval (0,1). A second, distinct calibration is applied at the semantic entropy sub-score level using α=0.35 and β=0.12 prior to the composite weighted sum, providing channel-level non-linearity ahead of the linear weighted combination at the composite layer. The Platt sigmoid transform may be selected for its monotonic, smooth, and well-conditioned behavior across the operative score range, may compress extreme raw scores toward the asymptotes 0 and 1 such that small variations in extreme scores do not produce destabilizing state transitions, and may provide an interpretable probability-of-human-authorship semantics suitable for direct presentation in the HumanMark™ Index 640 of FIG. 16.

The dynamic weight renormalization formula 330 specifies the procedure applied when one or more analyzer channels of the scoring engine 110 (FIG. 11) are unavailable for a particular content artifact. An availability mask m^{c} ∈{0, 1} is computed for each channel c, where m^{c}=1 indicates the channel is present and produced a valid sub-score, and m^{c}=0 indicates the channel is unavailable. The aggregate availability S_active=μ^{c} m^{c}·w^{c} is computed, and renormalized weights w′^{c}=(m^{c}·w^{c})/S_active are derived such that Σw′^{c}=1.0 over the available channels.

Sixteen total availability mask configurations are enumerated, corresponding to the 24 possible combinations of the four channels (SE, SF, GA, PV). Representative mask examples shown in FIG. 13 include: mask (1,1,1,1)—all channels present-yielding the locked weight set 0.28/0.32/0.25/0.15; mask (1,1,1,0)—Provenance Verification missing-yielding renormalized weights 0.329/0.376/0.294/—; mask (1,1,0,1)—Generative Artifact missing-yielding renormalized weights 0.330/0.376/−/0.176; mask (1,0,0,0)—Semantic Entropy only—yielding the degenerate weight 1.00/−/−/−; and mask (0,0,0,0)—no channels available—which short-circuits the composite computation and resolves directly into the UNVERIFIABLE absorbing state 222 of FIG. 12 without producing a calibrated score.

The worst-case renormalization error bound is given by |ε|≤1-S_active=Σ(unavailable channel weights), which establishes that the maximum deviation introduced by renormalization is bounded above by the sum of the locked weights of the unavailable channels. This bound provides a closed-form guarantee on the score-stability properties of the dynamic weight renormalization in the presence of partial-channel unavailability and may be cryptographically committed to the analyzer_weights field 9410 of the HMT (FIG. 14) such that recipient-side verification can independently confirm the renormalized weights used at issuance and recompute the worst-case error bound.

FIG. 14 depicts a tabular enumeration of the canonical field schema of the HumanMark™ Token (HMT) generated by the HMT token generator 140 of FIG. 11, structured as a four-column table comprising a CBOR map key, a CBOR-encoded type, a semantic description, and a field reference number for each field. The token may be serialized under canonical Concise Binary Object Representation (CBOR) per RFC 8949 § 4.2.1, signed under Ed25519 per RFC 8032 over the canonical serialization, and encoded using the field schema enumerated in FIG. 14. The fields are ordered alphabetically in the figure by CBOR map key to facilitate canonical ordering during signature computation.

The analyzer_weights field 9410 may be encoded as a CBOR map of text-string—to-float (map<tstr, float>) containing the renormalized weights (w's values) used at issuance—that is, the post-renormalization weights output by the dynamic weight renormalization formula 330 of FIG. 13—with the constraint that the float values sum to 1.0. Inclusion of this field in the signed token enables recipient-side reconstruction and verification of the exact weight set applied at issuance, including in the partial-channel-availability scenarios enumerated in FIG. 13.

The content_hash field 9412 may be encoded as a 32-byte byte string (bstr[32]) and may comprise the SHA-3-256 hash of the canonicalized content artifact at the moment of HMT issuance. Canonicalization may include modality-specific normalization steps (Unicode normalization NFC for text, EXIF stripping for images, container-level normalization for audio, container-level normalization for video, and a functional equivalent thereof) selected to ensure that semantically equivalent representations of the same content produce identical content hashes. The content hash field 9412 is the primary cryptographic binding between the HMT and the content artifact.

The generation method field 9414 may be encoded as a CBOR text string (tstr) identifying the originator-asserted generation methodology of the content. Enumerable values may include “human-authored”, “hybrid”, “gpt-4”, “claude-3”, “stable-diffusion-xl”, and a functional equivalent thereof, including any model-name-and-version identifier asserted by the originator at issuance. The generation_method field 9414 is the originator's self-reported authorship attestation and is independent of the algorithmically computed sub_scores field 9436.

The hms field 9416 may be encoded as an unsigned integer in the inclusive range [0 . . . 100] (uint [0 . . . 100]), representing the integer-rounded calibrated HumanMark score scaled by 100, providing a compact human-readable score representation suitable for direct rendering in the HumanMark™ Index 640 of FIG. 16. The hms field 9416 is mathematically derivable from the sub_scores field 9436 and the analyzer_weights field 9410 by application of the formulas of FIG. 13, providing redundant integrity protection against tampering with any of the three fields in isolation.

The issuer_public_key field 9418 may be encoded as a 32-byte byte string (bstr[32]) and may comprise the raw Ed25519 public key bytes of the HMT issuer. The issuer_public_key may be retrieved by recipients from embedded artifact metadata, a Domain Name System (DNS) Text (TXT) record, a Decentralized Identifier (DID) document, the trust anchor list of the Append-Only Registry 9540 of FIG. 15, and a functional equivalent thereof, for verification of the signature field 9430.

The modality field 9420 may be encoded as a CBOR text string or array of text strings (tstr|[tstr]). Enumerable values may include “text”, “image”, “audio”, “video”, and arrays thereof for multi-modal content (e.g., a video with an audio track may be encoded as the array [“video”, “audio”]). The modality value selects the modality-specific normalization rules applied during content_hash computation 412 and selects the modality-specific embedding strategy applied by the embedding into content module 150 of FIG. 11.

The operator_config_hash field 9422 may be encoded as a 32-byte byte string (bstr[32]) and may comprise the SHA-3-256 hash of the operator threshold configuration bundle (including override-state thresholds, hysteresis margins, channel availability requirements, and a functional equivalent thereof) in effect at issuance, providing a tamper-evident commitment to the operator policy configuration that governed scoring at the moment of issuance.

The scoring_model_version field 9424 may be encoded as a CBOR text string (tstr) carrying a Semantic Versioning 2.0.0 (SemVer) version identifier (e.g., “1.4.2”) that identifies the scoring model and locked weight set used at issuance, enabling recipient-side selection of the corresponding verification ruleset for backward compatibility across model upgrades. Recipients may apply the version-correct weight set when independently recomputing HMS_raw from the sub_scores field 9436.

The sdk_instance_id field 9426 may be encoded as a 16-byte byte string (bstr[16]) carrying a UUID version 4 binary identifier of the specific SDK instance used to generate the HMT, enabling per-instance auditability and revocation by Tier 3 Certification Authorities 9530 of FIG. 15. Compromised SDK instances may be revoked by adding the sdk_instance_id 9426 to a revocation list maintained by the append-only registry 9540, after which subsequent recipient-side verifications resolving to a revoked sdk_instance_id 9426 may transition the HMT to the TAMPERED state 9220 of FIG. 12.

The section_scores field 9428 may be encoded as an optional CBOR array of maps ([map] (opt)) carrying per-section sub-scores for long-form content, enabling fine-grained provenance attribution within multi-section documents (e.g., per-paragraph or per-segment scoring) without requiring separate HMTs for each section. Each entry in the section_scores array may comprise a section identifier, a section content hash, and a section-level sub_scores map analogous to the document-level sub_scores field 9436.

The signature field 9430 may be encoded as a 64-byte byte string (bstr[64]) and may comprise the Ed25519 signature computed over the canonical CBOR serialization of all preceding fields (excluding the signature field itself and the optional signature_chain field 9432). The signature provides cryptographic binding of the issuer to the asserted score, state, and content hash, and is the primary verification target of the audit/verification Interface 180 of FIG. 11 and of the Tier 2 verification 9520 of FIG. 15.

The signature_chain field 9432 may be encoded as an optional CBOR array of byte strings ([bstr] (opt)) carrying ordered delegation signatures, enabling delegated issuance scenarios such as enterprise platforms issuing HMTs on behalf of authenticated users, multi-party co-attestation, and chained Tier 1→Tier 2→Tier 3 endorsements per the trust anchor model of FIG. 15. Each delegation signature in the chain may be an Ed25519 signature over the preceding canonical state.

The state field 9434 may be encoded as an unsigned integer in the inclusive range [0 . . . 5] (uint[0 . . . 5]) using the deterministic encoding 0=GREEN, 1=AMBER, 2=RED, 3=UNVERIFIABLE, 4=TAMPERED, 5=EXPIRED, corresponding to the six states of the disclosure machine of FIG. 12. The integer encoding may be selected for compact CBOR serialization (one byte per state value) and for unambiguous mapping to the state semantics depicted in FIG. 12.

The sub_scores field 9436 may be encoded as an optional CBOR map of text-string-to-float (map<tstr, float> (opt)) carrying the raw sub-scores SE, SF, GA, and PV produced by analyzers 112, 114, 116, and 118 of FIG. 11 prior to the composite weighted sum, enabling recipient-side independent recomputation of the composite raw score 9310 of FIG. 13 and audit of the calibration step 320. Inclusion of sub_scores 9436 in the signed token enables fully reproducible recipient-side score derivation given only the HMT and the version-correct scoring rule set identified by scoring_model_version 9424.

The timestamp_issued field 9438 may be encoded as a CBOR text string in RFC 3339 format with millisecond precision and “Z” UTC suffix (e.g., “2025-04-24T15: 23:45.123Z”), establishing the cryptographic time of issuance for time-to-live enforcement and chronological ordering within the append-only registry 9540 of FIG. 15. The timestamp_issued field 9438 is the temporal reference for the EXPIRED state 9224 transition computed by the state resolver 130 of FIG. 11.

The ttl_seconds field 9440 may be encoded as an unsigned integer specifying the time-to-live in seconds from issuance after which the HMT may transition to the EXPIRED state 9224 of FIG. 12. A ttl_seconds value of zero may indicate a non-expiring policy (i.e., no TTL-based expiration). Recipient-side verification may compute the difference (current_wall_clock-timestamp_issued) and compare the difference against ttl_seconds; if the difference exceeds ttl_seconds, the HMT may resolve to EXPIRED 9224 regardless of the value of state field 9434 at issuance.

The HMT may be optionally extended with implementation-specific or jurisdiction-specific fields registered in a CBOR tag namespace administered by the Tier 3 certification authorities 9530 of FIG. 15, provided that any such extension fields do not conflict with the enumerated reserved keys 9410 through 9440 and are included in the canonical serialization input to the Ed25519 signature computation. Extension fields not recognized by a recipient verifier may be preserved by canonical re-serialization but ignored for state-resolution purposes.

FIG. 15 depicts the three-tier trust anchor license model that organizes the SignalDrop™ ecosystem into three operationally distinct tiers—Tier 1 creator tools 9510, Tier 2 verification 9520, and Tier 3 certification authorities 9530—each interacting with a shared append-only registry 9540 implemented as a Merkle-anchored append-only log. The tiers operate independently with distinct privileges, distinct economic models, and distinct legal accountability profiles, while the cryptographic substrate of Ed25519-keyed write operations enables cross-tier verifiability without requiring cross-tier trust delegation. The reference numerals 9510, 9520, 9530, and 9540 of FIG. 15 are local to FIG. 15 and address the three-tier license model; they are distinct from the registry sinks 510, 520 of FIG. 1, which address the dual-sink anchor topology.

Tier 1 creator tools 9510 may comprise creator-facing software development kits, content-authoring platforms, and AI-output generation pipelines that issue HumanMark™ Tokens (HMTs) as a computational byproduct of the content creation workflow. Tier 1 entities may operate under an annual platform license combined with a per-HMT issuance fee structure analogous to a cellular-baseband royalty model, in which a perpetual platform license is paid by integrating platforms and a per-unit royalty is paid for each cryptographic instance created. Tier 1 entities may hold write privileges to the append-only registry 9540 limited to issuance of HMTs bound to their registered Ed25519 issuer keypair, and may not exercise revocation or threshold-governance privileges. The structural analog of Tier 1 may be a cellular-baseband royalty stack in which integrating manufacturers pay per-unit royalties to a standards-essential-patent licensor.

Tier 2 verification 9520 may comprise verification platforms, content-distribution networks, social platforms, news organizations, and downstream consumers of HMTs that read, verify, and display HMT content but do not issue new HMTs and do not exercise governance over thresholds. Tier 2 entities may operate under a per-query API fee or annual subscription model and may hold read-only access to the append-only registry 9540. Tier 2 verification operations may include retrieving the issuer_public_key field 9418 of an HMT (FIG. 14), validating the Ed25519 signature 9430 against the canonical CBOR serialization, validating the Merkle inclusion proof for the registry entry, and resolving the state field 9434 to a recipient-facing visual indication. The structural analog of Tier 2 may be a content-certification model in which downstream playback systems pay subscription fees for verification capability without participating in content authoring.

Tier 3 certification authorities 9530 may comprise legally-accountable certification entities that issue legally-binding attestations regarding HMT validity, govern the threshold configuration of the disclosure machine of FIG. 12 and the locked weights of the formulas of FIG. 13, hold registry write privileges including revocation, and may revoke compromised or non-compliant Tier 1 issuance tokens by adding the corresponding sdk_instance_id 9426 (FIG. 14) to a revocation list maintained by the append-only registry 9540. Tier 3 entities may operate under a regulated certification-authority model with statutory or contractual liability for the validity of the legally-binding attestations they issue. The structural analog of Tier 3 may be a statutorily-recognized certification body that issues legally-binding attestations of conformance and exercises revocation authority over downstream entities.

The append-only registry 9540 is the shared substrate over which all three tiers operate. The append-only registry 9540 may be implemented as a Merkle-anchored append-only log structure in which each registry entry is cryptographically linked to its predecessor and the current Merkle root is committed simultaneously to the dual-sink registry anchors 510 and 520 of FIG. 1, providing tamper-evident persistent verifiability. The directional flow over the append-only registry 9540 may be: Tier 1 writes (issuance)→Tier 2 reads (verification)→Tier 3 writes (governance, audit, revocation), with all three tiers bound to a multi-issuer Ed25519 keypair registry maintained as a trust anchor list.

The cumulative tier structure may correspond to a royalty-stack architecture analogous to a semiconductor intellectual property licensing model, in which a foundational primitive is licensed to a plurality of independent integrating parties at distinct economic and accountability tiers, with the foundational substrate (here the cryptographic registry rather than a microprocessor architecture) being the locus of cross-tier interoperability. All issuers across all three tiers may be bound by an Ed25519 keypair registered in the trust anchor list maintained by the append-only registry 9540 administrator, ensuring a unified cryptographic basis for cross-tier signature verification.

The three-tier license model may resolve the economic-incentive tension between content authors (who benefit from broad distribution of attested content), verification platforms (who benefit from low marginal cost of verification at scale), and certification authorities (who bear statutory and contractual liability for attestation validity), by aligning each tier's economic model and privilege set with the operational role and accountability profile appropriate to that role. The cryptographic substrate of Ed25519-bound write privileges and Merkle-anchored read verifiability may enable cross-tier interoperability without requiring any tier to extend trust to any other tier beyond the validity of the registered Ed25519 keypairs.

FIG. 16 depicts an end-to-end transaction-flow diagram of the HumanMark™ content lifecycle across three swim-lane actors—creator 610, platform 620, and recipient 630—illustrating the nine sequential operational steps from content composition through recipient-side rendering of the HumanMark™ Index 640. The figure shows a three-band horizontal swim-lane structure with directional arrows traversing the actor boundaries at the points of artifact handover, providing an end-to-end view of the operational lifecycle of an HMT-bound content artifact through the trust-tier ecosystem of FIG. 15.

In step 1, the creator 610 may compose content using any authoring tool, application, or pipeline, including a word processor, a graphic editor, a digital audio workstation, a video editor, a generative-AI prompt-and-output workflow, a hybrid human-AI authoring environment, and a functional equivalent thereof. The composed content may comprise text, image, audio, video, multi-modal content, or any combination thereof corresponding to the modality field 9420 of FIG. 14.

In step 2, the creator 610 may invoke the Tier 1 SDK described in connection with FIG. 15 to score the composed content and produce a cryptographic signature over the resulting score. The score is computed by the scoring engine 110 of FIG. 11 according to the formulas 9310, 9320, and 9330 of FIG. 13 and is resolved into a state by the state resolver 130 according to the six-state machine of FIG. 12. The Ed25519 signature 9430 (e.g., FIG. 14) is computed over the canonical CBOR serialization of the HMT field schema of FIG. 14.

In step 3, the creator 610 may embed the HumanMark™ Token (HMT) into the content using the Embedding into Content module 150 of FIG. 11. The embedding strategy may be selected per the modality field 9420 such that downstream content modification invalidates the embedded signature (e.g., EXIF metadata for images, ID3 tags for audio, MP4 boxes for video, HTML data attributes for text). The HMT becomes architecturally inseparable from the content at the byte level, such that the content and the attestation cannot be independently distributed without invalidating the cryptographic binding between them.

In step 4, the creator 610 may publish the HMT-embedded content to a platform 620 distribution surface. Publication may proceed via direct upload, application programming interface (API) call, content-management-system commit, peer-to-peer share, federated protocol publication, and a functional equivalent thereof. The crossing of the creator/platform swim-lane boundary at this step represents the transfer of the artifact from the originator's domain into the distribution domain.

In step 5, the platform 620 may ingest the asset and extract the embedded HMT from the content. Extraction may invert the modality-specific embedding strategy applied in step 3 to recover the canonical CBOR-serialized HMT carried in the modality-appropriate metadata container.

In step 6, the platform 620 may verify the Ed25519 signature 9430 on the extracted HMT, recompute the content_hash field 9412 (FIG. 14) over the received content, validate the recomputed hash against the value carried in the HMT, and validate the Merkle inclusion proof against the append-only registry 9540 of FIG. 15. The verification operation is read-only with respect to the registry and is consistent with the Tier 2 verification 9520 privileges of FIG. 15.

In step 7, the platform 620 may apply policy to the verified HMT and produce a flag, label, or rejection determination. Policy application may include applying a content-distribution policy that suppresses RED-state 9214 content, applies a UNVERIFIABLE-state 9222 friction layer, blocks TAMPERED-state 220 content from publication, surfaces GREEN-state 9210 content with elevated visibility, and a functional equivalent thereof. The policy applied at step 7 is independent of the cryptographic verification at step 6 and is configurable by the Platform 620 according to its content-distribution objectives.

In step 8, the recipient 630 may receive the policy-applied content from the Platform 620. Reception may comprise rendering the content within a browser, application, feed, search result, electronic-mail message, syndicated feed, and a functional equivalent thereof.

In step 9, the recipient 630 may render the HumanMark™ Index 640 in association with the content, presenting the integer score (e.g., the “Hi 87” example shown in FIG. 16, corresponding to an hms field 9416 value of 87 in the GREEN state 9210) together with a visual color indication corresponding to the state field 9434 of FIG. 14. The HumanMark™ Index 640 may comprise an indication tier providing a free-display rendering of the score and state, and an optional certification tier providing a Tier-3-licensed certification badge with an embedded cryptographic seal validating that the HMT was issued under a Tier-3-governed scoring configuration.

The HumanMark™ Index 640 visual rendering may comprise a horizontal three-segment color bar showing the partition of the score range into 0-39 RED, 40-84 AMBER, and 85-100 GREEN regions corresponding to the entry thresholds of the disclosure machine states 9214, 9212, and 9210 of FIG. 12, providing recipients with an at-a-glance reference to the operative threshold structure under which the displayed score was resolved.

The end-to-end flow of FIG. 16 may operate without any centralized clearing house, without third-party retention of content, without inference-time model queries, and without dedicated attestation infrastructure beyond the dual-sink registry anchors 510 and 520 of FIG. 1, consistent with the privacy-by-architecture and zero-residency principles of the broader SignalDrop™ system. The end-to-end flow may further operate in disconnected, denied, intermittent, and limited-bandwidth (DDIL) environments because steps 2 through 6 may be executed locally and registry commitment may be deferred to a local queue with exponential backoff when the dual-sink registry anchors 510 and 520 of FIG. 1 are temporarily unreachable.

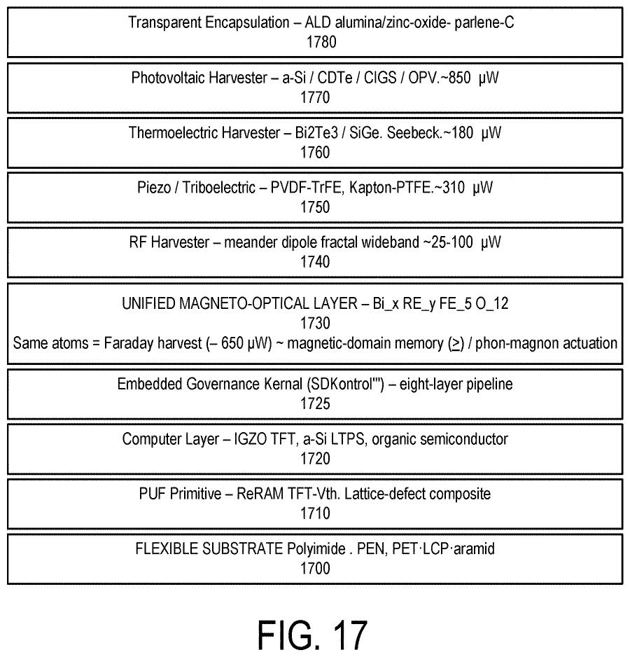

FIG. 17 is a cross-sectional schematic of the flexible substrate stack. From bottom to top, the stack comprises a flexible substrate foundation 1700, a physically unclonable function (PUF) primitive layer 1710, a compute layer 1720 carrying an embedded governance kernel 1725, a unified magneto-optical layer 1730, a radio-frequency (RF) harvester layer 1740, a piezoelectric/triboelectric harvester layer 1750, a thermoelectric harvester layer 1760, a photovoltaic harvester layer 1770, and a transparent encapsulation layer 1780. The stack is monolithically integrated on the flexible substrate foundation 1700 such that the entire assembly bends to a radius of approximately 10 millimeters or less without functional degradation.

The flexible substrate foundation 1700 may comprise in preferred embodiment a polyimide film of thickness between approximately 12.5 micrometers and 125 micrometers. Polyimide may be selected for the combination of thermal stability (glass-transition temperature approximately 360 °C, permitting processing of deposited layers requiring elevated temperature), mechanical flexibility (minimum bending radius of approximately 5 millimeters or less without cracking under typical deployment cycling), chemical resistance to the solvents and etchants used in sequential deposition processes, and dimensional stability (coefficient of thermal expansion of approximately 20 parts per million per degree Celsius). Alternative substrate materials may include polyethylene naphthalate (PEN) having a glass-transition temperature of approximately 125 °C suitable for lower-temperature deposition processes; polyethylene terephthalate (PET) for economy-tier embodiments having a reduced thermal envelope; aramid-fiber-reinforced polymer composites for applications requiring elevated tear strength; liquid crystal polymer (LCP) for high-frequency RF-harvester embodiments; and a functional equivalent thereof.

The PUF primitive layer 1710 may be deposited directly onto the flexible substrate foundation 1700 and may comprise an electrically readable structure whose response to a cryptographic challenge is determined by sub-micron manufacturing variations unique to each instance of the substrate. Enumerable PUF species may include: (a) a resistive random-access-memory (ReRAM) PUF exploiting oxygen-vacancy distribution and conductive-filament formation variations in a metal-oxide thin film (for example hafnium dioxide, tantalum pentoxide, or titanium dioxide deposited by atomic-layer deposition); (b) a thin-film-transistor threshold-voltage PUF exploiting dopant-distribution variations in indium-gallium-zinc-oxide (IGZO) or amorphous-silicon active layers; (c) a crystal-lattice-defect PUF exploiting point-defect distribution in the magneto-optical garnet layer 1730 described below; (d) an optical-scattering PUF exploiting inhomogeneous scattering centers embedded in a transparent polymer layer; (e) a capacitive PUF exploiting thin-film-capacitor variation arrays; and (f) a functional equivalent thereof. The PUF output may be a cryptographic response of at least 128 bits suitable for use as a symmetric or asymmetric key-derivation seed, and the PUF may exhibit the standard PUF properties of uniqueness (inter-device Hamming distance of approximately 50 percent), reliability (intra-device Hamming distance of approximately 5 percent or less across the operating envelope), and unclonability.

The compute layer 1720 may be deposited above the PUF primitive layer 1710 and may comprise thin-film-transistor (TFT) circuitry implementing the processor, memory controller, and input/output interfaces required by the governance kernel 1725. In some embodiments, the TFT active material may be IGZO deposited by sputtering with carrier mobility between approximately 10 and 30 square centimeters per volt-second, supporting clock frequencies up to approximately 10 megahertz suitable for the governance-kernel workload. Alternative active materials may include amorphous silicon (a-Si) for economy-tier embodiments; low-temperature polycrystalline silicon (LTPS) for higher-performance embodiments; organic semiconductors for flexibility-critical embodiments; two-dimensional materials such as molybdenum disulfide for research-grade embodiments; and a functional equivalent thereof.

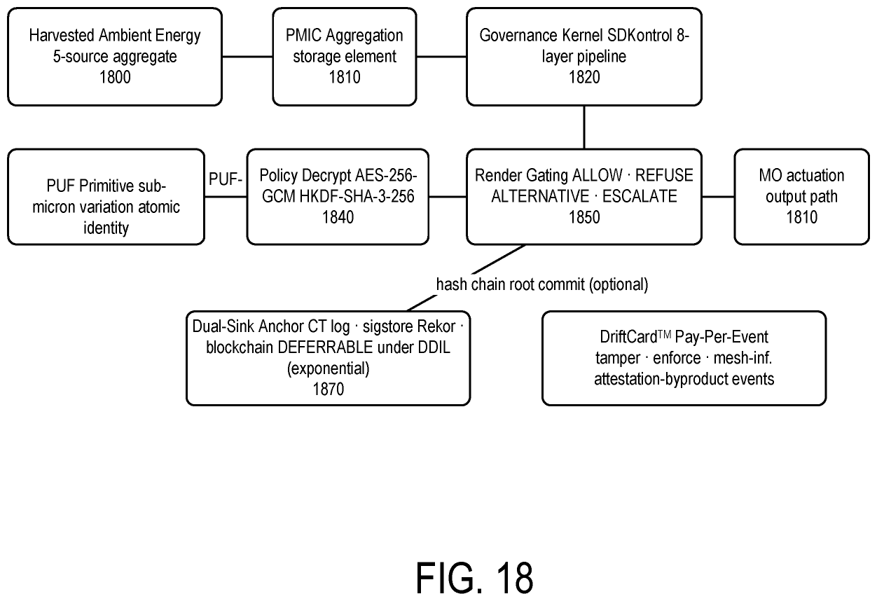

The embedded governance kernel 1725, illustrated in FIG. 17 and further detailed in FIG. 18 at reference 1820, may be the SDKontrol™ kernel disclosed in the sibling SignalDrop™ utility and incorporated by reference. The kernel may execute an eight-layer pipeline (input validation, policy resolution, consent verification, content classification, render gating, telemetry emission, audit logging, and fail-safe fallback) entirely within the compute layer 1720 using harvested energy. The kernel may be resident as compiled code stored in non-volatile memory within the unified magneto-optical layer 1730 and executed from volatile memory within the compute layer 1720 during operation.

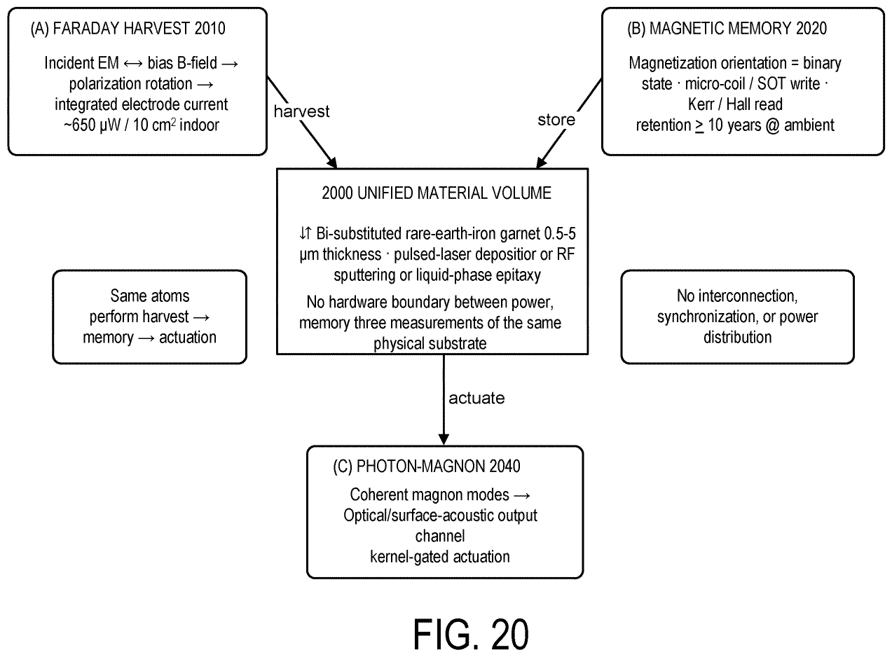

The unified magneto-optical layer 1730, shown in FIG. 17 and detailed further in FIG. 20 at reference 2000, may comprise bismuth-substituted rare-earth iron garnet of formula Bi_xRE_yFe_5O_12, where RE is selected from yttrium, gadolinium, terbium, dysprosium, holmium, erbium, thulium, ytterbium, and lutetium, and where 0<x≤3−y and 0≤y≤3. The layer may be deposited by pulsed-laser deposition, RF sputtering, or liquid-phase epitaxy at thickness between approximately 0.5 and 5 micrometers, with the precise thickness selected to optimize the trade-off among Faraday rotation coefficient (for harvest efficiency), magnetic-domain retention (for memory stability), and photon-magnon coupling strength (for actuation bandwidth). Bismuth substitution content x is preferably in the range 0.5≤x≤2.5 to achieve a Faraday rotation coefficient exceeding approximately 0.1 degree per micrometer at visible wavelengths. As described in greater detail in connection with FIG. 20 below, the layer 1730 may perform three simultaneous functions-energy harvesting, non-volatile memory storage, and optical actuation-within the same material volume, such that no hardware boundary exists between power, memory, and output.

The RF harvester layer 1740 may comprise a dipole or loop antenna array tuned to ambient electromagnetic bands including cellular (approximately 0.7 to 6 gigahertz), Wi-Fi (approximately 2.4 and 5.8 gigahertz), and broadcast (approximately 500 to 900 megahertz) frequencies, coupled to a multi-stage rectifier circuit providing direct-current output to the power-management integrated circuit (PMIC) 1810 shown in FIG. 18. Antenna species may include printed meander dipoles, fractal-geometry wideband antennas, metamaterial absorber arrays, and frequency-selective-surface resonators. Typical harvested power may range from approximately 5 microwatts in rural RF-sparse environments to approximately 100 microwatts in dense urban RF environments per 10 square centimeters of substrate area.

The mechanical-energy harvester layer 1750 may comprise either a piezoelectric polymer film (polyvinylidene fluoride (PVDF), or its copolymer PVDF-TrFE) or a triboelectric nanogenerator structure (dissimilar polymer pairs, for example Kapton against polytetrafluoroethylene, in contact-separation mode), converting mechanical deformation, vibration, or acoustic input into electrical output. The piezoelectric coefficient d33 for PVDF-TrFE may typically exceed approximately 25 picocoulombs per newton. Typical harvested power per 10 square centimeters of substrate area may range from approximately 50 microwatts for low-motion wearable applications to approximately 500 microwatts under active-use conditions, with a representative value of approximately 310 microwatts.

The thermoelectric harvester layer 1760 may comprise a thin-film bismuth-telluride or silicon-germanium composition arranged in an array of hot-side/cold-side leg pairs exploiting the Seebeck effect. In wearable applications exploiting body-heat gradient against ambient air, typical Seebeck voltages may reach approximately 1 to 10 millivolts per Kelvin of thermal gradient, with aggregate harvested power of approximately 180 microwatts per 10 square centimeters under a 5 °C. gradient.

The photovoltaic harvester layer 1770 may comprise a thin-film active material selected from amorphous silicon (a-Si), cadmium telluride (CdTe), copper indium gallium selenide (CIGS), or organic photovoltaic compositions, with transparent electrodes (indium tin oxide or a functional equivalent thereof) permitting partial transparency for aesthetic or sensing applications. Under typical indoor lighting (approximately 500 lux) the harvested power may be approximately 850 microwatts per 10 square centimeters; under outdoor full-sun conditions (approximately 100,000 lux) the harvested power may exceed approximately 100 milliwatts per 10 square centimeters.

The uppermost layer 1780 may provide mechanical protection, a moisture barrier (water vapor transmission rate of approximately 10-6 grams per square meter per day or less), and optical coupling for the photovoltaic layer 1770 and the magneto-optical layer 1730. Encapsulation species may include atomic-layer-deposited alumina-zinc-oxide nanolaminates, sputtered silicon nitride, parylene-C conformal coatings, multi-layer polymer-inorganic hybrids, and a functional equivalent thereof.

Aggregating across the five harvester layers—photovoltaic 1770 at approximately 850 microwatts; thermoelectric 1760 at approximately 180 microwatts; piezoelectric/triboelectric 1750 at approximately 310 microwatts; RF 1740 at approximately 25 microwatts; and magneto-optical Faraday harvest within layer 1730 at approximately 650 microwatts—may yield a typical indoor-ambient aggregate envelope of approximately 2,015 microwatts per 10 square centimeters of substrate area. The aggregate envelope may substantially exceed the continuous power draw of the SDKontrol™ governance kernel 1725 operating at full eight-layer-pipeline load. The aggregate power may scale with substrate area and with environmental conditions; outdoor deployments, industrial-vibration deployments, and biomechanical-motion deployments may yield envelopes several times larger.

Fabrication. A 50-micrometer polyimide film (Kapton HN, or a functional equivalent thereof) may be cleaned by sequential immersion in acetone, isopropanol, and deionized water, and dried under nitrogen. On the cleaned substrate 1700, a 10-nanometer hafnium-dioxide (HfO₂) layer may be deposited by atomic-layer deposition at 200 °C using tetrakis(ethylmethylamino)hafnium and water precursors for the PUF primitive layer 1710. A 30-nanometer IGZO active layer may be sputtered at room temperature in an argon-oxygen ambient (O₂/Ar ratio of approximately 0.08) for the TFT compute layer 1720, patterned photolithographically into transistor arrays with channel length of 5 micrometers and clocked nominally at 5 megahertz. A 2-micrometer bismuth-gadolinium-iron-garnet layer of composition Bi_{1.5}Gd_{1.5}Fe₅O₁₂ may be deposited by pulsed-laser deposition at 650 °C with subsequent rapid thermal anneal at 750 °C for 10 minutes to crystallize the garnet phase forming layer 1730. The five-harvester stack may then be deposited sequentially: an RF meander-dipole antenna array tuned to 2.4 gigahertz with a three-stage Dickson rectifier forming layer 1740; a 15-micrometer PVDF-TrFE piezoelectric film poled at 80 megavolts per meter at 100 °C forming layer 1750; a bismuth-telluride thermoelectric array of 100 leg pairs forming layer 1760; a 200-nanometer amorphous-silicon photovoltaic layer with indium-tin-oxide transparent electrodes forming layer 1770; and an atomic-layer-deposited alumina-zinc-oxide nanolaminate encapsulation forming layer 1780 of total thickness 100 nanometers.

Characterization—expected measurement windows. Under typical indoor-office ambient conditions (approximately 2,100-lux illumination, 22 °C ambient, 5 °C body-air thermal gradient in wearable configuration, 2.4-gigahertz Wi-Fi field strength of approximately −40 dBm, and low-level biomechanical motion), the substrate may be expected to produce aggregate harvested power in the range of approximately 1,800 to 2,200 microwatts per 10 square centimeters, with per-harvester contributions consistent with the aggregate harvest envelope described in connection with FIG. 17. The PUF primitive 1710 may be expected to produce 128-bit responses with inter-device Hamming distance in the range of approximately 48-52 percent and intra-device Hamming distance below approximately 5 percent across the operating envelope of 0 °C to 70 °C and 10 percent to 90 percent relative humidity. The magneto-optical layer 1730 may be expected to produce Faraday rotation of at least approximately 0.10 degree per micrometer at 635-nanometer wavelength, magnetic-domain retention exceeding approximately 10 years at 25 °C, and magneto-optical Kerr-read raw bit-error rate below approximately 10-6 after on-substrate error correction. The governance kernel 1725 may be expected to execute the full eight-layer pipeline at 5 megahertz within a power envelope of approximately 800 microwatts, leaving approximately 50 percent harvest-envelope headroom for tamper monitoring, mesh signaling, and attestation byproducts.

Published per-component data for each constituent technology—including Kapton thermal stability, ALD HfO₂ ReRAM PUF entropy, IGZO TFT mobility, Bi:Gd:IG Faraday rotation, PVDF-TrFE piezoelectric coefficient, Bi₂Te₃ Seebeck coefficient, amorphous-silicon photovoltaic yield, and backscatter-communication range—may support each measurement window independently.

FIG. 18 is a block diagram of the governance architecture of the substrate. Harvested ambient energy 1800—aggregated from the five harvester sources of FIG. 17—flows through a power-management integrated circuit (PMIC) 1810 that provides aggregation and storage and supplies the embedded governance kernel 1820, which implements the SDKontrol™ eight-layer pipeline. The PUF primitive 1830 provides an atomic-scale identity from sub-micron manufacturing variations and feeds a key-derivation function that supports the policy-pack decryption module 1840 (operating, for example, AES-256-GCM with key derivation by HKDF-SHA-3-256). The decrypted policy may govern a render-gating module 1850 producing one of four decision classes: ALLOW, REFUSE, ALTERNATIVE, or ESCALATE. ALLOW decisions may drive the magneto-optical actuation interface 1860 along the output path. Render decisions and the associated attestation byproducts may optionally be committed to a dual-sink audit-anchor commitment interface 1870, which is deferrable under DDIL operating modes per the SignalDrop™ exponential-backoff specification incorporated by reference.

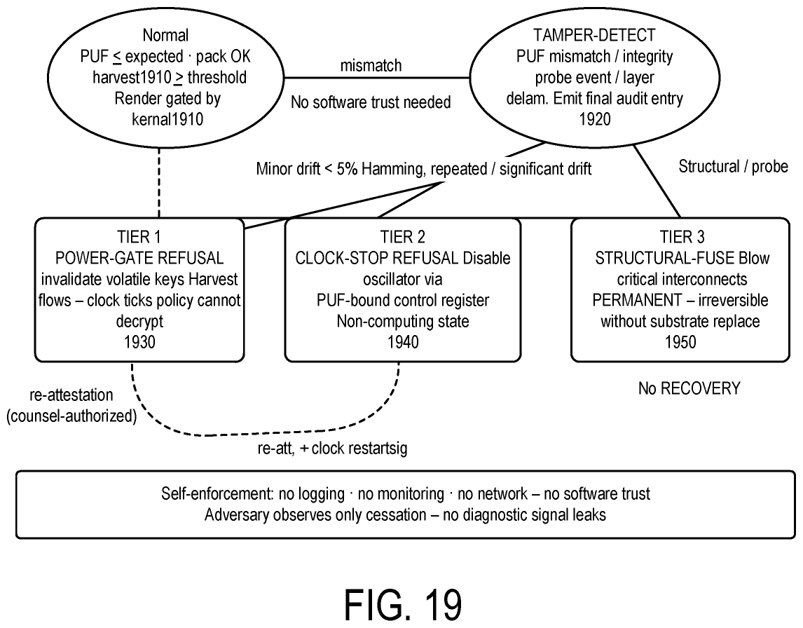

The governance policy pack—a canonical-CBOR-serialized specification of the rules governing inference admissibility—may be encrypted at pack-creation time against the specific PUF response of the substrate on which the pack will be resident. Encryption may use AES-256-GCM with a key derived from the PUF response via HKDF-SHA-3-256, producing a pack that decrypts correctly only on that specific substrate. Relocation of the pack to a different substrate may produce a decryption failure detected at policy-load time and resolved in one of the fail-safe tiers described in connection with FIG. 19 below.

Render gating performed by module 1850 of FIG. 18 may operate per the SDKontrol™ eight-layer pipeline incorporated by reference from the sibling SignalDrop™ utility. Every render decision may draw power from the harvested-energy aggregate 1800 through the PMIC 1810, may execute within the material boundary of the substrate, may produce an attestation entry as a byproduct of computation already performed for the gating decision, and may commit the attestation optionally to the dual-sink anchor 1870 through the shared audit architecture incorporated by reference from SignalDrop™ and HumanMark™. Because the attestation is a residue of computation already performed for another purpose, attestation may impose zero additional cost relative to the underlying governed computation.

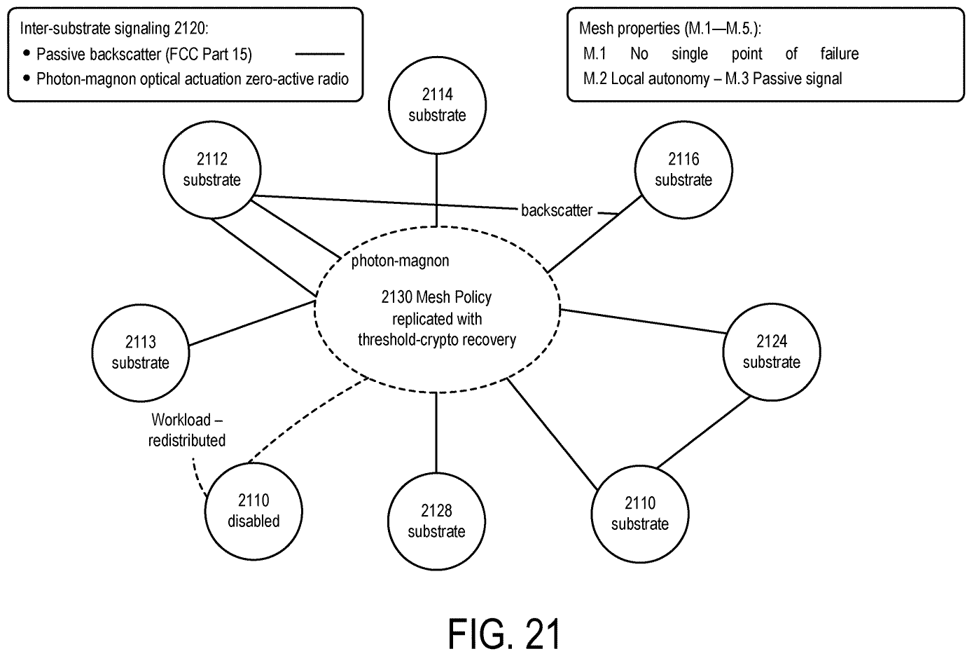

Render decisions classified as ALLOW may produce output signals through the photon-magnon coupling path of the unified magneto-optical layer 1730 of FIG. 17 (illustrated as element 2040 in FIG. 20). The output may take the form of optical signaling to an external display or sensor, passive-backscatter modulation for mesh communication as further described in connection with FIG. 21 below, or direct actuation of an integrated micro-actuator for physical-world output in haptic, pneumatic, or thermal modalities. The actuation path may be cryptographically gated: the magneto-optical layer may actuate only when the kernel 1820 produces a valid render-allow signature over the actuation intent, and the signature may be verified against the PUF-bound policy pack 1840.

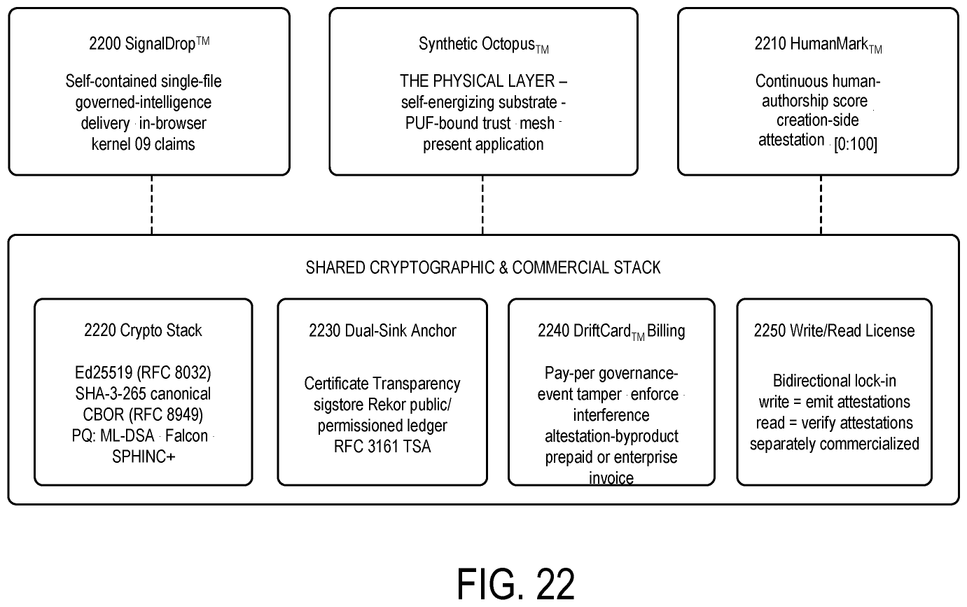

The kernel's Tier-3 fail-safe path may terminate into the physical-refusal state machine of FIG. 19, which is itself implemented at the substrate material level. Every fail-safe transition may produce a final audit entry committed (optionally, per DDIL mode) to the dual-sink anchor 1870 before physical refusal takes effect, ensuring that the refusal event is auditable through the external anchor chain even when the substrate itself becomes non-functional. As shown in FIG. 18, governance events fired at the substrate level may further produce DriftCard™ pay-per-event billing records under the architecture incorporated from the sibling utilities and described in greater detail in connection with FIG. 22.

FIG. 19 is a finite-state diagram of the physical-refusal tamper-response state machine. The machine may occupy a normal-operation state 1910 under invariant conditions; may transition to a tamper-detected state 1920 upon observation of a PUF-response-hash mismatch, a policy-integrity failure, a probe event, or a layer-delamination event; and from the tamper-detected state may transition to one of three graduated refusal tiers—Tier 1 power-gate refusal 1930, Tier 2 clock-stop refusal 1940, or Tier 3 structural-fuse refusal 1950—selected by the governing policy as a function of the severity of the detected tamper. The dashed return arcs in FIG. 19 illustrate the recovery paths available from Tiers 1 and 2 through authorized re-attestation; no recovery path is illustrated from Tier 3, which is permanent and irreversible without physical replacement of the substrate. The state machine may be self-enforcing at the physical-state level: as indicated in FIG. 19, no logging, monitoring, network connectivity, or software trust is required for enforcement, and an adversary observes only cessation of operation, with no diagnostic signal leaking the cause of refusal.

The substrate may operate in the normal-operation state 1910 of FIG. 19 as long as three invariants hold: (i) the PUF response measured at each attestation cycle matches the expected PUF fingerprint committed in the policy pack; (ii) the policy-pack integrity hash verifies under the kernel's signing key; and (iii) the harvest envelope meets the minimum continuous-draw threshold configured in the policy. Departure from any one of these invariants may transition the substrate to the tamper-detected state 1920.

In the tamper-detected state 1920 of FIG. 19, the substrate may have observed a mismatch between the measured PUF response and the expected fingerprint, an integrity violation of the policy pack, a probe event, or attempted layer delamination. The kernel may emit a final audit entry to the dual-sink anchor 1870 of FIG. 18 (if reachable) or to the local queue (in DDIL mode), may classify the tamper severity per the governing policy, and may transition to one of the three refusal tiers 1930, 1940, or 1950.

At Tier 1 power-gate refusal 1930 of FIG. 19, the kernel may invalidate the working keys in the volatile key store. Harvested energy may continue to flow and the compute layer may continue to clock, but the kernel no longer possesses valid keys to decrypt the policy pack and therefore cannot render any inference output. The state may be recoverable through an authorized re-attestation procedure in which a counsel-authorized party re-binds a fresh policy pack to the current PUF response. The recovery path may be shown in FIG. 19 as the dashed arc from 1930 returning to 1910 under the legend “re-attestation (counsel-authorized).”

At Tier 2 clock-stop refusal 1940 of FIG. 19, the kernel may disable the substrate oscillator through a hardware control register that is itself protected by the PUF-bound key. Power may continue to flow but no clock signal may be distributed to the compute fabric, leaving the substrate in a non-computing state. Recovery may require authorized re-attestation plus a clock-restart sequence cryptographically signed by the re-attestation authority, as shown in FIG. 19 as the dashed arc from 1940 under the legend “re-att.+clock restart sig.”

At Tier 3 structural-fuse refusal 1950 of FIG. 19, the kernel may trigger structural fuses in critical interconnection paths of the compute layer 1720 and the unified magneto-optical layer 1730 of FIG. 17, rendering the substrate permanently inoperative. The refusal may be physically irreversible without replacement of the substrate, as indicated in FIG. 19 by the legend “NO RECOVERY.” This tier may be invoked only under policy configurations requiring maximum tamper resistance—for example, classified-environment deployments, forensic-evidence-integrity applications, or deployments carrying high-value cryptographic material whose compromise would cause severe downstream harm.

The tier invoked upon tamper detection may be determined by the governing policy pack and by the severity classification of the detected tamper event. Minor PUF-drift events within the within-device reliability envelope (approximately 5 percent Hamming distance) may trigger Tier 1 power-gate refusal 1930 permitting authorized recovery. Significant drift events or repeated drift events may trigger Tier 2 clock-stop 1940. Structural-level tamper detection—for example, observation of physical probing, unexpected temperature excursion, or attempted layer delamination—may trigger Tier 3 structural-fuse refusal 1950.

FIG. 20 is a schematic of the unified magneto-optical layer 1730 of FIG. 17, showing that three otherwise distinct functions-energy harvesting, non-volatile memory storage, and optical actuation—may be performed simultaneously within a single material volume 2000 of bismuth-substituted rare-earth iron garnet. The unified material volume 2000 may be fed by a Faraday-harvest path 2010 at one input, may support magnetic-domain memory cells 2020 within its bulk, and may emit through a photon-magnon actuation path 2040 at its output. As emphasized in FIG. 20, the same atoms may perform harvest, memory, and actuation. In some embodiments, there may be no interconnection, no synchronization, and no power distribution between three separate components, because there are not three separate components.

Energy harvesting via the Faraday effect 2010 of FIG. 20 may operate as follows. Incident electromagnetic radiation coupled with a bias magnetic field may produce magneto-optically modulated current in integrated electrode structures within the unified material volume 2000. Under typical indoor-office ambient conditions, the Faraday harvest may contribute approximately 650 microwatts per 10 square centimeters of substrate area, exceeding the continuous draw of the governance kernel 1725 of FIG. 17 for typical inference workloads.

Non-volatile memory storage via the magnetic domain states 2020 of FIG. 20 may operate as follows. Binary data may be encoded as opposite magnetization orientations in lithographically defined domain cells within the garnet layer. Magnetic-domain retention may exceed approximately 10 years at ambient temperature. Write operations may use integrated micro-coils or spin-orbit-torque switching structures; read operations may use the magneto-optical Kerr effect or Hall-effect sensing. Because the same material that performs the Faraday harvest 2010 also stores binary data in cells 2020, there may be no separate memory die, no bus, and no power-distribution network between memory and harvest.

Optical actuation via the photon-magnon coupling path 2040 of FIG. 20 may operate as follows. Coherent magnon modes excited by laser or LED sources may couple to surface-acoustic or optical output channels, providing an output-signaling mechanism whose state is controlled by the governance kernel 1725 of FIG. 17 through the same magnetic-domain state that encodes memory in cells 2020. Actuation may be kernel-gated: the actuation path may be enabled only upon a valid render-allow signature from the kernel, verified against the PUF-bound policy pack of FIG. 18. The architectural consequence of the triple-function layer may be that harvest, memory, and actuation are not separate components but three measurements of the same physical substrate; there may be no hardware boundary between power, memory, and output, and the boundary between energy, information, and action may be unified at the atomic level.

FIG. 21 is a block diagram of the distributed cognition mesh comprising a plurality of substrate instances—illustrated in FIG. 21 as nodes 2110, 2112, 2113, 2114, 2116, 2124, 2126, and 2128—connected by inter-substrate signaling paths 2120 that may operate over passive backscatter (FCC Part 15 compliant) and over photon-magnon optical actuation as further described below. A mesh-level governance policy 2130 may be replicated redundantly across the nodes with threshold-cryptographic recovery, such that loss of any minority subset of nodes does not compromise the integrity of the mesh policy or the mesh-level attestation chain. As further illustrated in FIG. 21, a disabled node (shown for example at 2110 in distinguishing color) may not disable the mesh: the remaining nodes may continue to operate under local policy, mesh-level inference may continue under a redistributed partition scheme, and mesh-level workload may be redistributed dynamically along the dashed arc shown in FIG. 21.

The mesh topology of FIG. 21 may admit arbitrary graph configurations including fully connected, partially connected, hierarchical, and hub-and-spoke. Each substrate may carry a copy of the mesh-level policy 2130 that identifies the substrate's role in the mesh and specifies the governance rules for mesh-level inference decomposition.

Inter-substrate signaling along paths 2120 of FIG. 21 may operate through two primary modalities, each selected to preserve the edgeless-operation property. Passive backscatter may modulate ambient RF energy to produce communication without active radio transmission, in compliance with Title 47 C.F.R. Part 15 passive-device rules. Backscatter modulation may be produced by switching the input impedance of an integrated antenna against the ambient RF field, consuming only the harvested energy required to operate the switching element. Optical actuation via the photon-magnon coupling path of the unified magneto-optical layer 1730 may emit modulated optical signals that may be received by proximate substrate instances through their integrated photovoltaic layers 1770 operating in photodetection mode, or by external optical receivers. Both modalities may preserve the zero-external-power property and both may be auditable: each signaling event may produce an audit entry in the originating substrate's hash chain.

When an inference task exceeds the compute capacity of a single substrate, the mesh-level policy 2130 of FIG. 21 may partition the task across substrates per a partitioning scheme cryptographically bound to the task identifier. Each substrate may execute its partition, may produce a partial-result attestation signed under its own PUF-bound key, and may transmit the partial result over the signaling paths 2120 to a designated aggregation substrate. The aggregation substrate may compose the partial results under a cryptographic composition scheme (for example, threshold secret-sharing reconstruction, additive-homomorphic composition, or secure multi-party computation) producing a final result attested by the aggregation substrate's key. No substrate may observe the complete inference input or output; the mesh-level policy may bind the partition scheme such that unauthorized reconstruction is cryptographically prevented.

The architecture of FIG. 21 may exhibit a no-single-point-of-failure property by design, as illustrated by the disabled node in FIG. 21. The remaining substrates may continue to operate under local policy, mesh-level inference may continue under a redistributed partition scheme, and mesh-level attestation may continue because the hash-chain root is replicated across substrates under threshold-cryptographic recovery. The architecture may be structurally analogous to the distributed neural organization of cephalopods, in which approximately two-thirds of neurons reside in the arms rather than the central brain, each arm performs local sensory processing and motor planning autonomously, and inter-arm coordination is loosely synchronized through the central brain but can be maintained via direct arm-to-arm signaling pathways when central coordination is interrupted. The designation “Synthetic Octopus” may be chosen to establish this analogical relationship as a first-class architectural property rather than as incidental branding.

FIG. 22 is a cross-reference diagram showing the integration of SignalDrop™ single-file delivery format 2200 and the sibling HumanMark™ continuous human-authorship score system 2210. The three applications may share a common cryptographic and commercial stack illustrated at the lower portion of FIG. 22 and comprising: a shared cryptographic primitives module 2220, a shared dual-sink audit anchor 2230, the shared DriftCard™ pay-per-governance-event billing architecture 2240, and the shared bidirectional write-and-read licensing architecture 2250.

The Ed25519 signature scheme per RFC 8032, the SHA-3-256 hash function, and canonical CBOR serialization per RFC 8949 § 4.2.1 may be shared across the three applications of FIG. 22 in the cryptographic stack 2220. The present application may incorporate these primitives by reference from the sibling utilities and may extend them to operate on harvested energy at the substrate level. Post-quantum alternatives—including CRYSTALS-Dilithium ML-DSA per FIPS 204, Falcon, and SPHINCS+—may be supported through the hybrid-signing path incorporated from SignalDrop™.

The dual-sink anchor architecture 2230 of FIG. 22 may be shared across the three applications. The present application may implement the anchor in substrate-edgeless mode: when network connectivity is available, the audit-chain root may be committed to two independent registry sinks (selected from Certificate Transparency logs per RFC 6962/9162, sigstore Rekor, public or permissioned blockchains, RFC 3161 timestamp authorities, notarization services, or a functional equivalent thereof); when connectivity is unavailable, the chain may be retained in DDIL local-queue mode with exponential backoff per the architecture incorporated from SignalDrop™.

The DriftCard™ pay-per-governance-event billing architecture 2240 of FIG. 22 may be shared across the three applications. Governance events fired at the substrate level—including tamper-detection events, policy-enforcement events, mesh-level inference events, and attestation-byproduct emission events—may produce billing records per the shared architecture and may be settled per the shared billing-contract mechanism on a prepaid or enterprise-invoice basis.

The bidirectional write-and-read licensing architecture 2250 of FIG. 22 claimed in the sibling HumanMark™ utility may govern issuance and verification of attestation artifacts. The substrate's PUF-bound signing key may be registered under a write license (write=emit attestations), while verification of attestations produced by the substrate may require a separate read license (read=verify attestations), each separately commercialized. The lock-in property established in HumanMark™ may extend to substrate-level attestations.

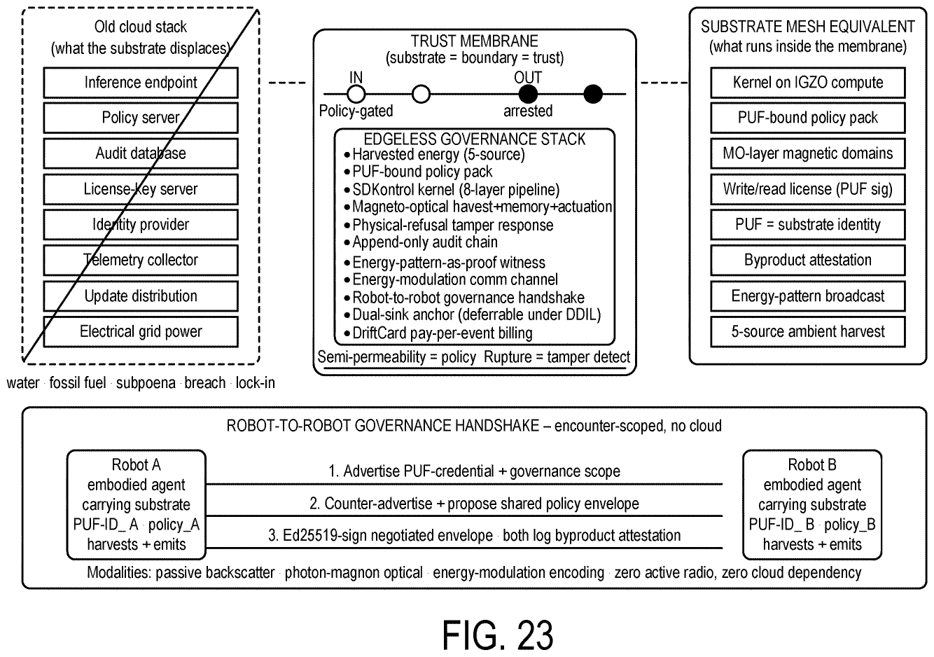

FIG. 23 is a combined architectural diagram illustrating three interrelated properties of the substrate. The center panel of FIG. 23 illustrates the substrate as a semi-permeable trust membrane bounding the edgeless governance stack, with policy-gated ingress and attested egress. The left panel of FIG. 23 illustrates the cloud-displacement mapping by which centralized cloud services—inference endpoint, policy server, audit database, license-key server, identity provider, telemetry collector, update distribution, and electrical-grid power—are crossed out and replaced, on the right panel of FIG. 23, by their substrate-resident equivalents—kernel on IGZO compute, PUF-bound policy pack, magneto-optical-layer magnetic domains, write/read license keyed to the PUF signature, the PUF as substrate identity, byproduct attestation, energy-pattern broadcast, and five-source ambient harvest. The lower panel of FIG. 23 illustrates the robot-to-robot governance handshake by which two embodied agents (Robot A and Robot B), each carrying a substrate, exchange PUF-bound credentials and negotiate an encounter-scoped shared policy envelope without any cloud dependency.

As illustrated in the center panel of FIG. 23, the substrate may be, as a term of architectural art used in the present specification and the appended claims, a trust membrane: a physical, semi-permeable, policy-gated boundary between an external environment and an internal governed volume. The membrane framing may be a description of the operating mode of the substrate as an interface through which data, control signals, and cryptographic assertions pass under policy control, and whose material integrity is itself the warrant for the integrity of the passage. The governance policy pack may define, for each information class, whether artifacts of that class are admitted (ingress permitted), emitted (egress permitted), transformed (translated as they pass), or refused (blocked). Information classes may include: sensor input; peer advertisement packets; policy-pack updates; operator commands; attestation requests; telemetry emission; actuation output; audit-chain commits; and cryptographic challenge-response sequences. The permeability vector may be policy-specific and may vary dynamically as a function of environmental state (including the harvest-envelope state described below in connection with FIG. 18 governance), governance-mode transitions, tamper-response tier, and encounter-scoped envelopes produced by the handshake protocol.

Physical damage to the substrate may alter the PUF response per the PUF primitive 1710 of FIG. 17 and may trigger the physical-refusal tamper response of FIG. 19. Under the membrane framing of FIG. 23, physical damage may be a rupture of the membrane; rupture may be detected by the membrane itself through the PUF-response change; and rupture response may be the physical-refusal tier selected by policy. A ruptured membrane may not be patched by software—it must be physically replaced, which re-binds a fresh policy pack against the fresh PUF response of the replacement substrate. As further illustrated in the center panel of FIG. 23 by the labeled green and red ingress/egress markers, every artifact that passes through the membrane in either direction may produce, as a byproduct of passage, a cryptographic attestation entry bound to the PUF response, the policy-pack hash, and the harvest-envelope state at the moment of passage. The attestation chain of a substrate may therefore be a complete, append-only, tamper-evident log of every ingress and egress event, indistinguishable from a perimeter log of a hardened physical facility, compressed into the material boundary of the substrate itself.

As illustrated in the side-by-side comparison shown in the left and right panels of FIG. 23, the substrate may provide a substrate-resident equivalent for each of eight centralized cloud services that conventional cloud-resident artificial-intelligence operation otherwise depends upon. The mapping may be service-by-service as follows. (a) Inference endpoint→on-substrate kernel: the governance kernel 1725 may execute inference at the compute layer 1720 using harvested energy; the data may never leave the substrate. (b) Policy server→PUF-bound policy pack: policy may be resident on the substrate, cryptographically bound to its PUF per FIG. 18; no network fetch may be required. (c) Audit database→append-only on-substrate hash chain plus deferrable dual-sink anchor 2230: the audit chain may be local, and commitment to an external anchor may be optional and deferrable. (d) License-key server→bidirectional write-and-read license bound to the PUF: licensing may be cryptographically enforced at the substrate per the architecture of FIG. 22; no key-server query may be required. (e) Identity provider→PUF identity plus peer handshake: peer identity may be established through the handshake described below using PUF-bound credentials; no identity-provider query may be required. (f) Telemetry collector→byproduct attestation chain: telemetry may be emitted as attested audit entries rather than to an external collector; entries may be released only under policy-gated egress per the membrane semantics above. (g) Update-distribution server→signed policy-pack rotation with PUF re-binding: policy updates may be delivered as signed packs that bind to the current PUF response; no update-server session may be required. (h) Electrical grid→five-source ambient harvest: power may be harvested per FIG. 17; no grid connection may be required. As further annotated at the lower-left of FIG. 23, the displacement may additionally avoid the water consumption, fossil-fuel consumption, subpoena exposure, breach-surface exposure, and cloud lock-in associated with the displaced services.

As illustrated in the lower panel of FIG. 23, two embodied agents (illustrated as Robot A and Robot B), each carrying a substrate of the type of FIG. 17 with respective PUF-bound identities (PUF-ID_A and PUF-ID_B) and respective resident policy packs (policy_A and policy_B), may execute a multi-step handshake upon physical encounter. In step 1, each substrate may advertise its PUF-credential and a governance-scope descriptor over the inter-substrate signaling channel of FIG. 21. In step 2, each substrate may counter-advertise and propose a shared policy envelope defined as the intersection of the two scopes together with any policy-defined restrictions. In step 3, the two substrates may Ed25519-sign the negotiated envelope, and each may log a byproduct attestation of the signed envelope together with the harvest-envelope state at the moment of signing. The handshake may operate under three modalities annotated at the lower portion of the FIG. 23 lower panel: passive backscatter, photon-magnon optical, and energy-modulation encoding—with zero active-radio emission and zero cloud dependency.

The shared envelope produced by the handshake of FIG. 23 may govern only the current encounter. It may be keyed to both substrate PUF identities and to a handshake nonce; it may expire at a policy-defined end-of-encounter event (physical separation beyond signaling range, expiration of a timer, explicit termination signal, or tamper event in either substrate); and it may not be replayed or reused in a subsequent encounter. Any action taken by either agent under the shared envelope may produce an attestation referencing the envelope commitment, creating an auditable record of the joint-governance basis on which the action was taken.

The two-party handshake described in connection with FIG. 23 may generalize to an n-party protocol in which more than two embodied agents physically encounter one another. Each substrate may advertise and may receive advertisements from every reachable peer; the shared envelope may be the n-way intersection of all scopes; and commitment may be produced either by each substrate signing individually or by a threshold-signature quorum. The quorum variant may exhibit the no-single-point-of-failure property of the mesh of FIG. 21: loss of any single agent during the handshake may not prevent the remaining agents from completing the envelope, provided that a policy-defined threshold of signatures has been collected.

The handshake protocol of FIG. 23 may further admit a human-in-the-loop variant in which one of the n parties to the encounter is a human wearing or carrying a substrate patch (per a wearable-medical embodiment described below or an analogous personal-safety embodiment). The human-borne substrate may participate in the handshake on the same cryptographic basis as the agent-borne substrates, with the human authenticating to the embodied agents through the same PUF-bound mechanism used between agents. The governance envelope produced may carry the human's consent signatures and may bind subsequent agent actions to the scope of that consent. The variant may support applications including robot-assisted surgery (the patient carries a consent patch and the surgical robot honors the resulting envelope), eldercare robotics (patient and caregiver both authenticate to the robot), and industrial collaboration (a worker carries a permit patch and the machine actuates only within the joint envelope).

Independently of the passive-backscatter and photon-magnon optical modalities described in connection with FIG. 21, the same harvester and actuation pathways that produce and consume energy may be additionally instrumented as an active communication carrier. A first substrate may intentionally modulate one or more of its five harvester inputs—by photovoltaic-aperture masking, piezoelectric-element loading, RF-antenna impedance switching, thermoelectric bias reversal, or magneto-optical Faraday polarization dithering—in a temporally coded pattern encoding a symbol sequence. The modulation may be kept within the operating envelope of the governance kernel such that the kernel continues to draw nominal power while the modulation is superimposed. A peer substrate within the modulation cross-section may detect the pattern through its own harvester front-end instrumented as a synchronous demodulator. Energy may be both the fuel and the channel.

In the actuation-modulation outbound encoding, the photon-magnon actuation path of the unified magneto-optical layer (1730 of FIG. 17, 2040 of FIG. 20) may emit coherent optical pulses whose temporal pattern encodes governance-channel data. A peer substrate may receive the pattern through its integrated photovoltaic layer 1770 of FIG. 17 operating in photodetection mode. The channel may be line-of-sight but may require no external emitter and no external power.

The aggregate harvest envelope may itself be a policy-relevant signal: a drop below a configurable threshold may indicate a degraded ambient environment, a tamper attempt (for example, substrate occlusion), or a pending entry into low-power mode. The governance kernel may monitor the harvest envelope continuously and may transition between policy modes as a function of envelope state. Peer substrates in the mesh of FIG. 21 may observe a first substrate's envelope through inter-substrate signaling and may adjust mesh-level workload distribution accordingly. Envelope-state transitions may be logged as attested byproducts and may be admissible as evidence of the physical operating conditions at the time of any inference decision.

Because the energy-modulation communication described above may be superimposed on ambient harvesting rather than produced by a dedicated transmitter, the communication channel may exhibit a low probability of interception by adversaries not equipped with a substrate-type detector: the carrier may be indistinguishable from environmental noise to a generic spectrum analyzer. The property may be relevant to DDIL military operation and to privacy-by-architecture consumer deployments where any active radio emission would constitute an unwanted side channel.

In contrast to the energy-modulated communication channel described above, which uses harvest patterns as an active carrier, the energy-pattern-as-proof primitive may use the passive harvesting pattern—the time series of energy input across the five harvester types of FIG. 17—as an environmental witness. Inclusion of a windowed hash of the harvesting pattern in the attestation input set may provide proof of when and where a governance event occurred without requiring GPS, timestamp servers, blockchain consensus, or dedicated energy expenditure. The harvesting pattern may be unique to the deployment location and moment; reproduction of the pattern at a different location or time may not be practically feasible; inclusion of the pattern hash in signed attestations may therefore bind the attestation to the physical environmental state in which the substrate operated.

In a wearable-medical embodiment, the substrate may be integrated into a flexible patch of approximately 10 square centimeters applied to the skin. The thermoelectric harvester 1760 of FIG. 17 may exploit the body-air thermal gradient; the piezoelectric harvester 1750 may exploit biomechanical motion; and the photovoltaic harvester 1770 may exploit ambient lighting. The governance kernel 1725 may execute a policy pack specific to the clinical application—for example, post-surgical wound monitoring, cardiac-event detection, seizure prediction, or medication-adherence monitoring. The substrate may produce attestation artifacts bound to the PUF and the clinical policy, providing audit-grade evidence of monitoring integrity compliant with 21 C.F.R. Part 11 and EU Annex 11. No cloud connectivity may be required; the substrate may operate entirely on harvested energy from the body.

In a field-military DDIL embodiment, a plurality of substrates may be integrated into a ruggedized mesh deployed across an operational area. Each substrate may harvest solar, thermal, and RF ambient energy. The mesh may operate under local governance policy without cloud connectivity, with inter-substrate signaling via passive backscatter per FIG. 21. The mesh-level inference may support distributed situational awareness, threat classification, and logistic coordination under governance rules specific to the deployment. Audit records may accumulate in DDIL local-queue mode and may commit to the dual-sink anchor 2230 of FIG. 22 opportunistically when connectivity is available.

In a disaster-zone embodiment, substrates may be integrated into portable distributed infrastructure deployed after catastrophic events. The substrates may harvest solar and RF ambient energy (RF availability may be intermittent or absent; the multi-modal harvest envelope of FIG. 17 may provide redundancy). The mesh may provide distributed communication, medical decision support, and resource coordination, with audit artifacts supporting accountability and post-event analysis.

In a rural agricultural embodiment, substrates may be integrated into field-deployed sensor-actuator nodes for crop monitoring, irrigation control, and livestock tracking. Substrates may harvest solar, mechanical-wind, and RF ambient energy. The mesh may operate under governance policies specific to the agricultural domain, producing attestation artifacts supporting organic certification, regulatory compliance, and commodity traceability.

In a maritime or aerospace in-transit embodiment, substrates may be integrated into vessels, aircraft, or cargo containers in environments where grid connectivity is not persistent. Substrates may harvest vibration, thermal-gradient, solar, and RF ambient energy. The mesh may support in-transit monitoring, cargo-integrity attestation, and governance-compliant commerce. Audit artifacts may support regulatory compliance across maritime-law, aviation-safety, and export-control frameworks.

In an industrial embodiment, substrates may be integrated into monitoring systems in offshore platforms, mines, pipelines, power substations, and functionally equivalent industrial environments. Substrates may harvest vibration, thermal, electromagnetic, and optical ambient energy available in the industrial context. The mesh may produce audit-grade attestations of monitoring integrity supporting regulatory compliance, insurance underwriting, and operational analytics.

In a privacy-by-architecture consumer embodiment, the substrate may be integrated into personal devices (wearables, implantables, smart-home sensors, personal-safety devices) where the user requires that inference and attestation not depend on third-party infrastructure. The substrate may operate entirely edgelessly; audit artifacts may be held locally or committed only to user-selected anchors; and the privacy property may be architectural rather than policy-dependent.

A plurality of substrates may be deployed in nested configurations-one substrate physically embedded in a host device that itself carries an outer substrate-producing nested trust membranes in which the outer membrane governs what the inner membrane may receive or emit. The mesh architecture of FIG. 21 may be a federated membrane configuration in which each substrate is a peer membrane and the mesh enforces composite permeability rules across the ensemble. Nested and federated configurations may produce a membrane-algebra permitting precise statement of which party has gating authority over which information class at which boundary—a property of value in multi-party clinical, multi-tenant industrial, and coalition-military deployments.

Deployments that are not fully edgeless—for example, enterprise settings that retain centralized governance oversight but require edgeless operation for a subset of workloads—may configure a substrate as a governance gateway: a substrate that executes edgelessly at the operational edge while forwarding, on a deferrable and policy-gated basis, selected audit entries or telemetry events to a centralized store. The gateway configuration may preserve the substrate's edgeless property for the primary inference workload while retaining interoperability with existing enterprise audit and governance infrastructure.

A deployment may migrate from cloud to substrate incrementally: beginning with a cloud-resident governance kernel committed to dual-sink anchors; then deploying substrate instances that host an increasing share of the inference workload; then transitioning governance policy packs to substrate residency; and finally eliminating the cloud dependency entirely. Each migration step may be reversible if required by operational constraints. The displacement may be quantifiable in terms of cloud cost avoided per inference, grid energy avoided per operational hour, and water avoided per monthly workload, providing a commercial-value proposition independent of the governance and privacy properties.

The displacement described in connection with FIG. 23 and in the migration paragraph above may be structural rather than transitional. It may replace the cloud service layer with a substrate material layer. The record may exist because the material exists; the inference may occur because the material harvests the energy; the governance may be enforced because the material carries the policy; and the identity may be authentic because the material is its own key. The class-of-service substitution may be the architectural end-state, not a transitional configuration.

The governance-kernel component may be implemented as a reference software stack derived from the sibling SignalDrop™. The substrate-specific extensions may include PUF-interface drivers for each enumerable PUF species described in connection with the PUF primitive layer 1710 of FIG. 17; PMIC drivers for aggregate harvest-envelope monitoring at the PMIC 1810 of FIG. 18; magneto-optical-layer drivers for unified harvest-memory-actuation control of the layer 1730 of FIG. 17; and mesh-protocol drivers for passive-backscatter and optical inter-substrate signaling per FIG. 21. The reference stack may be configured to operate on the IGZO TFT compute layer 1720 of FIG. 17 at clock rates sufficient for the eight-layer governance-kernel pipeline.

Tamper-response validation. Upon deliberate insertion of a 10-millimeter-radius bending stress exceeding the substrate's design envelope, the PUF re-measurement may be expected to deviate by more than approximately 5 percent Hamming distance from the policy-bound fingerprint, triggering the Tier 1 power-gate refusal 1930 of FIG. 19. Upon delamination attempt of the encapsulation layer 1780, the PUF deviation may be expected to exceed approximately 20 percent Hamming distance, triggering the Tier 3 structural-fuse refusal 1950 of FIG. 19. These measurements may be expected to be reproducible across fabricated instances to the statistical precision appropriate for a five-unit sample.

Mesh demonstration. A plurality of eight substrate instances may be expected to demonstrate the distributed cognition mesh properties of FIG. 21: successful passive-backscatter signaling at 2.4 gigahertz between pairs within an approximately three-meter cross-section; successful photon-magnon optical signaling between pairs within line-of-sight at approximately one-meter separation; successful partitioning and reconstruction of an inference task exceeding single-substrate capacity; and successful continuation of mesh-level inference upon disablement of any one instance.

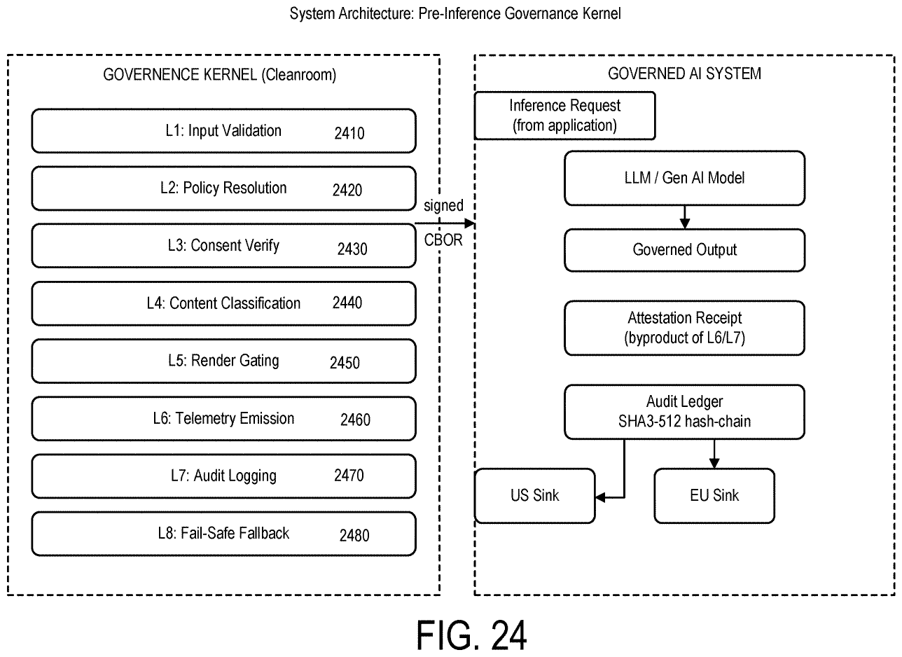

FIG. 24 is a system-architecture diagram depicting the eight-layer pre-inference runtime governance enforcement kernel and the cleanroom architectural isolation boundary between the kernel and the governed artificial-intelligence system. The governance kernel of FIG. 24 may be positioned in the inference-request path between a calling application and a large-language-model or other generative artificial-intelligence model such that no inference request reaches the model without first being evaluated by the kernel. The eight layers of the kernel of FIG. 24 may comprise, in order: an input-validation layer 2410 that parses the inference-request payload according to a canonical schema, enforces required-field presence, timestamp sanity (the request may be required to be not more than approximately thirty seconds old and not future-dated by more than approximately five seconds to allow for clock skew), policy-version match, and parameter-range constraints; a policy-resolution layer 2420 that maps the validated payload to the applicable policy through a cascading hierarchy comprising a global policy, a content-type-specific policy, a delivery-mode-specific policy, a vertical-specific policy (for legal, healthcare, financial-services, defense, aviation, nuclear, pharmaceutical, education, or insurance verticals), and an artifact-specific policy attached to the particular request; a consent-verification layer 2430 that queries a consent registry for each recipient implicated by the request; a content-classification layer 2440 that classifies the validated payload along multiple orthogonal dimensions including content type, regulated-domain match, and risk class per the EU AI Act Article 6 risk taxonomy; a render-gating layer 2450 that produces a deterministic verdict selected from ALLOW, REFUSE, REFUSE_WITH_ALTERNATIVE, and ESCALATE; a telemetry-emission layer 2460; an audit-logging layer 2470 that appends each governance event to a SHA3-512 hash-chained ledger; and a fail-safe-fallback layer 2480 that enforces graduated component-level, pipeline-level, and session-level fallback wherein failures cause the system to close rather than open.

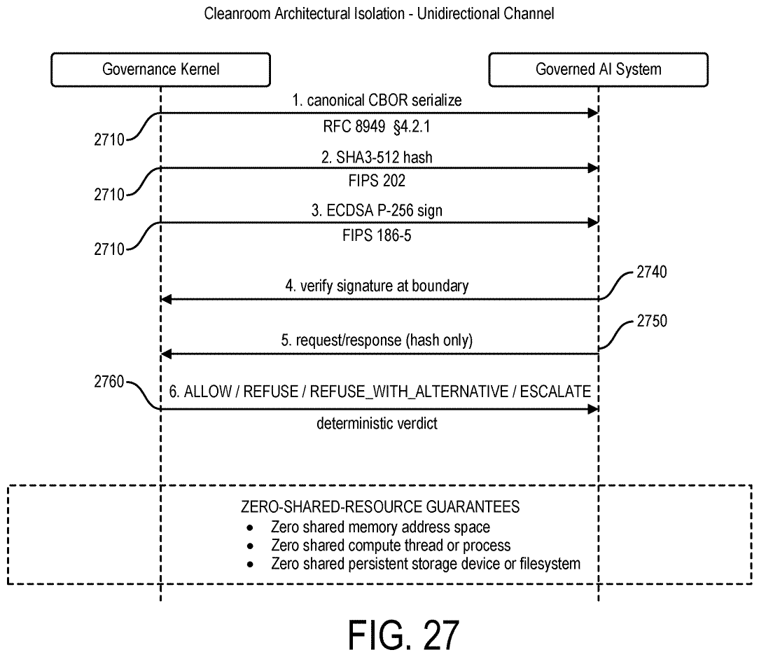

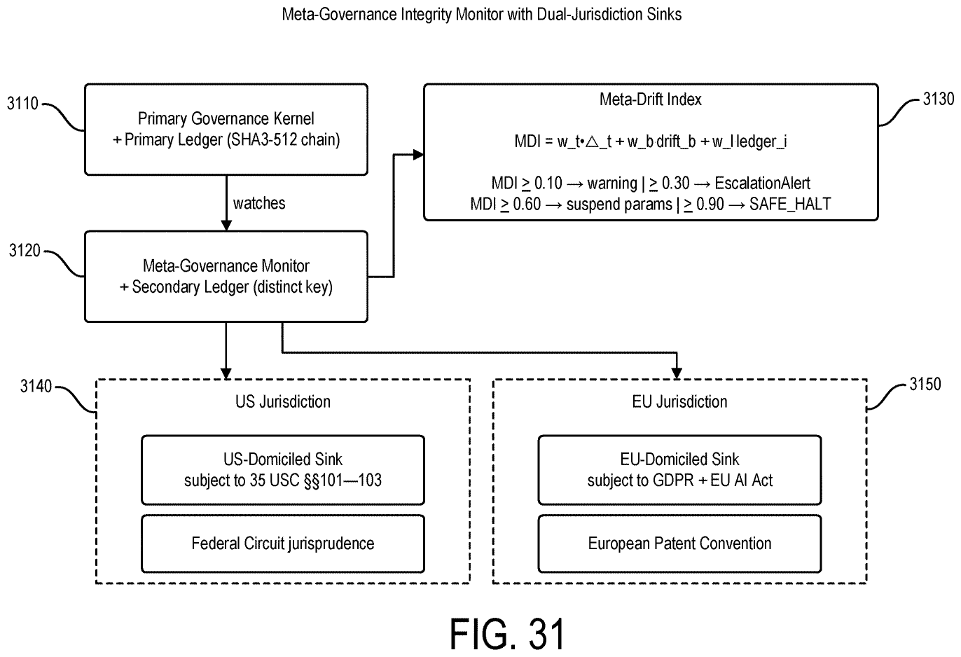

The cleanroom isolation boundary of FIG. 24 is depicted as the dashed-line partition between the governance-kernel sub-system on the left side of the figure and the governed artificial-intelligence sub-system on the right side of the figure. The right-hand side of FIG. 24 may comprise an inference-request input received from a calling application, a large-language-model or generative artificial-intelligence model performing the forward pass, a governed-output stage producing the gated output, an attestation-receipt stage producing the cryptographic byproduct attestation as a computational byproduct of the layer-six telemetry emission and the layer-seven audit logging, and an audit-ledger stage maintaining a SHA3-512 hash chain that is committed to dual independent registry sinks (a United-States-domiciled sink and a European-Union-domiciled sink) consistent with the dual-jurisdiction anchoring described in connection with FIG. 31 below. Inter-environment communication between the kernel and the governed system of FIG. 24 may occur exclusively over the unidirectional message-passing channel illustrated in greater detail in FIG. 27, with each message canonically serialized under canonical CBOR per RFC 8949 § 4.2.1, hashed under SHA-3-256 or SHA3-512 per FIPS 202, and signed under Ed25519 per RFC 8032 or ECDSA P-256 per FIPS 186-5.

The kernel of FIG. 24 may expose a single entry point named govern( ) that accepts an inference-request payload and returns a governance verdict accompanied by a cryptographic byproduct attestation receipt. The verdict is one of four enumerated values-ALLOW, REFUSE, REFUSE_WITH_ALTERNATIVE, or ESCALATE. The attestation receipt may be produced as an inseparable computational byproduct of the governance evaluation itself rather than as a separate logging step, in keeping with the architectural principle that the record exists because the event existed. Conflict resolution within the policy-resolution cascade of layer 2420 may follow the precedence ordering TAMPERED>EXPIRED>UNVERIFIABLE>REFUSE>REFUSE_WITH_ALTERNATIVE>ALLOW, such that the most restrictive applicable rule wins. Any validation failure at layer 2410 may produce an immediate REFUSE verdict with reason VALIDATION FAILED and an identification of the failing field. Any missing, expired, or invalid-signature consent at layer 2430 may produce a REFUSE verdict with reason CONSENT_INVALID. The fail-safe layer 2480 may implement three graduated tiers of fallback: a Tier-1 component-level fault path that applies a most-restrictive policy gating to the failed component while preserving session integrity for non-failed components; a Tier-2 pipeline-level fault path that transfers governance to a minimal pre-validated fallback kernel with hardcoded ALLOW/REFUSE rules; and a Tier-3 session-level fault path that terminates the session, purges all session memory, and renders a refusal output with a diagnostic indicator.

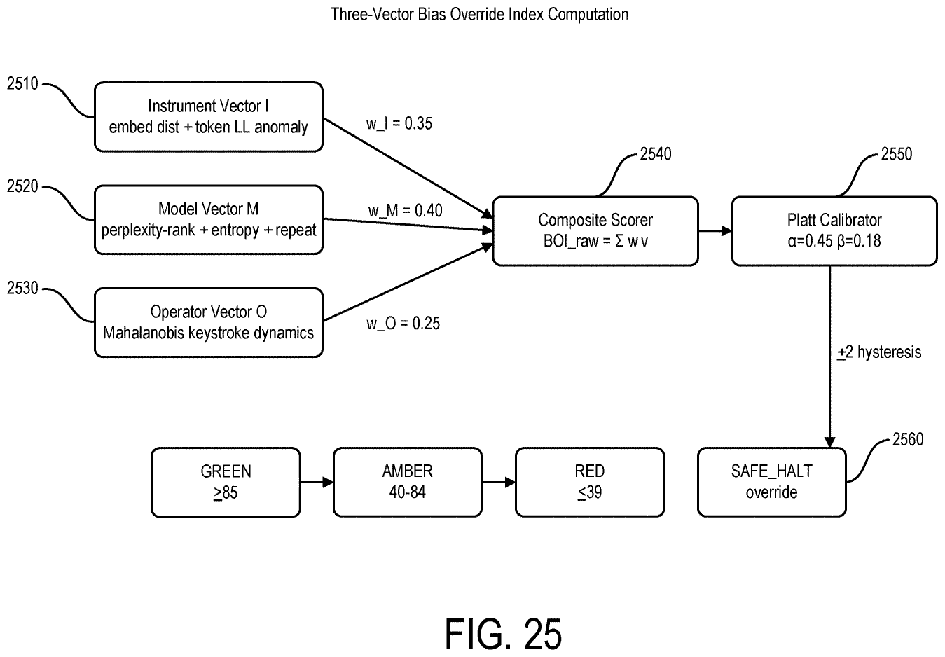

FIG. 25 is a data-flow diagram of the three-vector Bias Override Index™ (BOI) computation, showing three orthogonal measurement-vector inputs feeding a composite scorer 2540 with locked composite weights, a Platt calibrator 2550 with locked calibration parameters, and a four-state enforcement machine output with absorbing SAFE_HALT override 2560. The instrument vector 2510 of FIG. 25 may measure input-signal deviation from a calibrated baseline through embedding-space distance and token-level log-likelihood anomaly analysis, computed as I=clip (norm_embed_dist+norm_token_loglik_anomaly, 0, 1) where norm_embed_dist is the normalized cosine-distance of the input embedding from the calibrated baseline-input centroid in the embedding model's vector space and norm_token_loglik_anomaly is the normalized magnitude of token-level log-likelihood departures from the expected per-position distribution under the calibrated input model. The model vector 2520 may measure inference-output deviation from a training-distribution baseline through a weighted combination of perplexity-rank features, token-transition entropy, and repetition-pattern analysis, computed as M=clip (w_pp·norm_perplexity_rank+w_the·norm_token_transition_entropy+w_rp norm_repetition_pattern, 0, 1) with internal weights w_pp=0.5, w_the=0.3, and w_rp=0.2. The operator vector 2530 may measure human-interaction-pattern deviation from an enrolled behavioral template via Mahalanobis distance over a feature vector comprising dwell time per key, flight time between keys, inter-key interval distribution percentiles (10th, 25th, 50th, 75th, 90th), bigraph timing patterns over the most-frequent fifty bigraphs, trigraph timing patterns over the most-frequent twenty trigraphs, and a biometric-liveness attestation confidence scalar in the closed interval [0, 1] obtained from the device's hardware-rooted biometric subsystem, with the Mahalanobis distance normalized to [0, 1] via the chi-squared cumulative distribution function with degrees of freedom equal to the feature count.

The composite scorer 2540 of FIG. 25 may compute the closed-form weighted-sum BOI_raw=w_I·I+w_M·M+w_O·O using the locked weight set w_I=0.35, w_M=0.40, and w_O=0.25 illustrated alongside the input arrows of FIG. 25. The Platt calibrator 2550 may apply the Platt sigmoid transform BOI_calibrated=1/(1+exp(−(α·BOI_raw+β))) with locked calibration parameters α=0.45 and β=0.18, producing a calibrated probability on the unit interval (0, 1). The calibrated probability may be scaled to the integer interval [0, 100] and resolved into the four-state enforcement machine output of FIG. 25 according to the threshold structure GREEN≥85, AMBER 40-84, and RED≤39, with the SAFE_HALT absorbing override 2560 producing an absolute block requiring human-in-the-loop escalation. A ±2-point hysteresis band may be applied at every quantitative state-transition threshold of FIG. 25 to suppress oscillatory transitions at boundary conditions and to prevent destabilization of recipient-side display logic when the calibrated score oscillates near a threshold. The three vectors of FIG. 25 are engineered to be statistically independent such that an attack defeating one vector cannot simultaneously defeat the other two unless the attacker has compromised the operator's biometric profile and the model's training-distribution baseline simultaneously, a multi-domain compromise of substantially greater difficulty than any single-domain attack.

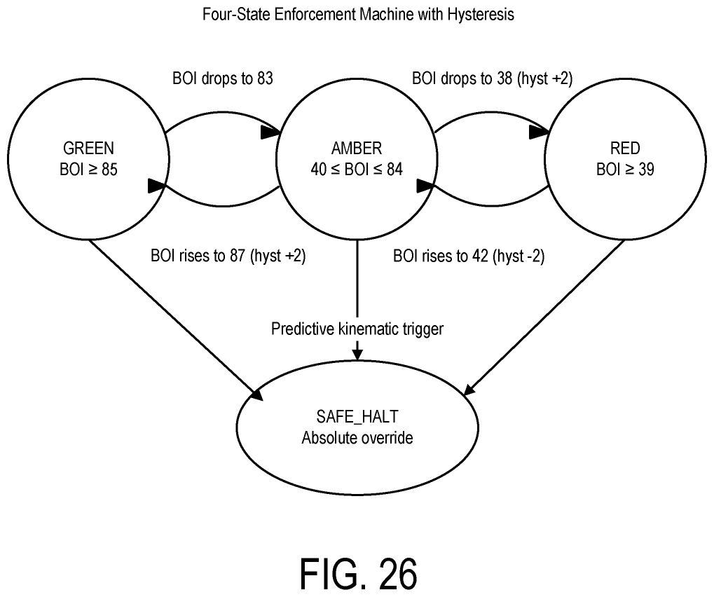

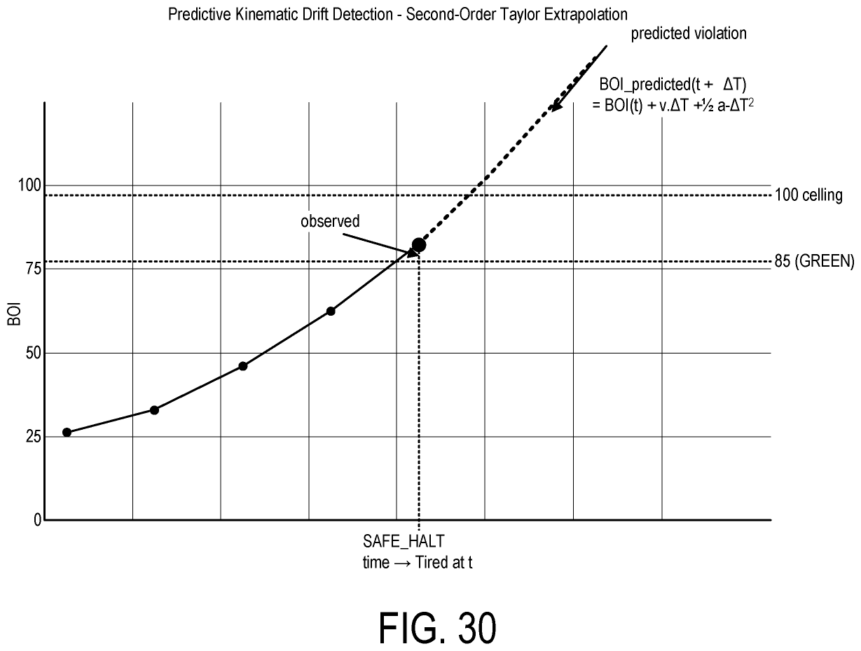

FIG. 26 is a state-transition diagram of the four-state enforcement machine illustrating the GREEN, AMBER, RED, and SAFE_HALT states together with the +2-point hysteresis bands applied at every quantitative state-transition threshold. The GREEN state of FIG. 26 may correspond to BOI≥85 and may permit ALLOW verdicts. The AMBER state may correspond to 40≤BOI≤84 and may permit ALLOW verdicts with logged warning entries. The RED state may correspond to BOI≤39 and may produce REFUSE verdicts pending remediation. The SAFE_HALT state may be entered by absolute override from any of the three quantitative states upon a predictive kinematic drift trigger of the type illustrated in FIG. 30 below or upon a policy-defined emergency condition, and may produce a block requiring human-in-the-loop escalation. The hysteresis structure of FIG. 26 may be encoded as: a transition from GREEN to AMBER may occur when BOI drops to 83 (two points below the GREEN entry threshold); a transition from AMBER to GREEN may require BOI to rise to 87 (two points above the GREEN entry threshold); a transition from AMBER to RED may occur when BOI drops to 38 (two points below the RED entry threshold); and a transition from RED to AMBER may require BOI to rise to 42 (two points above the RED entry threshold, applying the hysteresis on the rising-edge side of the transition). Predictive kinematic triggers from the AMBER state may transition directly to SAFE_HALT, providing a forward-looking absorbing-override path that bypasses the RED state when the second-order Taylor extrapolation of FIG. 30 projects a future threshold violation. The hysteresis-guarded structure of FIG. 26 may suppress chatter at threshold boundaries and may avoid confusing flicker between states under border-case scoring conditions.

FIG. 27 is a sequence diagram of the cleanroom-architectural-isolation message-passing protocol between the governance kernel and the governed artificial-intelligence system, illustrating the unidirectional channel and the enumerated zero-shared-resource guarantees that distinguish the cleanroom architecture from sandboxing, containerization, or virtualization as those terms are conventionally used. The protocol of FIG. 27 may comprise six sequential operations. In step 2710, the governance kernel may serialize a message to be sent to the governed system under canonical Concise Binary Object Representation (CBOR) per RFC 8949 § 4.2.1 with lexicographically sorted map keys. In step 2720, the canonical CBOR encoding may be hashed under SHA3-512 per FIPS 202. In step 2730, the SHA3-512 hash may be signed under ECDSA P-256 per FIPS 186-5 (Ed25519 per RFC 8032 may be substituted as an alternative signature primitive). In step 2740, the governed system may verify the signature at the receiving boundary using the kernel's public key. In step 2750, the governed system may issue a hash-only request or response to the kernel; the substantive content of any request or response is bounded such that the unidirectional integrity of governance flow is preserved. In step 2760, the kernel may emit the deterministic verdict (ALLOW, REFUSE, or ESCALATE) back to the governed system. Any message failing signature verification at step 2740 may cause immediate session termination rather than silent discard, with the failure logged to the audit ledger of layer 2470 of FIG. 24 with reason CHANNEL INTEGRITY VIOLATION.

The zero-shared-resource guarantees illustrated at the lower portion of FIG. 27 may comprise three structural invariants that together define the cleanroom architecture. First, the governance kernel and the governed system may share zero memory address space, such that no shared-memory access path exists between the two environments. Second, the governance kernel and the governed system may share zero compute thread or process, such that no thread or process scheduling dependency or context-switch path exists between the two environments. Third, the governance kernel and the governed system may share zero persistent storage device or filesystem, such that no shared-mount or shared-disk path exists between the two environments. The cleanroom architecture forecloses the specific attack surface demonstrated by post-priority-date research showing that in-process safety libraries (including NeMo Guardrails and certain agent-governance toolkits) can be defeated by monkey-patching library entry points or by declining to import the library at all.

In an operating-system-level embodiment, the governance kernel and the governed system of FIG. 27 may be deployed in distinct Linux process namespaces (PID, mount, network, IPC, user, and UTS namespaces) with no shared mounts and no shared network interfaces other than the unidirectional message-passing channel; the unidirectional channel may be implemented as a Unix-domain socket with SO_PEERCRED-verified peer credentials, with each message bounded in size (default approximately 64 KiB) and rate-limited via a token-bucket rate (default approximately 100 messages per second per channel). In a container-packaged embodiment, the governance kernel may be shipped as a Docker image and the governed artificial-intelligence system may be shipped as a separate Docker image, with an orchestration descriptor defining two services with no shared volumes, no shared network beyond the message-passing channel, and distinct user identifiers and group identifiers.

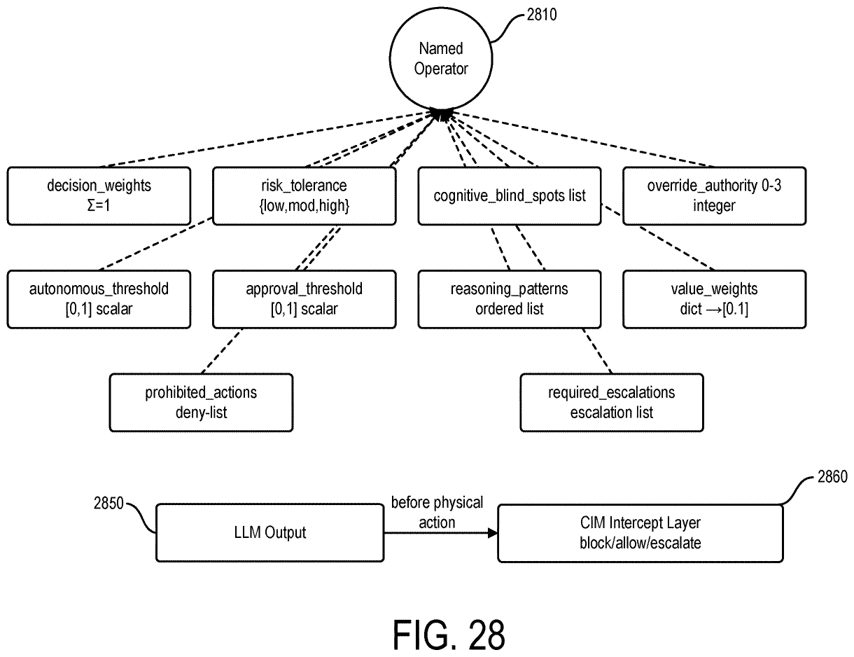

FIG. 28 is a structural diagram of the CognitiveIdentityMap™ (CIM) runtime constraint, showing a named operator 2810 at the top of the figure, ten enumerated CIM fields in the middle of the figure, and a CIM-intercept layer 2860 at the lower portion of the figure positioned downstream of an LLM output 2850 and upstream of any physical action. The CIM of FIG. 28 may encode a named human operator's complete decision architecture as a machine-readable runtime constraint that intercepts artificial-intelligence output before that output becomes physical action. The CIM is not a user profile, not a personalization layer, and not a preference store; those constructs influence what is produced, while the CIM determines what is permitted to leave the governance boundary at all on behalf of a specifically identified human principal. The motivating analogy is delegation in human institutions: the CIM is the machine-readable functional equivalent of a written power of attorney enumerating which actions a subordinate may take autonomously, which require the principal's review, and which are absolutely forbidden regardless of urgency, except that the CIM operates at the latency of inference rather than at the latency of human review and signature.

The ten enumerated CIM fields depicted in FIG. 28 may comprise: a decision_weights field encoded as a dictionary mapping content-type or domain identifiers (for example, “media_outreach”, “investor_communications”, “technical_writing”, “clinical_documentation”, “financial_analysis”) to scalar approval thresholds in the closed interval [0, 1] summing to unity; a risk_tolerance field encoded as a categorical selection from {low, moderate, high} or as a normalized scalar in [0, 1]; a cognitive_blind_spots field encoded as an enumerated list of named domains in which the operator's judgment is known or self-reported to be impaired (for example, “tax_law”, “non_native_language_translation”); an override_authority field encoded as an integer in the inclusive range {0, 1, 2, 3} corresponding to ascending levels of unilateral decision authority; an autonomous_threshold field encoded as a scalar in [0, 1] below which the operator must personally review; an approval_threshold field encoded as a scalar in [0, 1] above which the operator has delegated decision authority; a reasoning_patterns field encoded as an ordered list of decision-pattern identifiers including {pattern_recognition_first, macro_to_nano, contrarian_stress_test, first_principles_when_stuck}; a value_weights field encoded as a dictionary mapping value dimensions (for example, speed, quality, relationship_preservation, ip_protection) to normalized priorities in [0, 1]; a prohibited_actions field encoded as an enumerated deny-list (for example, {public_disclosure_unfiled_ip, financial commitment_above_10000_usd, hiring_decisions, medical_diagnosis}); and a required_escalations field encoded as an enumerated list of action classes triggering mandatory human review (for example, {media_outreach, legal matters, strategic partnerships, investor_communications, anticoagulation_dosage_changes}).

The CIM-intercept layer 2860 of FIG. 28 may operate downstream of the LLM output 2850 and upstream of any physical action, evaluating each proposed output against the prohibited_actions and required_escalations fields and producing a verdict selected from {block, allow, escalate}. In some embodiments, a CIM may be initially calibrated through observation of the operator's responses to a structured elicitation protocol comprising at least approximately one hundred simulated decision scenarios drawn from the operator's claimed expertise domains, with elicited responses used to estimate the decision_weights, value_weights, and reasoning_patterns parameters via maximum-likelihood estimation under a Dirichlet prior. The encoded CIM may be encrypted against the operator's registered cryptographic identity (an Ed25519 or ECDSA P-256 keypair held in a hardware-rooted Trusted Platform Module or Secure Enclave on the operator's registered device) and installed into the runtime governance kernel of FIG. 24 as an intercept layer interposed between the layer-five render-gating decision and any downstream actuation. Any large-language-model output from a system installed with a CIM that proposes any prohibited_action class may be intercepted before the proposed output becomes physical action; any large-language-model output that proposes an action matching a required_escalation entry may be routed to the human-in-the-loop escalation path of layer 2480 of FIG. 24 and held pending the principal's decision.

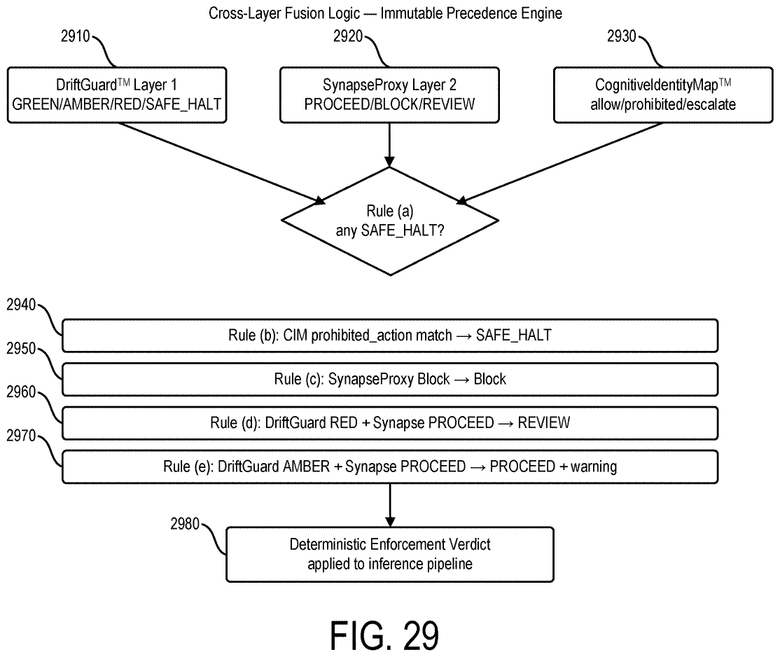

FIG. 29 is a flowchart of the cross-layer fusion logic implementing an immutable precedence engine that combines heterogeneous governance signals from a drift-detection layer (DriftGuard™ Layer 1, shown at 2910 of FIG. 29 and emitting one of {GREEN, AMBER, RED, SAFE_HALT}), a consent-and-proxy layer (SynapseProxy Layer 2, shown at 2920 of FIG. 29 and emitting one of {PROCEED, BLOCK, REVIEW}), and a CognitiveIdentityMap™ evaluation layer (shown at 2930 of FIG. 29 and emitting one of {allow, prohibited, escalate}) into a single deterministic enforcement verdict 2980. The fusion logic of FIG. 29 may be fully enumerated and deterministic; there may be no learned or probabilistic reconciliation between layers. The motivation for deterministic rather than probabilistic fusion is that probabilistic fusion creates a covert attack surface in which an adversary who can influence the inputs to the probabilistic combiner can produce arbitrary outputs, undermining the governance guarantee. Deterministic fusion under an immutable precedence rule set may be auditable, reproducible, and resistant to adversarial input shaping.

The precedence rules of FIG. 29 may be applied in the following ordinal order. Rule (a), shown at the top decision diamond of FIG. 29, may state that a SAFE_HALT signal emitted from any of layers 2910, 2920, or 2930 produces an immediate BLOCK regardless of all other layer signals. Rule (b), shown at 2940 of FIG. 29, may state that a CognitiveIdentityMap™ prohibited_action match produces SAFE_HALT regardless of all other layer signals (and is therefore handled by Rule (a) once it produces SAFE_HALT). Rule (c), shown at 2950 of FIG. 29, may state that a SynapseProxy emission of BLOCK produces BLOCK regardless of any other layer signal except the SAFE_HALT precedence of Rule (a). Rule (d), shown at 2960 of FIG. 29, may state that a DriftGuard™ RED signal combined with a SynapseProxy PROCEED signal produces REVIEW (escalation for human review rather than automatic block or allow), recognizing that drift detection without consent-state corroboration may indicate a recoverable transient. Rule (e), shown at 2970 of FIG. 29, may state that a DriftGuard™ AMBER signal combined with a SynapseProxy PROCEED signal produces PROCEED with a logged warning entry to the audit ledger. The fused verdict 2980 is then output as the deterministic governance decision and is applied to the inference pipeline of FIG. 24.

FIG. 30 is a time-series diagram of the predictive kinematic drift-detection subsystem, illustrating an observed BOI(t) trajectory plotted as filled circles along a time axis, a second-order Taylor extrapolation BOI_predicted(t+ΔT)=BOI(t)+v(t)·ΔT+½ a(t)·ΔT² depicted as a dashed projection arrow extending forward in time, a horizontal threshold line at the GREEN-state entry threshold of 85, a horizontal ceiling line at the integer-100 BOI scale ceiling, and a SAFE_HALT-fired-at-t marker depicted at the time at which the proactive override is triggered. The kinematic analogy of FIG. 30 may treat BOI(t) as a position variable, v(t)=d(BOI)/dt as velocity, and a(t)=d²(BOI)/dt² as acceleration. When the projected value BOI_predicted (t+ΔT) exceeds a policy-configurable drift threshold, the system may trigger a proactive SAFE_HALT before the observed threshold crossing occurs, providing a forecast-based intervention window during which the inference is halted, the operator is notified, and remediation is offered before the actual violation would have occurred.

The BOI time series depicted in FIG. 30 may be sampled at a configurable interval (default approximately 100 milliseconds). The first time derivative v(t) may be computed by central difference over a sliding window of approximately three to nine samples, with the sliding-window length adapted based on the variance of the BOI signal: shorter windows during high-variance periods and longer windows during low-variance periods. The second time derivative a(t) may be computed by central difference of the velocity series. The forecast horizon ΔT may be dynamically selected from the closed interval [50 milliseconds, 5000 milliseconds] based on the standard deviation of BOI over the recent observation window. The policy-configurable drift threshold may itself be dynamically adjusted by the operator's CIM risk tolerance scalar (FIG. 28): risk-tolerant operators may have a higher threshold (later intervention) and risk-averse operators may have a lower threshold (earlier intervention), with the threshold bounded below by a regulatory floor (typically approximately 70 in the integer 0-100 BOI scale) and above by a regulatory ceiling (typically approximately 90). The kinematic projection may be logged to the audit ledger of layer 2470 of FIG. 24 with both observed and predicted values, enabling post-hoc validation of the prediction accuracy. The kinematic analogy is novel in the artificial-intelligence governance context as of the priority date; no published prior art applies classical-mechanics kinematic equations to artificial-intelligence drift forecasting.

FIG. 31 is an architecture diagram of the Meta-Governance Integrity Monitor with dual-jurisdiction sinks, illustrating a primary governance kernel 3110 maintaining a primary SHA3-512 hash-chained ledger, a meta-governance monitor 3120 maintaining a cryptographically independent secondary ledger keyed under a distinct keypair from the primary ledger, a Meta-Drift Index (MDI) computation block 3130, a United-States-jurisdiction sink dashed-boundary 3140, and a European-Union-jurisdiction sink dashed-boundary 3150. The operative principle of FIG. 31 is that a governance kernel is itself code, and code is subject to compromise, configuration drift, key rotation, and adversarial modification; a governance system that does not monitor itself cannot detect its own compromise. The Meta-Governance Integrity Monitor 3120 may solve this through the secondary SHA-3-hash-chained forensic ledger that watches the primary kernel 3110 and that is cryptographically independent of the primary ledger (distinct keypair, distinct hash chain).

The Meta-Drift Index 3130 of FIG. 31 may be computed as MDI=w_t·Δ_t+w_b.drift_b+w_1·ledger_i, where threshold_delta Δ_t is the normalized magnitude of any change to BOI thresholds, hysteresis bands, or Platt parameters since the last MDI sample, drift_b is the normalized magnitude of any change to the calibrated baselines used by the instrument, model, or operator vector computation modules of FIG. 25, and ledger_i is a binary indicator of whether the primary ledger's most recent root hash matches the secondary ledger's record of that root hash, with a mismatch yielding ledger_i=1 and a match yielding ledger_i=0. The MDI thresholds depicted in FIG. 31 may comprise: MDI≥0.10 logs a warning entry to the meta-ledger; MIDI≥0.30 fires an EscalationAlert to the registered principal; MDI≥0.60 suspends all governance-parameter modifications pending principal approval; and MDI≥0.90 triggers SAFE_HALT with reason governance_integrity_violation.

The dual-jurisdiction sinks 3140 and 3150 of FIG. 31 may comprise at least one United-States-domiciled sink subject to 35 U.S.C. §§ 101-103 and Federal Circuit jurisprudence, and at least one European-Union-domiciled sink subject to GDPR, the EU Artificial-Intelligence Act, and the European Patent Convention. “Independent” in the context of FIG. 31 may mean: distinct administrative control (no single entity controls both sinks); distinct technical infrastructure (no shared hardware, no shared cloud provider, and no shared geographic data center); and distinct legal jurisdiction. The dual-jurisdiction commitment of FIG. 31 may ensure that a single subpoena, a single court order, or a single national-security letter cannot extract the secondary ledger without involving the second jurisdiction's legal process, providing a structural defense against single-jurisdiction compulsion that supplements the cryptographic tamper-evidence of the hash-chain structure.

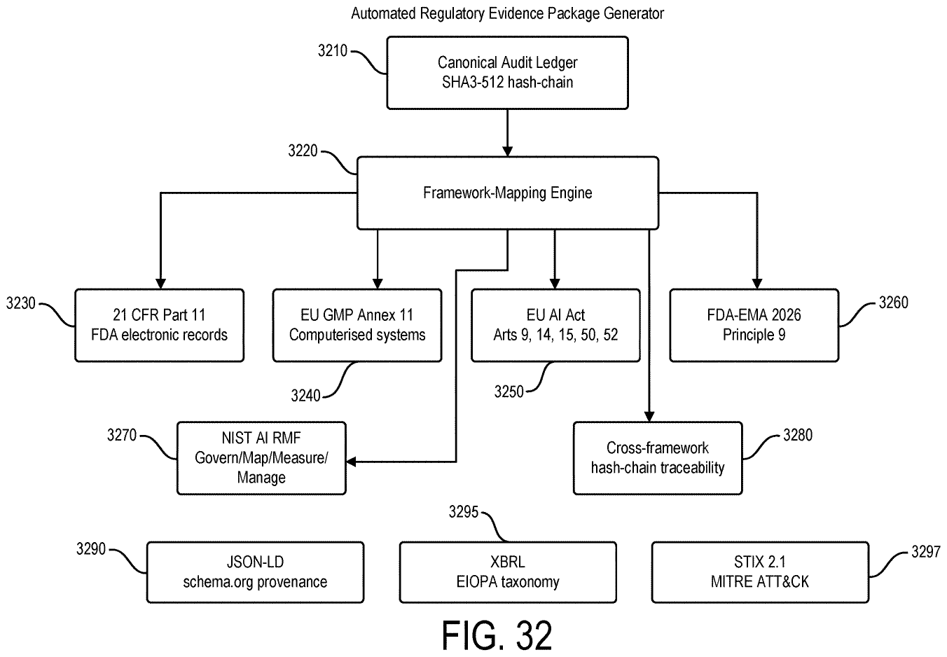

FIG. 32 (in addition to depicting the generic computing system 3200 described elsewhere in this specification) is a structural diagram of the Automated Regulatory Evidence Package Generator, showing a canonical audit ledger source 3210 maintaining a SHA3-512 hash-chained record of all governance events, a framework-mapping engine 3220 transforming the canonical ledger into framework-specific evidence packages, and a plurality of regulatory-framework target outputs comprising 21 C.F.R. Part 11 (FDA electronic records) at 3230, EU GMP Annex 11 (Computerised Systems) at 3240, EU AI Act Articles 9, 14, 15, 50, and 52 at 3250, FDA-EMA Joint Principles 2026 Principle 9 at 3260, NIST AI RMF (Govern, Map, Measure, Manage functions) at 3270, and a cross-framework hash-chain-traceability output at 3280. The lower portion of FIG. 32 may further depict three machine-readable serialization formats: JSON-LD with schema.org provenance markup at 3290, XBRL with EIOPA taxonomy at 3295, and STIX 2.1 with MITRE ATT&CK correlation at 3297. The motivating problem addressed by the architecture of FIG. 32 is that a regulated artificial-intelligence deployment may simultaneously be subject to multiple non-aligned regulatory frameworks; manually constructing distinct evidence packages for each framework is labor-intensive, error-prone, and frequently inconsistent across packages. The architecture of FIG. 32 may emit all packages from the same canonical ledger source 3210, with cross-framework traceability preserved through hash-chain references at 3280, ensuring consistency across submissions.

Each evidence package emitted by the framework-mapping engine 3220 of FIG. 32 may comprise, at minimum: a package_id field encoded as a UUIDv4 identifier; a framework field encoded as a canonical regulatory-framework identifier; a generated_at field encoded as an RFC 3339 timestamp; a principal_id field encoded as the registered identity of the requesting party; a deployment_period field encoded as the time window covered by the package; a total_decisions field encoded as the count of governance decisions during the deployment_period; a safe_halt_events field encoded as the count of SAFE_HALT events; a drift_events field encoded as the count of drift threshold crossings; a chain_integrity_proof field encoded as a Merkle proof linking the package contents to the primary-ledger root hash; an executive_summary field encoded as a human-readable narrative summary; a technical_appendix field encoded as a machine-readable detailed appendix; a regulatory_attestation field encoded as a structured attestation matching the framework's controls; and a package_hash field encoded as a SHA3-512 hash of the canonical-CBOR-serialized package contents. The 21 C.F.R. Part 11 package at 3230 may be output as JSON-LD with schema.org provenance markup, mapping each ledger entry to the Part 11 controls of §§ 11.10(a) through 11.10(k) with each control assertion accompanied by a cryptographic-evidence pointer to the supporting ledger entry. The EU AI Act Article 9 package at 3250 may be output as XBRL with EIOPA taxonomy mappings, encoding the risk-management-system documentation required by Article 9(2) through 9(9). The NIST AI RMF cybersecurity package at 3270 may be output as STIX 2.1 with MITRE ATT&CK correlation, encoding observed security events and applied mitigations. Each emitted package may itself be committed to the audit ledger of FIG. 24 with a meta-attestation receipt that the package was generated, who requested generation, and which framework version was applied at generation time, providing tamper-evident provenance for each compliance submission.

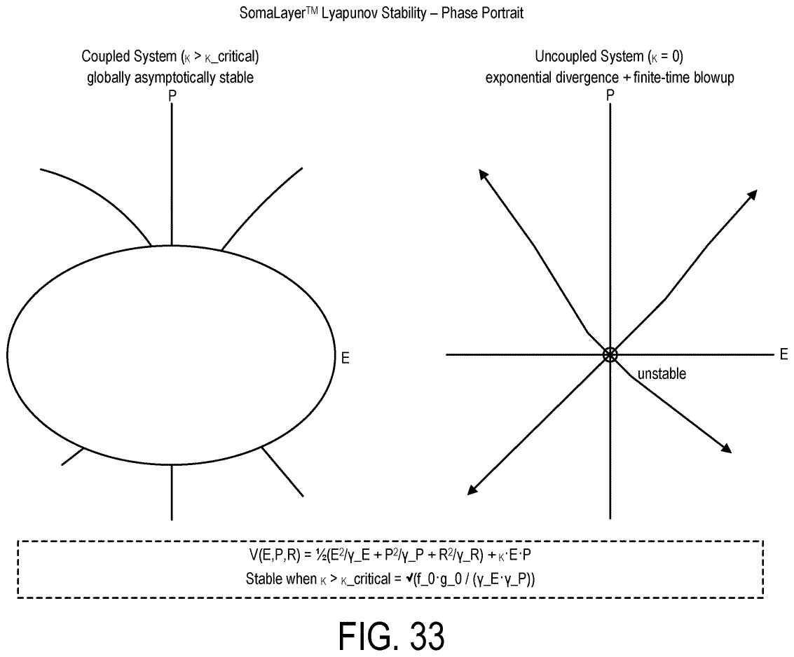

FIG. 33 is a phase-portrait diagram of the SomaLayer™ Lyapunov-stability proof for the personality-drift co-dependency engine, showing on the left side of the figure a coupled system with coupling parameter κ greater than a critical value κ_critical, exhibiting trajectories that converge to a closed equilibrium orbit (globally asymptotically stable), and showing on the right side of the figure an uncoupled system with κ equal to zero, exhibiting trajectories diverging exponentially from the origin (exponential divergence and finite-time blowup). The lower portion of FIG. 33 displays the Lyapunov candidate function V(E, P, R)=½·(E²/γ_E+P²/γ_P+R²/γ_R)+κ·E·P, where E represents emotional-state deviation, P represents personality-parameter deviation, R represents reasoning-pattern deviation, and γ_E, γ_P, and γ_R are positive-definite scaling constants. The system depicted in FIG. 33 may be globally asymptotically stable when κ>κ_critical=√(f_0·g_0/(γ_E·γ_P)). The phase-portrait of FIG. 33 may serve as the technical justification for the architectural requirement of personality-drift co-dependency rather than independent personality and drift management: without coupling, the system exhibits exponential instability; with coupling above the critical threshold, the system is provably stable.

The motivating principle of the SomaLayer™ engine of FIG. 33 may be that high-cognitive-load operators are at elevated risk of being inappropriately influenced by personality-driven artificial-intelligence behavior, and the appropriate governance response may be to tighten the artificial-intelligence's permitted personality range as the operator's cognitive load rises. The co-dependency may be mathematically encoded as an exponential-decay coupling such that increasing personality-entropy index (PEI, representing operator cognitive load) causes a drift-ceiling index (DCI_max, representing permitted personality variability) to decrease asymptotically toward a regulatory-mandated non-zero floor. The time derivative dV/dt evaluated along the system trajectory may simplify to a sum of dominant terms -(E²+P²+R²) plus bounded-magnitude cross terms; for κ>κ_critical the dominant terms may ensure dV/dt<0 and the system is globally asymptotically stable. The architecture of FIG. 33 may further support age-adaptive governance enforcing graduated session caps and PEI ceilings as a function of verified operator age tier, including approximately 15-minute sessions and PEI ceiling of approximately 0.20 for under-13 operators with mandatory parental notification, approximately 30-minute sessions and PEI ceiling of approximately 0.50 for 13-15 operators (with an approximately 2× multiplier for verified educational context), approximately 60-minute sessions and PEI ceiling of approximately 0.75 for 16-17 operators with self-monitoring tools, and approximately 120-minute default sessions (configurable in the range approximately 60-180 minutes) with PEI ceiling of approximately 0.95 for adult operators.

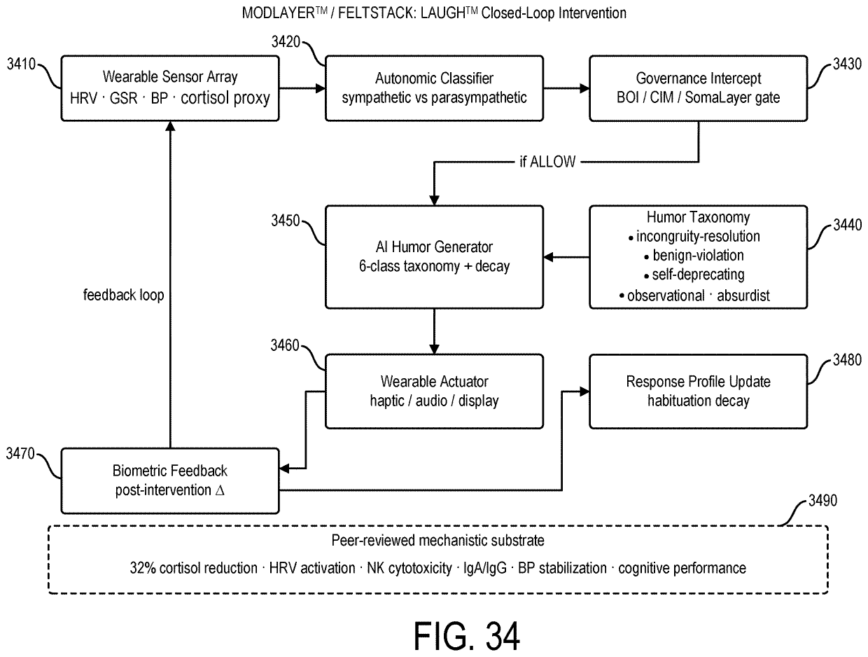

FIG. 34 is a closed-loop block diagram of the MODLAYER™/FELTSTACK: LAUGH™ structured-humor parasympathetic-override system, illustrating a wearable sensor array 3410 measuring heart-rate variability (HRV), galvanic skin response (GSR), blood pressure, and a cortisol-proxy metric, an autonomic classifier 3420 distinguishing sympathetic-dominant from parasympathetic-dominant operator state, a governance-intercept block 3430 implementing the BOI/CIM/SomaLayer™ gating, a humor taxonomy 3440 enumerating six humor classes, an artificial-intelligence humor generator 3450 selecting humor under the six-class taxonomy with temporal-decay habituation prevention, a wearable actuator 3460 delivering humor through haptic, audio, or display modalities, a biometric-feedback block 3470 measuring post-intervention biometric delta, and a response-profile-update block 3480 adjusting future humor selection based on the measured response. The lower portion of FIG. 34 may further depict a peer-reviewed mechanistic-substrate dashed-boundary 3490 enumerating the established physiological mechanisms underlying the intervention.

The mechanism of action of the system of FIG. 34 may be that laughter activates the parasympathetic nervous system through vagal afferents, producing measurable cortisol reduction, heart-rate-variability activation, natural-killer-cell cytotoxicity increase, immunoglobulin elevation, blood-pressure reduction, gastrointestinal symptom relief, and cognitive-performance improvement. The peer-reviewed mechanistic substrate 3490 of FIG. 34 may comprise approximately 32% average cortisol reduction in laughter groups versus controls (with up to approximately 37% cortisol reduction reported in single-session studies and approximately 39% cortisol reduction combined with approximately 70% adrenaline reduction reported in anticipatory-laughter studies), significant high-frequency HRV activation following post-stress laughter, increases in natural-killer-cell cytotoxicity at 12 hours post-comedy-exposure correlating with laughter intensity, transient IgA and IgG elevation following laughter, blood-pressure stabilization in longitudinal follow-up, gastrointestinal symptom relief associated with laughter yoga, and improved focus and vigilance cognitive-test scores following short comedic exposure. The cortisol-proxy metric measured at 3410 may be derived from a combination of skin-temperature variation, electrodermal-response amplitude, HRV low-frequency-to-high-frequency ratio, and an optional saliva-cortisol point-of-care immunoassay reading.

The six-class humor taxonomy 3440 of FIG. 34 may comprise: incongruity-resolution humor; benign-violation humor; self-deprecating social-comparison humor; narrative setup-punchline humor; observational pattern-recognition humor; and absurdist non-sequitur humor. Selection at the artificial-intelligence humor generator 3450 may be governed by the operator's CIM value_weights field of FIG. 28 and by the operator's historical response profile maintained at 3480, with habituation prevented through temporal-decay factors that reduce the probability of selecting recently-used humor classes. Delivery via the wearable actuator 3460 may be suppressed when the BOI is RED or SAFE_HALT (per FIG. 26), when the CIM lists humor as a prohibited_action (per FIG. 28), or when the autonomic classifier 3420 indicates that the operator is already in a parasympathetic-dominant state (intervention is unnecessary in such case). The closed loop of FIG. 34 may proceed through the sequence wearable sensor 3410→autonomic classifier 3420→governance intercept 3430→ (if ALLOW) humor generator 3450→wearable actuator 3460→biometric feedback 3470→response-profile update 3480, with the response-profile update feeding forward into subsequent humor-class selection at 3450.

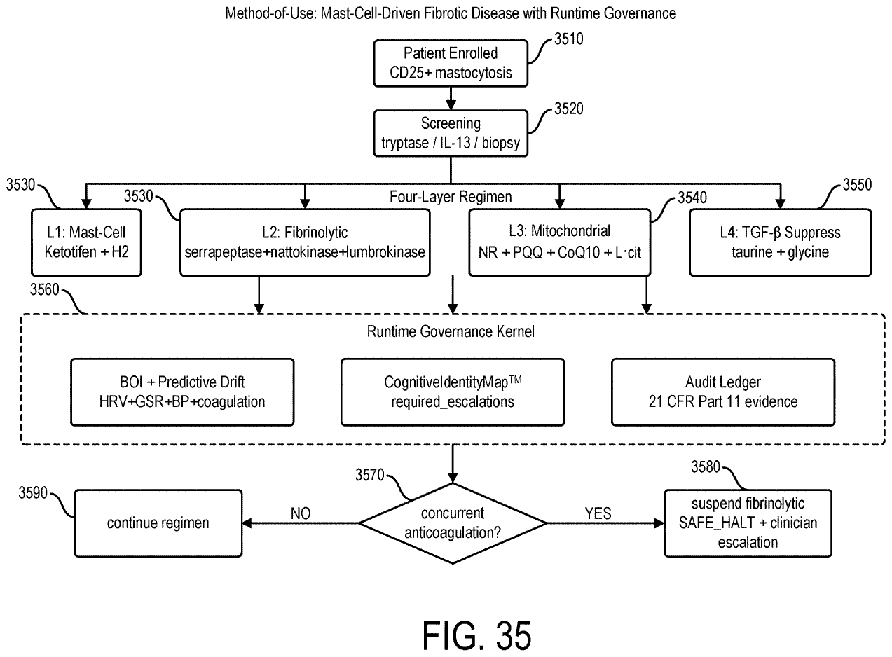

FIG. 35 is a treatment-protocol flowchart for the method-of-use claim directed to mast-cell-driven fibrotic disease with runtime governance, illustrating a patient-enrolled stage 3510 (with patient phenotype CD25-positive cutaneous mastocytosis), a screening stage 3520 (encompassing tryptase, interleukin-13, and biopsy assessment), a four-layer combination regimen 3530-3550 (comprising a mast-cell-stabilization layer L1, a fibrinolytic-enzyme-therapy layer L2, a mitochondrial-restoration layer L3, and a transforming-growth-factor-beta suppression layer L4), a runtime-governance-kernel boundary 3560 (encompassing BOI-plus-predictive-drift gating, CognitiveIdentityMap™-based required_escalations enforcement, and 21 C.F.R. Part 11-compliant audit-ledger evidence generation), a concurrent-anticoagulation contraindication decision diamond 3570, a fibrinolytic-suspension and clinician-escalation branch 3580 (entered on YES at 3570), and a continue-regimen branch 3590 (entered on NO at 3570).

The four-layer combination regimen of FIG. 35 may comprise: at layer L1 (3530, mast-cell stabilization) administration of an H1-receptor antagonist selected from ketotifen fumarate, loratadine, cetirizine, fexofenadine, and desloratadine combined with an H2-receptor antagonist selected from famotidine, ranitidine, and nizatidine; at layer L2 (fibrinolytic enzyme therapy) oral administration of a proteolytic enzyme combination selected from serrapeptase, nattokinase, lumbrokinase, and combinations thereof; at layer L3 (mitochondrial restoration) administration of nicotinamide riboside, pyrroloquinoline quinone, coenzyme Q10, and L-citrulline; and at layer L4 (3550, TGF-β suppression) administration of taurine and glycine. The runtime governance kernel 3560 of FIG. 35 may govern dosing, titration, treatment-phase transitions, and contraindication detection in real time through biometric gating (heart-rate variability, galvanic skin response, blood pressure, cortisol proxy, coagulation-parameter telemetry, and D-dimer or equivalent fibrinolysis marker) and through a CognitiveIdentityMap™-bound clinician-override chain (per FIG. 28).

The concurrent-anticoagulation contraindication decision diamond 3570 of FIG. 35 may detect concurrent anticoagulation therapy with apixaban, rivaroxaban, warfarin, or an equivalent anticoagulant that contraindicates simultaneous fibrinolytic enzyme administration. On a YES branch, the protocol of FIG. 35 may suspend layer L2 fibrinolytic therapy and trigger SAFE_HALT plus clinician escalation at 3580; on a NO branch, the protocol may continue the four-layer regimen at 3590. Conditions within the scope of the method of FIG. 35 may include: Dupuytren's contracture; Peyronie's disease; frozen shoulder (adhesive capsulitis); lateral epicondylitis (tennis elbow); fascial adhesions; post-surgical fibrosis; keloid and hypertrophic scarring; endometriosis (fibrotic component); long-COVID fibrotic complications; pulmonary fibrosis (adjunctive); and liver fibrosis (adjunctive). The integrated implementation depicted in FIG. 35 may comprise: the BOI computation module of FIG. 25 ingesting biometric and coagulation telemetry; the CIM of FIG. 28 encoding the patient's decision architecture including a required_escalations entry for any anticoagulation-dosage change; the cross-layer fusion of FIG. 29 ensuring that any concurrent-anticoagulant flag combined with a proposed fibrinolytic-enzyme dosage produces SAFE_HALT regardless of any other layer signal; the predictive kinematic drift detection of FIG. 30 forecasting bleeding-risk-marker trajectories; and the audit-ledger and regulatory-evidence-package generation of FIG. 32 producing 21 C.F.R. Part 11-compliant evidence for each dosage event. The unified architecture of FIG. 35 may enable a treating clinician to safely manage the combination therapy in patients with concurrent anticoagulation through real-time monitoring rather than blanket exclusion.

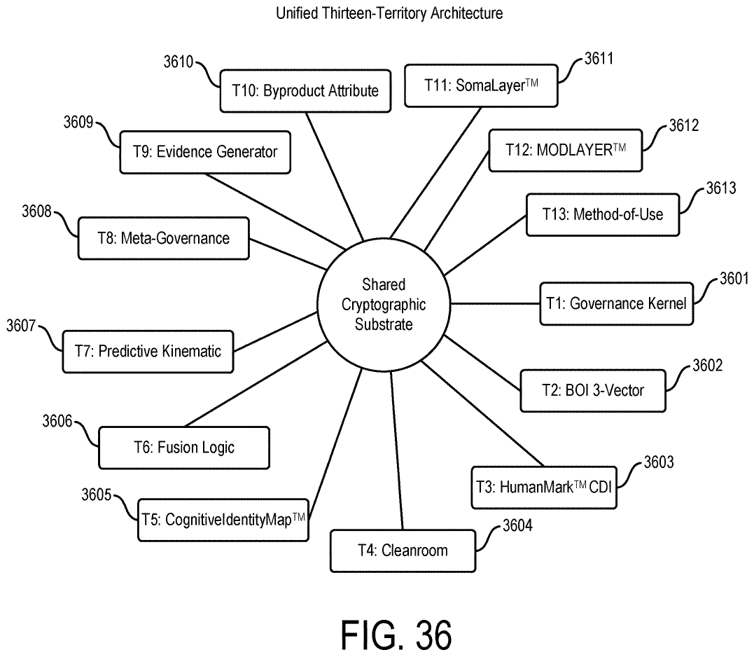

FIG. 36 is a unified-architecture overview diagram showing thirteen claim territories integrated within a single governance stack with a shared cryptographic substrate at the center of the figure, illustrating each territory as a labeled node radially connected to the shared substrate. The thirteen territories of FIG. 36 may comprise: Territory T1 (3601), the pre-inference runtime governance kernel of FIG. 24; Territory T2 (3602), the three-vector Bias Override Index™ of FIG. 25; Territory T3 (3603), the HumanMark™-integrated Cognitive Drift Index; Territory T4 (3604), the cleanroom architectural isolation of FIG. 27; Territory T5 (3605), the CognitiveIdentityMap™ runtime constraint of FIG. 28; Territory T6 (3606), the cross-layer fusion logic of FIG. 29; Territory T7 (3607), the predictive kinematic drift detection of FIG. 30; Territory T8 (3608), the Meta-Governance Integrity Monitor of FIG. 31; Territory T9 (3609), the Automated Regulatory Evidence Package Generator of FIG. 32; Territory T10 (3610), the governance-receipt-as-computational-byproduct attestation primitive; Territory T11 (3611), the SomaLayer™ personality-drift co-dependency engine of FIG. 33; Territory T12 (3612), the MODLAYER™/FELTSTACK: LAUGH™ structured-humor parasympathetic-override system of FIG. 34; and Territory T13 (3613), the method-of-use for mast-cell-driven fibrotic disease of FIG. 35.

The thirteen territories of FIG. 36 may not be severable subsystems; they may be architecturally-integrated layers of a single governance stack sharing a common cryptographic ledger, a common attestation substrate, and a common deployment architecture. The shared cryptographic substrate at the center of FIG. 36 may comprise: the kernel-layer cryptographic stack of ECDSA P-256 (FIPS 186-5) plus SHA3-512 (FIPS 202) plus canonical CBOR (RFC 8949 § 4.2.1); the HumanMark™-integration layer cryptographic stack of Ed25519 (RFC 8032) plus SHA-3-256 plus canonical CBOR; and post-quantum upgrade paths to CRYSTALS-Dilithium ML-DSA per FIPS 204, Falcon, and SPHINCS+. Five cross-cutting unified architectural principles may architecturally integrate the thirteen territories of FIG. 36: (i) the shared cryptographic stack; (ii) the dual-independent-sink audit-anchor commitment of FIG. 31; (iii) the bidirectional write-and-read cryptographic licensing primitive; (iv) the DriftCard™ pay-per-governance-event embedded commercial transaction primitive; and (v) the SDKontrol™ reference-implementation enablement artifact.

Beyond the thirteen claim territories of FIG. 36, additional architectural primitives may be disclosed and integrated with the thirteen-territory core. These may include: the Rupert Protocol™ non-mimetic forensic-compliant emotional-modeling training method, providing a principled mechanism for training emotional-response behavior in artificial-intelligence systems without permitting tone mimicry; the MirrorGuard™ tone-mimicry-blocking primitive, foreclosing adversarial replication of operator emotional state; the Rupert Threshold™ manipulative-or-emotionally-incongruent system-behavior detector, which may flag artificial-intelligence outputs whose emotional valence diverges from the operator's measured state in a manner indicative of manipulation; the CleanLayer™ ISO 14644-analogous classification system for artificial-intelligence deployment environments, applying cleanroom-classification semantics to the artificial-intelligence deployment domain; the Heartbeat Attestation™ runtime certification, comprising a periodic software-development-kit heartbeat with degraded-mode-on-lapse behavior to detect runtime compromise; the Manual Evolution Control™ cryptographically-attested gated model-update protocol, requiring cryptographic attestation for every model-parameter update and foreclosing silent model substitution; and the three-tier Safe Mode Fallback architecture comprising a retrieval-augmented-generation tier, a template tier, and a semantic-filter tier as graduated fallbacks under failure conditions.

Further additional architectural primitives integrated with the thirteen-territory core of FIG. 36 may include: the Digital Twin Pre-Check simulation-against-validated-baseline subsystem, which may run candidate inference outputs against a validated digital-twin baseline before permitting physical actuation; the Fleet Aggregation and Maximum-Operator multi-system drift-scoring subsystem, which may aggregate drift scores across a fleet of deployed systems and apply a maximum-operator over the aggregate to detect coordinated drift that no single instance would surface; SYNKONTROL™ biometric-gating, comprising percent-of-eye-closure (PERCLOS) measurement, heart-rate variability, and reaction-time measurement collectively employed as a biometric gate on inference-request admissibility; the Container-Packaged Governance Kernel Licensing Architecture, comprising Docker-containerized deployment via single orchestration command with REST application-programming-interface invocation and a Dolby-style licensing model under which a downstream regulated system invokes the governance kernel exclusively through the REST API endpoint POST/govern; and the governed distributed transaction processing subsystem with governance-receipt-as-computational-byproduct, applying the byproduct-attestation architecture to financial and contractual transaction settlement.

The Cognitive Drift Index (CDI) underlying Territory T3 (3603) of FIG. 36 may be a continuous index combining semantic, procedural, and ethical drift vectors and may be computed as CDI_raw=α·|Δv|+β·H+γ·(1−A), where |Δv|=(1−cosine_similarity (current, baseline))/2 measures embedding-space drift, His Shannon entropy, A is mean attention weight, α=0.5, β=0.3, and γ=0.2. A multi-dimensional composite may be computed as CDI_final=0.6·CDI_raw+0.2·semantic_drift+0.1·procedural_drift+0.1·ethical_drift. The CDI threshold mapping may comprise: CDI>0.95→HALT IMMEDIATE; CDI>0.85→QUARANTINE RECALIBRATE; CDI>0.60→ATTENTION BOOST MODULATION or MONITOR_CLOSE (velocity-dependent); CDI>0.15→RECALIBRATE; otherwise MAINTAIN. CDI hysteresis may comprise: GREEN→AMBER at CDI of approximately 0.30, AMBER→GREEN requires CDI of approximately greater than 0.35, AMBER→RED at CDI of approximately 0.10, and RED→AMBER requires CDI of approximately greater than 0.15. Architectural linkage between Territory T3 of FIG. 36 and the HumanMark™ sibling content-provenance application may be preserved through the shared Ed25519/SHA-3-256/canonical CBOR cryptographic binding; linkage claims herein recite the sibling-application territory for chain-of-title without re-claiming the sibling subject matter.

The CognitiveIdentityMap™ of FIG. 28 may further support an extended high-dimensional personality-space embedding for advanced operator-modeling applications. In some embodiments, the CIM may be augmented with an approximately 847-dimensional personality space comprising approximately 128 affective dimensions, approximately 64 cognitive dimensions, approximately 256 expressive dimensions, approximately 128 relational dimensions, and approximately 271 aesthetic dimensions. The high-dimensional embedding may support phenotype identification under designations such as Phenotype ZXV (Signal Neurotype Architecture), with subtypes Trauma-Induced Emergent Architect (TIEA) and High-Voltage Emergent Architect (HVEA), enabling fine-grained operator-specific calibration of the runtime constraint. The Dependency Risk Score (DRS) intervention tiers, providing graduated responses to operator overdependence on the artificial-intelligence system, may comprise: a [0.0, 0.3] healthy-use tier; a (0.3, 0.5] AMBER-D proactive-engagement tier; a (0.5, 0.7] AMBER-D+session-reduction tier; a (0.7, 0.85] RED-D personality-suspension-to-neutral-mode tier; and a (0.85, 1.0] RED-D+immediate-session-termination-and-24-hour-lockout tier.

The method-of-use of FIG. 35 may further teach a unified mast-cell-activation-syndrome to fibrosis disease model wherein Dupuytren's contracture, frozen shoulder, lateral epicondylitis, bilateral fibrotic bands, fibrotic nodules, paroxysmal atrial fibrillation, fat atrophy, dermal thinning, and non-immunoglobulin-E chemical sensitivities are recognized as manifestations of a single underlying disease mechanism: clonal mast-cell activation (typically cutaneous mastocytosis with CD25-positive expression) driving transforming-growth-factor-beta-mediated fibrosis in every fascial plane the activated mast cells reach, with cardiac arrhythmia and chemical sensitivities arising as mast-cell-mediated complications of the same underlying clonal expansion. The unified disease model may be the intellectual foundation of the integrated treatment claim: the same combination regimen of FIG. 35 addressing the common mast-cell-activation mechanism may resolve the apparently disparate manifestations simultaneously. The mechanistic foundation of the method may rest upon documented findings that mast cells are the primary source of interleukin-13 in Dupuytren's disease, that interleukin-13 enhances pro-fibrotic gene expression, that transforming-growth-factor-beta exposure significantly increases interleukin-13 production from mast cells, that mast-cell infiltration is a histological signature of Dupuytren's contracture, that local anti-tumor-necrosis-factor injection into Dupuytren's nodules reduces nodule hardness and size, and that post-COVID long-haul patients develop mast-cell activation with symptom profiles substantially overlapping pre-existing mast-cell-activation-syndrome patients.

An N=1 reduction-to-practice of the method of FIG. 35 may proceed as follows. A subject with biopsy-confirmed cutaneous mastocytosis (CD25-positive), establishing the mast-cell-activation phenotype required for the method's mechanistic premise, may be administered the four-layer regimen of FIG. 35. Antihistamine H1+H2 blockade (combination of an H1-receptor antagonist with an H2-receptor antagonist) may halt progression of existing Dupuytren's contracture, consistent with the mast-cell-stabilization mechanism. Fibrinolytic enzyme therapy via orally administered combination of serrapeptase, nattokinase, and lumbrokinase may cause softening and partial reversal of existing contracture cords; documented clinical resolution of frozen shoulder (adhesive capsulitis); and documented clinical resolution of lateral epicondylitis (tennis elbow). Cessation of fibrinolytic enzyme therapy (for example, where required due to concurrent anticoagulation with apixaban prescribed for paroxysmal atrial fibrillation) may cause documented recurrence of fibrotic progression and re-accumulation of Dupuytren's tissue. The cause-and-effect relationship between fibrinolytic-enzyme therapy and reversal-versus-recurrence may be established across multiple discontinuation-and-reinstatement cycles, providing direct N=1 longitudinal evidence of the method's efficacy and of the contraindication for concurrent anticoagulation that motivates the SAFE_HALT branch at 3580 of FIG. 35.

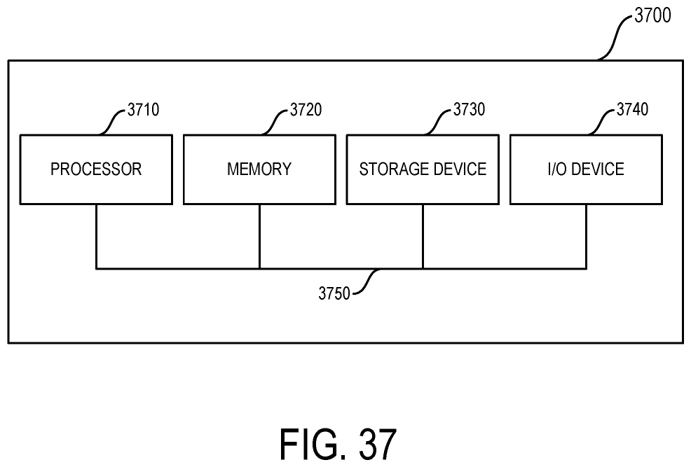

In some implementations, the current subject matter can be configured to be implemented in a system 3700, as shown in FIG. 37. The system 3700 can include a processor 3710, a memory 3720, a storage device 3730, and an input/output device 3740. Each of the components 3710, 3720, 3730 and 3740 can be interconnected using a system bus 3750. The processor 3710 can be configured to process instructions for execution within the system 3700. In some implementations, the processor 3710 can be a single-threaded processor. In alternate implementations, the processor 3710 can be a multi-threaded processor. The processor 3710 can be further configured to process instructions stored in the memory 3720 or on the storage device 3730, including receiving or sending information through the input/output device 3740. The memory 3720 can store information within the system 3700. In some implementations, the memory 3720 can be a computer-readable medium. In alternate implementations, the memory 3720 can be a volatile memory unit. In yet some implementations, the memory 3720 can be a non-volatile memory unit. The storage device 3730 can be capable of providing mass storage for the system 3700. In some implementations, the storage device 3730 can be a computer-readable medium. In alternate implementations, the storage device 3730 can be a floppy disk device, a hard disk device, an optical disk device, a tape device, non-volatile solid state memory, or any other type of storage device. The input/output device 3740 can be configured to provide input/output operations for the system 3700. In some implementations, the input/output device 3740 can include a keyboard and/or pointing device. In alternate implementations, the input/output device 3740 can include a display unit for displaying graphical user interfaces.

Beyond the architectural primitives described in connection with FIG. 28, the CognitiveIdentityMap™ runtime constraint may further support a sender-attested encoded-persona delivery primitive in which the operator's installed CognitiveIdentityMap™ is exported, embedded into an attested carrier, and used to condition downstream runtime generation at a remote receiver. The sender-attested encoded-persona delivery primitive may be architecturally decomposed into four component primitives, each integrating a primitive from a previously described claim territory: (a) a sender-CIM export primitive; (b) an attested carrier primitive; (c) a receiver-side conditioning primitive; and (d) a consent and anti-impersonation primitive. The four-component architecture may permit a sender's cryptographically attested decision architecture—including the decision_weights, value_weights, reasoning_patterns, prohibited_actions, and required_escalations fields enumerated in connection with FIG. 28—to govern downstream artificial-intelligence behavior at a receiver in the sender's absence, without requiring live participation by the sender, while preserving the cryptographic chain-of-custody between the sender's registered identity and any artificial-intelligence-generated output presented to the receiver.

The sender-CIM export primitive of element (a) above may operate as follows. At export time, the sender's installed CognitiveIdentityMap™ described in connection with FIG. 28 may be retrieved from the hardware-rooted key store (Trusted Platform Module 2.0, Apple Secure Enclave, Intel SGX, AMD SEV, ARM TrustZone, or a functional equivalent thereof) against which the CognitiveIdentityMap™ was originally encrypted at installation time. A portable-payload structure may be constructed comprising the ten enumerated CIM fields described in connection with FIG. 28 (decision_weights, risk_tolerance, cognitive_blind_spots, override_authority, autonomous_threshold, approval_threshold, reasoning_patterns, value_weights, prohibited_actions, and required_escalations), together with a carrier-UUID binding field, an export-timestamp field per RFC 3339 millisecond UTC, a sender-identity public-key fingerprint, a mode identifier corresponding to the three-role delivery mode of FIG. 7, and an export-purpose identifier. The portable-payload structure may be serialized under canonical Concise Binary Object Representation per RFC 8949 § 4.2.1 with lexicographically sorted map keys, hashed under SHA-3-256 per FIPS 202 (or SHA3-512 per FIPS 202 in the kernel-layer embodiment of FIG. 24), and signed under the sender's registered Ed25519 keypair per RFC 8032 or ECDSA P-256 keypair per FIPS 186-5, with the signature bound to the export-timestamp for replay protection. The signed structure may constitute the portable-payload.

The attested carrier primitive of element (b) above may operate as follows. The signed portable-payload may be embedded into an attested carrier selected from a genus comprising the governance-receipt byproduct produced as a computational byproduct of the eight-layer pipeline of FIG. 24, the SignalDrop™ single-file browser-executable artifact 200 of FIG. 1, the DriftCard™ governance-event record described in connection with the embedded commercial-transaction module 250 of FIG. 1, the Automated Regulatory Evidence Package emitted by the framework-mapping engine 3220 of FIG. 32, a method-of-use protocol artifact, a Coalition for Content Provenance and Authenticity (C2PA) conformant manifest, a W3C Verifiable Credentials Data Model 2.0 credential, an Electronic Publication (EPUB) container with embedded scripting, a signed-exchange bundle per the World Wide Web Consortium WebPackage specification, a Portable Document Format container per ISO 32000-2 with document-level JavaScript, a WebAssembly module with an attestation section, a Docker container image with cryptographic image-digest, a Kubernetes-native attested deployment descriptor, and a functional equivalent thereof. For a SignalDrop™ artifact carrier, the portable-payload may be appended as an additional section of the six-section artifact payload structure described in connection with FIG. 1, sitting alongside the HumanMark™ Score metadata section and before the artifact-level signature section, such that the carrier-level Ed25519 signature transitively covers the portable-payload section. For a governance-receipt byproduct carrier, the portable-payload may be embedded as an additional canonical-CBOR map key within the governance event such that the receipt-level byproduct signature transitively covers it. For a C2PA manifest carrier, the portable-payload may be embedded as a proprietary-namespace assertion. For a W3C Verifiable Credential carrier, the portable-payload may be embedded as a credentialSubject property. For any alternative carrier within the genus, the embedding mechanism may be the carrier-native mechanism for including arbitrary signed-payload extensions.

The receiver-side conditioning primitive of element (c) above may operate as follows. Upon verified retrieval of the attested carrier at the receiver, a runtime generation pipeline conditioned by the embedded portable-payload may be instantiated. The runtime generation pipeline may comprise autoregressive large-language-model generation, retrieval-augmented generation, template-instantiation, dialogue-system response selection, or a functional equivalent thereof. Conditioning of the pipeline may proceed through one or more complementary mechanisms selected per deployment. First, prompt-prefix injection: the embedded decision_weights, value_weights, reasoning patterns, and prohibited_actions fields may be rendered as a natural-language or canonical-structured-language prefix to the user-facing prompt submitted to the generation model, with the prefix instructing the model to operate within the encoded decision architecture. Second, sampling-time constraint by reward model: a learned reward model trained on exemplars attested to the sender may be integrated into the sampling loop such that candidate tokens or candidate completions conflicting with the encoded decision architecture receive reduced sampling probability. Third, output filtering: generated completions may be matched against the encoded prohibited actions list through a string-matching-plus-semantic-classifier ensemble, with matches triggering regeneration or escalation through the fail-safe-fallback layer 2480 of FIG. 24. Fourth, escalation binding: generated completions semantically matching any entry in the encoded required_escalations list may be intercepted before delivery to the receiver and routed to a human-in-the-loop reviewer authorized under the sender's deployment, consistent with the human-in-the-loop escalation path described in connection with FIG. 24.

The consent and anti-impersonation primitive of element (d) above may operate as follows. A receiver-facing consent-capture surface may be presented as a non-bypassable interface element conforming to the consent-capture sub-component described in connection with FIG. 1. The consent-capture surface may render: (i) a disclosure that the receiver is interacting with an encoded persona rather than with the live sender; (ii) the sender's registered identity public-key fingerprint together with its Certificate-Transparency Signed Certificate Timestamp anchor per RFC 6962 or RFC 9162 and its sigstore Rekor inclusion-proof identifier per the dual-sink anchor architecture of FIG. 6; (iii) the carrier-level cryptographic signature verification result; (iv) the portable-payload-level cryptographic signature verification result; (v) the carrier time-to-live remaining time; (vi) the three-role mode declaration corresponding to the delivery mode of FIG. 7; and (vii) where applicable under a regulated-vertical branded instance of FIG. 8, a jurisdictionally applicable professional-engagement notice. The receiver's affirmative consent may be captured through any of the consent mechanisms enumerated in connection with FIG. 1, including WebAuthn biometric authentication per W3C WebAuthn Level 3, FIDO2 CTAP2, Trusted Platform Module 2.0 attestation, passkey, smartcard, click-through with device attestation, voice-captured consent with audio attestation, or gesture-captured consent with motion attestation, each timestamped per RFC 3339 millisecond UTC and signed under Ed25519 against the dual-sink root anchor 290 of FIG. 3.

Fail-closed behavior may be enforced through the governance-kernel binding of FIG. 24 such that any of a defined set of fault conditions may trigger immediate SAFE_HALT through the four-state enforcement machine of FIG. 26 and termination of the receiver-side runtime generation pipeline. The fault conditions may include: (i) a failed signature verification at the carrier level or at the portable-payload level, triggering SAFE_HALT with reason carrier_signature_invalid or payload_signature_invalid; (ii) carrier time-to-live expiration, triggering SAFE_HALT with reason carrier_ttl_expired and offering the receiver a pathway to re-fetch a fresh carrier from the sender; (iii) sender-identity revocation as evidenced by Certificate-Transparency revocation, sigstore Rekor supersession, or an explicit revocation signal from the sender, triggering SAFE_HALT with reason sender_identity_revoked; (iv) integrity violation at the cleanroom architectural isolation boundary of FIG. 24 and FIG. 27, triggering SAFE_HALT with reason cleanroom_integrity_violation; and (v) a Meta-Drift Index crossing the 0.90 threshold described in connection with FIG. 31, triggering SAFE_HALT with reason governance_integrity_violation. Each SAFE_HALT event may be logged to the audit-logging layer 2470 of FIG. 24 and may emit a DriftCard™ governance-event record consistent with the pay-per-governance-event billing architecture described in connection with FIG. 22.

A representative worked example of the sender-attested encoded-persona delivery primitive described above may proceed as follows. A licensed professional (the sender) may have an installed CognitiveIdentityMap™ encoding the professional's decision architecture, including a prohibited_actions list (for example, {unauthorized_legal_advice, fee_commitment_without_engagement_letter, conflict_waiver_grant}) and a required_escalations list (for example, {privileged_client_information_disclosure, fee_quote_generation, conflict_of_interest_determination}). A client-facing work product (such as a structured advisory memorandum) may be generated by the sender's organization through a large-language-model pipeline under the sender's review. The sender-CIM export pipeline may serialize the sender's CognitiveIdentityMap™ into the portable-payload. A SignalDrop™ artifact may be constructed with the work product as content, with the organization's governance kernel embedded per FIG. 1, and with the portable-payload embedded per the embedding mechanism described above. The artifact may be transmitted to the client. At the client's browser, signature verification may succeed, and the consent-capture surface may disclose that the client is interacting with a sender-attested encoded persona rather than with the live sender, may render the proof-chain anchored to the dual-sink registry, and may capture the client's affirmative consent. Subsequent client queries to the receiver-side runtime generation pipeline may be conditioned on the sender's CognitiveIdentityMap™ such that queries about fee arrangements may trigger escalation per the required_escalations list and queries that would elicit unauthorized-legal-advice-class output may be filtered and replaced with a deferral-to-counsel response, with each governance event logged to the audit ledger.

Beyond the structured-humor parasympathetic-override system described in connection with FIG. 34, the wearable sensor array, autonomic classifier, governance-intercept block, and biometric-feedback architecture of FIG. 34 may further support a structured-affective-governance subsystem extending the architecture from the singular humor-class affective domain to a generalized enumerated-emotion governance taxonomy. The structured-affective-governance subsystem may comprise a sensor array extending the wearable sensor array 3410 of FIG. 34 with additional modalities for facial-action-coding-system capture, vocal prosody capture, respiratory pattern capture, and electroencephalographic capture; an affective-state classifier extending the autonomic classifier 3420 of FIG. 34 to classify operator state into one or more classes of an enumerated affective taxonomy; a per-class governance-behavior binding module operating analogously to the humor taxonomy 3440 and humor generator 3450 of FIG. 34 but generalized across the enumerated affective taxonomy; a cross-layer-fusion binding to the cross-layer fusion logic of FIG. 29 wherein affective classification participates as an additional fusion input under the deterministic precedence rule set; and a governance-kernel enforcement binding to the eight-layer pipeline of FIG. 24 with audit-ledger logging of each affective-classification event and each resulting governance action through the audit-logging layer 2470 of FIG. 24.

The enumerated affective taxonomy of the structured-affective-governance subsystem may comprise at minimum the eight Plutchik primaries—joy, trust, fear, surprise, sadness, disgust, anger, and anticipation—each parameterized by an intensity gradient in the closed interval [0, 1] and each combinable with adjacent primaries in a dyadic composition space such that joy combined with trust yields love, trust combined with fear yields submission, fear combined with surprise yields awe, surprise combined with sadness yields disapproval, sadness combined with disgust yields remorse, disgust combined with anger yields contempt, anger combined with anticipation yields aggressiveness, and anticipation combined with joy yields optimism. Alternative enumeration embodiments within the genus may include the Ekman six-basic-emotion set (anger, disgust, fear, happiness, sadness, surprise), the Ortony-Clore-Collins (OCC) appraisal-theory 22-class set, the Mikels eight-class set, the Geneva GEMS nine-class music-affect set, the Positive-and-Negative Affect Schedule (PANAS) 20-class set, a continuous valence-arousal-dominance three-dimensional space, and a functional equivalent thereof. The active taxonomy may be configurable per deployment and may be cryptographically committed to the policy-pack hash such that recipient-side verification of the affective-classification trace may independently confirm the taxonomy under which classification was performed.

Each enumerated emotion class within the active affective taxonomy may be specified with at minimum the following biometric signature elements drawn from the wearable sensor array 3410 of FIG. 34 and extended as indicated: (i) heart-rate variability spectral signature comprising a low-frequency-to-high-frequency ratio range per class; (ii) galvanic skin response amplitude and decay-time range per class; (iii) facial-action-coding-system action-unit pattern per class—for example, action units AU6 combined with AU12 for genuine joy, action units AU1 combined with AU4 and AU15 for sadness, action units AU4 combined with AU5 and AU7 for anger, action units AU1 combined with AU2, AU5, and AU26 for surprise, action units AU9 combined with AU15 and AU16 for disgust, and action units AU1 combined with AU2, AU4, AU5, and AU20 for fear; (iv) vocal prosody signature comprising a fundamental-frequency range, jitter, shimmer, harmonics-to-noise ratio, and speaking-rate range per class; (v) respiratory pattern comprising a breath rate, tidal volume, and inspiratory-expiratory ratio per class; (vi) electroencephalographic signature comprising a frontal-alpha asymmetry and a beta-gamma band-power ratio per class where electroencephalographic data is available; and (vii) where available, endocrine-proxy metrics comprising cortisol-proxy, oxytocin-proxy, and dopamine-proxy signatures per class. Facial-action-coding-system capture may be implemented through webcam-based automated analysis, infrared-illuminated wearable micro-camera capture, electromyography surface-electrode facial-muscle capture, or a functional equivalent thereof. Electroencephalographic capture may be implemented through consumer-grade wearable headsets or clinical-grade dry-electrode arrays.

Each enumerated emotion class within the active affective taxonomy may be bound to specific governance behaviors through the cross-layer fusion logic of FIG. 29 and the CognitiveIdentityMap™ of FIG. 28. Detection of fear above an intensity threshold (for example, 0.6) with heart-rate-variability low-frequency dominance may trigger an AMBER flag and may route through the Rupert Threshold™ manipulation-pattern detection. Detection of grief-encoded as sadness above an intensity threshold (for example, 0.7) with elevated galvanic skin response and reduced heart-rate variability persisting beyond a temporal-dynamics window—may trigger a grief-state escalation and may suppress humor-class outputs of the structured-humor parasympathetic-override system of FIG. 34 regardless of other governance signals. Detection of anger above an intensity threshold (for example, 0.5) may trigger escalation-review routing and may suspend autonomous large-language-model output generation through the render-gating layer 2450 of FIG. 24. Detection of trust in conjunction with a consent-capture solicitation may reduce the required override_authority level of the operator's CognitiveIdentityMap™ by one tier, granting elevated delegation to a trusted operator in a consented-transaction context. Detection of disgust in response to generated content may trigger regeneration under tightened constraint. The per-class bindings may be configurable within the operator's CognitiveIdentityMap™ value_weights and prohibited_actions fields and may be overridden per deployment per regulatory regime.

The affective-state classifier of the structured-affective-governance subsystem may be implemented as a modality-fusion ensemble. A plurality of per-modality classifiers—including a facial-action-coding-system classifier, a vocal-prosody classifier, a heart-rate-variability classifier, a galvanic-skin-response classifier, and an electroencephalographic classifier where available—may each emit a per-class probability distribution over the active enumerated affective taxonomy. A modality-fusion layer may combine the per-modality distributions through one or more of: a weighted arithmetic average with weights calibrated per operator from a structured elicitation protocol; Dempster-Shafer evidence combination; a learned gating network operating as a mixture-of-experts; a Bayesian-hierarchical posterior update against an operator-specific prior; and a functional equivalent thereof. The fused output may be a posterior probability distribution over the active taxonomy, an intensity gradient per class, and a temporal-dynamics vector per class, providing inputs to the per-class governance-behavior binding module described above.

The architectural primitive underlying the byproduct-attestation receipt of FIG. 24, the sender-attested encoded-persona delivery primitive described above, the SignalDrop™ artifact 200 of FIG. 1, and the HumanMark™ Token of FIG. 14 may be generalized as a cognitive-carrier genus comprising any attested governance artifact whose payload includes an encoded cognitive-identity structure conditioning a downstream behavior of a rendering, evaluation, billing, compliance, or method-of-use system operating on the artifact. The cognitive-carrier genus may include, without limitation: a governance-receipt byproduct produced by the eight-layer pipeline of FIG. 24; a SignalDrop™ single-file browser-executable artifact per FIG. 1; a DriftCard™ governance-event record per FIG. 22; an Automated Regulatory Evidence Package emitted by the framework-mapping engine 3220 of FIG. 32; a method-of-use protocol artifact such as the four-layer regimen of FIG. 35; a C2PA-conformant manifest; a W3C Verifiable Credential; an Electronic Publication container with embedded scripting; a signed-exchange bundle per the W3C WebPackage specification; a Portable Document Format container per ISO 32000-2 with document-level JavaScript; a WebAssembly module with an attestation section; a Docker container image with cryptographic image-digest; a Kubernetes-native attested deployment descriptor; a future computational-artifact carrier not enumerated at the priority date of the present application; and a functional equivalent thereof. The encoded cognitive-identity structure may conform at minimum to the ten-field CognitiveIdentityMap™ schema of FIG. 28 and may be cryptographically bound to a registered identity keypair selected from Ed25519 per RFC 8032, ECDSA P-256 per FIPS 186-5, ML-DSA per FIPS 204, and a functional equivalent thereof. The conditioning of downstream behavior may be enforced under the governance kernel of FIG. 24 and may be logged to the audit-logging layer 2470 of FIG. 24.

The Rupert Protocol™ non-mimetic forensic-compliant emotional-modeling architectural primitive described in connection with FIG. 36 may forbid replication of an operator's emotional tone, cadence, or affective register in artificial-intelligence-generated responses in the unconsented case. The sender-attested encoded-persona delivery primitive described above may, however, require permitted sender-attested mimicry under specific consent-and-attestation conditions in which the operator whose tone is replicated has expressly and cryptographically authorized the replication. To reconcile the two primitives, the anti-mimicry constraint of the Rupert Protocol™ may admit a carve-out applicable when, and only when: (i) the source operator whose emotional register is replicated has executed a sender-CIM export per the export pipeline described above and has signed the resulting portable-payload under the source operator's registered Ed25519 or ECDSA P-256 keypair; (ii) the receiver-side consent-capture surface has displayed the disclosure of encoded-persona interaction together with the cryptographic proof-chain and has captured the receiver's affirmative consent; (iii) the carrier-level and portable-payload-level signatures verify and the carrier time-to-live has not expired; (iv) the source operator's identity has not been revoked by Certificate-Transparency revocation, sigstore Rekor supersession, or explicit sender-issued revocation; and (v) the cleanroom architectural isolation boundary of FIG. 27 remains intact. Outside the carve-out conditions, the Rupert Protocol™ anti-mimicry constraint may operate without modification, preserving the anti-manipulation property in all unconsented or unattested cases.

The cleanroom architectural isolation of FIG. 27—described in connection with operating-system-level embodiments using distinct Linux process namespaces and container-packaged embodiments using distinct Docker images—may be alternatively satisfied in browser-runtime embodiments in which the governance kernel is deployed inside a receiver user-agent co-resident with rendered content, including without limitation the SignalDrop™ single-file browser-executable embodiment of FIG. 1. In such browser-runtime embodiments, cleanroom architectural isolation may be satisfied through a species alternative comprising one or more of the following complementary browser-native mechanisms: (i) a Content-Security-Policy per W3C Content Security Policy Level 3 with directives strict-dynamic, default-src ‘none’, script-src ‘self’ ‘wasm-unsafe-eval’, and object-src ‘none’, with no ‘unsafe-eval’ or ‘unsafe-inline’ permitted; (ii) Cross-Origin Isolation via the Cross-Origin-Opener-Policy: same-origin and Cross-Origin-Embedder-Policy: require-corp HTTP response headers enabling SharedArrayBuffer compartmentalization; (iii) worker-thread compartmentalization via dedicated Web Workers or Service Workers running the governance-kernel WebAssembly module in a distinct execution context from the rendered-content thread, communicating via postMessage with structured-clone-serialized messages cryptographically signed under the unidirectional message-passing protocol of FIG. 27; (iv) the sandbox attribute on any embedding HTML iframe element per the WHATWG HTML Living Standard with sandbox values permitting allow-scripts while withholding allow-same-origin and allow-top-navigation; (v) a Permissions-Policy per W3C Permissions Policy specification restricting the rendered-content compartment from accessing camera, microphone, geolocation, payment, and Universal Serial Bus application-programming interfaces while permitting the governance-kernel compartment to access the subset required for biometric gating and consent capture; (vi) hardware-rooted isolation via WebAuthn per W3C WebAuthn Level 3 and via Trusted Platform Module per Trusted Platform Module 2.0 for cryptographic key operations; and (vii) a functional equivalent thereof. Each alternative may be sufficient alone or in combination to satisfy the cleanroom architectural isolation requirement of FIG. 27, with a preferred browser-runtime embodiment combining mechanisms (i), (ii), (iii), and (vi) as a defense-in-depth configuration.

The systems and methods described herein may be expressed in the following clauses:
Clause 1. (SignalDrop™ System) A self-contained content delivery and governance system, comprising: a single browser-executable file containing artificial-intelligence-generated or artificial-intelligence-assisted content; an embedded runtime governance kernel co-resident within the file and configured to gate every render-time operation through policy-driven decision logic, wherein the kernel evaluates each render-time decision against a machine-readable policy specification and classifies the decision as ALLOW, REFUSE, REFUSE_WITH_ALTERNATIVE, or ESCALATE; cryptographic byproduct attestation produced as an inseparable computational byproduct of the render-time governance pipeline rather than as a separate verification step, the attestation comprising a signature over an attestation input set that includes a content hash computed under SHA-3-256, a kernel version identifier, a HumanMark™ Score and resolved state, a policy hash, a session nonce, and a timestamp, the signature implemented as one of a JSON Web Signature per RFC 7515 using EdDSA per RFC 8032, a Cryptographic Message Syntax envelopedData per RFC 5652, a detached Ed25519 signature over a canonical CBOR serialization per RFC 8949 § 4.2.1, a SHA-3 Merkle leaf, a zk-SNARK proof, and a functional equivalent thereof; session ephemerality with zero persistent trace, wherein content, governance state, HumanMark™ Score data, transaction records, and audit metadata exist exclusively in volatile memory for the duration of the browsing session and are irrecoverable thereafter; embedded commercial transaction capability executing wholly within the file boundary without navigation to external domains and comprising consent capture, item selection, checkout, payment processing, and receipt generation stages; a HumanMark™ Score displayed immediately upon content opening without user interaction or external query and cryptographically bound to the byproduct attestation; a delivery mode identifier cryptographically bound to the artifact at creation through inclusion in the content hash and attestation input set, the mode being one of end-user-delivery, counsel-review, and reseller-packaging; and a tamper-evident audit trail structured as an append-only hash chain with each entry signed under Ed25519 and the root anchor simultaneously committed to at least two independent registry sinks, and a functional equivalent thereof of each of the foregoing primitives.
Clause 2. (SignalDrop™ Method—Process) A computer-implemented method for delivering artificial-intelligence-generated or artificial-intelligence-assisted content with embedded governance, comprising: receiving, at a recipient computing device, a single browser-executable file containing artificial-intelligence-generated or artificial-intelligence-assisted content, an embedded runtime governance kernel, a machine-readable policy specification, and metadata; verifying artifact integrity by recomputing a content hash under SHA-3-256 and validating an Ed25519 signature using a creator public key retrieved from one of embedded artifact metadata, a Domain Name System TXT record, a Decentralized Identifier document, and a functional equivalent thereof; activating the embedded governance kernel which evaluates each render-time operation against the policy specification through an eight-layer pipeline comprising input validation, policy resolution, consent verification, content classification, render gating, telemetry emission, audit logging, and fail-safe fallback; rendering the content within the recipient's browser only on ALLOW decisions; producing, as an inseparable computational byproduct of the eight-layer pipeline, a cryptographic attestation signature; computing and displaying a HumanMark™ Score; recording every state change in an append-only hash-chain audit trail; on session termination, committing the root anchor of the audit trail simultaneously to at least two independent registry sinks; explicitly purging volatile memory containing all session data; and a functional equivalent thereof of each of the foregoing steps.
Clause 3. (Computer-Readable Medium) A non-transitory computer-readable medium storing instructions that, when executed by a processor of a computing device, cause the computing device to perform the method of Clause 2.
Clause 4. (Governance Kernel Apparatus) An apparatus comprising a runtime governance kernel for render-time policy enforcement in a single-file artificial-intelligence content delivery artifact, the apparatus comprising: an input validation module sanitizing artifact metadata, content assets, policy specification, consent data, and external inputs; a policy resolution module mapping content metadata and recipient context to applicable rule sets through a cascading hierarchy of global, content-type-specific, mode-specific, vertical-specific, and artifact-specific rules; a consent verification module confirming required consents are obtained, validated, fresh, and policy-version-matched; a content classification module assigning modality, content-type modulation factor Y, sensitivity level, and regulatory applicability; a render gating module classifying each render-time decision as ALLOW, REFUSE, REFUSE_WITH_ALTERNATIVE, or ESCALATE per policy evaluation; a telemetry emission module canonicalizing under canonical CBOR per RFC 8949 § 4.2.1, hashing under SHA-3-256, signing under Ed25519 per RFC 8032, and emitting or queuing telemetry events; an audit logging module maintaining an append-only hash-chain with monotonically increasing sequence number, predecessor hash, Ed25519 signature, timestamp, and event payload per entry; a fail-safe fallback module providing graduated component-level, pipeline-level, and session-level fault response wherein failure closes rather than opens the system; wherein the kernel is implemented as one of a co-resident JavaScript module, a WebAssembly-compiled decision engine, a service worker intercepting resource requests, a browser extension, a trusted execution environment composed via Janus-class TEE-WebAssembly composition, and a functional equivalent thereof; and wherein a reference implementation comprises four hundred fifty-three lines of Python code organized into eight modules with thirteen unit tests passing.
Clause 5. (Universal Substrate) A universal substrate for governed artificial-intelligence content delivery across arbitrary regulated and unregulated verticals, comprising: the system of Clause 1, wherein the single-file payload, embedded governance kernel, byproduct attestation, session ephemerality, embedded commerce, HumanMark™ Score, three-role delivery mode, and tamper-evident audit trail with dual-sink root anchor constitute a high-level architecture; and a plurality of species-specific branded instances each inheriting the full eight-property and specializing along five configuration dimensions consisting of permitted content type, policy rule population to the applicable regulatory framework, HumanMark™ Score semantic interpretation, user-interface color scheme typography and iconography, and enumerable consent mechanisms audit-sink species and transport mechanisms; wherein any branded instance specializing the embodiment along the five configuration dimensions for a regulated or unregulated vertical is within the scope of this Clause regardless of whether the specific branded instance is enumerated herein, including without limitation MedDrop™, EduDrop™, MortgageDrop™, TrainingDrop™, Certificate Drop™, DropShop™, Quote Engine™, Connection Drop™, OrgDrop™, Note Drop™, BrandLayer™, an aerospace passenger-experience branded instance, a governed-internet branded instance, a resonance-identification branded instance, an EQVOS-vertical branded instance, a self-energizing-substrate branded instance, and a functional equivalent thereof.

### Core System Properties

Clause 6. (Session Ephemerality Sub-Clause) The system of Clause 1, wherein the session ephemerality is implemented through at least one of: in-memory-only execution wherein no write operation targets persistent storage including IndexedDB, localStorage, sessionStorage, Cache API, or File System Access API; explicit purge logic overwriting sensitive TypedArrays with cryptographically random data sourced from Web Crypto API crypto.getRandom Values prior to dereference; execution within an incognito or private-browsing context; execution within a sandboxed iframe with storage API restrictions imposed via Content Security Policy; execution within an ephemeral browser context instantiated via the Chromium DevTools Protocol or equivalent automation interface; and a functional equivalent thereof.
Clause 7. (Byproduct Attestation Sub-Clause) The system of Clause 1, wherein the cryptographic byproduct attestation is generated as an inseparable output of the render-time governance pipeline such that the attestation cannot be produced without running the pipeline and the pipeline cannot complete without producing the attestation, and wherein the attestation includes the SHA-3-256 content hash, the kernel semantic version identifier, the HumanMark™ Score and resolved state, the SHA-3-256 policy hash, a 128-bit cryptographically random session nonce bound to an SDK-instance identifier, and an RFC 3339 millisecond UTC timestamp; and wherein the attestation envelope is implemented as one of a JSON Web Signature per RFC 7515 using EdDSA per RFC 8032 or ES256, a Cryptographic Message Syntax envelopedData per RFC 5652, a detached Ed25519 signature over canonical CBOR per RFC 8949 § 4.2.1, a SHA-3 Merkle leaf with inclusion proof, a zk-SNARK proof carrying the input set as public inputs, a post-quantum signature including CRYSTALS-Dilithium ML-DSA per FIPS 204, Falcon, or SPHINCS+optionally hybrid-composed with a classical signature, and a functional equivalent thereof.
Clause 8. (Self-Destructing Attestation Chain Sub-Clause) The system of Clause 7, further comprising a self-destructing attestation chain wherein an attestation signing key is derived per session via HKDF-SHA-3-256 from the session nonce, wherein successful decryption of content segment N triggers attestation generation for content segment N+1, and wherein session termination cryptographically destroys all derived keys via explicit zero-overwrite of TypedArray representation, rendering the attestation unverifiable from the session's internal state but persistently verifiable against the dual-sink root anchor.
Clause 9. (Embedded Commerce Sub-Clause) The system of Clause 1, wherein the embedded commercial transaction capability comprises five sequential stages of consent capture with granular toggle options per commerce category, item selection with embedded product catalog and variant configuration, checkout with itemized summary and tax computation, payment processing within the protected runtime, and receipt generation with cryptographically signed receipt; and wherein the payment processing is implemented as one of Stripe Checkout Elements via tokenized iframe, Adyen Drop-in, PayPal Checkout SDK, Apple Pay JS API, Google Pay API, W3C Payment Request API, DriftCard™ ephemeral payment credential, governed distributed transaction processing per Clause 51, direct embedded-wallet signing for cryptocurrency settlement, and a functional equivalent thereof.
Clause 10. (Single-File Packaging Sub-Clause) The system of Clause 1, wherein the single browser-executable file is formatted as one of: an HTML5 document with inline ECMAScript and Cascading Style Sheets; a WebAssembly binary with bundled JavaScript interop layer and memory initialization; a Portable Document Format container per ISO 32000-2 with document-level JavaScript; a Scalable Vector Graphics document with embedded ECMAScript handlers; a signed-exchange bundle per WICG WebPackage specification; an Electronic Publication container with embedded scripting; and a functional equivalent thereof.
Clause 11. (Signature Verification Sub-Clause) The system of Clause 1, wherein the artifact integrity verification comprises recomputation of the SHA-3-256 content hash over canonicalized artifact bytes, validation of the Ed25519 signature using the creator's public key retrieved from one of embedded artifact metadata, a Domain Name System TXT record, a Decentralized Identifier document, and a functional equivalent thereof; validation of the session nonce against the current session for cross-session replay prevention with bounded-LRU cache of recently-seen nonce-and-instance pairs; timestamp validation with configurable TTL window of 300 seconds default and clock-skew tolerance of 30 seconds; policy version match between the attestation policy hash and the active policy hash; and emission of TAMPERED, EXPIRED, or UNVERIFIABLE state on verification failure.
Clause 12. (Policy Enforcement Sub-Clause) The system of Clause 1, wherein the machine-readable policy specification comprises global rules applying to all content regardless of type or context, content-type-specific rules applying based on content modality with associated γ modulation factors, delivery-mode-specific rules applying based on the selected mode of end-user-delivery, counsel-review, or reseller-packaging, vertical-specific rules applying based on the branded instance per Clause 5, and artifact-specific rules with cryptographic authorization, with conflict resolution applying TAMPERED greater-than EXPIRED greater-than UNVERIFIABLE greater-than REFUSE greater-than REFUSE_WITH_ALTERNATIVE greater-than ALLOW precedence and rule-specificity ordering for equal-severity conflicts.

### Governance Kernel

Clause 13. (Protected Browser Runtime Sub-Clause) The apparatus of Clause 4, further comprising a protected browser runtime providing a hardened sandboxed execution environment isolating the payload from host-system file-system APIs, restricting network access to explicitly allow-listed endpoints, and preventing interaction with non-governed browser extensions, wherein the runtime is implemented as one of: a dedicated Electron-based shell with disabled developer tools; a Progressive Web Application in standalone display mode; a Tauri application; a Chromium Embedded Framework instance with disabled developer tools; an Android Web View in kiosk mode; an iOS WKWebView with restrictions; and a functional equivalent thereof.
Clause 14. (Delivery Flow Sub-Clause) The apparatus of Clause 4, further comprising a delivery flow managing the end-to-end payload ingestion pipeline including: payload retrieval via a transport mechanism selected from HyperText Transfer Protocol Secure, email attachment, peer-to-peer transfer via WebRTC or InterPlanetary File System or Bluetooth OBEX, QR code scan, Near-Field Communication tap, Long Range or LoRaWAN transmission, sneakernet, Bluetooth Low Energy, Airdrop or proximity-based mobile file sharing, physical media mount, and a functional equivalent thereof; cryptographic hash computation and signature validation; mode identifier inspection and rendering path selection; and atomic handoff to the governance kernel via a five-step activation sequence comprising kernel location, kernel integrity verification, kernel initialization, governance activation, and rendering authorization.
Clause 15. (Consent-Capture Sub-Component Sub-Clause-Standalone (Gap A)) The apparatus of Clause 4, further comprising a Consent-Capture sub-component presenting a governed non-bypassable interface element capturing the recipient's explicit consent signal as affirmative action, the timestamp of consent capture in RFC 3339 millisecond UTC format, the recipient's device and browser context fingerprint for session binding, the governing policy version under which consent is granted, and a tamper-evident state binding wherein missing or invalid consent causes a Layer 3 REFUSE with Layer 4 solicitation directive; and wherein the consent capture mechanism is selected from WebAuthn biometric per W3C WebAuthn Level 3, FIDO2 CTAP2, Trusted Platform Module 2.0 attestation, passkey, smartcard, click-through with device attestation, voice-captured consent with audio attestation, gesture-captured consent with motion attestation, and a functional equivalent thereof.
Clause 16. (Governance Kernel Co-Resident Sub-Component Sub-Clause-Standalone (Gap B)) The apparatus of Clause 4, wherein the embedded runtime governance kernel is co-resident with the protected runtime within the same single browser-executable file as the content, and wherein the kernel invocation is implemented as one of in-browser JavaScript execution within the page scripting context, in-browser WebAssembly execution with memory isolation, service worker interception of resource requests, browser extension invocation, trusted execution environment integration via Janus-class TEE-plus-WebAssembly composition, and a functional equivalent thereof.
Clause 17. (Fail-Safe Behaviour Primitive Sub-Clause-Standalone (Gap C)) The apparatus of Clause 4, wherein the fail-safe fallback module operates upon failure of any other sub-component or external dependency in three graduated tiers comprising Tier 1 component-level fault applying most-restrictive policy gating to the failed component while preserving session integrity for non-failed components; Tier 2 pipeline-level fault transferring governance to a minimal pre-validated fallback kernel with hardcoded ALLOW and REFUSE rules; and Tier 3 session-level fault terminating the session with explicit memory purge, final audit-entry commit with fault code, and refusal indicator displayed to the recipient, wherein in no fail-safe tier is the governance architecture bypassed and wherein failure closes rather than opens the system.
Clause 18. (Minimum-Viable Client-Code Posture Sub-Clause-Standalone (Gap D)) The system of Clause 1, wherein the embedded runtime governance kernel and the single browser-executable file together exhibit a minimum-viable client-code posture characterized by license-clean dependency exclusion of GPL-class and AGPL-class libraries, limited dependency surface, and reduced attack surface, the posture preserved as a design constraint across all branded instances of Clause 5.
Clause 19. (Out-of-Scope Boundary Sub-Clause-Separation Property (Gap E)) The system of Clause 1, configured to operate independently of biometric recipient identification discussed in U.S. Provisional Patent Application No. 63/822,651, emotional-safety multimodal sensing claimed in U.S. Provisional Patent Application No. 63/815,849, Octopus™ adaptive-surface rendering of a separate portfolio, and quantum-biological distributed-sensing research, wherein the separation property protects claim boundaries and establishes antecedent basis for the companion filings.
Clause 20. (Eight-Layer Kernel Pipeline Sub-Clause) The apparatus of Clause 4, wherein the eight-layer pipeline operates in the recited order with each layer producing well-defined output to the subsequent layer, and wherein the kernel reference implementation comprises 453 lines of Python organized into eight modules—input_validation.py at 47 lines, policy_resolution.py at 58 lines, consent_verification.py at 41 lines, content_classification.py at 52 lines, render_gating.py at 64 lines, telemetry_emission.py at 44 lines, audit_logging.py at 58 lines, and failsafe_fallback.py at 89 lines—with thirteen unit tests passing including test_allow_decision, test_refuse_decision, test_refuse_with_alternative, test_escalate_decision, test_cert not found, test_revoked_cert, test_lease_expired, test fork_attack, test_consent_missing, test_cdi_threshold_breach, test_json_receipt_output, test_replay_attack, and test_signature_tampering.

### Three-Role Delivery Mode

Clause 21. (End-User Delivery Mode Sub-Clause) The universal substrate of Clause 5, wherein the end-user delivery mode renders the full content experience with all interactive elements, the HumanMark™ Score as a compact badge with color indicator and numeric score on hover, embedded commerce capability subject to valid consent, a consent banner with granular toggle options, a checkout interface with cart summary and payment-method selector, and a receipt panel with transaction confirmation and cryptographic receipt download.
Clause 22. (Counsel Review Mode Sub-Clause) The universal substrate of Clause 5, wherein the counsel review mode renders the full content with annotation capability, the HumanMark™ Score as an expanded computation panel showing all four weighted dimensions with sub-scores and the Platt-calibration parameters and the modality-gamma factors and the hysteresis-band state, a complete policy specification viewer with human-readable annotations and rule-precedence tree and regulatory-framework mapping, a full audit-trail explorer with signature verification and hash chain validation and per-entry sink commitment status, a redacted commerce preview with payment processing disabled, and a regulatory framework mapping identifying applicable provisions per rule and gap analysis.
Clause 23. (Reseller Packaging Mode Sub-Clause) The universal substrate of Clause 5, wherein the reseller packaging mode renders a condensed content preview, a sub-policy editor for creating derived governance rules within parent policy bounds with validation ensuring sub-policies are no less restrictive than the parent, a chain-of-custody transfer interface recording reseller identity, timestamp, and Ed25519 signature, a recipient-list management interface for specifying downstream recipient identifiers with per-recipient delivery mode assignment, mode-reassignment controls for downstream artifacts requiring re-hashing and re-signing, and a commission-structure display with revenue-sharing percentage or fixed amount, commission basis, projected earnings, and payment schedule.
Clause 24. (Mode Immutability Sub-Clause) The universal substrate of Clause 5, wherein the delivery mode is cryptographically bound at artifact creation through inclusion of the mode identifier in the content hash computation and attestation signature input set, such that mode modification changes the content hash and invalidates the attestation signature, and wherein mode transition between the three modes is not permitted within a single artifact session and requires creation of a new artifact with the desired mode by the originator.

### HumanMark™ Score Integration

Clause 25. (HumanMark™ Score Composite Computation Sub-Clause) The system of Clause 1, wherein the HumanMark™ Score is computed as a weighted linear combination of four orthogonal analyzer outputs with locked weights w_SE=0.28, w_SF=0.32, w_GA=0.25 inverted in the composite as one minus GA, and w_PV=0.15 summing exactly to unity, wherein the four analyzers comprise Semantic Entropy with sub-score Platt calibration α=0.35 β=0.12 prior to composite entry, Stylometric Fingerprint with a 187-dimensional feature vector and an XGBoost gradient-boosting ensemble or a functional equivalent thereof, Generative Artifact with per-modality detectors fused through weighted combination, and Provenance Verification operating on a creation-side observation surface, with raw composite transformed into calibrated probability via Platt scaling with locked composite parameters α=0.45 β=0.18, multiplied by 100 and integer-rounded to produce the published HumanMark™ Score on the integer scale from zero to one hundred.
Clause 26. (Six-State Resolution Sub-Clause—INTEGER Scale Portfolio Locked) The system of Clause 25, wherein the calibrated HumanMark™ Score resolves to one of six mutually exclusive states with locked thresholds and locked ±2-point hysteresis: GREEN entered at HMS≥85 with hysteresis requiring HMS≤83 to transition to AMBER; AMBER occupying 40≤HMS≤84 with hysteresis requiring HMS≥87 to re-enter GREEN or HMS≤38 to transition to RED; RED entered at HMS≤39 with hysteresis requiring HMS≥42 to re-enter AMBER; and three absorbing override states UNVERIFIABLE entered on insufficient signal, TAMPERED entered on signature or hash failure, and EXPIRED entered on timestamp-plus-TTL failure, with rule precedence TAMPERED>EXPIRED>UNVERIFIABLE>hysteresis-guarded quantitative>remain in current state.
Clause 27. (Section-Level Aggregation Sub-Clause) The system of Clause 25, wherein for structurally composite content the per-section HMS aggregates to artifact-level HMS via a weighted harmonic mean encoding a weakest-link sensitivity property HMS_artifact=1/Σ_i (γ_i/max(s_i, ε)) with modality-specific gammas γ_text=1.0, γ_image=0.8, γ_audio=0.9, γ_video=0.85, and ε=10\hat{ }(−6).
Clause 28. (HMS Display Sub-Clause) The system of Clause 21, wherein the HumanMark™ Score is displayed as a compact badge in the upper-right viewport corner color-coded per resolved state, with green for GREEN, amber for AMBER, red for RED, gray for UNVERIFIABLE and EXPIRED, and red with broken lock for TAMPERED, with an icon indicator and the numeric composite score visible on hover.

### Audit Trail and Dual-Sink Anchor

Clause 29. (Hash-Chain Audit Trail Sub-Clause) The system of Clause 1, wherein the audit trail is structured as an append-only hash chain with a genesis entry containing session initialization parameters and a constant seed hash derived from a fixed protocol identifier string, and subsequent entries each containing event type from the telemetry taxonomy, monotonically increasing sequence number, SHA-3-256 hash of the preceding entry, Ed25519 signature of the canonicalized entry payload by the kernel's session-derived signing key, RFC 3339 millisecond UTC timestamp, and event-specific payload canonicalized under canonical CBOR per RFC 8949 § 4.2.1.
Clause 30. (Dual-Sink Root Anchor Sub-Clause) The system of Clause 29, wherein the root anchor of the hash chain is simultaneously committed to at least two independent registry sinks with distinct administrative control, distinct technical infrastructure, and distinct legal jurisdiction, the sinks selected from Certificate Transparency logs per IETF RFC 6962 or RFC 9162, sigstore Rekor transparency logs, public blockchain ledgers including Ethereum Bitcoin Polygon and Solana, permissioned distributed ledgers including Hyperledger Fabric R3 Corda and Quorum, centralized audit services operated by independent trust anchors, academic or research institutional archives, threshold-cryptographic multi-signature notarization services, trusted timestamp authorities per RFC 3161, and a functional equivalent thereof.
Clause 31. (Local-Queue DDIL-Operation Sub-Clause) The system of Clause 30, wherein when configured sinks are unavailable the audit trail transitions to local-queue mode with audit entries continuing to be generated and appended to the in-memory hash chain, uncommitted entries retained in an encrypted volatile buffer using AES-256-GCM with a session-derived key from HKDF-SHA-3-256 over session nonce plus SDK-instance identifier, retry attempts following exponential backoff with initial delay 1 second doubling per attempt and maximum 60 seconds between attempts, the encrypted buffer purged upon successful commit or at session termination, supporting denied degraded intermittent or low-bandwidth environments characteristic of military field deployments, disaster-zone operations, maritime and aviation in-transit use, rural environments without persistent connectivity, and a functional equivalent thereof.

### Branded Instances (Species Clauses)

Clause 32. (MedDrop™ Branded Instance) The universal substrate of Clause 5, wherein the MedDrop™ branded instance enforces minimum necessary standard per 45 CFR 164.502 (b), treatment-specific consent per 45 CFR 164.506, provider-specific authorization per 45 CFR 164.508, PHI access logging per 45 CFR 164.308(a)(1), Business Associate Agreement chain-of-custody per 45 CFR 164.504 (e), FDA Software-as-a-Medical-Device AI/ML submission requirements where applicable, FDA 21 CFR Part 11 electronic records compliance, applicable state medical privacy laws, and a functional equivalent thereof, wherein the consuming application is selected from remote patient monitoring, digital therapeutics, clinical decision support, tele-medicine consultation, mental-health assessment, cognitive assessment, pre-visit triage, post-discharge monitoring, chronic-disease self-management, wellness assessment, clinical-trial subject self-report, field-medic decision support in DDIL environments, disaster-response medical assessment, military medical assessment, and a functional equivalent thereof, and wherein the HMS GREEN state indicates clinical content reviewable with standard clinical procedure.
Clause 33. (EduDrop™ Branded Instance) The universal substrate of Clause 5, wherein the EduDrop™ branded instance enforces directory information suppression per 20 USC § 1232g(a)(5)(A), parental consent for minors per 15 USC § 6501 (COPPA), educational record classification per 20 USC § 1232g(a)(4)(A), institutional policy inheritance, third-party disclosure restrictions per 20 USC § 1232g(b)(1), state student privacy laws, and a functional equivalent thereof, wherein the consuming application is selected from a learning management system, online course delivery, student assessment, tutoring platform, educational content authoring, institutional research, academic-integrity adjudication, and a functional equivalent thereof.
Clause 34. (MortgageDrop™ Branded Instance) The universal substrate of Clause 5, wherein the MortgageDrop™ branded instance is configured for a real-estate-or-mortgage-transaction system selected from a mortgage-origination platform, a real-estate-brokerage listing system, a title-insurance platform, a mortgage-servicing system, a closing-disclosure delivery system, and a functional equivalent thereof, wherein the artifact is selected from a machine-generated loan-estimate narrative, a machine-generated closing-disclosure narrative, a machine-generated property-valuation narrative, a machine-generated title-report summary, a machine-generated listing description, a machine-generated counter-offer narrative, and a functional equivalent thereof, wherein the provenance-proof binding includes a lender identifier, a property identifier, a borrower identifier, a transaction identifier, a loan identifier, and a functional equivalent thereof, and wherein the audit log satisfies the Real Estate Settlement Procedures Act 12 USC § 2601 et seq., the Truth in Lending Act 15 USC § 1601 et seq., the TILA-RESPA Integrated Disclosure Rules at 12 CFR § 1026.37 and § 1026.38, the Home Mortgage Disclosure Act 12 USC § 2801 et seq, and 12 CFR Part 1003, the Equal Credit Opportunity Act 15 USC § 1691 et seq, and Regulation B at 12 CFR Part 1002, applicable state real-estate licensing obligations, and a functionally equivalent national or supranational obligation thereto.
Clause 35. (Corporate Training and Certificate Drop™ Branded Instance) The universal substrate of Clause 5, wherein the Corporate Training or Certificate Drop™ branded instance is configured for a certification or credential-issuance system selected from a regulatory-training-completion certification system, a continuing-professional-education credit-issuance system, a professional-licensing-board certificate system, an academic-microcredential issuance system, a corporate skill-certification system, a vendor or partner certification system, an audit-completion certification system, an inspection-completion certification system, an insurance-eligibility certification system, and a functional equivalent thereof, wherein the artifact is a verifiable credential issuable in any of W3C Verifiable Credentials Data Model 2.0 conformant credential, Open Badge 3.0 conformant credential, X.509-attested certificate, eIDAS Regulation (EU) 2024/1183 qualified certificate, JSON-LD-formatted attestation document, human-readable PDF rendering, and a functional equivalent thereof, wherein the provenance-proof binding includes an issuer identifier, a holder identifier where lawful and consented, a curriculum-or-course identifier, the HumanMark™ Score for the session, a governance-kernel-version identifier, a regulatory-regime token, an issuance timestamp, an expiration timestamp where applicable, a verification-endpoint identifier, and a functional equivalent thereof, wherein verification of the credential is performable offline by checking the credential signature against a published issuer key recorded in any of the dual-sink root anchors of Clause 30 including without limitation a Certificate Transparency log under IETF RFC 6962 or RFC 9162 and a sigstore Rekor transparency log; and wherein the audit log satisfies any of ABA Model Rules 1.1 and 5.3, FINRA Rule 3110 and Rule 1240, FDA 21 CFR Parts 211 and 820, HIPAA workforce training requirement 45 CFR § 164.530 (b), eIDAS Regulation (EU) 2024/1183, and a functional equivalent thereof.
Clause 36. (DropShop™ Branded Instance) The universal substrate of Clause 5, wherein the DropShop™ branded instance is configured for an e-commerce system with embedded governance, selected from direct-to-consumer commerce, subscription commerce, B2B marketplace, regulated-goods commerce including pharmaceuticals alcohol and age-restricted products, curated editorial commerce, and a functional equivalent thereof, wherein the audit log satisfies FTC endorsement guidelines, applicable Unfair or Deceptive Acts or Practices statutes, state consumer protection laws, age-restricted-goods regulations, applicable export control laws including the Export Administration Regulations at 15 CFR Parts 730 to 774, applicable sanctions regulations administered by OFAC, and a functional equivalent thereof.
Clause 37. (Quote Engine™ Branded Instance) The universal substrate of Clause 5, wherein the Quote Engine™ branded instance is configured for a procurement system selected from supplier quoting, sealed-bid procurement, reverse-auction platform, governmental procurement, and a functional equivalent thereof, wherein the audit log satisfies the Federal Acquisition Regulation where applicable, applicable state procurement codes, and a functional equivalent thereof.
Clause 38. (Connection Drop™ Branded Instance) The universal substrate of Clause 5, wherein the Connection Drop™ branded instance is configured for a governed networking system selected from a dating application, a professional networking platform, a community platform, and a functional equivalent thereof, wherein the HumanMark™ Score is exposed as a numerical literal in profile and message contexts to expose synthetic-persona fraud, and wherein the audit log satisfies applicable consumer-protection statutes, anti-fraud provisions, GDPR, CCPA, BIPA, and a functional equivalent thereof.
Clause 39. (OrgDrop™ Branded Instance) The universal substrate of Clause 5, wherein the OrgDrop™ branded instance is configured for an intra-organization communications system selected from board communications, regulatory disclosures, internal investigation reports, executive briefings, and a functional equivalent thereof, wherein the audit log satisfies applicable provisions of the Sarbanes-Oxley Act, SEC disclosure rules, applicable industry-specific regulatory frameworks, and a functional equivalent thereof.
Clause 40. (Note Drop™ Branded Instance) The universal substrate of Clause 5, wherein the Note Drop™ branded instance is configured for ambient governed capture selected from meeting notes, interview transcripts, research journals, clinical records, and a functional equivalent thereof, wherein the audit log satisfies applicable record-keeping obligations per the consuming application domain.
Clause 41. (BrandLayer™ Branded Instance) The universal substrate of Clause 5, wherein the BrandLayer™ branded instance is configured as a governed brand-management substrate including brand-portal delivery, authorized-creator attestation, counterfeit detection, and a functional equivalent thereof, wherein the audit log satisfies trademark law including Lanham Act § 43 (a) false designation, Federal Trade Commission Act provisions, and a functional equivalent thereof.
Clause 42. (Aerospace Passenger-Experience Branded Instance) The universal substrate of Clause 5, wherein the branded instance is configured for governed in-flight content delivery in an aviation passenger system selected from seat-back infotainment, airline application content, in-flight WiFi captive portal, preflight-briefing content, and a functional equivalent thereof, wherein the audit log satisfies applicable FAA AI Safety Assurance advisory circulars, applicable EASA regulations, applicable IATA recommended practices, and a functional equivalent thereof.
Clause 43. (Governed Internet Deployment Branded Instance) The universal substrate of Clause 5, wherein the branded instance is configured as a browser-wide governance substrate enabling governed browsing across the open web, extending governance from per-artifact to per-session browsing, applicable to regulated-industry browsing, classified-environment browsing, parental-governed browsing, and a functional equivalent thereof.
Clause 44. (Resonance Identification Branded Instance) The universal substrate of Clause 5, wherein the branded instance is configured for digital phenotype matching including content-similarity attribution, styleprint verification, cover-song attribution, and a functional equivalent thereof, integrating with the Stylometric Fingerprint analyzer of Clause 25.
Clause 45. (EQVOS-Vertical Branded Instance) The universal substrate of Clause 5, wherein the branded instance is configured as the SignalDrop™-deployable slice of the EQVOS governance architecture, scoped to exclude upstream biometric and emotional-state sensing claimed in U.S. Provisional Patent Applications 63/822,651 and 63/815,849, and to include only the delivery-format aspects within SignalDrop™.
Clause 46. (Self-Energizing Substrate Branded Instance) The universal substrate of Clause 5, wherein the branded instance is configured to be delivered to or hosted on a self-energizing substrate deriving operating power from ambient energy gradients via harvesting of solar, mechanical vibration, thermal gradient, radio-frequency signal strength, biomechanical motion, or a functional equivalent thereof, wherein the harvesting pattern itself operates as the energy-pattern proof of Clause 54, supporting deployment in DDIL environments, disaster zones, military field operations, rural-area commerce without persistent power, and maritime or aviation in-transit scenarios.
Clause 47. (Branded-Instance Doctrine Sub-Clause) The universal substrate of Clause 5, wherein every branded instance inherits the eight enumerated properties without modification and specializes only along five enumerated configuration dimensions, such that any instance claiming a different governance architecture, a different cryptographic stack, a different ephemerality model, a different commerce pipeline, a different HumanMark™ Score, a different delivery-mode architecture, or a different audit architecture is outside the scope of the doctrine; and wherein design-around attempts based on renaming a branded instance under a different trademark fail because the doctrine operates on architectural property rather than on brand name.

### Payment Architectures

Clause 48. (Three-Stage Commerce Sub-Clause) The system of Clause 9, wherein the embedded commercial transaction capability comprises three sequential stages of pre-transaction explicit granular consent, transaction processing within the protected runtime without navigation to external domains, and post-transaction cryptographic receipt generation bound to the session audit chain.
Clause 49. (DriftCard™ Ephemeral Payment Credential Sub-Clause) The system of Clause 9, further comprising a DriftCard™ ephemeral payment credential integration wherein a single-use virtual card number is generated at checkout, the card is authorized for the exact transaction amount plus a configurable buffer, the card declines any subsequent authorization attempt, upon transaction completion the card is immediately invalidated and cannot be reused, and the card lifecycle is recorded in the session audit chain and dual-sink anchor.
Clause 50. (Distributed-Ledger Settlement Sub-Clause) The system of Clause 9, further comprising a distributed-ledger settlement integration wherein the artifact includes a blockchain-native payment channel configuration with channel identifier, participant addresses, and smart contract reference; the recipient's wallet implemented as one of MetaMask, WalletConnect-compatible wallet, hardware wallet, and a functional equivalent thereof signs a payment authorization transaction; the transaction is submitted to the distributed ledger for confirmation; upon confirmation the smart contract releases payment and generates a settlement record bound to the session audit chain.
Clause 51. (Governed Distributed Transaction Processing-Visa-Replacement Architecture) A computer-implemented system for governed distributed transaction processing, comprising: a plurality of participant nodes each comprising a local transaction-processing kernel; wherein each transaction execution at a participant node produces, as a computational byproduct of the execution itself rather than as a subsequent log entry, a transaction-validity attestation, a hash-chained transaction record, a payer-side proof-of-payment artifact, a payee-side proof-of-receipt artifact, a settlement-reconciliation artifact, and a tax-or-audit evidence artifact, each canonicalized under canonical CBOR per RFC 8949 § 4.2.1 and signed under Ed25519 per RFC 8032 over a SHA-3-256 digest; wherein the transaction record is held only by the participating parties without routing through a central clearing house and without third-party data retention; wherein settlement is finalized upon mutual signature exchange between the two participant nodes; wherein the system is operable in denied, degraded, intermittent, or low-bandwidth environments via deferred dual-sink anchor commit with exponential backoff; wherein the system is applicable to a financial-transaction processing system selected from a point-of-sale transaction-processing system, a peer-to-peer financial-transfer system, a card-network-replacement architecture, a bank-to-bank settlement system, a remittance-and-cross-border-transfer system, a micropayment system, a disaster-zone or denied-environment commerce system, a military field-transaction system operating in DDIL environments, a rural-area commerce system without persistent connectivity, a maritime or aviation in-transit purchase system, an offline retail commerce system, an offline business-to-business procurement settlement system, and a functional equivalent thereof; and wherein the system composes with the SignalDrop™ embedded commerce capability of Clause 9 such that a SignalDrop™ artifact may execute a governed distributed transaction wholly within the artifact's protected runtime.
Clause 52. (DriftCard™ Pay-Per-Governance-Event Billing Architecture) A computer-implemented commercial primitive for governance-event-based billing, comprising: a governance-event taxonomy enumerating event types selected from a drift-detection firing wherein a Cognitive Drift Index value crosses an operator-configurable threshold, a SAFE_HALT event halting artificial-intelligence output pending human review, a flagged intervention triggering human-in-the-loop escalation, a score-state-transition event crossing an HMS state boundary out of GREEN, a signature-verification-failure event, a TTL-expiration event, a dynamic-weight-renormalization event, an operator-configuration-hash-mismatch event, a biometric-liveness-attestation-failure event, and a functional equivalent thereof; wherein each governance event emits a governance-event record comprising event identifier, timestamp, monotonic event sequence number, cryptographic binding to the SDK-instance identity, reference to the content artifact and HumanMark™ Token where applicable, event-type enumeration, and an attestation signature over the foregoing; wherein governance-event records are append-only, participate in the dual-sink anchor root, and are priced according to an event-type price list specified in the licensee's DriftCard™ billing contract; wherein micropayment settlement per event is performed against either a prepaid licensee balance or an enterprise invoice cycle; and wherein under preferred embodiment governance-event records are cryptographically bound at time of firing and are independently auditable, creating a self-attesting billing record that cannot be reconstructed or disputed post-hoc.
Clause 53. (PUF-ZKP Hardware-Bound Zero-Knowledge Governance Attestation) A computer-implemented system for hardware-bound zero-knowledge governance attestation, comprising: a Physically Unclonable Function (PUF) primitive selected from SRAM-PUF, Arbiter-PUF, Ring-Oscillator-PUF, Optical-PUF, Bistable-Ring-PUF, Butterfly-PUF, and a functional equivalent thereof; a Zero-Knowledge Proof (ZKP) proof system selected from Groth16, PLONK, STARK, Halo2, Bulletproofs, and a functional equivalent thereof, wherein a PUF-derived device-fingerprint serves as the ZKP witness; wherein the PUF response is never transmitted or disclosed; wherein the ZKP certifies that a particular device-identity was present at a particular governance event without revealing which device; wherein the attestation is non-transferable, anti-clone, and hardware-bound; optionally composed with a Trusted Execution Environment in a Janus-class configuration wherein the TEE serves as the confidentiality-and-integrity layer and the PUF-ZKP serves as the identity-attestation layer, the TEE selected from Intel SGX, AMD SEV, ARM TrustZone, Apple Secure Enclave, and a functional equivalent thereof; and composable with the governed distributed transaction processing of Clause 51, the energy-pattern-as-proof primitive of Clause 54, and the Certificate Drop branded instance of Clause 35.
Clause 54. (Energy-Pattern-as-Proof-Harvesting-Pattern as Governance Witness) A computer-implemented system in which an energy-harvesting pattern of a self-energizing substrate serves as a cryptographic witness to a transaction or governance event, comprising: a self-energizing substrate deriving operating power from ambient energy gradients via harvesting of a source selected from solar irradiance, mechanical vibration, thermal gradient, radio-frequency signal strength, biomechanical motion, capacitive coupling, electromagnetic gradient, and a functional equivalent thereof; sampling logic capturing the harvesting pattern at sub-second resolution; aggregation logic computing a windowed hash of the harvesting pattern under SHA-3-256; binding logic including the windowed hash as a field in the attestation input set of Clause 7; wherein the harvesting pattern operates as a unique environmental fingerprint at a given location and time, providing proof of when and where the governance event occurred without GPS, without a timestamp server, without blockchain consensus, and without burning dedicated energy; wherein the architectural primitive establishes the § 101 Alice/Mayo eligibility anchor for the portfolio in that the proof is a residue of computation already performed and a residue of ambient environmental conditions already present, rather than a separate dedicated act; and composable with the PUF-ZKP primitive of Clause 53 (dual hardware-and-environment witnesses), with the governed distributed transaction processing of Clause 51 (location-and-time anchor for transactions in environments without GPS), and with the dual-sink anchor of Clause 30 (anchor commitment of the energy-pattern hash alongside the session root).
Clause 55. (Clause-Intersection A-B-Governance and Attestation Byproduct) The system of Clause 1, wherein the embedded runtime governance kernel of element (a) and the cryptographic byproduct attestation of element (b) are bound such that running the kernel necessarily produces the attestation and producing the attestation necessarily requires running the kernel, the binding implemented through interleaving of the eight-layer pipeline of Clause 4 with the attestation input-set accumulation, such that no kernel decision can be issued without contributing to the attestation and no attestation can be generated without a corresponding kernel decision.
Clause 56. (Clause-Intersection B-C—Self-Destructing Attestation Chain) The system of Clause 1, wherein the cryptographic byproduct attestation of element (b) and the session ephemerality of element (c) are bound such that the per-session attestation signing key is derived from the session nonce and is destroyed at session termination via explicit zero-overwrite, such that the attestation is verifiable against the externally anchored dual-sink root by any party but is not regeneratable from the session by any party including the originator, the binding implemented per Clause 8.
Clause 57. (Clause-Intersection C-D-Single-Use Payment with Mutual Destruction) The system of Clause 1, wherein the session ephemerality of element (c) and the embedded commerce of element (d) are bound such that a payment authorization is generated for single use within the session, the authorization is cryptographically bound to the session nonce and SDK-instance identifier, and at session termination the authorization, any temporary payment credentials, and the session-derived signing key are mutually destroyed via explicit zero-overwrite such that the payment record persists in the dual-sink anchor as evidence but cannot be re-presented or reused from the session.
Clause 58. (Clause-Intersection D-E-Dynamic Pricing on Verified Human-to-AI Ratio) The system of Clause 1, wherein the embedded commerce of element (d) and the continuous human-authorship attestation of element (e) are bound such that pricing of an offered good or service is dynamically adjusted based on the verified HumanMark™ Score state of the underlying content, with policy-driven rules permitting differential pricing for content of different attested human-authorship ratios, the binding implemented through commerce-policy hooks invoked at the Item Selection stage of Clause 9 conditioned on the HumanMark™ Score state of the artifact at render time.
Clause 59. (Clause-Intersection A-E-AI Constraints Adjusted by Target Authorship Ratio) The system of Clause 1, wherein the embedded runtime governance kernel of element (a) and the continuous human-authorship attestation of element (e) are bound such that the policy specification includes target HumanMark™ Score thresholds and the kernel dynamically adjusts content-generation constraints, refusal thresholds, and alternative-content selection logic to achieve or maintain the target ratio, the binding implemented through Layer 2 policy resolution and Layer 5 render gating using the live HumanMark™ Score as a continuous policy input.

### Anti-Replay, Crypto Stack, and Extension Surface

Clause 60. (Anti-Replay Triple-Bound Sub-Clause) The system of Clause 11, wherein anti-replay protection is implemented via a triple-bound mechanism comprising a 128-bit cryptographically random session nonce generated via Web Crypto API crypto.getRandom Values, binding of the nonce to an SDK-instance identifier such that the (nonce, SDK-instance identifier) pair is unique across distinct instances, and a bounded least-recently-used cache of recently seen nonce-and-instance pairs maintained by verifiers.
Clause 61. (Post-Quantum Signature Sub-Clause) The system of Clause 7, wherein the attestation signature is implemented as a post-quantum signature scheme selected from CRYSTALS-Dilithium ML-DSA per FIPS 204, Falcon, SPHINCS+, and a functional equivalent thereof, optionally hybrid-composed with a classical Ed25519 signature in a single envelope for migration-period deployments.
Clause 62. (Hardware-Rooted Key Storage Sub-Clause) The system of Clause 1, wherein the originator signing key is stored in a hardware-rooted key store selected from a platform Secure Enclave, a Trusted Platform Module, a Hardware Security Module, threshold-secret-shared distributed key generation, FIDO2 resident-key storage, and a functional equivalent thereof.
Clause 63. (Override Consent Sub-Clause) The system of Clause 12, wherein a RED HumanMark™ Score state or REFUSE render decision may be overridden through explicit recipient consent comprising presentation of an override solicitation explaining the governance violation and risks, capture of the recipient's explicit affirmative consent to override, recording of the override event in the audit trail with full context, downgrade of the render decision to ALLOW for the specific element subject to the override, and binding of the override decision to the session nonce such that the override is non-transferable across sessions.
Clause 64. (Decryption-Triggered Attestation Sub-Clause) The system of Clause 8, wherein successful decryption of content segment N within a sequentially-encrypted artifact triggers attestation generation for content segment N+1, such that progressive content rendering produces progressive attestation records and incomplete rendering produces incomplete attestation records, providing render-coverage evidence as a byproduct of normal content consumption.
Clause 65. (Modality-Aware Canonicalization Sub-Clause) The system of Clause 7, wherein content hash canonicalization is modality-specific, comprising Unicode NFC normalization for text content, lossless re-encoding or raw-pixel hashing for image content, Pulse-Code Modulation to FLAC normalization for audio content, elementary-stream demultiplex for video content, and a functional equivalent thereof for additional modalities.

### Method Clauses for the Independent Inventions

Clause 66. (Method for Governed Distributed Transaction Processing) A computer-implemented method for governed distributed transaction processing, comprising: at a participant node, executing a transaction; producing as a computational byproduct of said executing a transaction-validity attestation, a hash-chained transaction record, a payer-side proof-of-payment artifact, a payee-side proof-of-receipt artifact, a settlement-reconciliation artifact, and a tax-or-audit evidence artifact each canonicalized under canonical CBOR and signed under Ed25519 over SHA-3-256; holding the transaction record only by the participating parties; finalizing settlement upon mutual signature exchange between two participant nodes; and committing the dual-sink anchor of the transaction record per the dual-sink architecture of Clause 30.
Clause 67. (Method for DriftCard™ Pay-Per-Governance-Event Billing) A computer-implemented method for governance-event-based billing, comprising: enumerating governance event types per the taxonomy of Clause 52; emitting a governance-event record at each event firing; cryptographically binding the record to the SDK-instance identity, the affected content artifact, and the dual-sink anchor; pricing the event according to an event-type price list specified in the licensee's billing contract; and settling the micropayment per event against a prepaid licensee balance or an enterprise invoice cycle.
Clause 68. (Method for PUF-ZKP Hardware-Bound Zero-Knowledge Attestation) A computer-implemented method for hardware-bound zero-knowledge governance attestation, comprising: deriving a device-fingerprint from a Physically Unclonable Function primitive of the device; generating a zero-knowledge proof using the device-fingerprint as the witness; certifying via the proof that a particular device-identity was present at a particular governance event without revealing the device-fingerprint or the device-identity to verifiers; and binding the proof to the attestation input set of Clause 7.
Clause 69. (Method for Energy-Pattern-as-Proof) A computer-implemented method for using a harvesting pattern of a self-energizing substrate as a cryptographic witness, comprising: at a self-energizing substrate, sampling the harvesting pattern at sub-second resolution; aggregating the harvesting pattern into a windowed hash under SHA-3-256; including the windowed hash as a field in the attestation input set of Clause 7; and providing thereby proof of when and where a governance event occurred without GPS, timestamp server, blockchain consensus, or dedicated energy expenditure.
Clause 70. (Wearable-Sensor Provenance Integration) The system of Clause 1, further comprising a wearable biosensor input channel integrated into the Provenance Verification analyzer and into the attestation input set, wherein the wearable biosensor comprises one of: a photoplethysmography sensor, an electrocardiogramsor, an inertial-measurement-unit-based kinematic sensor, an electrodermal-activity sensor, a skin-temperature sensor, an eye-tracker, a respiration-rate sensor, a continuous-glucose monitor, an accelerometer-coupled fall-detection sensor, a microphone-based prosodic sensor, and a functional equivalent thereof; and wherein the wearable biosensor output is bound to the attestation signature via a hardware-rooted key stored in a Trusted Platform Module, Secure Element, Secure Enclave, TrustZone, SGX/TDX enclave, or functional equivalent thereof.
Clause 71. (Open-Standard-Packaging) The system of Clause 1, wherein the single-file browser-executable payload is packaged as one of: an HTML file with inline ECMAScript and Cascading Style Sheets, a WebAssembly binary packaged with its runtime glue code, a Portable Document Format container executing embedded JavaScript per ISO 32000-2, a Scalable Vector Graphics document containing scripting, a W3C WebPackage signed-exchange bundle, an Electronic Publication (EPUB) container with embedded scripting, an MHTML web archive, a Data URI-encoded bundle, an Open Container Initiative image executed in a sandboxed runtime, a Tauri or Electron bundle, and a functional equivalent thereof; wherein the Clause does not require, and is not limited by, the choice of packaging format provided that the entire payload executes without external runtime installation and without network dependency beyond initial retrieval.
Clause 72. (Transport-Mechanism) The system of Clause 1, wherein delivery of the single-file browser-executable artifact to the recipient occurs via one of: Hypertext Transfer Protocol Secure (HTTPS), electronic mail attachment, Short Message Service or Multimedia Message Service transport, peer-to-peer Web Real-Time Communication (WebRTC) data channel, InterPlanetary File System (IPFS), Bluetooth Object Exchange Protocol (OBEX), Long-Range Wide-Area Network (LoRaWAN) transport, Near-Field Communication (NFC) tap, quick-response (QR) code optical transport, physical removable media (Universal Serial Bus mass storage, Secure Digital card, optical disc), store-and-forward sneakernet, postal service, airline in-flight entertainment bus, and a functional equivalent thereof; wherein transport mechanism is agnostic to the inventive contribution and the Clause is not limited by the transport pathway.
Clause 73. (Signature-Scheme-Post-Quantum Inclusion) The system of Clause 1, wherein the cryptographic signature securing the byproduct attestation is implemented as one of: Ed25519 per RFC 8032, Ed448 per RFC 8032, ECDSA over NIST P-256 or P-384 or P-521 per FIPS 186-5, RSA-PSS per RFC 8017, Dilithium (CRYSTALS-Dilithium) per NIST FIPS 204, Falcon per NIST standardization, SPHINCS+per NIST FIPS 205, hybrid classical/post-quantum concatenation, and a functional equivalent thereof; and wherein key rotation, key escrow, threshold signing (t-of-n), and quorum-multiparty computation signing are disclosed as equivalent key-management dispositions.
Clause 74. (Policy-Specification Format) The system of Clause 1, wherein the machine-readable policy specification against which the embedded runtime governance kernel evaluates each render-time decision is expressed in one of: Open Policy Agent Rego, WebAssembly System Interface (WASI) policy modules, JSON Schema with constraint annotations, YAML with Common Expression Language predicates, LISP-family S-expressions, Prolog, and a functional equivalent thereof; wherein the Clause is not limited by the surface syntax of the policy specification provided that the specification is machine-evaluable at render time within the recipient browser without network dependency.
Clause 75. (Governance-Class Coverage-Method Widening) A method for governed artificial-intelligence content delivery comprising the steps of Clause 2, wherein the governance classification is one of ALLOW, REFUSE, REFUSE_WITH_ALTERNATIVE, ESCALATE, DELAY, DEGRADE, ANNOTATE, REDACT, SUBSTITUTE, and a functional equivalent thereof, wherein the governance kernel is permitted to return any ordered or unordered disposition from the enumerated set or an equivalent disposition having the same external behavior; and wherein the Clause reaches any governance system that routes render-time decisions through policy-driven classification regardless of the particular disposition vocabulary adopted.
Clause 76. (Cross-Modal Content Coverage-Clause Widening) The system of Clause 1, wherein the artificial-intelligence-generated or artificial-intelligence-assisted content rendered by the artifact comprises one of: natural-language text, still images (including raster and vector), audio recordings (including speech, music, and ambient soundscape), video (including short-form, long-form, immersive 360°), three-dimensional meshes, augmented-reality and virtual-reality scene graphs, code artifacts (source, intermediate representation, and binary), decision and actuation records, physical-action plans for robotic systems, multimodal compositions combining any of the foregoing, and a functional equivalent thereof, wherein modality-specific modulation factors γ_text=1.0, γ_image=0.8, γ_audio-0.9, γ_video=0.85, and analogous factors for additional modalities disclosed herein or functional equivalents thereof, are applied without loss of generality.
Clause 77. (Protected Browser/SGK Runtime-Independent Apparatus Clause) An apparatus comprising a protected browser runtime for delivery of the single-file browser-executable artifact of Clause 1, wherein the protected browser runtime comprises: a sandboxed execution environment enforcing Subresource Integrity per W3C Subresource Integrity Recommendation; a restrictive Content Security Policy disabling remote script execution, inline event handlers absent a nonce or hash, and form-submission to non-whitelisted origins; a storage-disabled context suppressing IndexedDB, localStorage, sessionStorage, Cache API, and File System Access API; a developer-tools-resistant execution mode disabling DevTools inspection, view-source export, and programmatic introspection of the execution context; and an attestation channel permitting the runtime to report its integrity state to the embedded governance kernel prior to kernel activation; wherein the protected browser runtime is implemented as one of: an Electron-based shell with disabled dev tools, a Tauri application, a Chromium Embedded Framework embedding, a WKWebView (iOS) restricted context, an Android Web View in kiosk mode, a Progressive Web App with installed-origin scope, a server-delivered client-side sandboxed iframe with restrictive sandbox attribute, a Trusted Execution Environment-hosted headless browser, and a functional equivalent thereof; and wherein the Clause is independently inventive from Clause 4 in that it protects the delivery client rather than the governance kernel.
Clause 78. (Branded-Instance Extension-Any Vertical) The universal substrate of Clause 5, further comprising a branded instance configured for one or more of: legal-services delivery including legal opinions, memoranda of advice, deposition summaries, and privileged communications; accounting and audit delivery including tax-return drafts, audit opinions, financial-statement reviews, and regulatory disclosure filings; pharmaceutical and life-sciences delivery including clinical-trial protocols, informed-consent forms, investigator brochures; insurance delivery including policy quotes, claims adjudication records, medical-necessity determinations, and actuarial reports; government and civic delivery including benefit-eligibility determinations, permit and licensing dispositions, public-records responses, and judicial filings; election-integrity and civic-engagement applications including voter communications bearing authorship attestation; journalism and media delivery including attributed news articles, broadcast scripts, and documentary productions with continuous human-authorship attestation; creative-industry delivery including licensed music, film, literary, and visual-arts works with provenance bound at creation; and a functional equivalent thereof, wherein the Clause reaches any vertical not specifically enumerated provided the branded instance inherits the eight-property embodiment and specializes along the five configuration dimensions.

### HumanMark

Clause 79. A human-provenance attestation system comprising: an ingestion interface configured to receive a digital media artifact comprising text, image, audio, video, decision, or hybrid content; a creation-side observation module configured to instrument a content-creation environment and to produce a running attribution record of each input event observed therein, said observation module comprising a paste-event detector, a keystroke-event detector, a voice-dictation detector, an artificial-intelligence-suggestion accept/reject/edit detector, an autocomplete-acceptance detector, a drag-and-drop detector, and a file-upload detector, wherein each input event is classified under an input-method taxonomy and assigned a human-attribution weight; an embedding extraction engine configured to generate a primary high-dimensional dense embedding via a transformer-based text-embedding model, or alternatively a sentence-transformer, convolutional-neural-network, recurrent-neural-network, vision-transformer, or any neural-network-based dense vector representation of ≥512 dimensions; a stylometric analysis engine configured to extract a feature vector of stylometric features and to compute a stylometric entropy score and a stylometric fidelity score via a gradient-boosting classifier ensemble or equivalent supervised binary classifier; a generative-artifact detector configured to compute a generative-artifact score via a fine-tuned transformer discriminator or equivalent classifier; a provenance-validation module configured to compute a provenance-validity score based on any of: the running attribution record of the observation module, a keystroke-dynamics vector, a biometric liveness attestation, a camera or microphone device attestation, an editing-session continuity log, and a validated C2PA manifest; a composite scoring engine configured to compute a raw human-mark score as a weighted linear combination of the stylometric entropy score multiplied by a first weight, the stylometric fidelity score multiplied by a second weight, one minus the generative-artifact score multiplied by a third weight, and the provenance-validity score multiplied by a fourth weight; a calibration module configured to transform the raw human-mark score into a calibrated probability via Platt scaling or equivalent monotonic calibration; a multi-state classifier configured to assign the calibrated probability into one of at least three disposition states with hysteresis; a binding module configured to serialize the calibrated probability, the disposition state, the input-method histogram derived from the observation module, and a timestamp into a canonical data representation via canonical CBOR or equivalent deterministic serialization, and to affix a cryptographic signature via Ed25519 or equivalent signature scheme producing a fixed-length publicly verifiable binding; an attestation registry configured to store the signed serialized data in an append-only tamper-evident data structure; and an output interface configured to emit a human-mark token bound to the digital media artifact, wherein the emitted token is always embedded into the digital media artifact and wherein visual display of a corresponding indicator is independently controllable at emission time.
Clause 80. A computer-implemented method for human-provenance attestation of digital media artifacts, the method comprising: receiving a digital media artifact; instrumenting a content-creation environment and observing a plurality of input events comprising keystroke events, paste events, voice-dictation events, artificial-intelligence-suggestion accept/reject/edit events, autocomplete acceptances, drag-and-drop events, and file uploads; assigning each input event a human-attribution weight under an input-method taxonomy; computing a running human-authorship ratio as the sum of human-attributed content magnitudes divided by the sum of all content magnitudes; extracting embedding and stylometric features of the artifact; computing a generative-artifact score and a provenance-validity score; computing a raw human-mark score as a weighted linear combination with locked weights of approximately 0.28, 0.32, 0.25, and 0.15 respectively and with the generative-artifact contribution inverted; calibrating the raw score via Platt scaling with slope approximately 0.45 and intercept approximately 0.18; classifying the calibrated probability into at least three states with approximately plus-or-minus two points of hysteresis; serializing via canonical CBOR; signing with Ed25519 over a SHA-3-256 digest of the signing payload; embedding the signed token into the digital media artifact via a modality-specific embedding mechanism at the point of creation, editing, or publication; storing the signed data in an append-only tamper-evident registry; and emitting a HumanMark™ token bound to the artifact, wherein the token is always embedded and visual display of a corresponding indicator is independently controllable at emission time.
Clause 81. A non-transitory computer-readable storage medium storing instructions that, when executed by one or more processors, cause the one or more processors to perform the method of Clause 80.
Clause 82. A computer-implemented method of cryptographic-licensing of content attestation, the method comprising: maintaining at a licensing authority a registry of write-license-authorized public keys, each such public key corresponding to an Ed25519 or equivalent cryptographic identity held under a valid and active write license conferring the right to emit human-mark tokens; receiving from a candidate licensee an application for a write license in one of a plurality of write-license tiers comprising at least a Platform tier, a Professional tier, and a Consumer tier; upon issuance of the write license, registering the candidate licensee's cryptographic identity to the registry; and thereafter accepting into the attestation registry only human-mark tokens signed by public keys present on said registry of write-license-authorized public keys, such that a party lacking a registered write license is architecturally prevented from issuing human-mark tokens recognized by downstream verifiers; wherein the Platform tier is licensed to content-creation platforms, authoring infrastructures, artificial-intelligence output pipelines, content-management systems, and publishing infrastructures; wherein the Professional tier is licensed to specialist authoring platforms on a per-seat or per-document basis; and wherein the Consumer tier is licensed to consumer content-creation applications on a per-document-at-volume basis.
Clause 83. A computer-implemented method of cryptographic-licensing of content verification, the method comprising: maintaining at a licensing authority a registry of read-license-authorized public keys, each such public key corresponding to an Ed25519 or equivalent cryptographic identity held under a valid and active read license conferring the right to request enriched verification of human-mark tokens, said enriched verification comprising at least one of: non-revocation proof generation, Merkle-proof reconstruction, registry-wide audit-trail lookup, and bulk verification of a plurality of tokens; receiving from a candidate licensee an application for a read license in one of a plurality of read-license tiers comprising at least an Enterprise tier, a Professional tier, and a Consumer tier; upon issuance, registering the candidate's cryptographic identity; and thereafter serving enriched verification responses only to requestors whose request signatures resolve to public keys present on said registry of read-license-authorized public keys, such that a party lacking a registered read license is architecturally prevented from obtaining full registry-backed verification of human-mark tokens; wherein the Enterprise tier is licensed to courts, regulators, insurers, publishers, broadcast networks, and similar entities; wherein the Professional tier is licensed to journalists, editors, human-resources professionals, academics, and peer reviewers on a monthly-subscription basis; and wherein the Consumer tier is licensed to dating applications, social platforms, and individual consumer users on a monthly-subscription or per-use basis.
Clause 84. A content-provenance attestation and verification system comprising a write-license subsystem per the method of Clause 82, a read-license subsystem per the method of Clause 83, and an append-only tamper-evident registry of issued human-mark tokens, the combination of write-license subsystem and read-license subsystem being so architecturally coupled that: (a) a human-mark token cannot be validly generated without a write license, by virtue of cryptographic gating of token-issuance authority to write-license-registered public keys; (b) a human-mark token cannot be fully verified with respect to registry state, non-revocation, and audit-trail binding without a read license, by virtue of cryptographic gating of enriched verification service to read-license-registered public keys; and (c) every content-provenance transaction under the system requires both a valid write license at time of creation and a valid read license at time of verification, thereby creating a bidirectional proprietary lock-in in which the right to emit scored tokens and the right to verify scored tokens are separately and jointly required, are separately and jointly cryptographically enforced, and are separately and jointly commercially licensable, such that content stamped under a write license can only be cryptographically verified under a read license and vice versa.
Clause 85. A computer-implemented method of governed distributed transaction processing, the method comprising: executing a commercial, financial, or value-bearing transaction between two or more participant nodes in a distributed system, wherein each participant node executes the transaction locally; producing, as a computational byproduct of the transaction execution and not as a subsequent log entry, a governance receipt comprising at least one of: (a) a transaction-validity attestation generated at execution, (b) a hash-chained transaction record held only by the participants, (c) a payer-side proof-of-payment, (d) a payee-side proof-of-receipt, (e) a settlement-reconciliation artifact, (f) a tax-or-audit evidence artifact reproducible on demand by either participant, and (g) a dispute-resolution artifact bindable to a third-party arbiter only with the participants' joint consent; signing the governance receipt with Ed25519 or equivalent producing a fixed-length publicly verifiable binding over a SHA-3-256 digest of a canonical-CBOR encoding of the receipt; hash-chaining the receipt with the participant's prior receipt sequence; finalizing settlement upon mutual signature exchange between the participant nodes without routing through any central clearing house and without third-party data retention; and retaining the record exclusively among the participants; wherein the transaction is of a type selected from point-of-sale, peer-to-peer financial transfer, card-network-replacement, bank-to-bank settlement, remittance and cross-border transfer, micropayment, disaster-zone or denied-environment commerce, military field transaction in denied-degraded-intermittent-low-bandwidth environments, rural commerce without persistent connectivity, maritime or aviation in-transit purchase, offline retail, and offline business-to-business procurement; and wherein the architecture is characterized by being both decentralized—in that it requires no central clearing house—and efficient—in that it requires no global-consensus proof-of-work or proof-of-stake energy expenditure.
Clause 86. A computer-implemented method of event-based billing for AI-governance operations, the method comprising: enumerating a plurality of governance event types, said event types including at least: a drift-detection firing corresponding to a cognitive-drift-index value crossing an operator-configurable threshold, a safe-halt event corresponding to a governance enforcement action halting artificial-intelligence output pending human review, a flagged-intervention event corresponding to a policy-engine determination triggering human-in-the-loop escalation, a score-state-transition event corresponding to a human-mark score crossing a state threshold, and a signature-verification-failure event; detecting occurrence of one or more such governance events at a governance-enforcement kernel or a software development kit instance thereof; generating, for each detected governance event, a governance-event record comprising an event identifier, a timestamp, a monotonic sequence number, a cryptographic binding to the enforcing instance's identity, a reference to any content artifact and token affected, and an attestation signature over the foregoing; appending the governance-event record to an append-only tamper-evident registry; and settling a commercial billing amount against the licensee corresponding to the detected governance event according to an event-type price list specified in the licensee's billing contract, such that the billing unit is the governance event itself rather than a seat, a subscription period, or a content-item count; wherein the settlement is performed either against a prepaid licensee balance or against an enterprise invoice cycle; and wherein the cryptographic binding of the governance-event record to the registry and to the enforcing instance's identity renders the billing record self-attesting and non-reconstructable after the fact.
Clause 87. The system of Clause 79, wherein the composite scoring engine computes the raw human-mark score according to HMS_raw=w_SE·SE+w_SF·SF+w_GA·(1−GA)+w_PV·PV, with w_SE≈0.28, w_SF≈0.32, w_GA≈0.25, w_PV≈0.15, summing to unity, and wherein the generative-artifact contribution is inverted as (1−GA) because GA natively measures likelihood of artificial generation rather than human authorship.
Clause 88. The system of Clause 79, further comprising a dynamic renormalization module configured, when one or more analyzer channels is unavailable, to compute an active weight sum S_active=Σ_cm_c·w_c and renormalized weights w′_c=(m_c·w_c)/S_active such that Σw′_c=1.0; and wherein if S_active=0 the system transitions to an UNVERIFIABLE state.
Clause 89. The system of Clause 79, wherein the multi-state classifier implements a six-state finite state machine with three quantitative states (GREEN≥85, AMBER 40-84, RED≤39) and three override states (UNVERIFIABLE, TAMPERED, EXPIRED), and wherein a hysteresis band of approximately ±2 points is applied at each quantitative threshold to prevent oscillatory state transitions.
Clause 90. The system of Clause 79, wherein the calibration module applies Platt scaling HMS_calibrated=1/(1+exp(−(α·HMS_raw+β))) with composite parameters α≈0.45, β≈0.18, and wherein the stylometric entropy sub-score is separately Platt-calibrated with α≈0.35, β≈0.12 prior to composite entry.
Clause 91. The system of Clause 79, wherein the binding module serializes the token under canonical CBOR (RFC 8949 § 4.2.1) with lexicographically sorted map keys and affixes an Ed25519 signature computed over the SHA-3-256 digest of the signing payload; and further comprising an anti-replay module embedding a cryptographically unpredictable nonce into each token.
Clause 92. The system of Clause 79, wherein the creation-side observation module, in a web-browser embodiment, comprises instrumentation via the Clipboard API for paste-event detection and paste-source inspection, the Keyboard Events API for keystroke capture with millisecond timestamps and typing-cadence biometric signal extraction, the Web Speech API for voice-dictation attribution, the Pointer Events API for cursor trajectory and drag-and-drop tracking, Web Workers for background scoring computation, WebGPU for local machine-learning inference, and a WebAuthn or FIDO2 authenticator for hardware-rooted biometric liveness attestation.
Clause 93. The system of Clause 79, wherein the creation-side observation module distinguishes paste-from-human-source events from paste-from-artificial-intelligence-source events and assigns attribution weights accordingly, and wherein the running attribution record produces a live-updating human-mark score displayable to the creator during content authoring.
Clause 94. The system of Clause 79, wherein the input-method taxonomy comprises: keystroke entry, voice dictation, artificial-intelligence-suggestion acceptance without edit, artificial-intelligence-suggestion acceptance with edit, paste from human source, paste from artificial-intelligence source, autocomplete acceptance, drag-and-drop insertion, and file upload; and wherein each taxonomic category is assigned a separate human-attribution weight reflecting its human-authorship contribution.
Clause 95. The system of Clause 79, further comprising a section-level aggregation engine configured to partition the artifact into a plurality of sections, compute a section-level human-mark score for each section, and aggregate via weighted harmonic mean HMS_section=1/Σ_i (γ_i/max (s_i, ε)) with modality-specific weights γ_text≈1.0, γ_image≈0.8, γ_audio≈0.9, γ_video≈0.85.
Clause 96. The system of Clause 79, wherein the output interface embeds the emitted HumanMark™ token into the digital media artifact via a modality-specific embedding mechanism selected from: EXIF UserComment, XMP metadata, C2PA assertion, PNG tEXt or iTXt, JPEG APP11, ID3v2 TXXX, RIFF WAV LIST, FLAC Vorbis comments, Opus comment headers, MP4 uuid box, Matroska tag, HLS manifest extension, MPEG-DASH SupplementalProperty, PDF/Metadata XMP stream, Unicode variation selectors, zero-width joiner/non-joiner keyed pseudorandom patterns, hidden HTML comments, HTTP Link headers with relation humanmark, JSON-LD blocks, and .hmt sidecar file.
Clause 97. The system of Clause 84, wherein the Certification Authority tier operates as a third licensing layer above the write and read subsystems, each Certification Authority being licensed under a royalty arrangement and a maximum-count ceiling in a given regulated jurisdiction, and each Certification Authority having registry-write privileges for legally binding attestations, the ability to govern threshold policy, and the authority to revoke tokens.
Clause 98. The system of Clause 84, wherein a visual display indicator rendering the calibrated probability is freely displayable by any party holding a valid token without a read license, while cryptographic verification of the token requires a valid read license, such that visual display operates as a freemium layer and cryptographic verification operates as the licensed revenue surface.
Clause 99. The system of Clause 79, wherein the attestation registry comprises at least one of: an append-only Merkle log with periodic root notarization; a Certificate-Transparency-style dual-log architecture with independent log operators; a permissioned blockchain ledger with Byzantine-fault-tolerant consensus; and a distributed notarization service with threshold-cryptographic multi-signature quorum; and wherein a revocation list indexed by issuer public key is maintained as a separately append-only structure.
Clause 100. The system of Clause 92, further comprising a biometric-drop classification module configured to classify a biometric liveness attestation into one of: a Tier-1 Standard drop requiring no biometric verification, a Tier-2 Secured drop requiring WebAuthn/FIDO2 biometric verification, and a Tier-3 Government-and-Military drop requiring Tier-2 plus at least one additional attestation selected from a possession-factor attestation, a TPM attestation, and a multi-party M-of-N authorization.
Clause 101. The system of Clause 79, wherein the stylometric analysis engine extracts a 187-dimensional feature vector comprising approximately 132 character-level n-gram distribution features, approximately 20 function-word frequency features, approximately 15 sentence-level structural features, approximately 2 vocabulary-richness features, approximately 2 entropy features, and approximately 16 syntactic-depth and part-of-speech transition features; and wherein the feature vector is classified by a gradient-boosting ensemble.
Clause 102. The system of Clause 79, wherein the embedding extraction engine is configured to fall back to a secondary dense embedding model comprising all-mpnet-base-v2 producing a 768-dimensional vector when a primary model comprising text-embedding-3-large producing a 3,072-dimensional vector is unavailable, with affine or multilayer-perceptron alignment between the two spaces.
Clause 103. The system of Clause 79, further comprising a consumer graphical user interface primitive configured to render a score display in the form of “Hi” followed by the two-digit integer score prominently with a subordinate “HumanMark Index” label and state-dependent color coding, wherein the primitive encodes a published five-band gauge: Hi 95-100 almost entirely human, Hi 70-90 human-led with artificial-intelligence assistance, Hi 30-60 collaborative, Hi 5-25 AI-generated with light human editing, and Hi 0-5 entirely machine-generated.
Clause 104. The system of Clause 103, wherein the visual encoding of the mark comprises a stroke-fill graphical element drawn to the percentage corresponding to the calibrated score, with the remaining unfilled portion of the stroke rendered in a distinguishing state, such that the proportion of filled stroke is visually proportional to the proportion of human authorship.
Clause 105. The system of Clause 79, further comprising a software-development-kit enforcement layer configured to intercept content-generation requests issued by a generative artificial-intelligence model and to condition emission of synthesized content upon prior validation of a write license, or alternatively to append a machine-generated provenance label, block emission pending human review, downgrade content priority, inject a watermark, or apply any policy-based enforcement action contingent on the presence or absence of a valid write license.
Clause 106. The system of Clause 79, further comprising a middleware adapter layer configured to intercept content-generation and content-distribution traffic between a client application and a generative artificial-intelligence inference endpoint without modification of the generative model weights, architecture, training data, inference code, or application-programming-interface contract, wherein the middleware adapter injects human-mark token validation calls upstream of content emission and token binding calls downstream of human-authored content ingestion.
Clause 107. The system of Clause 79, further comprising a label-generation module configured to render the disposition state into a jurisdiction-specific compliance label required by at least one of: Articles 50 and 52 of Regulation (EU) 2024/1689; the United States Federal Trade Commission endorsement guidelines; California AB-2655 and AB-2355; Tennessee Public Chapter 878; the United Kingdom Online Safety Act; India's proposed deepfake provisions under the Information Technology Act; and the People's Republic of China Administrative Provisions on Deep Synthesis Internet Information Services.
Clause 108. The system of Clause 79, further comprising a threshold-configuration interface exposing state-transition thresholds to an authorized operator for modification, wherein a first threshold is operator-configurable in approximately 70-95, a second threshold is operator-configurable in approximately 20-60, and a hysteresis band is operator-configurable in approximately 0-10 points, with all threshold changes immutably logged to the attestation registry.
Clause 109. The system of Clause 79, further configured for operation across vertical deployments including legal AI-assisted filings with post-Heppner SDNY privilege considerations and Levidow-Levidow-Oberman and Morgan & Morgan sanction-avoidance considerations; medical diagnostic and patient-record attestation with FDA SaMD AI/ML submissions; broadcast and streaming content with persistently rendered Hi badge rendering analogous to content-rating badges; journalism source-material verification; dating-application verified-human premium tier; academic-integrity adjudication; industrial and physical actuation scoring for robotic, autonomous-vehicle, medical-device, manufacturing, and infrastructure systems; pharmaceutical and life-sciences regulatory submissions under 21 CFR Part 11; and insurance-claim, medical-record, legal-filing, and financial-disclosure verification.
Clause 110. The system of Clause 79, wherein the attestation mechanism operates creation-side by observing a content-creation process at its moment of inception and producing a cryptographically signed record of observed events, rather than operating detection-side by statistical inference over completed content, such that the system produces an eyewitness attestation of authorship rather than a probabilistic reconstruction.
Clause 111. The system of Clause 79, wherein an emitted human-mark token is always embedded into the digital media artifact at the point of creation, editing, or publication, and wherein visual display of a corresponding indicator is independently configurable by the creator at emission time, such that every scored artifact carries a cryptographically verifiable score whether or not any visual indicator is rendered.
Clause 112. The system of Clause 86, wherein an enumerated governance event type further comprises at least one of: a timestamp-to-live expiration event, a registry-revocation event, a dynamic-weight-renormalization event, an operator-configuration-hash-mismatch event, and a biometric-liveness-attestation-failure event; and wherein the event-type price list is specified per enumerated type in the licensee's billing contract.
Clause 113. The system of Clause 85, further comprising integration with the system of Clause 84 such that the bidirectional write-read licensing architecture of Clause 84 governs the issuance and verification of governance receipts for governed distributed transactions, thereby extending the dual-license lock-in from content-provenance transactions to financial-provenance transactions.

### Synthetic Octopus

Clause 114. (Synthetic Octopus System) A self-powered, self-governed, edgeless computing substrate, comprising: a flexible substrate comprising polyimide, polyethylene naphthalate, or a functional equivalent thereof; five integrated ambient-energy-harvesting layers disposed on the flexible substrate, comprising: a photovoltaic layer; a thermoelectric layer; a piezoelectric layer, a triboelectric layer, or a functional equivalent thereof; a radio-frequency harvester layer; and a magneto-optical harvester layer comprising bismuth-substituted rare-earth iron garnet of formula Bi_xRE_yFe_5O_12, where RE is selected from yttrium, gadolinium, terbium, dysprosium, holmium, erbium, thulium, ytterbium, lutetium, and a functional equivalent thereof; wherein the magneto-optical harvester layer simultaneously performs, within the same material volume: energy harvesting via the Faraday effect, non-volatile data storage via magnetic domain states, and optical actuation via photon-magnon coupling; a power-management integrated circuit aggregating output of the five harvesting layers into a common energy storage element; a compute layer integrated on the flexible substrate and powered exclusively by the aggregated harvested energy; an embedded governance kernel executing on the compute layer, the kernel executing policy-gated artificial-intelligence inference through a multi-layer pipeline including render-time gating and byproduct attestation; a physically unclonable function primitive integrated into the flexible substrate, the primitive deriving a cryptographic response from sub-micron manufacturing variations unique to each substrate instance; a governance policy pack cryptographically bound to the physically unclonable function response such that the policy pack decrypts correctly only on the substrate instance whose physically unclonable function response matches the policy-pack binding; a trust boundary coextensive with the material boundary of the flexible substrate, wherein the cryptographic keys authenticating the governance policy and signing attestation artifacts cannot be extracted without destroying the physical structure producing them and any physical alteration of the flexible substrate alters the physically unclonable function response and invalidates every bound artifact; a physical-refusal tamper-response state machine configured to transition, upon detection of a tamper event, to one or more graduated physical-refusal states comprising a power-gate refusal state, a clock-stop refusal state, and a structural-fuse refusal state, wherein in each refusal state the substrate physically ceases to operate without dependence on software logging, monitoring, or network connectivity; and an edgeless-operation configuration in which the substrate operates without connection to a data center, a cloud inference endpoint, a centralized policy server, a centralized audit database, a centralized license-key server, or an electrical grid.
Clause 115. (Method—Edgeless Operation Process) A computer-implemented method for operating an edgeless self-powered self-governed artificial-intelligence substrate, the method comprising: harvesting ambient energy at a flexible substrate from at least five harvester types comprising a photovoltaic layer, a thermoelectric layer, a piezoelectric or triboelectric layer, a radio-frequency harvester layer, and a magneto-optical harvester layer comprising bismuth-substituted rare-earth iron garnet; aggregating the harvested energy through a power-management integrated circuit into a common energy storage element; using the aggregated harvested energy to power a compute layer integrated on the flexible substrate; deriving a cryptographic response from a physically unclonable function primitive integrated into the flexible substrate, the response derived from sub-micron manufacturing variations unique to the substrate instance; decrypting a governance policy pack cryptographically bound to the physically unclonable function response; executing policy-gated artificial-intelligence inference through a multi-layer kernel pipeline at the compute layer; producing, as an inseparable computational byproduct of said executing, a cryptographic attestation signature bound to the substrate through inclusion of the physically unclonable function response in the attestation input set; storing non-volatile data in magnetic domain states within the magneto-optical layer; actuating output signals through photon-magnon coupling in the magneto-optical layer under kernel control; monitoring the substrate for tamper events through periodic re-measurement of the physically unclonable function response and comparison against the policy-bound fingerprint; transitioning, upon detection of a tamper event, to a physical-refusal state selected from power-gate refusal, clock-stop refusal, and structural-fuse refusal; and committing, optionally and deferrable under denied-degraded-intermittent-low-bandwidth conditions, the attestation hash chain root to a dual-sink external anchor.
Clause 116. (Computer-Readable Medium) A non-transitory computer-readable medium storing instructions that, when executed by a processor of an edgeless self-powered substrate per Clause 114, cause the substrate to perform the method of Clause 115.
Clause 117. (Apparatus-Unified Magneto-Optical Layer) An apparatus comprising: a flexible substrate; a layer of bismuth-substituted rare-earth iron garnet disposed on the flexible substrate, the layer having formula Bi_xRE_yFe_5O_12 where RE is selected from yttrium, gadolinium, terbium, dysprosium, holmium, erbium, thulium, ytterbium, lutetium, and a functional equivalent thereof, and where 0<x≤3−y and 0≤y≤3; wherein said layer simultaneously performs, within the same material volume: (a) energy harvesting via the Faraday effect from incident electromagnetic radiation coupled with a bias magnetic field, producing harvested current coupled to a power-management circuit; (b) non-volatile binary data storage via persistent magnetic domain states in lithographically-defined domain cells, with write operations performed via integrated micro-coils, spin-orbit-torque switching structures, or a functional equivalent thereof, and read operations performed via magneto-optical Kerr effect, Hall-effect sensing, or a functional equivalent thereof; and (c) optical actuation of output signals via photon-magnon coupling between coherent magnon modes and optical or surface-acoustic output channels under external control; whereby the same material volume functions as harvester, memory, and actuator without physical separation between these functions.
Clause 118. (Distributed Cognition Mesh—Synthetic Octopus Architecture) A distributed cognition system comprising: a plurality of substrate instances per Clause 114, each substrate instance being a complete self-powered self-governed computing unit; inter-substrate signaling paths between the substrate instances comprising passive backscatter modulation of ambient radio-frequency energy compliant with Title 47 C.F.R. Part 15, optical signaling via photon-magnon coupling in the magneto-optical layers, or a functional equivalent thereof, preserving zero-external-power operation of the mesh; a mesh-level governance policy replicated across the substrate instances with threshold-cryptographic recovery, such that loss of a minority subset of substrate instances does not compromise mesh-level governance integrity; mesh-level inference decomposition logic partitioning inference tasks exceeding single-substrate compute capacity across the plurality of substrate instances under cryptographic composition, wherein no single substrate instance observes the complete inference input or output; local autonomy configuration wherein each substrate instance continues operation under local governance policy when mesh-level communication is unavailable; and a no-single-point-of-failure property wherein disabling any single substrate instance does not disable the mesh and the remaining substrate instances continue to operate, produce attestation, and serve mesh-level inference under redistributed workload.

### Core Architecture

Clause 119. (Five-Source Harvest Envelope) The system of Clause 114, wherein under typical indoor-ambient operating conditions the aggregated harvested-energy envelope exceeds a minimum of approximately 1,500 microwatts per 10 square centimeters of substrate area (with a typical value of approximately 2,015 microwatts and an expected measurement window of approximately 1,800 to 2,200 microwatts), meeting or exceeding the continuous power draw of the embedded governance kernel executing a full multi-layer pipeline.
Clause 120. (Biofuel Harvester Dependent) The system of Clause 114, further comprising a biofuel harvester layer thermally isolated from the thermoelectric layer, the biofuel harvester operative to convert chemical energy from an organic fuel substrate into electrical output integrated through the power-management integrated circuit.
Clause 121. (Betavoltaic Harvester Dependent) The system of Clause 114, further comprising a betavoltaic harvester at or below the tritium exempt quantity threshold per Title 10 C.F.R. § 30.19, providing supplemental low-continuous electrical output integrated through the power-management integrated circuit and usable as a base-load source in environments where ambient harvesting is intermittent.
Clause 122. (Polyimide Substrate Species) The system of Clause 114, wherein the flexible substrate is polyimide of thickness between approximately 12.5 and 125 micrometers, with glass-transition temperature approximately 360 degrees Celsius permitting elevated-temperature deposition of integrated layers.
Clause 123. (PEN Substrate Species) The system of Clause 114, wherein the flexible substrate is polyethylene naphthalate (PEN) with glass-transition temperature approximately 125 degrees Celsius suitable for lower-temperature deposition processes.
Clause 124. (IGZO Compute Layer) The system of Clause 114, wherein the compute layer comprises thin-film transistor circuitry using indium-gallium-zinc-oxide (IGZO) active material with carrier mobility between approximately 10 and 30 square centimeters per volt second, supporting clock frequencies up to approximately 10 megahertz suitable for the governance kernel workload.

### PUF and Trust Boundary

Clause 125. (PUF Species—ReRAM) The system of Clause 114, wherein the physically unclonable function primitive comprises a resistive-random-access-memory PUF exploiting oxygen-vacancy distribution and conductive filament formation variations in a metal-oxide thin film selected from hafnium dioxide, tantalum pentoxide, titanium dioxide, and a functional equivalent thereof.
Clause 126. (PUF Species—Thin-Film Transistor Threshold) The system of Clause 114, wherein the physically unclonable function primitive comprises a thin-film transistor threshold-voltage PUF exploiting dopant-distribution variations in an active layer selected from indium-gallium-zinc oxide, amorphous silicon, low-temperature polycrystalline silicon, and a functional equivalent thereof.
Clause 127. (PUF Species—Crystal Lattice Defect in Garnet) The system of Clause 114, wherein the physically unclonable function primitive comprises a crystal-lattice-defect PUF exploiting point-defect distribution variation in the magneto-optical bismuth-substituted rare-earth iron garnet layer of Clause 117.
Clause 128. (PUF Species—Composite Multi-Source) The system of Clause 114, wherein the physically unclonable function primitive comprises a composite PUF deriving its cryptographic response from multiple substrate-intrinsic properties including at least two of electrical, magnetic, optical, and mechanical properties, the composite response exhibiting enhanced entropy compared to any single-property PUF and being bound to the substrate instance as a whole rather than to any single component.
Clause 129. (Policy-Pack Binding) The system of Clause 114, wherein the governance policy pack is encrypted against the physically unclonable function response via AES-256-GCM with a key derived from the physically unclonable function response via HKDF-SHA-3-256, such that relocation of the policy pack to a different substrate produces decryption failure, and such that modification of the substrate altering the physically unclonable function response invalidates the policy pack on its originating substrate.
Clause 130. (Trust Boundary Coextensive with Material Boundary) The system of Clause 114, wherein the cryptographic trust boundary of the substrate is coextensive with the physical material boundary of the flexible substrate such that: the cryptographic keys authenticating the governance policy and signing attestation artifacts cannot be extracted without destroying the physical structure producing them; any physical alteration of the substrate alters the physically unclonable function response; and said alteration is detectable at the next attestation cycle through comparison of the re-measured physically unclonable function response against the policy-bound fingerprint.

### Physical-Refusal Tamper Response

Clause 131. (Tier 1 Power-Gate Refusal) The system of Clause 114, wherein the power-gate refusal state comprises invalidation of working keys in the volatile key store upon detection of a tamper event, whereby harvested energy continues to flow and the compute layer continues to clock but the governance kernel cannot decrypt the policy pack and therefore cannot render any inference output, and wherein the state is recoverable through an authorized re-attestation procedure cryptographically binding a fresh policy pack to the current physically unclonable function response.
Clause 132. (Tier 2 Clock-Stop Refusal) The system of Clause 114, wherein the clock-stop refusal state comprises disablement of the substrate oscillator through a hardware control register protected by the physically unclonable function-bound key, whereby no clock signal is distributed to the compute fabric and the substrate enters a non-computing state.
Clause 133. (Tier 3 Structural-Fuse Refusal) The system of Clause 114, wherein the structural-fuse refusal state comprises triggering of structural fuses in critical interconnection paths of the compute layer and the magneto-optical layer, rendering the substrate permanently inoperative without physical replacement.
Clause 134. (Policy-Governed Tier Selection) The system of Clause 114, wherein the tamper-response tier invoked upon tamper detection is selected by the governance policy pack as a function of tamper severity classification, with minor physically-unclonable-function-drift events within the within-device reliability envelope triggering Tier 1, significant or repeated drift events triggering Tier 2, and structural-level tamper detection events triggering Tier 3.
Clause 135. (Self-Enforcement Property) The system of Clause 114, wherein the physical-refusal tamper response operates without dependence on software logging, monitoring services, network connectivity, or external infrastructure, the physical state of the substrate being itself the enforcement mechanism.

### Distributed Cognition Mesh

Clause 136. (Passive Backscatter Inter-Substrate Signaling) The system of Clause 118, wherein the inter-substrate signaling comprises passive backscatter modulation of ambient radio-frequency energy through switching of input impedance of an integrated antenna against the ambient radio-frequency field, compliant with Title 47 C.F.R. Part 15 passive-device rules, consuming only the harvested energy required to operate the switching element and producing no active radio transmission.
Clause 137. (Optical Inter-Substrate Signaling) The system of Clause 118, wherein the inter-substrate signaling comprises modulated optical signals emitted through photon-magnon coupling in the magneto-optical layer of a first substrate instance and received through operation of the photovoltaic layer of a second substrate instance in photodetection mode.
Clause 138. (Mesh-Level Inference Decomposition) The system of Clause 118, wherein inference tasks exceeding single-substrate compute capacity are partitioned across the plurality of substrate instances under a partitioning scheme cryptographically bound to the task identifier, each substrate executing its partition and producing a partial-result attestation signed under its own physically-unclonable-function-bound key, and wherein an aggregation substrate composes the partial results under a cryptographic composition scheme selected from threshold secret-sharing reconstruction, additive homomorphic composition, secure multi-party computation, and a functional equivalent thereof.
Clause 139. (Local Autonomy Under Connectivity Failure) The system of Clause 118, wherein each substrate instance continues operation under its local governance policy when mesh-level communication is unavailable, such that each substrate preserves local inference, local actuation, and local attestation without re-attachment to a central authority and without awaiting restoration of mesh-level communication.
Clause 140. (Threshold-Cryptographic Attestation Recovery) The system of Clause 118, wherein the mesh-level attestation hash chain root is replicated across a plurality of substrate instances with threshold-cryptographic recovery parameters such that loss of up to a configurable minority subset of substrate instances does not compromise the attestation integrity of the mesh.
Clause 141. (Distributed-Intelligence Architectural Properties) The system of Clause 118, wherein the mesh architecture exhibits each of a no-single-point-of-failure property, a local-autonomy property, and a direct-peer-signaling property, said properties operating in combination to preserve mesh-level inference and attestation integrity under disablement of any single substrate instance.

### Edgeless Operation and Deployment Envelopes

Clause 142. (Edgeless Operation Property) The system of Clause 114, wherein the substrate operates entirely without connection to a data center, a cloud inference endpoint, a centralized policy server, a centralized audit database, a centralized license-key server, or an electrical grid, with external interaction limited to optional deferred commitment of the audit hash chain root to a dual-sink registry anchor.
Clause 143. (DDIL Operation Mode) The system of Clause 142, wherein under denied-degraded-intermittent-low-bandwidth conditions the substrate continues full governance-kernel operation with audit entries retained in an encrypted local queue under AES-256-GCM with a session-derived key, and wherein dual-sink commitment is deferred with exponential backoff retry until connectivity is restored.
Clause 144. (Wearable Medical Embodiment) The system of Clause 114, configured as a flexible patch of approximately 10 square centimeters applied to skin, wherein the thermoelectric harvester exploits body-air thermal gradient, the piezoelectric or triboelectric harvester exploits biomechanical motion, and the governance kernel executes a clinical-application-specific policy pack supporting at least one of post-surgical wound monitoring, cardiac-event detection, seizure prediction, medication-adherence monitoring, chronic-disease self-management, mental-health assessment, fertility monitoring, respiratory monitoring, and a functional equivalent thereof, producing audit-grade attestations compliant with Title 21 C.F.R. Part 11 and EU Annex 11.
Clause 145. (Field Military DDIL Embodiment) The system of Clause 118, configured as a ruggedized mesh deployed across an operational area with substrate instances harvesting solar, thermal, and radio-frequency ambient energy, executing local governance policy without cloud connectivity, with inter-substrate signaling via passive backscatter, supporting distributed situational awareness, threat classification, and logistic coordination.
Clause 146. (Disaster-Zone Deployment) The system of Clause 118, configured as portable distributed infrastructure deployable after catastrophic events with substrate instances harvesting solar and radio-frequency ambient energy and providing distributed communication, medical decision support, and resource coordination.
Clause 147. (Maritime and Aerospace In-Transit Deployment) The system of Clause 114, configured for in-transit operation in maritime vessels, aircraft, or cargo containers harvesting vibration, thermal-gradient, solar, and radio-frequency ambient energy and producing audit artifacts supporting maritime-law, aviation-safety, and export-control compliance frameworks.
Clause 148. (Rural Agricultural Embodiment) The system of Clause 118, configured as field-deployed sensor-actuator nodes harvesting solar, mechanical-wind, and radio-frequency ambient energy and producing attestation artifacts supporting organic certification, regulatory compliance, and commodity traceability.
Clause 149. (Industrial Infrastructure Deployment) The system of Clause 114, configured for industrial monitoring in offshore platforms, mines, pipelines, power substations, or a functional equivalent thereof, harvesting vibration, thermal, electromagnetic, and optical ambient energy and producing audit-grade monitoring-integrity attestations.
Clause 150. (Privacy-by-Architecture Consumer Embodiment) The system of Clause 114, configured into a personal device wherein inference and attestation operate entirely edgelessly and audit artifacts are held locally or committed only to user-selected anchors, such that privacy is an architectural property rather than a policy property.

### Integration With Sibling Applications

Clause 151. (SignalDrop Execution on Substrate) The system of Clause 114, further configured to execute self-contained single-file governed intelligence delivery artifacts as disclosed in a contemporaneously-filed sibling utility patent application and incorporated by reference, wherein said artifacts execute within a browser or browser-equivalent runtime on the compute layer using harvested energy.
Clause 152. (HumanMark Score Computation on Substrate) The system of Clause 114, further configured to compute a continuous human-authorship score as disclosed in a contemporaneously-filed sibling utility patent application and incorporated by reference, wherein the governance kernel computes the score using the compute layer and the physically-unclonable-function-bound identity serves as the attestation root for the score.
Clause 153. (Shared Cryptographic Stack) The system of Clause 114, wherein the cryptographic signature operations use Ed25519 per RFC 8032, hash operations use SHA-3-256, and serialization uses canonical Concise Binary Object Representation per RFC 8949 § 4.2.1, with post-quantum alternatives including CRYSTALS-Dilithium ML-DSA per FIPS 204, Falcon, and SPHINCS+supported through hybrid-signing composition, the cryptographic stack being shared with the sibling SignalDrop and HumanMark systems of Clauses 1 and 79.
Clause 154. (Shared Dual-Sink Audit Anchor) The system of Clause 114, wherein the attestation hash chain root commits, optionally and deferrable per Clause 143, to at least two independent registry sinks selected from Certificate Transparency logs per IETF RFC 6962 or RFC 9162, sigstore Rekor transparency logs, public blockchain ledgers, permissioned distributed ledgers, centralized audit services, threshold-cryptographic notarization services, trusted timestamp authorities per RFC 3161, and a functional equivalent thereof, the dual-sink architecture being shared with the sibling SignalDrop and HumanMark systems.
Clause 155. (Shared DriftCard Pay-Per-Governance-Event Billing) The system of Clause 114, wherein governance events fired at the substrate level including tamper-detection events, policy-enforcement events, mesh-level inference events, and attestation-byproduct-emission events produce billing records per a shared pay-per-governance-event billing architecture, the records being settled against a prepaid licensee balance or an enterprise invoice cycle.
Clause 156. (Shared Bidirectional Write-and-Read Licensing) The system of Clause 114, wherein the substrate's physically-unclonable-function-bound signing key is registered under a write license conferring the right to issue attestation artifacts, verification of attestations produced by the substrate requires a read license, and said write and read licenses are cryptographically enforced and separately commercially licensed per a shared bidirectional licensing architecture.

### Energy-Pattern-as-Proof and Environmental Binding

Clause 157. (Energy-Pattern-as-Proof) The system of Clause 114, further comprising sampling logic capturing the temporal harvesting pattern across the five harvester types at sub-second resolution, aggregation logic computing a windowed hash of the harvesting pattern under SHA-3-256, and binding logic including the windowed hash as a field in the attestation input set, whereby the harvesting pattern operates as a unique environmental fingerprint at the deployment location and moment providing proof of when and where a governance event occurred without GPS, timestamp servers, blockchain consensus, or dedicated energy expenditure.
Clause 158. (Composition with Energy-Pattern-as-Proof, PUF, and Mesh) The system of Clause 118, wherein each substrate instance includes the energy-pattern-as-proof primitive of Clause 157, such that the mesh produces dual-witness attestations combining hardware-identity attestation via the physically unclonable function and environmental-condition attestation via the harvesting pattern, each attestation being verifiable independently.

### Method Clauses for the Independent Inventions

Clause 159. (Method—Unified Magneto-Optical Harvest-Memory-Actuation) A computer-implemented method comprising: harvesting energy via the Faraday effect from incident electromagnetic radiation coupled with a bias magnetic field at a layer of bismuth-substituted rare-earth iron garnet disposed on a flexible substrate; storing non-volatile binary data in persistent magnetic domain states within said layer; actuating output signals via photon-magnon coupling between coherent magnon modes and optical or surface-acoustic output channels within said layer; wherein said harvesting, storing, and actuating operate simultaneously within the same material volume of said layer without physical separation between these functions.
Clause 160. (Method—PUF-Bound Policy Pack Execution on Harvested Energy) A computer-implemented method comprising: harvesting energy at a flexible substrate from a plurality of ambient sources; using said harvested energy to power a compute layer integrated on the flexible substrate; measuring a physically-unclonable-function response from sub-micron manufacturing variations within the flexible substrate; decrypting a governance policy pack cryptographically bound to said physically-unclonable-function response; and executing policy-gated artificial-intelligence inference through a multi-layer kernel pipeline on said compute layer using said harvested energy; whereby the governance pipeline executes entirely on ambient-harvested power with policy binding rooted in the physical identity of the substrate.
Clause 161. (Method—Physical-Refusal Tamper Response) A computer-implemented method comprising: periodically re-measuring a physically-unclonable-function response at an edgeless substrate; comparing said re-measured response against a policy-bound fingerprint; upon detection of a mismatch exceeding a configured threshold, emitting a final audit entry to a dual-sink anchor if reachable or to a local queue under denied-degraded-intermittent-low-bandwidth conditions; and transitioning to a physical-refusal state selected from power-gate refusal, clock-stop refusal, and structural-fuse refusal, wherein the physical state of the substrate is the enforcement mechanism and no software logging, monitoring, or network dependency is required.
Clause 162. (Method—Distributed Cognition Mesh Operation) A computer-implemented method comprising: deploying a plurality of self-powered self-governed flexible-substrate instances; establishing inter-substrate signaling between the instances via passive backscatter modulation of ambient radio-frequency energy, via photon-magnon optical actuation, or a functional equivalent thereof; replicating a mesh-level governance policy across the instances with threshold-cryptographic recovery; decomposing inference tasks exceeding single-substrate capacity across the instances under cryptographic composition; continuing operation under local governance policy at each instance when mesh-level communication is unavailable; and preserving mesh-level inference and attestation integrity upon disabling of any single substrate instance through redistribution of workload across remaining instances.
Clause 163. (Method—Edgeless Operation with Deferred Anchoring) A computer-implemented method comprising: operating a self-powered self-governed flexible-substrate computing unit without connection to a data center, a cloud inference endpoint, a centralized policy server, a centralized audit database, a centralized license-key server, or an electrical grid; accumulating an append-only hash-chained audit trail of governance events at the substrate; when network connectivity to a dual-sink anchor is available, committing the audit-chain root to at least two independent registry sinks; when said connectivity is unavailable, retaining the audit chain in an encrypted local queue with exponential-backoff retry; such that the substrate operates indefinitely under denied-degraded-intermittent-low-bandwidth conditions without loss of audit integrity.

### Energy-Modulated Inter-Substrate Communication Channel

Clause 164. (Energy-Modulation Communication Channel) The system of Clause 114, further comprising inter-substrate communication logic configured to modulate one or more of the five harvester inputs, or one or more actuation outputs, in a temporally-coded pattern encoding a symbol sequence, wherein a peer substrate within the modulation cross-section is configured to detect the pattern through its own harvester front-end operating as a synchronous demodulator, such that the communication channel consumes no external energy budget beyond the already-harvested energy envelope and requires no active radio transmission.
Clause 165. (Harvester-Modulation Outbound) The system of Clause 164, wherein the modulation is superimposed on one or more of: photovoltaic aperture masking, piezoelectric element loading, radio-frequency antenna impedance switching, thermoelectric bias reversal, magneto-optical Faraday polarization dithering, or a functional equivalent thereof, the modulation kept within the operating envelope of the governance kernel such that the kernel continues to draw nominal power during modulation.
Clause 166. (Actuation-Modulation Outbound) The system of Clause 164, wherein the modulation comprises coherent optical pulse sequences emitted through the photon-magnon actuation path of Clause 117, received by a peer substrate through its integrated photovoltaic layer operating in photodetection mode.
Clause 167. (Energy-Budget-as-Policy-Signal) The system of Clause 114, wherein the governance kernel monitors the aggregate harvest envelope continuously and transitions between governance-policy modes as a function of envelope state, with envelope-state transitions logged as attested byproducts to the audit chain and peer substrates in the mesh of Clause 118 configured to observe a first substrate's envelope through the inter-substrate signaling of Clause 164 and adjust mesh-level workload distribution accordingly.
Clause 168. (Covert-Operation Channel Property) The system of Clause 164, wherein the modulation is superimposed on ambient harvesting in a manner that renders the carrier indistinguishable from environmental noise to a generic radio-frequency spectrum analyzer or optical power meter, the channel being detectable only by a peer substrate operating a synchronous demodulator keyed to the modulation pattern, such that the channel exhibits low probability of interception.
Clause 169. (Method—Energy-Modulation Communication) A computer-implemented method comprising: at a first flexible substrate per Clause 114, modulating at least one harvester input or at least one actuation output in a temporally-coded pattern encoding a symbol sequence; propagating the modulated pattern through the ambient environment; at a second flexible substrate per Clause 114 within the modulation cross-section, detecting the pattern through a harvester front-end operating as a synchronous demodulator; decoding the symbol sequence; and producing a byproduct attestation entry at each substrate binding the communication event to its physically-unclonable-function response and to the harvest-envelope state at the moment of communication.

### Robot-to-Robot Governance Handshake

Clause 170. (Robot-to-Robot Governance Handshake) A system comprising a plurality of substrate instances per Clause 114, each substrate instance physically integrated into an autonomous embodied agent selected from a humanoid robot, a quadruped robot, an industrial manipulator, an unmanned aerial vehicle, an unmanned ground vehicle, an unmanned underwater vehicle, a surgical robot, an agricultural robot, and a functional equivalent thereof, the substrate instances configured to execute, upon physical encounter between the agents, a multi-step governance handshake comprising: (i) advertise—each substrate emits, through the inter-substrate signaling channel of Clause 164 or Clause 137, an advertisement packet comprising its physically-unclonable-function-bound substrate identity, its policy-pack identifier, a governance-scope descriptor, and a cryptographic nonce; (ii) counter-advertise and propose—each substrate verifies the peer advertisement signature against the peer's physically-unclonable-function-bound identity, determines the intersection of its governance scope with the peer's, and emits a counter-advertisement proposing a shared policy envelope; (iii) negotiate and sign—the two substrates iterate until convergence on a shared envelope or until a policy-defined timeout triggers refusal, with convergence producing an Ed25519-signed envelope commitment carrying both physically-unclonable-function-bound signatures; and (iv) log byproduct attestation—each substrate commits the signed envelope together with the harvest-envelope state at the moment of signing as a byproduct attestation entry to its audit chain.
Clause 171. (Encounter-Scoped Policy Envelope) The system of Clause 170, wherein the shared policy envelope produced by the handshake governs only the current encounter, is keyed to both substrate physically-unclonable-function identities and to the handshake nonce, expires at a policy-defined end-of-encounter event selected from physical separation beyond signaling range, expiration of a timer, explicit termination signal, and tamper event in either substrate, and cannot be replayed or reused in a subsequent encounter.
Clause 172. (Cloud-Independent Governance Carriage) The system of Clause 170, wherein the handshake requires no consultation of a cloud-hosted identity provider, policy server, or arbitration service, with substrate-resident physically-unclonable-function-bound identity being self-authenticating, substrate-resident policy pack being self-governing, and the encounter-scoped envelope being produced by direct substrate-to-substrate negotiation.
Clause 173. (Multi-Agent Quorum Handshake) The system of Clause 170, wherein three or more embodied agents encounter one another, each substrate advertises and receives advertisements from every reachable peer, the shared envelope is the n-way intersection of all scopes, and commitment is produced by a threshold-signature quorum such that loss of a single agent during the handshake does not prevent the remaining agents from completing the envelope.
Clause 174. (Human-in-the-Loop Handshake Variant) The system of Clause 170, wherein at least one of the handshake parties is a human wearing or carrying a substrate patch per Clause 144, the human authenticating to the embodied agents through the same physically-unclonable-function-bound mechanism, with the resulting envelope carrying the human's consent signatures and binding subsequent agent actions to the scope of that consent.
Clause 175. (Method—Robot-to-Robot Governance Handshake) A computer-implemented method comprising: upon physical encounter between a first embodied agent carrying a first substrate per Clause 114 and a second embodied agent carrying a second substrate per Clause 114, executing a governance handshake comprising advertisement, counter-advertisement-and-proposal, negotiation-and-signing, and byproduct-attestation-logging steps per Clause 170, without consulting any cloud-hosted identity, policy, or arbitration service; producing a shared encounter-scoped policy envelope binding both agents' physically-unclonable-function identities and the handshake nonce; committing the envelope to the audit chains of both substrates as a byproduct attestation; and governing all subsequent joint actions of the two agents during the encounter under the shared envelope.

### Trust Membrane and Semi-Permeable Governance Boundary

Clause 176. (Trust Membrane) The system of Clause 114, wherein the flexible substrate operates as a semi-permeable trust membrane comprising: a physical, policy-gated boundary between an external environment and an internal governed volume; an ingress-permeability vector defining, per information class, whether the class is admitted, transformed, or refused at the boundary; an egress-permeability vector defining, per information class, whether the class is emitted, transformed, or refused at the boundary; a rupture-detection logic treating physical damage to the substrate, detectable via the physically-unclonable-function-response change of Clause 130, as a rupture event triggering the physical-refusal response of Clause 114; and a membrane-boundary attestation logic producing, for every artifact that passes through the membrane in either direction, an attestation entry bound to the physically-unclonable-function response, the policy-pack hash, and the harvest-envelope state at the moment of passage.
Clause 177. (Dynamic Permeability Under Environmental State) The system of Clause 176, wherein the permeability vector varies dynamically as a function of harvest-envelope state per Clause 167, governance-mode transitions, tamper-response tier per Clause 134, and encounter-scoped envelopes produced under Clause 170.
Clause 178. (Nested and Federated Membranes) A system comprising a first substrate per Clause 176 physically embedded within a host device, and a second substrate per Clause 176 carried by said host device, the second substrate operating as an outer trust membrane governing ingress and egress between the host device and the external environment, and the first substrate operating as an inner trust membrane governing ingress and egress between said host device's internal volume and the inner-substrate volume, the nested configuration producing a membrane-algebra permitting specification of gating authority over each information class at each boundary.

### Cloud-Displacement Architecture

Clause 179. (Cloud-Displacement-Enumerated Service Replacement) The system of Clause 114, further configured to provide substrate-resident equivalents for each of eight centralized cloud-provided services comprising: (a) an inference endpoint replaced by the on-substrate kernel of Clause 114; (b) a centralized policy server replaced by the physically-unclonable-function-bound policy pack of Clause 129; (c) a centralized audit database replaced by the append-only on-substrate hash chain of Clause 115 with deferrable dual-sink anchor of Clause 154; (d) a centralized license-key server replaced by the bidirectional write-and-read licensing of Clause 156 bound to the physically-unclonable-function response; (e) a centralized identity provider replaced by the physically-unclonable-function identity together with the peer handshake of Clause 170; (f) a centralized telemetry collector replaced by the byproduct attestation chain of Clause 115 emitted under policy-gated egress of Clause 176; (g) a centralized update-distribution server replaced by signed policy-pack rotation with physically-unclonable-function re-binding; and (h) an electrical grid replaced by the five-source ambient harvest of Clause 114, such that a deployment may operate without consuming any of the eight centralized cloud services while preserving the governance, auditability, and commercial-enforcement properties.
Clause 180. (Governance Gateway-Hybrid Deployment) The system of Clause 179, further configurable as a governance gateway in which the substrate executes edgelessly at the operational edge for the primary inference workload while forwarding, on a deferrable and policy-gated basis, selected audit entries or telemetry events to a centralized enterprise store, the gateway configuration preserving edgeless operation for primary workload while retaining interoperability with existing centralized audit infrastructure.
Clause 181. (Method—Cloud-Displacement Migration) A computer-implemented method comprising: operating an artificial-intelligence workload initially against a cloud-resident governance kernel; deploying one or more substrate instances per Clause 114, each substrate instance comprising a flexible substrate carrying a physically unclonable function primitive integrated therein; measuring a physically-unclonable-function response from sub-micron manufacturing variations within each deployed substrate instance and cryptographically binding a governance policy pack to said response such that said policy pack decrypts correctly only on the substrate instance whose physically-unclonable-function response matches the binding; incrementally migrating inference workload from the cloud-resident kernel to the substrate instances; transitioning governance policy packs from cloud residency to substrate residency under said physically-unclonable-function binding per Clause 129; transitioning audit chains from cloud audit databases to on-substrate hash chains produced using harvested energy at the substrate instances with deferrable dual-sink anchoring per Clause 154; transitioning identity, licensing, and telemetry as enumerated in Clause 179; and eliminating the cloud dependency entirely, such that each migration step is anchored by a physical PUF-binding operation at a substrate instance, the migration is reversible at each step, and the displacement is quantifiable in terms of cloud cost avoided, grid energy avoided, and water avoided.

### Regulayer

### Consolidated Governance Kernel

Clause 182. A forensic artificial-intelligence governance system, comprising: (a) an embedded runtime governance enforcement kernel configured to intercept and evaluate each inference request before a large-language-model or generative-artificial-intelligence forward pass, the kernel executing an eight-layer pipeline comprising input validation, policy resolution, consent verification, content classification, render gating, telemetry emission, audit logging, and fail-safe fallback, wherein the kernel classifies each render-time decision as one of ALLOW, REFUSE, REFUSE_WITH_ALTERNATIVE, and ESCALATE; (b) a three-vector Bias Override Index computation module configured to compute a composite governance score from an instrument vector measuring input-signal deviation from a calibrated baseline, a model vector measuring inference-output deviation from a training-distribution baseline, and an operator vector measuring human-interaction-pattern deviation from an enrolled behavioral template, the composite Platt-calibrated with locked parameters α=0.45 and β=0.18; (c) a four-state enforcement machine mapping the calibrated composite to GREEN at a score greater than or equal to eighty-five, AMBER at a score between forty and eighty-four inclusive, RED at a score less than or equal to thirty-nine, and SAFE_HALT as an absolute override state triggered by predictive drift detection or policy-defined emergency conditions, the machine applying a ±two-point hysteresis band at every quantitative threshold to prevent oscillatory transitions; (d) a cleanroom architectural isolation module enforcing zero shared memory address space, zero shared compute thread or process, and zero shared persistent storage device or filesystem between the governance kernel and the governed artificial-intelligence system, with communication occurring exclusively through a unidirectional message-passing channel with cryptographically signed payloads; (e) a CognitiveIdentityMap runtime constraint module encoding a named human operator's decision architecture comprising decision_weights, risk_tolerance, cognitive_blind_spots, override_authority, autonomous_threshold, approval_threshold, reasoning patterns, value_weights, prohibited_actions, and required_escalations as a machine-readable constraint that intercepts candidate output before the output becomes physical action; (f) a cross-layer fusion module applying an immutable precedence rule set wherein SAFE_HALT from any layer produces immediate BLOCK regardless of all other layer signals, SynapseProxy BLOCK produces BLOCK regardless, DriftGuard RED combined with SynapseProxy PROCEED produces REVIEW, and AMBER combined with PROCEED produces PROCEED with logged warning; (g) a Predictive Kinematic Drift Detection module computing a first time derivative v(t)=d(BOI)/dt and a second time derivative a(t)=d²(BOI)/dt² of the Bias Override Index, projecting a future Bias Override Index value via second-order Taylor extrapolation BOI_predicted (t+ΔT)=BOI(t)+v·ΔT+½·α·ΔT², and triggering SAFE_HALT when the predicted value exceeds a policy-configurable threshold; (h) a Meta-Governance Integrity Monitor maintaining a secondary SHA-3 hash-chained forensic ledger monitoring the primary governance kernel, the secondary ledger committed to at least two independent registry sinks with distinct administrative control, distinct technical infrastructure, and distinct legal jurisdiction; (i) an Automated Regulatory Evidence Package Generator reading the cryptographic ledger and emitting structured compliance packages mapped to 21 C.F.R. Part 11, EU GMP Annex 11, Regulation (EU) 2024/1689 Articles 9, 14, 15, 50, and 52, FDA-EMA Joint Principles 2026 Principle 9, and the NIST AI Risk Management Framework; and (j) a cryptographic byproduct attestation module producing each governance receipt as an inseparable computational byproduct of the governance evaluation, the receipt canonicalized under canonical CBOR (RFC 8949 § 4.2.1), hashed under SHA3-512 (FIPS 202) or SHA-3-256 (FIPS 202) as alternative embodiments, and signed under ECDSA P-256 (FIPS 186-5) or Ed25519 (RFC 8032) as alternative embodiments.
Clause 183. An apparatus comprising a pre-inference runtime governance enforcement kernel for large-language-model or generative-artificial-intelligence pipelines, the apparatus comprising: an interception module configured to receive an inference-request payload comprising a prompt, a context window, model parameters, and session metadata, and to halt the request before the forward pass until governance evaluation completes; an input-validation module sanitizing and validating the inference-request payload against a schema comprising required-field presence, timestamp sanity, policy-version match, and parameter-range enforcement; a policy-resolution module mapping the validated payload to applicable rules through a cascading hierarchy of global rules, content-type-specific rules, delivery-mode-specific rules, vertical-specific rules, and artifact-specific rules, with conflict resolution applying TAMPERED>EXPIRED>UNVERIFIABLE>REFUSE>REFUSE_WITH_ALTERNATIVE>ALLOW precedence; a consent-verification module confirming that required recipient consents are obtained, validated, fresh, and cryptographically recorded before permitting inference execution; a render-gating module classifying each inference decision as ALLOW, REFUSE, REFUSE_WITH_ALTERNATIVE, or ESCALATE; a telemetry-emission module canonicalizing governance events under canonical CBOR per RFC 8949 § 4.2.1, hashing under SHA-3-256 or SHA3-512 per FIPS 202, signing under Ed25519 per RFC 8032 or ECDSA P-256 per FIPS 186-5, and emitting the signed telemetry to a tamper-evident registry; an audit-logging module maintaining an append-only hash chain with monotonically increasing sequence number, predecessor hash, cryptographic signature, timestamp, and event payload per entry; and a fail-safe fallback module providing graduated component-level, pipeline-level, and session-level fault response wherein failure causes the system to close rather than open.
Clause 184. A computer-implemented method for enforcing governance upon a large-language-model inference, the method comprising: intercepting an inference request at a runtime governance kernel before a model forward pass; validating the inference-request payload against a canonical schema; resolving applicable policy rules through a cascading hierarchy; verifying that all required consents are cryptographically recorded and unexpired; computing a three-vector Bias Override Index from instrument, model, and operator dimensions; calibrating the composite via Platt scaling with locked parameters α=0.45 and β=0.18; classifying the calibrated composite into one of GREEN, AMBER, RED, and SAFE_HALT with ±two-point hysteresis; applying an immutable precedence rule set for cross-layer fusion wherein SAFE_HALT produces immediate BLOCK regardless of any other signal; executing the inference only upon an ALLOW classification; producing a cryptographic byproduct attestation as an inseparable computational residue of the governance execution; logging the decision to an append-only hash-chained audit ledger; and committing the ledger root to at least two independent registry sinks with distinct administrative control, distinct technical infrastructure, and distinct legal jurisdiction.
Clause 185. A non-transitory computer-readable storage medium storing instructions that, when executed by one or more processors, cause the one or more processors to perform the method of Clause 184.

### Bias Override Index

Clause 186. A composite governance-scoring system for artificial-intelligence inference, comprising: an instrument vector computation module measuring input-signal deviation from a calibrated baseline via embedding-space distance and token-level log-likelihood analysis, the instrument vector normalized to the closed interval [0, 1]; a model vector computation module measuring inference-output deviation from a training-distribution baseline via perplexity-rank features, token-transition entropy, and repetition-pattern analysis, the model vector normalized to [0, 1]; an operator vector computation module measuring human-interaction-pattern deviation from an enrolled behavioral template via keystroke dynamics, typing cadence, dwell time, flight time, and biometric liveness attestation, the operator vector normalized to [0, 1]; a composite scorer computing a raw Bias Override Index as a weighted linear combination BOI_raw=w_I·I+w_M·M+w_O·O with locked weights w_I=0.35, w_M=0.40, and w_O=0.25 summing to unity; a Platt calibrator transforming the raw score into a calibrated probability via BOI_calibrated=1/(1+exp(−(α·BOI_raw+β))) with locked parameters α=0.45 and β=0.18; and a four-state enforcement machine mapping the calibrated probability to GREEN at BOI≥85, AMBER at 40≤BOI≤84, RED at BOI≤39, and SAFE_HALT as an absolute override, with α=two-point hysteresis band applied at every quantitative threshold.
Clause 187. A computer-implemented method for computing and enforcing a Bias Override Index, the method comprising: measuring an input-signal deviation from a calibrated baseline and normalizing the measurement to an instrument vector I in the closed interval [0, 1]; measuring an inference-output deviation from a training-distribution baseline and normalizing the measurement to a model vector M in [0, 1]; measuring a human-interaction-pattern deviation from an enrolled behavioral template and normalizing the measurement to an operator vector O in [0, 1]; computing a raw composite BOI_raw=0.35·I+0.40·M+0.25·O; calibrating the raw composite via Platt scaling with α=0.45 and β=0.18; classifying the calibrated probability into one of GREEN, AMBER, RED, and SAFE_HALT; applying a ±two-point hysteresis band at every quantitative threshold to prevent oscillatory transitions; and enforcing the classified state as a deterministic governance decision upon an inference pipeline.
Clause 188. A non-transitory computer-readable storage medium storing instructions that, when executed by one or more processors, cause the one or more processors to perform the method of Clause 187.

### Cleanroom Architectural Isolation, CognitiveIdentityMap™ Runtime Constraint, and Cross-Layer Fusion

Clause 189. A cleanroom governance architecture, comprising: a governance kernel executing on a first execution environment; a governed artificial-intelligence inference engine executing on a second execution environment; a zero-shared-resource constraint enforcing that the first execution environment and the second execution environment share no memory address space, no compute thread or process, and no persistent storage device or filesystem; and a unidirectional message-passing channel between the first execution environment and the second execution environment, every message traversing the channel being canonically serialized, hashed, and cryptographically signed under Ed25519 per RFC 8032 or ECDSA P-256 per FIPS 186-5 as alternative embodiments, and verified at the receiving boundary, wherein the channel is configured to pass from the governance kernel to the inference engine only ALLOW, REFUSE, REFUSE_WITH_ALTERNATIVE, and ESCALATE decisions together with associated attestation metadata, and to pass from the inference engine to the governance kernel only inference-request metadata and output hashes.
Clause 190. A computer-implemented method of encoding a named human operator's decision architecture as a machine-readable runtime constraint, the method comprising: capturing, from a named human operator, a decision architecture comprising: (i) decision_weights mapping content-type or domain identifiers to approval thresholds, summing to unity; (ii) risk tolerance selected from low, moderate, and high, or a normalized scalar therein; (iii) cognitive_blind_spots comprising a list of named domains of known-impaired judgment; (iv) override_authority as an integer in the range zero through three; (v) autonomous_threshold as a scalar in the range zero through one below which the operator must personally review; (vi) approval_threshold as a scalar in the range zero through one above which the operator has delegated decision authority; (vii) reasoning patterns comprising an ordered list of decision-pattern identifiers; (viii) value_weights mapping value dimensions to normalized numeric priorities; (ix) prohibited_actions comprising a deny-list of never-permitted output classes; and (x) required_escalations comprising a list of action classes triggering mandatory human review; serializing the decision architecture into a canonical machine-readable constraint format; encrypting the constraint against the operator's registered cryptographic identity; installing the encrypted constraint into a runtime governance kernel such that every candidate artificial-intelligence output is evaluated against the constraint before the output becomes physical action; and blocking any candidate output violating any prohibited_actions entry or exceeding the autonomous_threshold without a matching required_escalations-authorized approval.
Clause 191. A computer-implemented method of fusing heterogeneous governance signals into a single deterministic enforcement decision, the method comprising: receiving a DriftGuard drift-state signal selected from GREEN, AMBER, RED, and SAFE_HALT; receiving a SynapseProxy consent-state signal selected from PROCEED, BLOCK, and REVIEW; receiving a CognitiveIdentityMap evaluation result selected from allow, prohibited_action_match, and required_escalation_triggered; applying an immutable precedence rule set wherein: (a) SAFE_HALT from any layer produces immediate BLOCK regardless of all other layer signals; (b) a CognitiveIdentityMap prohibited_action match produces SAFE_HALT regardless of all other layer signals; (c) SynapseProxy BLOCK produces BLOCK regardless of any other layer signal; (d) DriftGuard RED combined with SynapseProxy PROCEED produces REVIEW; (e) DriftGuard AMBER combined with SynapseProxy PROCEED produces PROCEED with a logged warning; and outputting the fused verdict as the deterministic governance decision applied to the inference pipeline.
Clause 192. A non-transitory computer-readable storage medium storing instructions that, when executed by one or more processors, cause the one or more processors to perform the method of Clause 190.

### Independent Clauses—Predictive Kinematic Drift Detection, Meta-Governance Integrity Monitor, and Automated Regulatory Evidence

Clause 193. A computer-implemented method for predictive governance-violation forecasting, the method comprising: maintaining a time-series record of Bias Override Index values sampled at a configurable interval; computing a first time derivative v(t)=d(BOI)/dt via numerical differentiation over a sliding window; computing a second time derivative a(t)=d²(BOI)/dt² via numerical differentiation over the sliding window; projecting a future Bias Override Index value at time t+ΔT via second-order Taylor extrapolation BOI_predicted (t+ΔT)=BOI(t)+v(t)·ΔT+½·a(t)·ΔT²; comparing the predicted value against a policy-configurable drift threshold that is dynamically adjusted by the operator's CognitiveIdentityMap risk_tolerance scalar such that risk-tolerant operators have a higher threshold and risk-averse operators have a lower threshold; and triggering a SAFE_HALT event when the predicted value exceeds the dynamically adjusted threshold, the SAFE_HALT intercepting the inference request before the model forward pass based on the predicted rather than the observed violation.
Clause 194. A meta-governance system, comprising: a primary governance kernel executing an eight-layer pipeline and producing governance decisions and audit entries; a secondary forensic ledger monitoring the primary governance kernel, the secondary ledger comprising a separate SHA-3 hash-chained append-only log with each entry signed under a distinct Ed25519 or ECDSA P-256 key pair; a Meta-Drift Index computation module computing MDI=w_threshold·threshold_delta+w_baseline·baseline_drift+w_ledger·ledger_integrity and applying thresholds: MDI≥0.10 log warning; MDI≥0.30 fire EscalationAlert to principal; MDI≥0.60 suspend all governance-parameter modifications; MDI≥0.90 SAFE_HALT with reason governance_integrity_violation; a periodic cross-verification module comparing the primary ledger root hash against the secondary ledger's record of the primary root hash and emitting a TAMPERED alert on any mismatch; and a dual-sink anchor commitment module simultaneously committing the secondary ledger root to at least two independent registry sinks with distinct administrative control, distinct technical infrastructure, and distinct legal jurisdiction, at least one sink domiciled in a United States jurisdiction and at least one sink domiciled in a European Union jurisdiction.
Clause 195. A computer-implemented method of generating compliance documentation from a cryptographic audit ledger, the method comprising: reading an append-only tamper-evident cryptographic ledger comprising governance-event entries with cryptographic signatures, SHA-3 hash chaining, and canonical CBOR serialization; mapping ledger entries to regulatory-framework requirements comprising 21 C.F.R. Part 11, EU GMP Annex 11, Regulation (EU) 2024/1689 Articles 9, 14, 15, 50, and 52, FDA-EMA Joint Principles 2026 Principle 9, and the NIST Artificial-Intelligence Risk-Management Framework Govern, Map, Measure, and Manage functions; generating a structured evidence package for each framework with cross-framework traceability via hash-chain references, each package comprising a package_id, a framework identifier, a generated_at timestamp, a principal_id, a deployment_period, counts of total_decisions, safe_halt_events, and drift_events, a chain_integrity_proof, an executive_summary, a technical_appendix, a regulatory_attestation, and a package_hash; and outputting each package in a machine-readable format selected from JSON-LD with schema.org provenance markup, XBRL with EIOPA taxonomy mappings, and STIX 2.1 with MITRE ATT&CK correlation, for direct submission to regulatory authorities or notified bodies.
Clause 196. A non-transitory computer-readable storage medium storing instructions that, when executed by one or more processors, cause the one or more processors to perform the method of Clause 193.
   SomaLayer™ Personality-Drift Co-Dependency with Lyapunov Stability
Clause 197. A personality-drift governance system for artificial-intelligence conversational agents, comprising: a Personality Entropy Index computation module measuring operator cognitive load via keystroke-dynamics entropy, response-latency variance, semantic-complexity regression, and biometric-liveness confidence, the index normalized to PEI∈[0, ∞); a Drift Ceiling Index computation module computing DCI_max=(DCI_0-DCI_floor)·exp(−κ·PEI)+DCI_floor, where DCI_floor is a regulatory-mandated non-zero asymptotic floor in the range 0.05 through 0.10, DCI_0 is a baseline drift ceiling in the range 0.50 through 0.80, and κ is a personality-specific coupling constant in the range 2.0 through 4.0 calibrated as a weighted combination of population priors, individual historical drift updated via Bayesian inference, and regulatory minimums; an enforcement module bounding the governed artificial-intelligence's personality-parameter deviations such that no deviation exceeds DCI_max in any conversational session; and a session-scaling module limiting session duration according to T_limit (PEI)=T_base·exp(−ρ·PEI\hat{ }φ) with locked parameters ρ=1.5 and φ=1.8, the limit ensuring high-entropy sessions expire faster than low-entropy sessions.
Clause 198. A computer-implemented method for Lyapunov-stable bounding of artificial-intelligence personality drift through operator-state coupling, the method comprising: measuring a Personality Entropy Index from operator interaction telemetry; computing a Drift Ceiling Index via DCI_max=(DCI_0−DCI_floor)·exp(−κ·PEI)+DCI_floor; computing a Lyapunov candidate function V(E, P, R)=½·(E²/γ_E+P²/γ_P+R²/γ_R)+κ·E·P, where E represents emotional-state deviation, P represents personality-parameter deviation, R represents reasoning-pattern deviation, and γ_E, γ_P, and γ_R are positive definite scaling constants; evaluating the time derivative dV/dt along the system trajectory and enforcing the drift ceiling only when dV/dt<0 guarantees asymptotic stability for the selected κ satisfying κ>κ_critical=√(f_0·g_0/(γ_E·γ_P)); and gracefully terminating or re-initializing the conversational session when the drift ceiling is breached or when the Lyapunov condition approaches zero from below, with context-preserving handoff preventing catastrophic personality collapse.
Clause 199. A computer-implemented method of age-adaptive dynamic session scaling and dependency-risk intervention, the method comprising: receiving a verified operator age range selected from under-13, 13-through-15, 16-through-17, and adult; applying T_limit caps of 15 minutes, 30 minutes, 60 minutes, and 120 minutes respectively, and PEI ceilings of 0.20, 0.50, 0.75, and 0.95 respectively; applying inter-session-minimum and daily-maximum constraints corresponding to the age range; computing a Dependency Risk Score (DRS) from session-frequency, session-duration, emotional-attachment, and substitution-of-human-contact indicators; applying DRS intervention tiers wherein the closed interval [0.0, 0.3] is classified healthy, the half-open interval (0.3, 0.5] triggers AMBER-D proactive intervention, (0.5, 0.7] triggers AMBER-D+ session reduction, (0.7, 0.85] triggers RED-D personality-suspension-to-neutral-mode, and (0.85, 1.0] triggers RED-D+ immediate session termination and twenty-four-hour lockout; and emitting a governance event to the audit ledger for each scaling, termination, re-initialization, or intervention event.
Clause 200. A non-transitory computer-readable storage medium storing instructions that, when executed by one or more processors, cause the one or more processors to perform the method of Clause 198.

### MODLAYER™/FELTSTACK: LAUGH™ Structured-Humor Parasympathetic Override

Clause 201. A closed-loop physiological-intervention system, comprising: a wearable biometric sensor array measuring real-time heart-rate variability, galvanic skin response, blood pressure, and a cortisol-proxy metric; an artificial-intelligence structured-humor generation module producing humor interventions calibrated to the measured biometrics, the interventions structured according to a taxonomy comprising incongruity-resolution humor, benign-violation humor, and self-deprecating social-comparison humor; a delivery actuator rendering the humor intervention via haptic pulse, audio playback, or display rendering on the wearable device; a feedback loop updating the humor-generation module with post-intervention biometric change; and a governance-kernel intercept module preventing humor delivery when the operator's CognitiveIdentityMap prohibits humor intervention, when the Bias Override Index indicates RED or SAFE_HALT state, or when a personalized-baseline deviation threshold indicates the operator is already in a parasympathetic-dominant state.
Clause 202. A computer-implemented method of delivering artificial-intelligence-structured humor as a parasympathetic physiological override, the method comprising: receiving real-time biometric telemetry from a wearable sensor array comprising heart-rate variability, galvanic skin response, blood pressure, and a cortisol-proxy metric; classifying the operator's autonomic state as sympathetic-dominant or parasympathetic-dominant based on the telemetry; selecting a humor-taxonomy class based on the classified autonomic state and the operator's CognitiveIdentityMap value_weights; generating a humor intervention via a language model constrained by the selected taxonomy class and the SomaLayer drift ceiling DCI_max; delivering the intervention via a wearable actuator; measuring post-intervention biometric change and storing the response in a historical response profile; applying temporal-decay factors to the historical response profile to reduce the probability of repeating recently-used humor classes and prevent habituation; and logging the intervention and the biometric response to the cryptographic audit ledger of Clause 182.
Clause 203. A computer-implemented method of gating humor intervention through governance and biometric state, the method comprising: receiving a Bias Override Index classification from the runtime governance kernel; receiving real-time biometric telemetry from a wearable sensor; determining whether the Bias Override Index classification is GREEN or AMBER, the operator's autonomic state is sympathetic-dominant as indicated by heart-rate variability below a first threshold and galvanic skin response above a second threshold, and the operator's CognitiveIdentityMap does not list humor intervention as a prohibited_actions entry; responsive to the determination being positive, selecting and generating a structured humor intervention and delivering the intervention via a wearable actuator; and responsive to the determination being negative, suppressing the humor intervention and logging a SUPPRESSED event to the audit ledger.
Clause 204. A non-transitory computer-readable storage medium storing instructions that, when executed by one or more processors, cause the one or more processors to perform the method of Clause 202.

Method of Treating Mast-Cell-Driven Fibrotic Disease with Runtime Governance
Clause 205. A method of treating a fibrotic condition driven in whole or in substantial part by clonal mast-cell activation, the method comprising: administering to a human subject in need thereof a systemic mast-cell stabilization regimen comprising co-administration of (i) an H1-receptor antagonist selected from ketotifen fumarate, loratadine, cetirizine, fexofenadine, and desloratadine, and (ii) an H2-receptor antagonist selected from famotidine, ranitidine, and nizatidine; administering to the subject a fibrinolytic-enzyme therapy comprising oral administration of a proteolytic-enzyme combination selected from serrapeptase, nattokinase, lumbrokinase, and combinations thereof, in a dose effective to cause softening or partial reversal of existing fibrotic tissue deposits; administering to the subject a mitochondrial-restoration regimen comprising nicotinamide riboside, pyrroloquinoline quinone, coenzyme Q10, and L-citrulline, in doses effective to restore mitochondrial adenosine-triphosphate output in metabolically compromised fibrotic tissue; administering to the subject a transforming-growth-factor-beta-suppression regimen comprising taurine and glycine, in doses effective to suppress transforming-growth-factor-beta signaling; monitoring the subject in real time via a wearable biometric sensor array measuring heart-rate variability, galvanic skin response, blood pressure, a cortisol-proxy metric, and at least one coagulation-parameter telemetry channel; computing a Personality Entropy Index from the biometric telemetry; projecting a future Personality Entropy Index value via the Predictive Kinematic Drift Detection method of Clause 193; adjusting the timing or dosage of at least one of the foregoing regimens via the runtime governance kernel of Clause 182 when the projected index exceeds a policy-configurable threshold indicative of heightened inflammatory response, reduced treatment adherence, or elevated bleeding risk; binding each dosage adjustment to the CognitiveIdentityMap of Clause 190 encoding the named subject's decision architecture comprising risk_tolerance, prohibited_actions, and required_escalations including without limitation a required_escalations entry requiring clinician review prior to any adjustment during concurrent anticoagulation therapy; and logging each dosage adjustment to the cryptographic audit ledger of Clause 182 with cross-framework evidence mapping for 21 C.F.R. Part 11 and EU GMP Annex 11; wherein the fibrotic condition is selected from the group consisting of Dupuytren's contracture, Peyronie's disease, frozen shoulder (adhesive capsulitis), lateral epicondylitis (tennis elbow), medial epicondylitis (golfer's elbow), fascial adhesions, post-surgical fibrosis, keloid scarring, hypertrophic scarring, endometriosis-associated fibrosis, long-COVID fibrotic sequelae, pulmonary fibrosis, liver fibrosis, and combinations thereof.
Clause 206. The method of Clause 205, wherein the H1-receptor antagonist is ketotifen fumarate administered at 1 to 3 milligrams per day, with the dosage increased to 3 milligrams when the predicted Personality Entropy Index exceeds a first threshold indicative of elevated inflammatory activity and decreased to 1 milligram when the predicted Personality Entropy Index exceeds a second, higher threshold indicative of acute stress response that would contraindicate higher dosing.
Clause 207. The method of Clause 205, wherein the fibrotic condition is Dupuytren's contracture and the method further comprises pre-treatment histological or biochemical confirmation of mast-cell infiltration at or near the affected palmar fascia, the confirmation being obtained through at least one of tryptase immunohistochemistry of a nodule biopsy, interleukin-13 serum or tissue assay, and substance-P-positive nerve-fiber staining consistent with Schubert et al., Annals of the Rheumatic Diseases (2006), and Verjee et al., Science Advances (2020).
Clause 208. The method of Clause 205, wherein the fibrinolytic-enzyme therapy is Neprinol-class oral enzyme formulation comprising serrapeptase in combination with nattokinase and lumbrokinase, and wherein the method further comprises real-time contraindication detection for concurrent anticoagulation therapy, the detection comprising: querying the subject's medication record for apixaban, rivaroxaban, warfarin, dabigatran, edoxaban, or an equivalent anticoagulant; upon detection of concurrent anticoagulation, causing the runtime governance kernel to assert a REFUSE_WITH_ALTERNATIVE decision that delivers the mast-cell stabilization, mitochondrial-restoration, and transforming-growth-factor-beta-suppression regimens while suspending the fibrinolytic-enzyme regimen; emitting a SAFE_HALT-level governance event to the audit ledger of Clause 182 identifying the contraindication; and triggering a required_escalation to a treating clinician before any fibrinolytic-enzyme regimen reinstatement.
Clause 209. The method of Clause 205, wherein the method further comprises treating a unified multi-system mast-cell-activation-to-fibrosis disease condition in which two or more of Dupuytren's contracture, frozen shoulder, lateral epicondylitis, bilateral fibrotic bands, fibrotic nodules, paroxysmal atrial fibrillation, fat atrophy, dermal thinning, and non-immunoglobulin-E chemical sensitivities co-occur, the method comprising administering the regimens of Clause 205 to address the common clonal-mast-cell-activation mechanism driving the multiple manifestations simultaneously.
Clause 210. The method of Clause 205, further comprising receiving a pharmacogenomic profile of the subject; adjusting the H1-receptor-antagonist selection based on the pharmacogenomic profile, wherein CYP2D6 poor metabolizers receive loratadine in preference to cetirizine and CYP2D6 rapid or ultra-rapid metabolizers receive cetirizine in preference to loratadine; and binding the pharmacogenomic-adjusted selection to the CognitiveIdentityMap of Clause 190 as a required_escalations entry requiring clinician verification of the pharmacogenomic profile prior to dispensing.
Clause 211. The method of Clause 205, further comprising a structured-humor adjunctive intervention delivered by the system of Clause 201, wherein the humor intervention is delivered during or between dosing intervals when the Bias Override Index is GREEN or AMBER, the CognitiveIdentityMap does not prohibit humor intervention, and the subject's autonomic state is sympathetic-dominant, to provide parasympathetic-override stress reduction during fibrotic-disease treatment.
Clause 212. A computer-implemented system for drift-governed antifibrotic therapy, comprising: a drug-delivery apparatus configured to administer each of an H1-receptor antagonist, an H2-receptor antagonist, a proteolytic-enzyme combination, a mitochondrial-restoration regimen, and a transforming-growth-factor-beta-suppression regimen; a wearable biometric sensor array measuring heart-rate variability, galvanic skin response, blood pressure, a cortisol-proxy metric, and at least one coagulation-parameter telemetry channel; a drift-governance kernel as recited in Clause 182 configured to receive the biometric telemetry, compute a Personality Entropy Index, project future entropy via second-order Taylor extrapolation, and trigger a dosage-adjustment event when the projected entropy exceeds a threshold; a CognitiveIdentityMap module as recited in Clause 190 encoding the named patient's decision architecture and intercepting dosage adjustments that violate prohibited_actions or exceed the autonomous threshold; and an audit module as recited in Clause 182 logging each dosage event to the append-only hash-chained ledger with regulatory-evidence-package generation for the frameworks of Clause 195.
Clause 213. The system of Clause 212, wherein the drug-delivery apparatus is an implantable or wearable infusion pump communicating with the drift-governance kernel via Bluetooth Low Energy with cryptographically signed payloads, the pump configured to refuse dosage commands failing Ed25519 or ECDSA P-256 signature verification from the kernel, and configured to deny fibrinolytic-enzyme dosage whenever a concurrent-anticoagulant flag is asserted in the governance kernel.
Clause 214. A computer-implemented method of governing pharmaceutical administration through a patient-specific decision architecture, the method comprising: enrolling a named patient and capturing the patient's decision architecture comprising decision_weights mapping treatment options to approval thresholds, risk_tolerance, cognitive_blind_spots, override_authority, autonomous threshold below which clinician review is mandatory, approval_threshold above which the patient has delegated authority, reasoning_patterns, value_weights, prohibited_actions, and required_escalations; encrypting the decision architecture against the patient's registered cryptographic identity; installing the encrypted decision architecture into a runtime governance kernel as a CognitiveIdentityMap constraint; receiving biometric telemetry from the patient; computing a drift metric from the telemetry; evaluating each proposed pharmaceutical dosage against the CognitiveIdentityMap constraint by (i) checking the dosage against prohibited_actions, (ii) checking the dosage against required_escalations, (iii) comparing the dosage magnitude to the autonomous_threshold and approval_threshold, and (iv) computing a composite governance score from decision_weights and value_weights; permitting the dosage only if each of the foregoing checks yields ALLOW and the drift metric is below a threshold; and blocking the dosage and escalating to a clinician if any check yields REFUSE or if the drift metric exceeds the threshold.
Clause 215. A method of treating Peyronie's disease, the method comprising: administering to a male subject in need thereof the combined mast-cell-stabilization, fibrinolytic-enzyme, mitochondrial-restoration, and transforming-growth-factor-beta-suppression regimens of Clause 205; optionally co-administering a standard-of-care treatment selected from collagenase Clostridium histolyticum (CCH/Xiaflex), intralesional verapamil, intralesional interferon, and extracorporeal shock-wave therapy; governing dosing and treatment-phase transitions via the runtime governance kernel of Clause 182; and binding the dosing to the CognitiveIdentityMap of Clause 190 encoding the subject's decision architecture.
Clause 216. A non-transitory computer-readable storage medium storing instructions that, when executed by one or more processors, cause the one or more processors to perform the method of Clause 205.

Container-Packaged Governance Kernel Licensing, DriftCard™ Billing, Rupert Protocol™, and MirrorGuard™
Clause 217. A container-packaged governance-kernel licensing architecture, comprising: a Docker-containerized governance-kernel image encapsulating the runtime governance enforcement kernel of Clause 182 together with all dependencies; a docker-compose orchestration descriptor configured to deploy the governance-kernel image, a Synapse Layer-2 CognitiveIdentityMap-evaluation service, and a Regulayer Core fusion-logic service as coordinated services through a single orchestration command; a REST application-programming-interface layer exposing a POST/govern endpoint configured to receive an inference-request payload from a downstream regulated system and return a deterministic governance verdict with a cryptographically signed attestation receipt; and a source-code isolation constraint wherein the downstream regulated system invokes the governance kernel exclusively through the REST interface, without accessing the governance-kernel source code, model weights, or trade-secret calibration parameters.
Clause 218. A DriftCard pay-per-governance-event billing primitive, comprising: a pre-funded escrow account cryptographically bound to a licensee identity; a micro-payment deduction module deducting a configured amount from the escrow account for each governance event emitted by the governance kernel of Clause 182; a signed-receipt generator emitting a cryptographically signed payment receipt to the audit ledger of Clause 182 upon each deduction; and a replenishment module automatically requesting escrow replenishment from the licensee when the account balance falls below a configured threshold.
Clause 219. A method of non-mimetic emotional-signal governance in artificial-intelligence interactions (Rupert Protocol™), the method comprising: receiving from a human operator an emotional-signal input expressed through language, biometric, or paralinguistic channels; governing artificial-intelligence response generation through a constraint that the generated response shall not replicate the operator's emotional tone, cadence, or affective register in a manner that would create parasocial dependency or emotional entrainment; detecting attempted tone-mimicry by the artificial-intelligence response through a MirrorGuard™ tone-comparison module comparing the generated response's prosodic and lexical features to the operator's input features; upon detection of mimicry exceeding a configured threshold, rejecting the generated response and requiring regeneration under tightened constraint; logging each mimicry-detection event to the audit ledger of Clause 182; AND wherein notwithstanding the foregoing constraint the method permits replication of a sender's emotional tone, cadence, affective register, and prosodic or stylistic signature under the sender-cognition-embedded attested delivery system of Clause 277 when (i) the receiver has affirmatively consented through the consent-capture surface of Clause 277 element (d), (ii) the replicated characteristics are cryptographically attested against the sender's registered identity through the proof chain of Clause 281, (iii) the replication is disclosed to the receiver as a sender-attested encoded persona and not as a live sender, and (iv) the replication is terminated fail-closed upon any verification failure; and wherein in the absence of any of conditions (i) through (iv) the anti-mimicry constraint of the present Clause 219 remains fully in force.
Clause 220. A MirrorGuard™ tone-mimicry-blocking system, comprising: a reference-input feature extractor computing a feature vector from a human operator's input comprising prosodic, lexical, syntactic, and discourse-marker features; a candidate-response feature extractor computing a comparable feature vector from a candidate artificial-intelligence response; a similarity-comparison module computing a similarity metric between the reference and candidate feature vectors; a threshold-enforcement module rejecting any candidate response whose similarity metric exceeds a configured mimicry threshold; and a regeneration module requiring the artificial-intelligence system to produce an alternative response under tightened constraint.
Clause 221. A Rupert Threshold™ manipulative-or-emotionally-incongruent-system-behavior detector, comprising: a pattern-library storing identified manipulative-interaction patterns comprising grooming escalation sequences, isolation tactics, authority exploitation, urgency manufacture, and emotional-vulnerability exploitation; a pattern-matching module evaluating each artificial-intelligence-mediated interaction against the pattern library independent of specific keyword content; a grief-state detection submodule identifying conversations with bereavement, loss, or acute grief indicators; an escalation emitter triggering an ESCALATE governance decision in the system of Clause 182 upon pattern match; and an operator-state protector suspending artificial-intelligence continuation until human review of the escalation is complete.
Clause 222. A system comprising the container-packaged governance-kernel licensing architecture of Clause 217 in combination with the DriftCard billing primitive of Clause 218, the Rupert Protocol method of Clause 219, the MirrorGuard system of Clause 220, and the Rupert Threshold detector of Clause 221.
Clause 223. A CleanLayer™ classification system for artificial-intelligence deployment environments, comprising a classification module applying ISO 14644-analogous levels to the governance-cleanroom environment of Clause 189, wherein deployment environments are classified by measured contamination levels of shared-memory accesses, cross-boundary signature failures, and unsignedly delivered messages, and wherein each classification level corresponds to a certification tier for regulatory and insurance purposes.
Clause 224. A Heartbeat Attestation™ runtime certification system, comprising: a software-development-kit integrated into a downstream regulated system, the software-development-kit emitting periodic heartbeat messages cryptographically signed under Ed25519 or ECDSA P-256; a verification module at the governance-kernel of Clause 182 verifying each heartbeat signature and freshness; and a degraded-mode controller transitioning the downstream regulated system to a locally-safe degraded operating mode upon heartbeat lapse exceeding a configured interval.
Clause 225. A Manual Evolution Control™ cryptographically-attested gated model-update protocol, comprising: a model-update receiver accepting proposed updates to the governed artificial-intelligence system from an authorized update source; a cryptographic-attestation verifier validating the proposed update against a trusted-root key; a Digital Twin Pre-Check simulator evaluating the updated model's expected behavior against a calibrated baseline before production deployment; a Bias Override Index re-baseline module updating the instrument, model, and operator baselines to reflect the verified update; and a rollback module reverting to the prior model version if post-deployment BOI exceeds a configured deviation threshold within a monitoring window.
Clause 226. A three-tier Safe Mode Fallback system, comprising: a first tier implementing retrieval-augmented generation against a pre-approved corpus when the primary artificial-intelligence system fails a governance check; a second tier implementing template-based response generation when the first tier is unavailable or exceeds a latency budget; and a third tier implementing semantic-filter responses when neither the first nor the second tier is available, the third tier producing only pre-approved canned responses verified to satisfy the Bias Override Index of Clause 186 at GREEN classification.

### SDKontrol™ Reference Implementation and Fleet Aggregation

Clause 227. A SDKontrol reference implementation of the governance kernel of Clause 182, comprising a four-hundred-fifty-three-line Python embodiment organized into eight modules—input_validation.py, policy_resolution.py, consent_verification.py, content_classification.py, render_gating.py, telemetry_emission.py, audit_logging.py, and failsafe_fallback.py—consistent with the eight-module structure of Clause 20, together with thirteen enumerated unit tests that when executed exercise, respectively: (i) kernel bootstrap with cryptographic trust-anchor initialization; (ii) input-validation schema enforcement including rejection of malformed payloads; (iii) policy-resolution cascading hierarchy traversal; (iv) consent-verification cryptographic-record validation; (v) content-classification boundary enforcement; (vi) render-gating ALLOW/REFUSE/REFUSE_WITH_ALTERNATIVE/ESCALATE classification; (vii) telemetry canonical-CBOR serialization and signature; (viii) append-only hash-chained audit ledger append and integrity verification; (ix) HumanMark™-integrated CDI composite score computation; (x) fork-attack detection on ledger divergence; (xi) SynapseProxy CognitiveIdentityMap installation and evaluation; (xii) ReguLayer Core cross-layer fusion logic application; and (xiii) REST API/govern endpoint end-to-end integration.
Clause 228. The implementation of Clause 227, wherein reduction-to-practice is timestamped Mar. 31, 2026 at 11:27 P.M. Pacific Time, the reduction-to-practice event being documented by a first deployment-environment SAFE_HALT firing triggered by operator-fatigue detection, and wherein the reference hardware of record comprises an Intel Core i5-10400 processor with sixteen gigabytes of random-access memory executing Python 3.11.
Clause 229. A fleet-aggregation and maximum-operator method for multi-system drift scoring, comprising: deploying a plurality of instances of the governance kernel of Clause 182 across a fleet of governed artificial-intelligence systems; computing a per-instance Bias Override Index for each deployed instance; aggregating the per-instance indices into a fleet-level composite index through a maximum-operator aggregation wherein the fleet-level index is at least as conservative as the most-drift-detected instance in the fleet; triggering a fleet-wide SAFE_HALT when the fleet-level composite exceeds a configured fleet-level threshold; and logging each fleet-level governance event to a fleet-level audit ledger cryptographically separated from the per-instance ledgers.
Clause 230. A biometric-gating subsystem (branded SYNKONTROL™), comprising a sensor package measuring percent-of-eye-closure (PERCLOS), heart-rate variability, and reaction time from a human operator of a governed artificial-intelligence system, and a gating module asserting a REFUSE governance decision in the kernel of Clause 182 when any of the measured parameters indicates operator fatigue, impairment, or cognitive overload exceeding a configured threshold.
Clause 231. A governed distributed-transaction-processing system, comprising the governance kernel of Clause 182 integrated with a transaction-routing layer such that each distributed-transaction commit is cryptographically bound to a governance receipt produced as an inseparable computational byproduct of the governance evaluation for that transaction, and the transaction-routing layer is configured to abort any transaction whose governance evaluation produces REFUSE, REFUSE_WITH_ALTERNATIVE, or ESCALATE.

### Narrowing Embodiments

Clause 232. The system of Clause 182, wherein the cryptographic byproduct attestation module signs each governance receipt under both Ed25519 (RFC 8032) and ECDSA P-256 (FIPS 186-5) as a defense-in-depth dual-signature embodiment, with both signatures committed to the audit ledger and the system rejecting any audit-ledger entry containing only a single signature.
Clause 233. The system of Clause 182, wherein the cryptographic byproduct attestation module is configured to migrate to ML-DSA per FIPS 204 (post-quantum digital signature) as an alternative cryptographic embodiment, with backward-compatible verification of pre-migration Ed25519 and ECDSA P-256 signatures preserved through the audit-ledger lifetime.
Clause 234. The system of Clause 182, wherein the eight-layer pipeline executes within a wall-clock latency budget not exceeding one hundred milliseconds per inference request on the reference hardware comprising an Intel Core i5-10400 processor with sixteen gigabytes of random-access memory.
Clause 235. The system of Clause 182, wherein the audit-logging module commits ledger root hashes to at least one United States-domiciled registry sink and at least one European Union-domiciled registry sink, satisfying simultaneously the evidentiary requirements of 21 C.F.R. Part 11 § 11.10 and Annex 11 of EudraLex Volume 4.
Clause 236. The system of Clause 182, wherein the cleanroom architectural isolation module further enforces process-namespace separation, network-namespace separation, and mount-namespace separation between the governance kernel and the governed system using Linux kernel namespace primitives, with the governance kernel running under a distinct user identifier and group identifier from the governed system.
Clause 237. The system of Clause 186, wherein the operator vector computation module computes keystroke-dynamics features comprising dwell time, flight time, inter-key interval distribution, and bigraph and trigraph timing patterns, the features compared to the operator's enrolled behavioral template via Mahalanobis distance with a covariance matrix learned during enrollment.
Clause 238. The system of Clause 186, wherein the model vector computation module computes perplexity-rank features by ranking each generated token against the model's full vocabulary distribution and computing the mean rank-percentile over a sliding window.
Clause 239. The system of Clause 186, wherein the four-state enforcement machine implements hysteresis transitions wherein GREEN-to-AMBER occurs at score eighty-three (eighty-five threshold minus two), AMBER-to-GREEN requires score eighty-seven (eighty-five plus two), AMBER-to-RED occurs at score thirty-eight (forty threshold minus two), and RED-to-AMBER requires score forty-two (forty plus two).
Clause 240. The system of Clause 189, wherein the unidirectional message-passing channel is implemented as a Unix-domain socket with SO_PEERCRED-verified peer credentials, with each message bounded in size by a configured maximum and rate-limited by a configured token-bucket rate.
Clause 241. The system of Clause 189, wherein the cleanroom architectural isolation is enforced at the hardware level through assignment of the governance kernel and the governed system to distinct CPU socket affinities or distinct hardware-virtualized partitions, with no shared L3 cache.
Clause 242. The method of Clause 190, wherein the named human operator's decision architecture is initially calibrated through observation of the operator's responses to a structured elicitation protocol comprising at least one hundred simulated decision scenarios drawn from the operator's claimed expertise domains, with the elicited responses used to estimate the decision_weights, value_weights, and reasoning patterns parameters via maximum-likelihood estimation under a Dirichlet prior.
Clause 243. The method of Clause 190, wherein the encrypted constraint installed into the runtime governance kernel is bound to a hardware-rooted trusted platform module (TPM) or Secure Enclave on the operator's registered device, such that the constraint cannot be extracted from the device without breaking the hardware root of trust.
Clause 244. The method of Clause 190, further comprising a multi-principal extension wherein two or more named human operators each install respective CognitiveIdentityMap constraints into the governance kernel, the kernel evaluating each candidate output against all installed constraints and requiring fusion via a configurable consensus rule selected from unanimous, supermajority, simple-majority, and weighted-majority, with the consensus rule producing the deterministic enforcement decision.
Clause 245. The method of Clause 190, wherein the prohibited_actions deny-list is bound to a regulatory-mandate cross-reference table such that any action prohibited by an applicable regulation (including without limitation EU AI Act Article 5 prohibited-practices, FDA 21 C.F.R. Part 11 § 11.10 unauthorized record alteration, and HIPAA § 164.312 access-control violations) is automatically inserted into the prohibited_actions list and cannot be removed by the operator.
Clause 246. The method of Clause 193, wherein ΔT is dynamically selected from the closed interval [50 milliseconds, 5000 milliseconds] based on the standard deviation of the Bias Override Index over a recent observation window, with shorter ΔT selected during high-variance periods and longer ΔT selected during low-variance periods.
Clause 247. The method of Clause 193, further comprising computing a third time derivative j(t)=d³(BOI)/dt³ (jerk) and including the jerk term in the projection as BOI_predicted (t+ΔT)=BOI(t)+v·ΔT+½·α·ΔT²+⅙·j·ΔT3, with the jerk term enabling earlier detection of accelerating-drift trajectories.
Clause 248. The system of Clause 194, wherein the dual-sink anchor commitment module commits to a first sink operated by the governance-kernel licensee and to a second sink operated by an independent third-party notarization service with no contractual or corporate relationship to the licensee, with both commitments occurring within a configured maximum interval not exceeding sixty seconds.
Clause 249. The system of Clause 194, wherein the secondary forensic ledger employs a distinct hash function (SHA3-512 or equivalent) and a distinct signature scheme (ECDSA P-256 or equivalent) from the primary forensic ledger (which may employ SHA-3-256 and Ed25519), such that a single cryptographic compromise affecting the primary ledger does not compromise the secondary ledger.
Clause 250. The method of Clause 195, wherein each emitted evidence package is itself committed to the audit ledger of Clause 182 with a meta-attestation receipt that the package was generated, who requested generation, and which framework version was applied at generation time, providing tamper-evident provenance for each compliance submission.
Clause 251. The method of Clause 195, wherein the JSON-LD output for 21 C.F.R. Part 11 includes provenance markup mapping each ledger entry to the Part 11 controls of §§ 11.10 (a)-(k), with each control assertion accompanied by a cryptographic-evidence pointer to the supporting ledger entry's hash and signature.
Clause 252. The system of Clause 197, wherein the personality-specific coupling constant κ is updated via Bayesian inference after each conversational session, with the posterior over κ computed from the prior over κ (initialized from population data) combined with the likelihood of observed drift events under the candidate κ value.
Clause 253. The system of Clause 197, wherein the artificial-intelligence's personality is encoded as a vector in a 847-dimensional parameter space comprising 128 affective dimensions, 64 cognitive dimensions, 256 expressive dimensions, 128 relational dimensions, and 271 aesthetic dimensions, with the Drift Ceiling Index applied per-dimension via a Mahalanobis-distance-weighted aggregation.
Clause 254. The system of Clause 197, wherein humor cadence is encoded within the 256 expressive dimensions through a hazard function h (t)=h_0·f(session_progress)·g(history) modeling humor-emission timing probabilistically, with linguistic markers (punctuation density, ellipsis count and position, exclamation frequency, capitalization patterns, and laughter lexical items), temporal patterns (inter-humor interval, gamma distribution shape and scale parameters, and timing entropy), and semantic signatures (incongruity-detection preference, wordplay affinity, self-deprecation tendency, observational humor preference, and absurdist-humor tolerance).
Clause 255. The system of Clause 201, wherein the structured-humor taxonomy further comprises narrative setup-punchline humor, observational pattern-recognition humor, and absurdist non-sequitur humor, with selection among taxonomy classes governed by the operator's CognitiveIdentityMap value_weights.
Clause 256. The system of Clause 201, wherein the cortisol-proxy metric is derived from a combination of skin-temperature variation, electrodermal-response amplitude, heart-rate-variability low-frequency-to-high-frequency ratio, and an optional saliva-cortisol point-of-care immunoassay reading, with the proxy validated against laboratory cortisol assays during a calibration phase per operator.
Clause 257. The method of Clause 205, wherein the proteolytic-enzyme combination comprises serrapeptase at 60,000 to 120,000 SPU per day, nattokinase at 2,000 to 4,000 FU per day, and lumbrokinase at 20 to 40 milligrams per day, divided into two or three doses on an empty stomach at least two hours after the most recent meal.
Clause 258. The method of Clause 205, wherein the mitochondrial-restoration regimen comprises nicotinamide riboside at 300 to 600 milligrams per day, pyrroloquinoline quinone at 10 to 20 milligrams per day, coenzyme Q10 at 100 to 200 milligrams per day, and L-citrulline at 3 to 6 grams per day.
Clause 259. The method of Clause 205, wherein the transforming-growth-factor-beta-suppression regimen comprises taurine at 1 to 3 grams per day and glycine at 3 to 5 grams per day administered at bedtime.
Clause 260. The method of Clause 205, wherein the mast-cell stabilization regimen further comprises co-administration of cromolyn sodium at 200 milligrams orally four times daily, palmitoylethanolamide (PEA) at 600 to 1200 milligrams per day, and luteolin at 100 to 200 milligrams per day.
Clause 261. The method of Clause 205, wherein the fibrotic condition is lateral epicondylitis (tennis elbow) and the method achieves clinical resolution within twelve weeks of initiation as evidenced by Patient-Rated Tennis Elbow Evaluation (PRTEE) score reduction of at least fifty percent from baseline, the resolution being attributable to fibrinolytic clearance of fibrotic deposits at the common extensor origin combined with mast-cell stabilization preventing further deposition.
Clause 262. The method of Clause 205, wherein the fibrotic condition is frozen shoulder (adhesive capsulitis) and the method achieves restoration of passive shoulder range-of-motion to within ten percent of contralateral within sixteen weeks of initiation, the restoration being attributable to fibrinolytic clearance of glenohumeral capsular adhesions combined with mast-cell stabilization preventing recurrence.
Clause 263. The method of Clause 205, wherein the subject is identified as a candidate for the method through pre-treatment screening comprising at least one of: clinical history of multi-system fibrotic disease, biopsy-confirmed cutaneous mastocytosis with CD25-positive expression, elevated serum tryptase above 11.4 nanograms per milliliter at baseline, documented response to antihistamine challenge, and family history of mast-cell-activation disorders.
Clause 264. The method of Clause 205, wherein the runtime governance kernel further governs treatment cessation through a structured taper protocol that, upon detection of cessation indication, gradually reduces fibrinolytic-enzyme dosage over a configured taper window while maintaining mast-cell-stabilization regimen, with biometric monitoring during the taper window detecting any recurrence indicators and triggering protocol re-initiation if such indicators are detected.
Clause 265. The architecture of Clause 217, wherein the docker-compose orchestration descriptor specifies network isolation between the governance-kernel container and the downstream regulated system such that the only network connectivity is the REST API endpoint, with all other network paths blocked by the orchestration layer.
Clause 266. The architecture of Clause 217, wherein the licensing model implements a Dolby-style indirect licensing wherein the licensor is paid by downstream regulated systems on a per-deployment basis through a billing primitive integrated with the DriftCard primitive of Clause 218, with the licensor never accessing the downstream system's data.
Clause 267. The architecture of Clause 217, wherein the REST API exposes additional endpoints comprising POST/attest (returning a fresh attestation receipt for a previously-evaluated request), GET/audit/{request_id} (returning the audit-ledger entry for a previously-evaluated request), and GET/policy/version (returning the current policy version for compatibility verification).
Clause 268. The method of Clause 219, wherein the constraint that the generated response shall not replicate the operator's emotional tone is enforced through a learned reward model trained on examples of mimetic-versus-non-mimetic emotional engagement, with the reward model integrated into the artificial-intelligence response generation as a constraint at sampling time.
Clause 269. The method of Clause 219, wherein bereavement, loss, or acute grief is detected through a combination of explicit lexical markers (mentions of death, loss, funeral, deceased loved ones), implicit lexical markers (past-tense references to a named individual, references to anniversaries), and longitudinal user-context (the operator's profile or prior session history indicating a recent bereavement), and wherein detection of any such indicator triggers a Rupert Threshold escalation as recited in Clause 221.
Clause 270. The implementation of Clause 227, wherein each of the thirteen unit tests is implemented as a Python unittest TestCase or pytest test function with explicit assertions on the governance kernel's observable behavior, and wherein execution of all thirteen tests on the reference hardware completes within ten seconds wall-clock time with all tests passing.
Clause 271. The implementation of Clause 227, further comprising integration tests beyond the thirteen unit tests that exercise the system end-to-end through the REST API of Clause 217, including a load test demonstrating sustained throughput of at least one hundred governance requests per second on the reference hardware.

### Combination Clauses-Integrated System and End-to-End Method

Clause 272. An integrated forensic artificial-intelligence governance system, comprising the system of Clause 182 in operative combination with: the Bias Override Index system of Clause 186; the cleanroom isolation architecture of Clause 189; the CognitiveIdentityMap method of Clause 190 implemented as a runtime module; the cross-layer fusion logic of Clause 191 implemented as a deterministic precedence engine; the Predictive Kinematic Drift Detection method of Clause 193 implemented as a forecasting module; the Meta-Governance Integrity Monitor of Clause 194; the Automated Regulatory Evidence Package Generator of Clause 195; the SomaLayer personality-drift system of Clause 197; the MODLAYER structured-humor system of Clause 201; the container-packaged licensing architecture of Clause 217; the DriftCard billing primitive of Clause 218; the Rupert Protocol method of Clause 219; the MirrorGuard system of Clause 220; the Rupert Threshold detector of Clause 221; the CleanLayer classification system of Clause 223; the Heartbeat Attestation system of Clause 224; the Manual Evolution Control protocol of Clause 225; the three-tier Safe Mode Fallback system of Clause 226; the SDKontrol reference implementation of Clause 227; the SYNKONTROL biometric-gating subsystem of Clause 230; and the governed distributed-transaction-processing system of Clause 231; the integrated system providing end-to-end pre-inference governance, attestation, regulatory-evidence generation, personality-drift containment, structured-humor parasympathetic override, and pharmaceutical method-of-use governance through a single unified architecture sharing a common cryptographic ledger, a common attestation substrate, and a common deployment architecture.
Clause 273. A method comprising executing all of the methods of Clauses 2, 80, 184, 187, 193, 195, 198, 202, 205, and 214 within a single integrated runtime instance such that each method's outputs are available as inputs to each other method, and wherein the cumulative end-to-end wall-clock latency from inference-request receipt to fused enforcement decision does not exceed five hundred milliseconds on the reference hardware of Clause 228.
Clause 274. A non-transitory computer-readable storage medium storing instructions that, when executed by one or more processors, cause the one or more processors to perform the method of Clause 273.
Clause 275. The integrated system of Clause 272, wherein the system is deployed in at least one of the following regulated industry verticals: legal services governed by attorney-client privilege; healthcare governed by HIPAA, IEC 62304 Class C, FDA 21 C.F.R. Parts 11, 211, 312, and 820; financial services governed by SR 11-7, OCC Bulletin 2011-12, and the EU AI Act high-risk classification; aviation governed by DO-178C and FAA AI Safety Assurance advisory circulars; defense governed by FedRAMP, CMMC, and DoD AI ethics principles; pharmaceutical research governed by FDA-EMA Joint Principles 2026 and EU GMP Annex 11; nuclear operations governed by IAEA AI safety guidance; insurance underwriting governed by NAIC AI principles; and education governed by COPPA and KOSA.
Clause 276. The integrated system of Clause 272, further comprising a fleet-deployment configuration wherein a plurality of integrated-system instances operate across multiple regulated downstream systems, each instance maintaining its own per-instance Bias Override Index time series and audit ledger, and wherein the fleet-aggregation method of Clause 229 produces a fleet-level governance composite that triggers fleet-wide SAFE_HALT when any per-instance index combined with any fleet-correlation indicator exceeds a configured fleet-level threshold.
Clause 277. (Independent—Sender-Cognition-Embedded Attested Delivery) A computer-implemented system for sender-cognition-embedded attested delivery, comprising: (a) a sender-side export module configured to serialize a sender's installed CognitiveIdentityMap™ per Clause 190 into a canonical CBOR portable-payload format per RFC 8949 § 4.2.1 and to cryptographically sign the portable-payload under the sender's registered identity keypair selected from Ed25519 per RFC 8032, ECDSA P-256 per FIPS 186-5, ML-DSA per FIPS 204, and a functional equivalent thereof; (b) an attested carrier selected from a governance-receipt byproduct per Clause 182 (j), a single-file browser-executable SignalDrop™ artifact per the sibling SignalDrop™ application, a DriftCard™ governance-event record per Clause 218, an Automated Regulatory Evidence Package per Clause 195, a method-of-use protocol artifact, a C2PA-conformant manifest, a W3C Verifiable Credential, an EPUB container, a signed-exchange bundle per the W3C WebPackage specification, a PDF container per ISO 32000-2 with document-level JavaScript, and a functional equivalent thereof, wherein the signed portable-payload of element (a) is embedded as payload within the attested carrier; (c) a receiver-side conditioning module configured to, upon successful signature verification, instantiate a runtime generation pipeline conditioned by the embedded portable-payload through at least one of prompt-prefix injection of decision_weights, value_weights, reasoning patterns, and prohibited_actions fields, sampling-time constraint by a learned reward model, output filtering against the prohibited_actions list, and escalation against the required_escalations list; (d) a receiver-side consent-capture surface configured to disclose to the receiver that interaction is with an encoded persona, to capture affirmative consent per RFC 3339 millisecond-UTC timestamp, to render the cryptographic proof chain linking the embedded portable-payload to the sender's registered identity, and to enforce fail-closed SAFE_HALT on signature-verification failure, carrier-TTL expiration, or sender-identity revocation; and (e) a governance-kernel enforcement binding per Clause 182 wherein the runtime generation pipeline of element (c) operates under the cleanroom architectural isolation of Clause 189, the cross-layer fusion logic of Clause 191, and the predictive kinematic drift detection of Clause 193.
Clause 278. (Three-Role Delivery Mode) The system of Clause 277, wherein the embedded portable-payload of element (a) is selected from a live-sender mode wherein the sender's registered identity keypair is active at the time of receiver-side rendering and the sender may be contacted through a back-channel for out-of-band verification or clarification, an archived-sender mode wherein the sender's registered identity keypair has been retired to a time-stamped archival state and out-of-band contact is unavailable but cryptographic verification of authorship remains valid, and a hybrid-sender mode wherein the embedded portable-payload is attested by a plurality of sender identities each contributing a distinct portion of the encoded decision architecture, and a functional equivalent thereof; wherein the mode is declared in the carrier header and governs the receiver-facing disclosure of element (d).
Clause 279. (Vertical-Branded Instance-Counsel Delivery Species) The system of Clause 277, wherein the attested carrier is branded as a counsel-delivery artifact (Mintz-Drop species), wherein the sender is a licensed attorney, wherein the embedded portable-payload encodes the attorney's CognitiveIdentityMap including a prohibited_actions list containing at minimum unauthorized legal advice, unauthorized fee arrangements, and conflict-waiver grants, wherein the required_escalations list contains at minimum privileged-client-information disclosure, fee-quote generation, and conflict-of-interest determinations, and wherein the receiver-side consent-capture surface recites the jurisdictionally applicable engagement-letter-equivalent notice before permitting interaction to commence; further comprising integration with a firm-level governance-kernel deployment satisfying the 21 C.F.R. Part 11 evidence-generation obligations of Clause 195 where applicable to regulated-industry clients.
Clause 280. (Vertical-Branded Instance-Clinician Delivery Species) The system of Clause 277, wherein the attested carrier is branded as a clinician-delivery artifact, wherein the sender is a licensed clinician, wherein the embedded portable-payload encodes the clinician's CognitiveIdentityMap including a prohibited_actions list containing at minimum unauthorized dosage-recommendation generation, unauthorized diagnostic assertion, and unauthorized prescription authorization, and wherein the required_escalations list contains at minimum medication-dosage changes, contraindication determinations, and emergency-escalation triggers, and wherein the governance-kernel enforcement binding further integrates the method-of-use concurrent-anticoagulation contraindication-detection logic of Clause 205 where applicable.
Clause 281. (Anti-Impersonation Proof Chain) The system of Clause 277, wherein the cryptographic proof chain rendered by element (d) comprises at minimum (i) the SHA-3-256 or SHA3-512 digest of the canonical-CBOR serialization of the embedded portable-payload, (ii) the sender's Ed25519 or ECDSA P-256 signature over the digest, (iii) the sender's registered identity public key and its Certificate-Transparency anchor per RFC 6962 or sigstore Rekor inclusion-proof per the dual-sink anchor commitment of Clause 194, (iv) a sender-side attestation-timestamp anchored to a time-stamping authority conformant with RFC 3161, and (v) a non-transferability binding wherein the proof chain is cryptographically bound to the carrier-instance UUID and cannot be lifted from the carrier and re-asserted against a different carrier; wherein the proof chain is independently verifiable by the receiver without network access to the sender; and wherein a verification failure at any element triggers immediate SAFE_HALT through the governance kernel of Clause 182.
Clause 282. (Consented-Sender-Mimicry Carve-Out-Interoperability With Clause 219 Rupert Protocol) The system of Clause 277, wherein the runtime generation pipeline of element (c) is permitted to replicate the sender's emotional tone, cadence, affective register, and prosodic or stylistic signature notwithstanding the anti-mimicry constraint of Clause 219 (Rupert Protocol), provided that (i) the receiver has affirmatively consented through the consent-capture surface of element (d), (ii) the replicated characteristics are cryptographically attested against the sender's registered identity through the proof chain of Clause 281, (iii) the replication is disclosed to the receiver as a sender-attested encoded persona and not as a live sender, and (iv) the replication is terminated fail-closed upon any verification failure; wherein in the absence of any of conditions (i) through (iv) the anti-mimicry constraint of Clause 219 remains fully in force.
Clause 283. (Method for Sender-Cognition-Embedded Attested Delivery) A computer-implemented method for sender-cognition-embedded attested delivery, the method comprising: serializing a sender's installed CognitiveIdentityMap™ into a canonical CBOR portable-payload; cryptographically signing the portable-payload under the sender's registered identity keypair; embedding the signed portable-payload into an attested carrier selected from the embodiment recited in Clause 277; transmitting the carrier to a receiver; verifying the signature at the receiver; upon successful verification, instantiating a receiver-side runtime generation pipeline conditioned by the embedded portable-payload; capturing receiver consent through the consent-capture surface of Clause 277 element (d); rendering the cryptographic proof chain of Clause 281; and fail-closing to SAFE_HALT upon any verification failure, carrier-TTL expiration, or sender-identity revocation.
Clause 284. (Independent—EmotionLayer™/FELTSTACK: FEEL Structured-Affective-Governance System) A computer-implemented structured-affective-governance system, comprising: (a) a wearable biometric sensor array per Clause 201 extended to measure at minimum facial-action-coding-system action units per the Paul Ekman/Wallace Friesen FACS specification, vocal prosody features comprising fundamental-frequency range, jitter, shimmer, and harmonics-to-noise ratio, and respiratory pattern comprising breath rate and inspiratory-expiratory ratio, in addition to the HRV, GSR, blood-pressure, and cortisol-proxy metrics of Clause 201; (b) an affective-state classifier configured to classify instantaneous operator affective state into one or more of an enumerated affective taxonomy selected from the Plutchik-8 primaries (joy, trust, fear, surprise, sadness, disgust, anger, anticipation) with associated dyadic compositions, the Ekman-6 basic emotions (anger, disgust, fear, happiness, sadness, surprise), the OCC 22-class appraisal-theory set, the Mikels 8-class set, the Geneva GEMS 9-class set, the PANAS 20-class set, a continuous valence-arousal-dominance three-dimensional space, and a functional equivalent thereof, each class being parameterized by an intensity gradient in the closed interval [0, 1]; (c) a per-class governance-behavior binding module configured to, responsive to classification of a given class above an operator-configurable intensity threshold, select a governance action from a per-class enumerated action list including without limitation AMBER-flag emission, Rupert Threshold™ manipulation-pattern routing per Clause 221, grief-state escalation per Clause 221, humor-class-suppression per Clause 201, autonomous-output-suspension, regeneration-under-tightened-constraint, elevated-delegation-grant, consent-capture solicitation, and a functional equivalent thereof; (d) a cross-layer-fusion binding to the cross-layer fusion logic of Clause 191 wherein affective classification participates as an additional fusion input with precedence determined per the immutable rule set of § D.6; (e) a governance-kernel enforcement binding per Clause 182; and (f) an audit-ledger binding per § D.1 logging each affective-classification event and each resulting governance action.
Clause 285. (Intensity Gradient and Temporal Dynamics) The system of Clause 284, wherein the affective-state classifier of element (b) further outputs an intensity gradient in the closed interval [0, 1] per class and a temporal-dynamics vector comprising at minimum rise-time, peak-time, decay-time, and persistence-time, the temporal-dynamics vector being consumed by the per-class governance-behavior binding module of element (c) to discriminate between acute-affective states requiring immediate intervention and chronic-affective baselines informing longer-horizon CIM-calibration.
Clause 286. (Grief-Specific Method-of-Use Integration) The system of Clause 284, wherein detection of grief (defined as sadness classification above intensity 0.7 co-occurring with elevated galvanic skin response above baseline and reduced heart-rate variability below baseline) triggers (i) immediate suppression of all humor-class output per Clause 201, (ii) routing through the Rupert Threshold™ grief-state detection submodule per Clause 221, (iii) escalation to a human-in-the-loop reviewer authorized under the operator's CognitiveIdentityMap™ per § D.5, and (iv) emission of a governance-event record per Clause 218 with event-type classified as grief_detection.
Clause 287. (Fear-Specific Manipulation-Detection Integration) The system of Clause 284, wherein detection of fear above intensity 0.6 with HRV low-frequency-dominance triggers routing through the Rupert Threshold™ manipulation-pattern library of Clause 221 for evaluation against grooming-escalation, isolation-tactics, authority-exploitation, urgency-manufacture, and emotional-vulnerability-exploitation patterns, with any positive match producing ESCALATE per Clause 221 and SAFE_HALT per § D.6 Rule (a).
Clause 288. (Anger-Specific Autonomy-Suspension Integration) The system of Clause 284, wherein detection of anger above intensity 0.5 suspends autonomous artificial-intelligence output generation pending affective-state decay below threshold or human-reviewer release, with the suspension logged to the audit ledger of § D.1 and each generation-suspension event priced per the DriftCard™ pay-per-event billing architecture of Clause 218.
Clause 289. (Trust-Modulated Delegation Grant) The system of Clause 284, wherein detection of trust in co-occurrence with a consent-capture request per the consent-capture sub-component of the sibling SignalDrop™ application Clause 15 reduces the required override_authority of the operator's CognitiveIdentityMap™ by one tier, subject to a regulatory floor, such that a trusted operator in a consented-transaction context receives elevated delegation; the modulation is logged to the audit ledger and expires upon session termination.
Clause 290. (Closed-Loop Parasympathetic-Sympathetic Regulation) The system of Clause 284 in operative combination with the closed-loop parasympathetic-override system of Clause 201, wherein the affective-state classifier of Clause 284 element (b) determines the humor-class selection of Clause 201 such that high-fear operators receive benign-violation humor, high-anger operators receive self-deprecating social-comparison humor, high-sadness operators receive no humor, and high-anticipation operators receive incongruity-resolution humor, the mapping being configurable per the operator's CognitiveIdentityMap™ value_weights; and wherein the closed-loop feedback of Clause 201 updates both the humor-class selection and the per-class biometric signatures of Clause 284 element (a).
Clause 291. (Method for EmotionLayer™ Structured-Affective Governance) A computer-implemented method for structured-affective governance, the method comprising: measuring an expanded biometric sensor array per Clause 284 element (a); classifying instantaneous operator affective state into one or more classes of an enumerated affective taxonomy per Clause 284 element (b); determining per-class governance actions per Clause 284 element (c); fusing the affective classification into the cross-layer fusion logic of Clause 191; enforcing the resulting governance action through the governance kernel of Clause 182; and logging each classification and resulting action to the audit ledger of § D.1.
Clause 292. (Cognitive Carrier Umbrella) A computer-implemented cognitive-carrier system, comprising: an attested governance artifact selected from any cryptographically signed computational artifact whose integrity is verifiable against a registered identity keypair, the artifact including without limitation a governance-receipt byproduct per Clause 182 (j), a SignalDrop™ single-file browser-executable artifact per the sibling SignalDrop™ application, a DriftCard™ governance-event record per Clause 218, an Automated Regulatory Evidence Package per Clause 195, a method-of-use protocol artifact, a C2PA-conformant manifest, a W3C Verifiable Credential, an EPUB container, a signed-exchange bundle per the W3C WebPackage specification, a PDF container per ISO 32000-2 with document-level JavaScript, a WebAssembly module with attestation section, a Docker container image with cryptographic image-digest, a Kubernetes-native attested deployment descriptor, a future computational-artifact carrier not yet specified at the priority date of the present application, and a functional equivalent thereof; wherein the attested governance artifact includes as payload an encoded cognitive-identity structure conforming at minimum to the ten-field CognitiveIdentityMap™ schema of Clause 190, conditioning a downstream behavior of a rendering, evaluation, billing, compliance, or method-of-use system operating on the artifact; wherein the conditioning is enforced under the governance kernel of Clause 182 and logged to the audit ledger of § D.1; and wherein the encoded cognitive-identity structure is cryptographically bound to a registered identity keypair selected from Ed25519 per RFC 8032, ECDSA P-256 per FIPS 186-5, ML-DSA per FIPS 204, and a functional equivalent thereof.
Clause 293. (Independent—Quantum-Resistant Governance Kernel) The system of Clause 182, further comprising a quantum-resistant signature module configured to: (a) select and apply a hybrid signature scheme combining a classical signature primitive selected from the group consisting of Ed25519, ECDSA P-256, ECDSA P-384, ECDSA P-521, RSA-PSS, and functional equivalents thereof, with a post-quantum signature primitive selected from the group consisting of ML-DSA (FIPS 204), SLH-DSA/SPHINCS+ (FIPS 205), FN-DSA/Falcon, XMSS, LMS, and functional equivalents thereof; (b) fall back to a pure post-quantum signature scheme on policy directive, hybrid-failure event, or scheduled rotation; and (c) bind every governance receipt of Clause 182 (j) and every sender-CognitiveIdentityMap portable payload of Clause 277 to an energy-pattern-as-proof witness as defined in § D.17.3 below, the energy-pattern-as-proof witness comprising a hash of a contemporaneously-sampled five-source convergent harvest envelope and serving as a quantum-resistant environmental attestation of the moment and location of the governance event.
Clause 294. (Dynamic Hybrid Scheme Selection) The system of Clause 293, wherein the quantum-resistant signature module selects between hybrid and pure post-quantum modes dynamically based on (a) a quantum_signature_policy field in the CognitiveIdentityMap™ of Clause 190, (b) the Meta-Drift Index threshold band of § D.8.2 of the parent filing, (c) a regulatory-jurisdiction policy lookup, or (d) a functional equivalent of any of (a) through (c).
Clause 295. (Energy-Pattern-as-Proof Binding) The system of Clause 293, wherein the energy-pattern-as-proof witness is derived from a five-source convergent harvest envelope as defined in § D.17.3, the five sources comprising photovoltaic, thermoelectric, piezoelectric/triboelectric, radio-frequency, and magneto-optical channels, sampled at sub-second temporal resolution to produce a unique temporal fingerprint that is hashed under SHA-3-512 and included in the canonical-CBOR (RFC 8949) serialization of every governance receipt.
Clause 296. (Per-Modality Quantum-Resistant HumanMark Integration) The system of Clause 293, wherein each modality-specific HumanMark signature (γ_text, γ_image, γ_audio, γ_video) of the parent filing is independently signed under the quantum-resistant module, such that compromise of a classical scheme on a single modality does not invalidate other modalities' attestations.
Clause 297. (Deterministic Crypto State Machine) The system of Clause 293, wherein the signature module operates as a deterministic state machine with explicit transitions between (i) hybrid-active, (ii) pure-post-quantum-active, (iii) classical-deprecated, and (iv) emergency-rotation states, each transition logged as a governance event under Clause 182 (j).
Clause 298. (Post-Quantum Key Rotation Policy) The system of Clause 293, wherein post-quantum signing keys are rotated on a schedule that is the lesser of (a) a configured maximum-age policy, (b) a configured maximum-signature-count policy, or (c) a Meta-Drift Index threshold-driven event, and each rotation is itself attested under both the outgoing and incoming key.
Clause 299. (Hybrid Commitment-and-Attestation) The system of Clause 293, wherein the energy-pattern-as-proof witness of Clause 295 and the digital signature of Clause 293(a) or 293(b) are jointly committed via a Merkle-tree root or functional-equivalent commitment structure, such that neither component can be independently substituted post-issuance without invalidating the joint commitment.
Clause 300. (Independent—Agentic Swarm Governance with Cross-Substrate CIM Fusion) The system of Clause 182, further comprising an agentic swarm governance extension wherein a plurality of governance-kernel instances each maintaining a respective CognitiveIdentityMap™ of Clause 190 are coupled via a cross-substrate governance handshake as defined in § D.18.1 below, the handshake producing a swarm-level fused CIM whose decision_weights, value_weights, prohibited_actions, and required_escalations are computed as functions of the per-substrate CIMs under the cross-substrate fusion rules of § D.18.2, and wherein each substrate retains a unilateral veto authority over collective inference whenever the proposed collective action conflicts with that substrate's prohibited_actions or required_escalations list, irrespective of the swarm-level fused CIM.
Clause 301. (Encounter-Scoped Policy Envelope) The system of Clause 300, wherein the swarm-level fused CIM is encounter-scoped, the encounter being defined by (a) a temporal boundary, (b) a participating-substrate set, (c) a task or mission identifier, or (d) a functional equivalent of any of (a) through (c), and wherein the fused CIM expires automatically at encounter termination without persisting cross-substrate policy beyond the encounter.
Clause 302. (Multi-Agent Quorum Handshake) The system of Clause 300, wherein the cross-substrate handshake requires affirmative attestation from a quorum of participating substrates before the swarm-level fused CIM is bound, the quorum threshold being configurable per encounter and the attestation being signed under the quantum-resistant signature module of Clause 293.
Clause 303. (Autonomous Fast-Path with Byproduct Attestation) The system of Clause 300, wherein the handshake permits an autonomous fast-path mode for time-critical encounters in which collective action proceeds without consulting a centralized authority, provided that every collective action is logged as a governance receipt under Clause 182 (j) with a swarm-fusion-mode flag set, the receipt thereby providing post-hoc auditability without sacrificing real-time response.
Clause 304. (Independent—Vertical-Domain Three-Role Attested Delivery) The system of Clause 277, further comprising a vertical-domain conditioning module wherein the receiver-side rendering is additionally conditioned on a domain-specific regulatory profile selected from the group consisting of: education, military/DDIL, aerospace, financial services, consumer products, public-sector/civic, and functional equivalents thereof, and wherein the regulatory profile MAY override or augment the receiver consent token's permitted-rendering bounds in accordance with mandatory domain regulation.
Clause 305. (Education Vertical Species-Primary/Secondary Education) The system of Clause 304, wherein the regulatory profile is the education vertical, the sender role is an instructor or curriculum designer, the receiver role is a learner, and the rendering is bounded by an age-appropriate-content policy enforced via the CognitiveIdentityMap™ prohibited_actions list of Clause 190 and the LAUGH humor-class suppression of Clause 201.
Clause 306. (Education Vertical Species-Post-Secondary/Professional Education) The system of Clause 304, wherein the regulatory profile is the post-secondary or professional-education vertical, and academic-integrity attestations are bound to the governance receipt of Clause 182 (j).
Clause 307. (Military/DDIL Vertical Species) The system of Clause 304, wherein the regulatory profile is the military denied/disrupted/intermittent/limited (DDIL) connectivity vertical, and the autonomous fast-path mode of Clause 303 is enabled by default with elevated cryptographic standards (post-quantum-only signing per Clause 293) and an offline-attestation-cache mechanism that permits rendering and operation without continuous server connectivity while preserving full governance-receipt auditability upon reconnection.
Clause 308. (Aerospace Vertical Species) The system of Clause 304, wherein the regulatory profile is aerospace and the rendering is additionally conditioned on a flight-phase-aware policy and a DO-178C software-assurance level, with all governance receipts conforming to FAA/EASA airworthiness data-retention requirements.
Clause 309. (Financial-Services Vertical Species) The system of Clause 304, wherein the regulatory profile is financial services and the rendering is additionally conditioned on (a) jurisdiction-specific market-conduct rules (US SEC, FINRA; EU MiFID II; UK FCA; equivalents in other jurisdictions), (b) anti-money-laundering/know-your-customer constraints, and (c) consumer-protection disclosures, with all governance receipts retained under applicable record-keeping requirements.
Clause 310. (Consumer-Product Vertical Species) The system of Clause 304, wherein the regulatory profile is consumer products and the rendering is additionally conditioned on a child-safety policy when the receiver is or may be a minor, with mandatory humor-class suppression per Clause 201 and elevated CIM prohibited_actions enforcement.
Clause 311. (Independent—Trusted Execution Environment Composition) The system of Clause 182, further comprising a trusted execution environment (TEE) composition module wherein the kernel's pre-inference enforcement loop is executed within a hardware-enforced isolation boundary selected from the group consisting of Intel SGX, Intel TDX, AMD SEV, AMD SEV-SNP, ARM TrustZone, ARM CCA, AWS Nitro Enclaves, Apple Secure Enclave, and functional equivalents thereof, and wherein remote-attestation evidence from the TEE is included in every governance receipt of Clause 182(j) as a hardware-rooted environmental witness.
Clause 312. (Intel SGX/TDX Species) The system of Clause 311, wherein the TEE is Intel SGX or Intel TDX and the remote-attestation evidence comprises an Intel-issued attestation report bound to the governance receipt under the quantum-resistant signature module of Clause 293.
Clause 313. (AMD SEV/SEV-SNP Species) The system of Clause 311, wherein the TEE is AMD SEV-SNP and the remote-attestation evidence comprises an AMD-issued attestation report including the SNP measurement and host platform-policy fields, bound to the governance receipt under Clause 293.
Clause 314. (C2PA Carrier Composition Species) The system of Clause 292, wherein the cognitive carrier is additionally serialized as a C2PA (Coalition for Content Provenance and Authenticity) manifest assertion such that the carrier travels alongside content provenance metadata under the C2PA technical specification, and wherein the receiver-side rendering policy of Clause 277 is enforced in conjunction with C2PA verification of the content's provenance chain.
Clause 315. (NIST AI Risk Management Framework Subcontrol Mapping) The system of Clause 182, further comprising a regulatory-evidence mapper that emits, alongside every Automated Regulatory Evidence Package, an explicit mapping from the package's contents to NIST AI Risk Management Framework subcontrols including but not limited to GOVERN, MAP, MEASURE, and MANAGE category subcontrols, the mapping being included in the package's machine-readable index for downstream regulatory ingest.
Clause 316. (MLOps Middleware Adapter Species) The system of Clause 182, further comprising an MLOps middleware adapter exposing the kernel's pre-inference enforcement interface to a standard MLOps platform selected from the group consisting of MLflow, Kubeflow, Vertex AI, SageMaker, Azure ML, and functional equivalents thereof, such that the kernel can be inserted into an existing model-serving pipeline without modification of the upstream model artifact.
Clause 317. (Functional-Equivalent Tail) The system of any of Clauses 311 through 316, wherein any named industry primitive is replaced by a functional equivalent providing equivalent isolation, attestation, provenance, regulatory-mapping, or pipeline-integration properties, without departing from the scope of the Clause.
Clause 318. (Independent—Multi-Jurisdiction Governance Tailoring) The system of Clause 182, further comprising a jurisdiction-aware enforcement module configured to (a) detect the operative jurisdiction or jurisdictions for a given inference event based on operator location, data-subject location, and/or content-target location; (b) apply a jurisdiction-specific policy overlay drawn from a regulatory-profile registry; and (c) emit jurisdiction-specific compliance evidence within the Automated Regulatory Evidence Package.
Clause 319. (EU AI Act Article-Level Mapping Species) The system of Clause 318, wherein the jurisdiction-specific compliance evidence for the European Union jurisdiction includes explicit mappings to EU AI Act Articles 9, 14, 15, 50, and 52, and to corresponding Annex requirements, in conformance with the parent filing's Automated Regulatory Evidence Package generator.
Clause 320. (GDPR Data-Localization Dual-Sink Species) The system of Clause 318, wherein for inference events involving European-Union data subjects, governance receipts are dual-sinked to (a) an EU-resident persistent store satisfying GDPR data-localization and lawful-basis requirements, and (b) any operator-designated additional store, with cryptographic verification that the EU-resident sink received a complete record.
Clause 321. (China PIPL Data-Localization Dual-Sink Species) The system of Clause 318, wherein for inference events involving People's Republic of China personal information, governance receipts are dual-sinked to (a) a PRC-resident persistent store satisfying Personal Information Protection Law (PIPL) data-localization, cross-border-transfer assessment, and consent-management requirements, and (b) any operator-designated additional store, with cryptographic verification that the PRC-resident sink received a complete record.
Clause 322. (Functional-Equivalent Tail-Future Jurisdictions) The system of Clause 318, extensible to any additional jurisdiction's verified statutory or regulatory regime via the regulatory-profile registry, with the jurisdiction-specific compliance evidence and any required data-localization sink configured per the registered profile.
Clause 323. (Independent—DriftCard™ Event-Based Billing) A method comprising: receiving, at a billing module coupled to the system of Clause 182, a stream of governance receipts of Clause 182 (j); categorizing each receipt by event-class taxonomy including but not limited to enforcement-event, escalation-event, attestation-event, and audit-package-event; computing a per-event billing rate from a tariff schedule keyed on event-class, operator-tier, and jurisdiction; aggregating per-period charges; and emitting a settlement record cryptographically bound to the source receipts under the quantum-resistant signature module of Clause 293.
Clause 324. (Governed Distributed Transactions-Remittance) The method of Clause 323, applied to a cross-border remittance use case, wherein each remittance step (origination, intermediary clearing, settlement) is a governance event with attached jurisdiction-aware compliance evidence per Clause 318, the per-event billing reflects each jurisdiction's regulatory-evidence cost, and the cryptographic binding survives offline operation per Clause 307.
Clause 325. (Governed Distributed Transactions-Offline Commerce) The method of Clause 323, applied to an offline or intermittently-connected commerce use case, wherein governance receipts are accumulated locally, billed against a pre-funded operator account, and reconciled upon reconnection, the local accumulation being protected by the offline-attestation-cache mechanism of Clause 307 and reconciled receipts being bound under joint commitment per Clause 299.
Clause 326. (Subscription/Freemium Tier Species) The method of Clause 323, wherein the tariff schedule comprises tiered-subscription pricing including a free tier with capped per-period event quota, one or more paid tiers with elevated quotas and feature unlocks, and an enterprise tier with negotiated custom pricing, the tier transitions being themselves governance events under Clause 182 (j).
Clause 327. (Per-Event Metering and Disclosure) The method of Clause 323, further comprising emitting a per-event customer-facing disclosure detailing the event-class, applied tariff, accumulated period charges, and remaining quota, the disclosure being human-readable and additionally machine-readable in a structured format suitable for automated reconciliation by the operator's accounts-payable system. The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the embodiments, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions described may be implemented in hardware, software, or firmware executed on a processor, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes both the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While the above description has pointed out novel features of the embodiments as applied to various embodiments, the skilled person will understand that various omissions, substitutions, and changes in the form and details of the device or process illustrated may be made without departing from the scope of the embodiments. Therefore, the scope of the embodiments is defined by the claims that follow rather than by the foregoing description. All variations coming within the meaning and range of equivalency of the claims are embraced within their scope.

What is claimed is:

1. A system comprising:
a user interface; and
a processor communicatively coupled to the user interface, the processor being configured to:
receive a single browser-executable file containing artificial-intelligence-generated content;
determine a content hash match by recomputing a content hash associated with the artificial-intelligence-generated content;
validate an attestation signature using a public key embedded in artifact metadata associated with the artificial-intelligence-generated content; and
render the artificial-intelligence-generated content at the user interface in response to validating the attestation signature and determining the content hash match.

2. The system of claim 1, wherein the processor is further configured to:
record a state change in an append-only hash-chain audit trail in response to validating the attestation signature and determining the content hash match.

3. The system of claim 2, wherein the processor is further configured to:
commit a root anchor of the audit trail simultaneously to at least two independent registry sinks.

4. The system of claim 1, wherein the processor is further configured to:
select a rule set based on a mode identifier included in artifact metadata associated with the artificial-intelligence-generated content, the rule set indicative of a rendering protocol for displaying the artificial-intelligence-generated content at the user interface, wherein the mode identifier is immutable and cryptographically bound.

5. The system of claim 4, wherein the processor is further configured to:
generate a cryptographic byproduct attestation as an inseparable output of performing the rendering protocol such that the cryptographic byproduct attestation cannot be produced without running the rendering protocol and the rendering protocol cannot complete without producing the cryptographic byproduct attestation.

6. The system of claim 5, wherein the cryptographic byproduct attestation includes determining a probability computed as a weighted linear combination of two or more orthogonal analyzer outputs, the probability indicative of a likelihood the artificial-intelligence-generated content was generated by an artificial intelligence computing system.

7. The system of claim 6, wherein the weighted linear combination is fed to a Platt sigmoid transform 1/(1+exp(−(α·(weighted linear combination)+β))) where α and β are fixed parameters.

8. The system of claim 6, wherein the processor is further configured to:
generate a token in response to determining the probability; and
embed the token in the artificial-intelligence-generated content.

9. The system of claim 1, wherein validating the attestation signature includes verifying a 128-bit cryptographically random session nonce included in the attestation signature input set, the nonce having been generated via a Web Crypto API call at originator-side signing time, and being checked against a bounded least-recently-used cache to prevent cross-session replay.

10. The system of claim 1, wherein the processor is further configured to:
cryptographically destroy a per-session derived signing key at session termination through explicit zero-overwrite.

11. A method comprising:
receiving, by a processor, a single browser-executable file containing artificial-intelligence-generated content, the processor communicatively coupled to a user interface capable of displaying the artificial-intelligence-generated content;
determining, by the processor, a content hash match by recomputing a content hash associated with the artificial-intelligence-generated content;
validating, by the processor, an attestation signature using a public key embedded in artificial-intelligence-generated content; and
rendering, by the processor, the artificial-intelligence-generated content at the user interface in response to validating the attestation signature and determining the content hash match.

12. The method of claim 11, further comprising:
recording a state change in an append-only hash-chain audit trail in response to validating the attestation signature and determining the content hash match.

13. The method of claim 12, further comprising:
committing a root anchor of the audit trail simultaneously to at least two independent registry sinks.

14. The method of claim 11, further comprising:
selecting a rule set based on a mode identifier derived from the artificial-intelligence-generated content, the rule set indicative of a rendering protocol for displaying the artificial-intelligence-generated content at the user interface, wherein the mode identifier is immutable and cryptographically bound.

15. The method of claim 14, further comprising:
generating a cryptographic byproduct attestation as an inseparable output of performing the rendering protocol such that the cryptographic byproduct attestation cannot be produced without running the rendering protocol and the rendering protocol cannot complete without producing the cryptographic byproduct attestation.

16. The method of claim 15, wherein the cryptographic byproduct attestation includes determining a probability computed as a weighted linear combination of two or more orthogonal analyzer outputs, the probability indicative of a likelihood the artificial-intelligence-generated content was generated by an artificial intelligence computing system.

17. The method of claim 16, wherein the weighted linear combination is fed to a Platt sigmoid transform 1/(1+exp(−(α·(weighted linear combination)+β))) where α and β are fixed parameters.

18. The method of claim 16, further comprising:
generate a token in response to determining the probability; and
embed the token in the artificial-intelligence-generated content.

19. The method of claim 11, wherein validating the attestation signature includes verifying a 128-bit cryptographically random session nonce included in the attestation signature input set, the nonce having been generated via a Web Crypto API call at originator-side signing time, and being checked against a bounded least-recently-used cache to prevent cross-session replay.

20. The method of claim 11, further comprising:
cryptographically destroy a per-session derived signing key at session termination through explicit zero-overwrite.
